(19) United States
(12) Patent Application Publication
(10) Pub. No.: US 2026/0067229 A1
(43) Pub. Date: Mar. 5, 2026

(54) ENHANCED ENCODER-AWARE NETWORK QUEUE MANAGEMENT AND NETWORK QUEUE AWARE ENCODING

(71) Applicant: Michael H. Rudow, Cleveland, OH (US)

(72) Inventor: Michael H. Rudow, Cleveland, OH (US)

(21) Appl. No.: 18/975,704

(22) Filed: Dec. 10, 2024

Related U.S. Application Data
(60) Provisional application No. 63/687,570, filed on Aug. 27, 2024.

(51) Int. Cl. H04L 47/32; H04L 1/00; H04L 47/2441

(52) U.S. Cl. CPC H04L 47/32; H04L 1/004; H04L 47/2441

(57) ABSTRACT

A queue management system (including but not limited to active queue management systems, traditional networks, and/or software-defined networking), method, computer program product, or integrated circuit that selectively manages flows based on methods for how the data of the flows have been encoded (such as FEC and/or compression) and/or characteristics of the flows (including but not limited to loss-recovery capabilities). Similarly, an encoder system, method, computer program product, or integrated circuit can make encoding decisions based on known and/or anticipated queue management policy (e.g., an FEC encoder may be configured to make frame splitting, parity symbol allocation, and/or packetization decisions based on known and/or anticipated queue management policy, and a data compressor may be configured to make data compression decisions based on known and/or anticipated queue management policy).

### CROSS-REFERENCE TO RELATED APPLICATION(S)

This patent application claims the benefit of U.S. Provisional Patent Application No. 63/687,570 entitled ENHANCED ENCODER-AWARE NETWORK QUEUE MANAGEMENT AND NETWORK QUEUE AWARE ENCODING filed Aug. 27, 2024, which is hereby incorporated herein by reference in its entirety. The subject matter of this patent application also may be related to the subject matter of U.S. patent application Ser. No. 18/647,873 filed Apr. 26, 2024, which claims the benefit of U.S. Provisional Patent Application No. 63/523,184 filed Jun. 26, 2023, each of which is hereby incorporated herein by reference in its entirety.

### STATEMENT REGARDING PRIOR DISCLOSURES BY THE INVENTOR OR A JOINT INVENTOR UNDER 37 C.F.R. 1.77(b)(6)

Appendix A of U.S. Provisional Patent Application No. 63/687,570, which is incorporated herein by reference, is a paper entitled FEC-Aware Queue Management prepared as a class project. The inventor believes that he is the sole inventor of any inventions disclosed in the paper (notwithstanding that others helped with authorship of the paper) and believes that the paper was not made publicly available in any way that would invoke 35 U.S.C. 102. The paper was submitted to be “peer reviewed” by the class through a portal (https://hotcrp.com/). The inventor believes that access to the document through the portal required a password and therefore was not publicly available. There was a mock “program committee” of classmates to decide whether to “accept” the paper to a mock conference. The paper was not presented. Pursuant to the guidance of 78 Fed. Reg. 11076 (Feb. 14, 2013), Applicant is identifying this disclosure in lieu of filing a declaration under 37 C.F.R. 1.130(a). Applicant believes that such disclosure is subject to the exceptions of 35 U.S.C. 102(b)(1)(A) or 35 U.S.C. 102(b)(2)(a) as having been made or having originated from one or more members of the inventive entity of the application under examination.

### FIELD OF THE INVENTION

The present invention generally relates to a novel queue management mechanism that makes packet dropping and other queueing decisions to synergize with encoder mechanisms (e.g., FEC loss-recovery and/or compression mechanisms), referred to herein as “FEC-Aware Queue Management,” and to the novel use of knowledge from the queue manager to make encoding decisions (e.g., frame splitting, parity symbol allocation, packetization, and/or compression decisions), referred to herein as “Queue-Aware Encoding.”

### BACKGROUND OF THE INVENTION

Data communication is still prone to data loss. For example, videoconferencing calls sometimes experience “partial burst losses,” e.g., in which one or more channel frames experience the loss of some fraction of its packets. Despite many previous attempts at packet loss recovery, there is still a need for better mechanisms for packet loss recovery in such communications.

Two general approaches have been used to recover such lost packets, these are: (1) retransmission-based approaches, and (2) forward error correction (FEC) approaches. However, retransmission-based approaches often lead to a packet loss recovery delay time that is greater than the usual short, playback time requirement of live communications. Therefore, videoconferencing applications often focus on using FEC approaches and codes for recovering packet losses in real-time (e.g., for long-distance communication).

Various types of FEC codes have been used for these applications with only limited levels of success. For example, standard FEC codes such as Reed-Solomon codes are inefficient at recovering in real-time the bursts of packet losses, which frequently arise.

A relatively new class of theoretical FEC code constructions, known as “streaming codes,” have been specifically designed to decode such losses. However, there are several obstacles (e.g., streaming code constructions have often been designed for transmitting only one packet per frame; however, in videoconferencing multiple packets are frequently sent for individual video frames; their theoretically assumed burst loss patterns are often not those of the packet loss patterns that arise in real-world videoconferencing applications) that have so far limited the practical adoption of these streaming codes.

Examples in the patent literature of prior attempts to address the recovery of lost packets in digital communications can be found in the following numbered U.S. patents: U.S. Pat. No. 8,352,832—“Unequal delay codes for burst-erasure channels,” U.S. Pat. No. 9,209,897—“Adaptive forward error correction in passive optical networks,” U.S. Pat. No. 9,843,413—“Forward error correction for low-delay recovery from packet loss,” U.S. Pat. No. 10,833,710—“Bandwidth efficient FEC scheme supporting uneven levels of protection,” U.S. Pat. No. 10,979,175—“Forward error correction for streaming data,” U.S. Pat. No. 11,036,525—“Computer system providing hierarchical display remoting optimized with user and system hints and related methods,” U.S. Pat. No. 11,489,620—“Loss recovery using streaming codes in forward error correction;” and in U.S. Patent Publication Nos. US20130039410A1—“Methods and systems for adapting error correcting codes,” and US20230106959—“Loss recovery using streaming codes in forward error correction.” Additional examples also can be found in Kuhn, N. et al., RFC 9265—Forward Erasure Correction (FEC) Coding and Congestion Control in Transport, Internet Research Task Force (IRTF), July 2022.

### SUMMARY OF VARIOUS EMBODIMENTS

In accordance with one embodiment of the invention, a queue management system and method include at least one queue for storing and forwarding packets associated with a number of data flows and a queueing manager comprising at least one processor and at least one tangible, non-transitory computer-readable memory storing instructions which, when executed by the at least one processor, perform computer processes to manage queueing of packets including, for each data flow, determining forward error correction (FEC) and/or data compression encoding characteristics for the data flow associated with an encoding system for the data flow and managing queueing of data flow packets using the at least one queue based on the encoding characteristics for the data flow including at least selectively dropping and/or reordering data flow packets based on the encoding characteristics for the data flow.

In various alternative embodiments, the encoding characteristics may include at least one of how the data of the flow has been encoded or loss-recovery capabilities of the flow. Selectively dropping and/or reordering packets may introduce patterns of losses in the data flow that are consistent with loss recovery capabilities of the encoding system, e.g., patterns of losses that include partial burst losses with optional guardspaces or partial guardspaces in the packet flow consistent with loss recovery capabilities of the encoding system. Some or all of the encoding characteristics may be received by the queueing manager from the data flow encoding system and/or may be derived by the queueing manager from the data flow packets. Selectively dropping and/or reordering packets may be based on at least one of the type of encoding system, the type of flow, QoS/QoE specifications for the flow, FEC parameters used by the encoding system to produce the flow (e.g., i), a frame splitting scheme used to produce the flow, a parity allocation scheme used to produce the flow, guard space characteristics for the flow, failsafe characteristics for the flow, or a data compression scheme used to produce the flow. Managing queueing of data flow packets may involve at least one of deciding which of a plurality of queues to queue a given packet or selectively reallocating packets across a plurality of queues. The queueing manager may be trained, alone or together with the encoding system, based on actions in various states and a reward function, optionally wherein the training involves fixing a combination of some (possibly none or all) of the flows and the queue management system, training that which is not fixed, and then iterating by changing what is fixed. At least one of the queueing manager component, the FEC encoding component, or the data compression encoding component may be tuned based on at least one of the other components, optionally wherein parameters of each component are trained jointly through reinforcement or other machine learning. The encoding system may include an FEC encoding system such as a CSIPB or CSIPBRAL FEC encoding system.

Additional embodiments may be disclosed and claimed.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 is a schematic block diagram of a packet loss recovery system generally applicable to frame splitting encoders such as Tambur, CSIPB, and CSIPBRAL, in accordance with certain embodiments of the present invention.

FIG. 2 is a schematic diagram showing logical elements of the streaming encoder for CSIPB, in accordance with certain embodiments.

FIG. 3 is a schematic diagram showing the concept of data frame splitting for CSIPB, in accordance with certain embodiments.

FIG. 4 is a schematic diagram showing one possible frame splitting scheme for CSIPB, in accordance with certain embodiments.

FIG. 5 shows data frame splitting from Tambur using this patent application's notation.

FIG. 6 shows data frame splitting under Cisco (U.S. Pat. No. 9,843,413, which is hereby incorporated herein by reference) patent example code 2 using this patent application's notation.

FIG. 7 is a schematic diagram showing the concept of parity allocation for CSIPB, in accordance with certain embodiments.

FIG. 8 is a schematic diagram showing one possible parity allocation scheme.

FIG. 9 is a schematic diagram showing another possible parity allocation scheme using a heuristic.

FIG. 10 shows parity allocation from Tambur using this patent application's notation.

FIG. 11 shows parity allocation under Cisco patent example code 2 using this patent application's notation.

FIG. 12 is a factor graph of parity symbols for CSIPB that is complete for P[i].

FIG. 13 is a factor graph of parity symbols for all parity.

FIG. 14 shows an example factor graph for τ=10 under the Cisco patent example code 1 using this patent application's notation.

FIG. 15 shows an example factor graph for τ=12 under the Cisco patent example code 2 using this patent application's notation.

FIG. 16 shows an example factor graph from Tambur using this patent application's notation.

FIG. 17 shows parity symbol generation for the ith data frame in accordance with CSIPB, in accordance with certain embodiments.

FIG. 18 shows parity symbol generation for the ith data frame for CSIPB with fail safe, in accordance with certain embodiments.

FIG. 19 is a factor graph of parity symbols for CSIPB with failsafe, in accordance with certain embodiments.

FIG. 20 shows the concept of packetization in accordance with CSIPB.

FIG. 21 shows one way for packetizing the ith data frame in accordance with CSIPB (referred to herein as Packetization #1).

FIG. 22 shows a second way for packetizing the ith data frame in accordance with CSIPB.

FIG. 23 illustrates how transmission switching is reflected from sent packets to received packets (e.g., based on packet loss/reception).

FIG. 24 provides a simplified illustration of how transmission switching is reflected from sent packets to received packets (e.g., based on packet loss/reception).

FIG. 25 shows an example of what is sent for time slots i through (i+bᵢ+τ) for non-negative integers i, bᵢ, and τ.

FIG. 26 shows an example of what may be received for time slots i through (i+bᵢ+τ) for non-negative integers i, bᵢ, and τ.

FIGS. 27 and 28 illustrate the streaming loss model in which a partial burst loss over ≤bᵢ time slots (up to ┌lⱼcⱼ┌ of S⁽⁰⁾[j], . . . , S^{(c}^{ⱼ}⁻¹⁾[j] are lost for j∈{i, . . . , i+bᵢ−1}) is followed by a guard space of ≥τ time slots (FIG. 28 removes some notation from FIG. 27) for non-negative integers i, cⱼ, bᵢ, and τ and real number between 0 and 1 (inclusive) lⱼ.

FIGS. 29-33 depict intended loss recovery of a partial burst loss using CSIPB.

FIGS. 34-46 schematically show an offline optimization to find splits and parity allocation via a linear program, in accordance with one embodiment.

FIG. 47 is a schematic diagram representing a heuristic for splitting video frames to recover type “Γ” immediately for any partial burst, in accordance with one embodiment.

FIG. 48 is a schematic diagram representing a process for splitting video frames using the heuristic of FIG. 47.

FIG. 49 illustrates a general methodology for splitting frames using reinforcement learning, in accordance with certain embodiments.

FIG. 50 illustrates a general methodology for splitting frames and allocating parity symbols using reinforcement learning, in accordance with certain embodiments.

FIG. 51 schematically illustrates the concept of “state” for reinforcement learning, in accordance with certain embodiments.

FIG. 52 shows one example of a reward function for training frame splitting and/or parity allocation, in accordance with certain embodiments.

FIG. 53 shows a machine learning model such as a reinforcement learning model that can be applied at inference time, e.g., at the time of deciding how to split frames and/or allocate parity symbols.

FIG. 54 shows a machine learning model that generally would be trained offline using actual and/or simulated data (e.g., data representing a number of calls) and generally involves iterating over the dataset, computing the loss during each time slot, and updating the model using the loss.

FIG. 55 shows one example of neural network (NN) model for training frame splitting, in accordance with certain embodiments.

FIG. 56 shows one possible loss function (referred to herein as “loss function 1”), in accordance with certain embodiments.

FIG. 57 shows one possible way to train the NN during jth call and ith time slot, in accordance with certain embodiments.

FIG. 58 shows an example of another way to split frames using stochastic optimization to split frames on-the-fly.

FIG. 59 shows the concept of multiparty communication (e.g., videoconferencing with any number of people, such as by applying the methodology for each pair of people).

FIG. 60 shows an example of intended loss recover from the perspective of a frame when using a failsafe for CSIPB, in accordance with certain embodiments.

FIG. 61 provides an overview of how one can model estimating the partial burst parameters using a model conducive to reinforcement learning, in accordance with certain embodiments.

FIG. 62 illustrates the concept of “state” for the modeling of FIG. 61, in accordance with certain embodiments.

FIG. 63 shows one example of a possible reward function for the modeling of FIG. 62, in accordance with certain embodiments.

FIG. 64 shows one example for the action block of FIG. 61, in accordance with certain embodiments.

FIG. 65 shows an example of alternating training of (a) estimating the partial burst, and (b) the streaming code (e.g., splitting and/or parity allocation), in accordance with certain embodiments.

FIG. 66 shows an example of jointly training (a) estimating the partial burst, and (b) the streaming code (e.g., splitting and/or parity allocation), in accordance with certain embodiments.

FIG. 67 is a schematic diagram for a method to determine whether the lost data of the ith data frame can be recovered assuming the prior τ data frames have been recovered, in accordance with one embodiment.

FIG. 68 is a schematic diagram showing a representation of encoding with stripes, in accordance with one embodiment.

FIG. 69 is a schematic diagram showing a representation of decoding with stripes in accordance with FIG. 68.

FIG. 70 is a schematic diagram showing logical elements of the streaming encoder for CSIPBRAL, in accordance with certain embodiments.

FIG. 71 is a schematic diagram showing the concept of parity allocation for CSIPBRAL, in accordance with certain embodiments.

FIG. 72 is a schematic diagram showing the concept of a parity allocation scheme for the first type of parity symbols in accordance with CSIPBRAL.

FIG. 73 is a schematic diagram showing a first heuristic to allocate first type parity symbols, in accordance with certain embodiments.

FIG. 74 is a schematic diagram showing a second heuristic to allocate first type parity symbols, in accordance with certain embodiments.

FIG. 75 is a schematic diagram showing the concept of a heuristic to allocate second type parity symbols, in accordance with certain embodiments.

FIG. 76 is a schematic diagram showing a heuristic to allocate second type parity symbols, in accordance with certain embodiments.

FIG. 77 is a factor graph of parity symbols for CSIPBRAL complete for parity symbols of ith data frame, in accordance with certain embodiments.

FIG. 78 shows first type parity symbol generation for the ith data frame in accordance with FIG. 77, in accordance with certain embodiments.

FIG. 79 shows second type parity symbol generation for the ith data frame in accordance with FIG. 77, in accordance with certain embodiments.

FIG. 80 is a factor graph of parity symbols for CSIPBRAL with failsafe, in accordance with certain embodiments.

FIG. 81 shows first type parity symbol generation for the ith data frame in accordance with FIG. 80, in accordance with certain embodiments.

FIG. 82 shows second type parity symbol generation for the ith data frame in accordance with FIG. 80, in accordance with certain embodiments.

FIG. 83 illustrates data frame splitting for CSIPBRAL using an analogous process to CSIPB.

FIG. 84 shows the concept of packetization in accordance with CSIPBRAL.

FIG. 85 shows one way for packetizing the ith data frame in accordance with CSIPBRAL (referred to herein as Packetization #2).

FIG. 86 shows a second way for packetizing the ith data frame in accordance with CSIPBRAL.

FIG. 87 illustrates how transmission switching is reflected from sent packets to received packets (e.g., based on packet loss/reception).

FIG. 88 provides a simplified illustration of how transmission switching is reflected from sent packets to received packets (essentially same as CSIPB) (e.g., based on packet loss/reception).

FIG. 89 shows an example of what is sent for time slots i through (i+bᵢ+τ).

FIG. 90 shows an example of what may be received for time slots i through (i+bᵢ+τ) for non-negative integers i, bᵢ, and τ.

FIG. 91 illustrates recovery of lost symbols of Γ[i], . . . Γ[i+τ−1] and Υ[i+bᵢ], . . . , Υ[i+τ−1] by time slot (i+τ−1) in accordance with certain embodiments of CSIPBRAL.

FIG. 92 illustrates recovery of lost symbols Υ[j], Υ[j+τ] and δ[j+τ] during time slot (j+τ) in accordance with CSIPBRAL.

FIG. 93 shows one possible state of the system following the recovery of FIG. 92; lost parity symbols prior to time slot (i+bᵢ+τ) are shown as available because they can be computed using the recovered and received data, and certain packets of time slot (i+bᵢ+τ) are shown as lost (as part of the partial guard space, although a partial burst could have started during time slot (i+bᵢ+τ)).

FIG. 94 shows D[i:i+bᵢ+τ−1] recovered by time slot (i+bᵢ+τ−1).

FIG. 95 illustrates recovery of all lost symbols of D[i] during time slot (i+τ) by solving a system of linear equations over D[i−τ:i+τ] using the recovered symbols of D[i−τ:i−1] as well as the received symbols of (a) P[i:i+τ], (b) D[i:i+τ], and (c) G[i:i+τ].

FIG. 96 shows lightning bolts reflecting that symbols of R[i+1:i+τ−1] may be lost; however, it is possible that some of these symbols have been recovered (e.g., the symbols of Γ[i+1:i+τ−1] and Υ[i+bᵢ:i+τ−1] may already decoded by time slot (i+τ−1) in certain embodiments).

FIGS. 97-98 illustrate intended loss recovery if all prior data frames have been decoded (e.g., only guardspace loss or an earlier partial burst has been decoded along with all prior data frames).

FIG. 99 schematically shows an offline optimization to find splits and parity allocation via a linear program, in accordance with one embodiment.

FIG. 100 shows the system computing the total number of parity symbols.

FIG. 101 shows one way to adjust the split and add padding.

FIG. 102 illustrates modeling a partial burst starting in time slot i for constraints on loss recovery and modeling as a guard space (not a partial guard space) after the burst by assuming

$${l}_{j}^{( G )} = 0$$

for j∈{i+bᵢ, . . . , i+bᵢ+τ−1} for this modeling.

FIG. 103 shows useful symbols for loss recovery in time slot j∈{i, . . . , i+bᵢ−1} in accordance with one embodiment.

FIG. 104 highlights received symbols Γ[j].

FIG. 105 highlights received symbols Υ[j].

FIG. 106 highlights received symbols P[j].

FIG. 107 highlights received symbols G[j].

FIG. 108 shows useful parity symbols for loss recovery, in accordance with this example.

FIG. 109 shows an initial step for first type loss recovery in accordance with this example.

FIG. 110 shows intermediate steps for first type loss recovery in accordance with this example.

FIG. 111 shows the final step for first type loss recovery in accordance with this example.

FIG. 112 shows second type loss recovery in accordance with this example.

FIG. 113 shows how a sufficient number of useful symbols can be used to recover missing symbols of D[i:z] by times lot (z+τ) for each time slot z of the partial burst.

FIG. 114 shows that the optimization can be modified to apply during time slot i (i.e., after packets have been sent for previous time slots) by adding constraints to reflect the actions from earlier in the call (e.g., how much parity was allocated) and then using the offline linear program solver to determine the splits for the remainder of the call, where, without loss of generality, the system assumes

$${l}_{i}^{( G )} \leq {l}_{i}$$

for all i (since otherwise lᵢ is just set to equal

$${l}_{i}^{( G )} .$$

FIG. 115 is a schematic diagram representing a heuristic for splitting video frames to recover type “Γ” immediately for any partial burst, in accordance with one embodiment.

FIG. 116 is a schematic diagram representing a process for splitting video frames to minimize parity associated with each data frame i (referred to herein as “max heuristic PG,” where PG is for partial guardspace).

FIG. 117 illustrates a general methodology for splitting frames using reinforcement learning, in accordance with certain embodiments.

FIG. 118 illustrates a general methodology for splitting frames and allocating parity symbols for CSIPBRAL using reinforcement learning, in accordance with certain embodiments.

FIG. 119 schematically illustrates the concept of “state” for reinforcement learning, in accordance with certain embodiments.

FIG. 120 shows one example of a reward function for training frame splitting and/or parity allocation, in accordance with certain embodiments.

FIG. 121 depicts a machine learning model that can be applied at inference time, e.g., at the time of deciding how to split frames and/or allocate parity symbols.

FIG. 122 depicts one way a machine learning model would be trained offline using actual and/or simulated data (e.g., data representing a number of calls) and could involve iterating over the dataset, computing the loss during each time slot, and updating the model using the loss.

FIG. 123 shows one example of neural network (NN) model for training frame splitting, in accordance with certain embodiments.

FIG. 124 shows one possible loss function (referred to herein as “loss function 2”), in accordance with certain embodiments.

FIG. 125 shows one possible way to train the NN during jth call and ith time slot, in accordance with certain embodiments.

FIG. 126 shows an example of another way to split frames is using stochastic optimization to split frames on-the-fly.

FIG. 127 is a schematic diagram for a method to determine whether the lost data of the ith data frame can be recovered assuming the prior τ data frames have been recovered, in accordance with one embodiment.

FIG. 128 shows an example of intended loss recover from the perspective of a frame when using a failsafe for CSIPBRAL, in accordance with certain embodiments.

FIG. 129 provides an overview of how one can model estimating the partial burst parameters using a model conducive to reinforcement learning, in accordance with certain embodiments.

FIG. 130 illustrates the concept of “state” for the modeling of FIG. 129, in accordance with certain embodiments.

FIG. 131 shows one example of a possible reward function for the modeling of FIG. 130, in accordance with certain embodiments.

FIG. 132 shows one example for the action block of FIG. 129, in accordance with certain embodiments.

FIG. 133 shows an example of alternating training of (a) estimating the partial burst, and (b) the streaming code (e.g., splitting and/or parity allocation), in accordance with certain embodiments.

FIG. 134 shows an example of jointly training (a) estimating the partial burst, and (b) the streaming code (e.g., splitting and/or parity allocation), in accordance with certain embodiments.

FIG. 135 illustrates another heuristic for encoding data frames to minimize parity associated with each data frame i by allocating all symbols to the first component (i.e., Γ[i]=D[i] for each time slot i).

FIG. 136 is a schematic diagram of a data compression system, in accordance with certain embodiments.

FIG. 137 illustrates treatment of compression as a reinforcement learning problem, in accordance with certain embodiments.

FIG. 138 shows the concept of alternating training of compression and streaming code (e.g., splitting, parity allocation, and/or parameter estimation), in accordance with certain embodiments.

FIG. 139 illustrates updating the state during the ith time slot, in accordance with certain embodiments.

FIG. 140 shows an example of a possible type of reward function, in accordance with certain embodiments.

FIG. 141 shows one possible compression scheme, in accordance with certain embodiments.

FIG. 142 shows one possible decompression, in accordance with certain embodiments.

FIG. 143 shows another possible decompression allowing for flagging to wait to decompress until more data is available (e.g., decoded), in accordance with certain embodiments.

FIG. 144 illustrates spreading information content as a simplified approach, in accordance with certain embodiments.

FIG. 145 illustrates decompression after spreading information content. Decompression first improves the decompression of the previous data frame and then uses it to have a better estimate when decompressing the current data frame.

FIG. 146 shows one possible compression to spread information content: create information and then spread some of it until later by deferring sending it.

FIG. 147 illustrates a second possible compression to spread information content is to smooth out when it is generated (e.g., generate less information now and generate more later).

FIG. 148 illustrates decompression after spreading information content. Decompression first improves the decompression of the previous data frames and then uses them to have a better estimate when decompressing the current data frame.

FIG. 149 illustrates one possible decompression allowing for decompressing then flagging to consider waiting for more data to render the frame (once can use the extra data to decompress to a better estimate of the uncompressed frame) detailed example of one way the process could work.

FIG. 150 illustrates treating compression and communication action (e.g., splitting) as a reinforcement learning problem.

FIGS. 151-163 provide an example of frame splitting, parity generation, and packetization under CSIPBRAL, in accordance with certain embodiments.

FIGS. 164-171 provide an example of FEC-aware compression, in accordance with certain embodiments.

FIG. 172 is a schematic block diagram showing components of a sender device and/or receiver device in accordance with certain embodiments.

FIG. 173 is a schematic diagram for an FEC-aware packet queue management system in accordance with certain embodiments.

FIG. 174 provides an example of a class of loss model for FEC-aware queue management, in accordance with certain embodiments.

FIG. 175 provides an example of a simplified class of loss model for FEC-aware queue management, in accordance with certain embodiments.

FIG. 176 illustrates a packet dropping procedure to drop certain packets on entry, in accordance with certain embodiments.

FIG. 177 illustrates a packet dropping procedure to drop certain packets from within the queue management system, in accordance with certain embodiments.

FIG. 178 illustrates the ith time updating the state.

FIG. 179 illustrates an example of a possible type of reward function.

It should be noted that the foregoing figures and the elements depicted therein are not necessarily drawn to consistent scale or to any scale. Unless the context otherwise suggests, like elements are indicated by like numerals. The drawings are primarily for illustrative purposes and are not intended to limit the scope of the inventive subject matter described herein.

### DESCRIPTION OF ILLUSTRATIVE EMBODIMENTS

### Introduction

Embodiments of the present invention provide various improvements in packet loss recovery, and, likely by extension, the quality-of-experience (QoE) of real-time, digital communications such as videoconferencing, live streaming, remote desktop, cloud gaming, remote controlled vehicles, virtual reality, augmented reality, extended reality, satellite/space communication (including Internet and other communications through satellites), or virtually any video or non-video communication that may be subject to burst or partial burst losses and needs to be decoded within strict constraints.

Some prior works of the inventor relating to the subject matter of this patent application are described in the following publications, which are incorporated herein by reference:
Michael Rudow and K. V. Rashmi, “Online Versus Offline Rate In Streaming Codes For Variable-Size Messages,” 2020 IEEE International Symposium on Information Theory (ISIT), 2020;
Rudow, Michael, and K. V. Rashmi. “Online versus offline rate in streaming codes for variable-size messages,” IEEE Transactions on Information Theory, Vol. 69, No. 6, pp. 3674-3690, 2023;
Rudow, Michael, and K. V. Rashmi. “Streaming codes for variable-size arrivals,” 2018 56th Annual Allerton Conference on Communication, Control, and Computing (Allerton). IEEE, 2018;
Rudow, Michael, and K. V. Rashmi. “Streaming Codes for Variable-Size Messages,” IEEE Transactions on Information Theory, Vol. 68, No. 9, pp. 5823-5849, September 2022;
Rudow, Michael, and K. V. Rashmi. “Learning-augmented streaming codes are approximately optimal for variable-size messages,” 2022 IEEE International Symposium on Information Theory (ISIT). IEEE, pp. 474-479, 2022;
M. Rudow and K. Rashmi. “Learning-Augmented Streaming Codes For Variable-Size Messages Under Partial Burst Losses,” In 2023 IEEE International Symposium on Information Theory (ISIT), pp. 1101-1106, 2023;
M. Rudow, et al. “Tambur: Efficient loss recovery for videoconferencing via streaming codes,” In Proceedings of the 20^{th} USENIX Symposium on Networked Systems Design and Implementation, Apr. 17-19, 2023;
Rudow, Michael (2024). Efficient loss recovery for videoconferencing via streaming codes and machine learning. Carnegie Mellon University. Thesis. https://doi.org/10.1184/R1/24992973.v1;
M. Rudow, et al. “Compression-informed coded computing,” In 2023 IEEE International Symposium on Information Theory (ISIT), pp. 2177-2182, 2023;
U.S. Pat. No. 11,489,620;
United States Patent Application Publication No. US 2023/0106959; and
U.S. patent application Ser. No. 18/647,873 filed Apr. 26, 2024, which claims the benefit of U.S. Provisional Patent Application No. 63/523,184 filed Jun. 26, 2023.

It should be noted that this patent application, and all incorporated or referenced publications, documents, and things, are each considered to be internally consistent, e.g., conventions used in one (e.g., terminology, definitions, notations, representations, etc.) may be used differently in others. To the extent of any inconsistency or conflict in the conventions used in any of the incorporated publications, documents, or things and the present application, those of the present application shall prevail for purposes of this patent application.

Before explaining at least one embodiment of the present invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. For example, many embodiments refer to the use of machine learning (including reinforcement learning) such as to train any of various aspects of the invention, and it should be understood that this terminology is meant to capture training using any machine learning training methodology including, without limitation, gradient descent, stochastic gradient descent, Q-learning, policy gradient, Monte Carlo methods, temporal difference learning, etc.).

### Streaming Encoders

For the sake of the following discussion, a streaming encoder that splits data frames into multiple components and then allocates parity symbols based at least in part on one or more of the components is referred to herein as a “frame splitting encoder.” Certain frame splitting encoders split data frames into two components, although other embodiments could split data frames into more than two components. For convenience, embodiments described herein generally include data frames split into two components. It should be noted that, in certain embodiments described herein, the encoder can choose between one component or two (or more) components for a given frame or frames, and, for purposes of this disclosure and claims, such an encoder that can choose between one component and two (or more) components is considered a frame splitting encoder.

Some frame splitting encoders use a fixed frame splitting scheme in which frames are split into multiple components in the same way. For convenience, such a frame splitting encoder is referred to herein as a fixed frame splitting encoder. One example of a fixed frame splitting encoder is Tambur (see, e.g., Tambur paper; U.S. Pat. No. 11,489,620; U.S. Patent Application Publication No. US 2023/0106959), which splits data frames using a constant fraction (i.e., the first component is always XX % of the symbols of the data frame for each data frame) for a constant fraction that is periodically set and held constant for a period of multiple frames (such as setting the constant fraction once every −2 seconds).

Some frame splitting encoders use a variable frame splitting scheme in which different data frames can be split into two or more components in different ways such as into different size components for different data frames. For convenience, such a frame splitting encoder is referred to herein as a “variable frame splitting encoder.” One example of a variable frame splitting encoder is referred to herein as a Communication Scheme Intended for Partial Bursts (CSIPB), some aspects of which are disclosed in the above-referenced paper M. Rudow and K. Rashmi, “Learning-Augmented Streaming Codes For Variable-Size Messages Under Partial Burst Losses,” In 2023 IEEE International Symposium on Information Theory (ISIT), pp. 1101-1106, 2023; and also in U.S. patent application Ser. No. 18/647,873, which is hereby incorporated herein by reference. Another example of a variable frame splitting encoder is a novel Communication Scheme Intended for Partial Bursts and with Robustness to Arbitrary Losses (CSIPBRAL) described herein.

Certain features described herein apply specifically to variable frame splitting encoders (e.g., CSIPB, CSIPBRAL, etc.) while other features additionally or alternatively may apply to fixed frame splitting encoders (e.g., Tambur) or even to frame splitting encoders and in some cases to non-frame splitting encoders more generally.

### Overview of Novel Concepts

Without limitation, the following are some of the novel concepts disclosed herein:
A new mechanism for allocating and creating parity for frame splitting encoders that generates two or more types of parity symbols such as to address partial guardspace and other types of losses.
The novel use of reinforcement learning in frame splitting encoders to perform frame splitting and/or parity symbol allocation.
A new frame splitting heuristic that produces no second component.
Multimodal operation in which the variable frame splitting encoder can support and switch between different frame splitting mechanisms and/or different parity allocation mechanisms.
A novel data compression mechanism that leverages knowledge from the streaming encoders (e.g., frame splitting, parity allocation, parameters, etc.), the network conditions (e.g., types of packet losses), etc., to make data compression decisions (referred to herein as “FEC-Aware Compression”) including but not limited to (a) tuning the size of the compressed frames based on properties of the FEC scheme, and/or (b) spreading information content over one or a plurality of frames based on properties of the FEC scheme.
The novel use of knowledge from the data compressor to make frame splitting and/or parity symbol allocation decisions (referred to herein as “Compression-Aware FEC”).
The joint design of data compression and FEC (e.g., through training both the compressor and loss-recovery mechanism where both the compressor and loss-recovery mechanism are learned).
A novel queue management mechanism that makes packet dropping and other queueing decisions to synergize with encoder mechanisms (e.g., FEC loss-recovery and/or compression mechanisms), referred to herein as “Encoder-Aware Queue Management.”
The novel use of knowledge from the queue manager to make encoding decisions (e.g., frame splitting, parity symbol allocation, packetization, and/or compression decisions) based on queue management policy, referred to herein as “Queue-Aware Encoding.”

It should be noted that any of the concepts described herein can be used and claimed alone and/or in combinations of any two or more concepts.

### Overview of Frame Splitting Encoder Systems

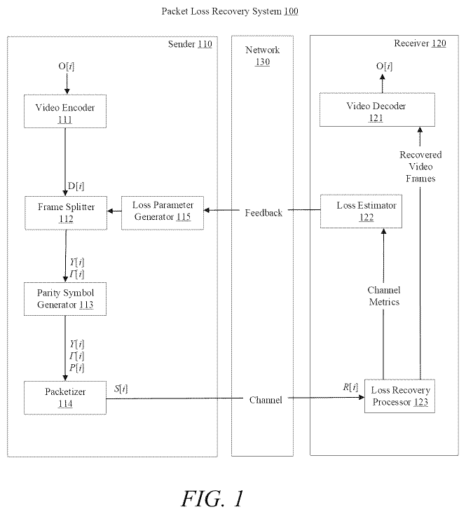

FIG. 1 is a schematic block diagram of a packet loss recovery system 100 generally applicable to frame splitting encoders such as Tambur, CSIPB, and CSIPBRAL, in accordance with certain embodiments of the present invention.

Among other things, the sender 110 includes a video encoder 111, a frame splitter 112, a parity symbol generator 113, a packetizer 114, and a loss parameter generator 115 (which logically may be part of the frame splitter 112 but is shown here separately for the sake of discussion). For convenience, the components encompassing the frame splitter 112, the parity symbol generator 113, the packetizer 114, and the loss parameter generator 115 may be referred to herein collectively as the “streaming encoder.”

Among other things, the receiver 120 includes a video decoder 121, a loss estimator 122, and a loss recovery processor 123. For convenience, the loss recovery processor 123 may be referred to herein as the “streaming decoder.”

The sender 110 and the receiver 120 communicate over a communication network 130 (sometimes referred to herein as a “communication channel” or just “channel” for communication from the sender 110 to the receiver 120) with the goal of conveying original video content O[i] (e.g., video content from a videoconference, live video stream, or other video source) from the sender 110 with recovery and output of the same original video content O[i] by the receiver 120. It should be noted that the term “video” as used herein can include video-related information (e.g., compressed or uncompressed video data, audio information, secondary audio program information, closed captioning information, and/or other types of data and metadata) although the concepts described herein can be applied more generally to any type of data and therefore embodiments are not limited to video-related data.

In summary, the sender 110 and receiver 120 perform the following operations:
(1a) at the sender 110, the video encoder 111 provides a stream of video frames D[i], which, for example, may be a stream of video frames that are received by the video encoder 111 (which could be compressed video frames) and optionally compressed by the video encoder 111 (e.g., if received video frames O[i] are not compressed),
(1b) at the sender 110, the loss parameter generator 115 provides loss estimation parameters (which are so named but may be set independently of losses in certain embodiments) for each of the video frames that in certain embodiments are modeled as a burst loss estimate and a packet loss estimate for each video frame as discussed herein (where the loss parameter generator 115 may receive burst/packet loss estimates as feedback signals from the loss estimator 122 of the receiver 120 as discussed below, or may generate its own burst/packet loss estimates or otherwise control loss estimation parameters and/or other parameters such as in the absence of feedback signals from the receiver or using machine learning),
(2) at the sender 110, the frame splitter 112 generally splits each video frame D[i] into two components, or a first and a second set of video data symbols, Υ[i] and Γ[i], based on the loss estimation parameters and the sizes of the video frames,
(3) again at the sender 110, based on the partitioning by the frame splitter 112, the parity symbol generator 113 generates a number of forward error correction parity symbols P[i] (i.e., linear combinations of data symbols from the a number of frames that are used to characterize and recover digital data if it is lost during its transmission),
(4) again at the sender 110, the packetizer 114 encodes or allocates the data symbols Υ[i] and Γ[i] and parity symbols P[i] into channel frames S[i] (where each channel frame includes one or more channel packets as discussed further below) in a manner that ensures recovery of the channel packets (and hence also the video frames encoded in the channel frames/packets) within a predetermined tolerance and transmits the channel frames S[i] to the receiver 120 over a lossy communication channel,
(5) at the receiver 120, the loss recovery processor 123 receives channel frames (referred to in the figure as R[i], as the received channel frames may differ from the transmitted channel frames S[i] due to burst losses, partial burst losses, and other communication issues where lost packets are known to be lost such as by examining sequence numbers in received packets) and recovers video frames using the data symbols and parity symbols from received channel frames/packets (note that the loss recovery processor 123 generally can recover video frames provided network losses do not exceed the tolerance for burst size and fraction of lost packets) and further provides channel metrics (e.g., frame and packet loss patterns, latency, frame/packet sizes, transmit times, etc.) to the loss estimator 122,
(6) again at the receiver 120, the video decoder 121 decodes the recovered video frames and outputs the decoded data to an output device, and
(7) again at the receiver 120, the loss estimator 122 estimates (e.g., using machine learning or heuristic techniques) future burst losses and fractions of packet losses for at least one future video frame and transmits these burst/packet loss estimates to the sender 110 as feedback signals for use by the loss parameter generator 115, although, alternatively, the loss estimator 122 may set burst/packet loss estimates using other methods (e.g., machine learning) so as to adjust the communication scheme.

It is absolutely critical to note that many of the prior works referenced herein use similar notation to mean very different things. Thus, for example, while many of the prior works split a video frame D[i] into two components (referred to here as Υ[i] and Γ[i] to distinguish from U[i] and V[i] components referenced in other works including other works of the inventor), generate parity bits called P[i], and send a channel frame S[i] that can be received as channel frame R[i], the values of Υ[i], Γ[i], and P[i] may be significantly different than the values of U[i], V[i], and P[i] referenced in other works, which will be clear from the present disclosure. In some cases, different terminology may be used to represent the same things (e.g., in some of the works, a channel frame may have been referred to as a packet). It should be noted that the concept of “error correction” discussed herein can apply to recovering from erasures (e.g., packet losses).

Generally speaking, the video encoder 111 may receive video frames O[i] periodically or substantially periodically (e.g., one every 33.3 ms for a 30 frame/sec video) and therefore video frames D[i] may be generated periodically or substantially periodically. In some embodiments, there may be a maximum size for incoming video frames O[i] and, if a particular incoming video frame (which may or may not be a compressed video frame) O[i] is larger than the maximum size, the system can split O[i] amongst multiple frames D[i], e.g., the system could create two video frames D[i] and D[i+1] if the size was greater than the maximum size but less than twice the maximum size, etc. This essentially would appear to the system as two or more video frames received back-to-back; it should be noted that when the intended loss recovery occurs, the latency will remain tolerable despite the splitting.

It should be noted that the loss estimation parameters produced by the loss parameter generator 115 and used to generate Υ[i], Γ[i], P[i], S[i] (e.g., burst/packet loss estimates) may be set conservatively in certain embodiments so that the losses are strictly better than those of actual burst/packet loss estimates with high probability. However, alternatively, these parameters can be used more generally as parameters to control the generation of Υ[i], Γ[i], P[i], S[i], e.g., used only as “knobs” to tune the coding construction (e.g., independently of any actual burst/packet loss estimates). Thus, for example, the loss estimation parameters generated by the loss parameter generator 115 and used by the frame splitter 112 may have no correlation to actual burst/packet losses experienced at the receiver 120 but instead could be set in other ways, e.g., based on expected or worst-case burst/packet loss estimates, or using additional metadata (e.g., one-way delay, channel frame rate, channel bit rate, network congestion information, etc.). Generally speaking, a “burst” can mean different things in different contexts, including but not limited to two or more packet losses within a predetermined number of consecutive frames, and, in this respect, the term “burst” does not limit embodiments to any particular type or length of losses.

In some embodiments, rather than splitting the data of a video frame into the two components Υ[i] and Γ[i], the two components may be created in other ways based on the data of the video frame such that, given access to a certain number of prior frames, the components Υ[i] and Γ[i] suffice to recover D[i]. For example, rather than Υ[i] and Γ[i] containing symbols of D[i], Υ[i] and Γ[i] could be full rank random linear combinations of the symbols of D[i]. That is to say, the construction is not required to be systematic.

It should be noted that channel frames/packets S[i] can be transmitted using any appropriate data communication protocol. For example, some embodiments transmit channel frames/packets using the User Datagram Protocol (UDP).

In certain embodiments, when losses do not exceed the estimates, the encoding scheme ensures that the first component is recovered strictly before its playback deadline and the other or second component is recovered by its playback deadline. Overall, estimating loss characteristics for each frame and using the estimates to create parity symbols enables the present invention to provide fine granularity for tuning the communication system's bandwidth overhead for each frame; in particular, the bandwidth overhead associated with a frame can vary from frame to frame. Doing so enables maximizing bandwidth savings while providing formal guarantees for recovering burst losses within a bounded latency.

It should be noted that the loss estimation parameters fed back from the receiver 120 to the sender 110 can be viewed as the receiver 120 conservatively estimating how lossy the network conditions will be based on prior losses or network conditions. For example, the feedback could report on actual prior losses (e.g., a frame or packet loss rate over some number of past channel frames or packets) or the feedback could provide a prediction of an upcoming frame or packet loss rate (e.g., if network conditions are deteriorating, then the feedback could predict a greater channel frame or packet loss rate than was actually detected in the past). In certain embodiments, the loss parameter generator 115 also could estimate loss parameters such as from prior feedback or other information (e.g., network performance information received from the receiver 120 or from other sources). The loss estimator 122 and/or the loss parameter generator 115 may utilize AI/ML or other predictive analytics to produce future loss estimation parameters based on any relevant data source. Additionally, the loss estimation parameters can be treated in some embodiments as a “knob” to adjust the coding scheme (e.g., using machine learning, including reinforcement learning) rather than based on actual burst/packet loss estimates, as discussed above. Certain embodiments therefore perform learning-augmented encoding of video frames to improve QOE (e.g., by optimizing for metrics meant to approximate the QOE, including but not limited to peak signal-to-noise ratio (PSNR), structural similarity (SSIM), or Learned Perceptual Image Patch Similarity (LPIPS)).

It should be noted that the video frames, D[i], may have different numbers of symbols, e.g., due to data compression variability. It should be noted that data compression algorithms usually (but not always) introduce dependencies between compressed video frames, e.g., where the ability to decompress one compressed video frame depends on having correctly decompressed one or more prior compressed video frames.

Each video frame, for example the ith video frame, denoted as D[i], is partitioned, where each symbol in the partitioning can be thought of as a vector where the symbol is an element of a mathematical entity called a field (e.g., a finite field, or other fields like the real numbers). An illustrative example would be a finite field of non-negative integers mod a prime, where all operations are performed over finite fields such as using modular arithmetic or extension fields (the order is a prime power) where arithmetic is field arithmetic and is not necessarily “modular arithmetic.” For simplicity, the discussion below is expressed in usual arithmetic without affecting meaning.

Each video frame should be decoded at the receiver 120 within a strict latency for it be most useful in playback (e.g., to avoid video “freeze”). However, it should be noted that even if there is a freeze, recovering a frame late still may be useful to enable playing later frames that are encoded using inter-frame dependencies (e.g., failing to recover frame 10 in time to play it is bad, but recovering frame 10 in time to use frame 10 to decode and play frame 11 still may be useful). In some embodiments, this latency requirement is modeled by imposing the requirement that each video frame “i” is decoded by the time the packets for frame (i+τ) are received. The parameter τ may be chosen, e.g., based on the frame rate and one-way propagation delay so that the latency of decoding each frame is tolerable, and while the value of i is often fixed for an entire call, the value of τ can be changed by the encoder between calls or even during a call, e.g., after a significant change to the frame rate. For example, if the maximum tolerable latency is 150 ms, the one-way propagation delay is 50 ms, and a frame is encoded every 33.3 ms (i.e., the frame rate), z could be set to 3 frames, i.e., (150 ms-50 ms)/33.3 ms/frame. In some embodiments, the parameter z could be changed during a call, e.g., if the frame rate or latency were to change).

It should be noted that the variability in sizes of frames is a challenge to achieving the objective of the present invention since at each frame, the optimal number of symbols to transmit can depend on the sizes of future messages, which are inherently variable and unknown. This leads to the distinction that can be made in this technology between “offline” coding schemes, which have access to (a) the sizes of messages of future frames, and (b) parameters of partial bursts indicative of worst-case losses for each future frame, and “online” schemes, which do not have access to such information. This distinction will be seen below to impact how certain embodiments of the present invention proceed to estimate or predict burst loss characteristics.

When an online setting situation exists where the sizes of future frames are unavailable, certain embodiments use estimated burst loss characteristics to determine a suitable range of values for the split and then employ a learning-augmented algorithm or model, or a heuristic, to determine the split.

In an offline setting, an optimization algorithm (using a linear program) may be used to estimate burst loss characteristics and determine how to split each frame into these two components.

Periodically estimating or predicting future burst loss or burst characteristics enables certain embodiments of the present invention to tune a communication system's bandwidth overhead based on the invariably changing network conditions. For certain calls where the network conditions are consistent (including consistently imposing certain types of losses), the estimate of future burst loss or burst characteristics enables certain embodiments of the present invention to tune the communication system's bandwidth overhead to be well-suited to the network conditions; as such, the predictions for burst loss or burst characteristics also may be consistent.

In some cases, this feedback from the receiver to the sender can be viewed as the receiver conservatively estimating how lossy the network conditions will be based on prior losses or network conditions, although, as discussed above, loss estimation parameters can be based on other information and can be produced in other ways such as using reinforcement learning (e.g., modeling the system as a Markov decision process). For example, the feedback could report on actual prior losses (e.g., a frame or packet loss rate over some number of past frames or packets) or the feedback could provide a prediction of an upcoming frame or packet loss rate (e.g., if network conditions are deteriorating, then the feedback could predict a greater frame or packet loss rate than was actually detected in the past). When there is no feedback, or in other cases, the loss parameter generator 115 may set the parameters in other ways, such as by setting the parameters to prior values or by estimating or predicting future network conditions such as from prior feedback or other information (e.g., network performance information received from the receiver or from other sources). In any case, certain embodiments set (or attempt to set) the parameters to lead to an acceptably low data loss or freeze rate (i.e., post loss recovery) assuming certain network conditions (e.g., estimating the data loss rate as being at most a certain value with probability at least some possibly different value where the probability is over the state of the system, which includes the network conditions).

In order to make these estimates of burst characteristics, one embodiment of the present invention assumes M to be the maximum possible number of packets sent per frame. For the ith frame, suppose cᵢ packets are sent. Let Lᵢ be a length M vector where the jth position is +1 if the jth packet is received, −1 if the jth packet is lost, and 0 for all but the first cᵢ positions. To then compute these characteristics or parameters, a machine learning model is applied to (a) the concatenation of a recent window of w of such loss vectors (i.e., (L_{i-w+1}, . . . , Lᵢ)), or (b) Lᵢ if the model (used by the sender to set the parameters bᵢ and lⱼ for j=i, . . . , i+bᵢ−1 which have not yet been set) has a state that can capture information about prior values Lⱼ for j<i.

At times, there could be an underestimation of losses, which could lead to some packets not being recovered. In certain applications (e.g., where data compression is used such as in videoconferencing or video streaming), there may be interpacket dependencies (e.g., the ability to decompress one packet could depend on having successfully received and decompressed one or more other packets) such that failure to recover one packet could result in several subsequent packets being unusable even if received intact. Thus, in some embodiments, the receiver can send additional feedback to indicate that a reset is needed, in which case the sender could reset data compression starting with a packet that is not dependent on past packets (sometimes referred to herein as a “keyframe,” which is essentially a self-sufficient frame).

### Overview of CSIPB

A description of CSIPB is included herein mainly to provide background information on the concept of a variable frame splitting encoder and also to contrast with the novel CSIPBRAL variable frame splitting encoder described herein below. Also, certain features described herein can be applied to CSIPBRAL.

CSIPB adaptively splits a data frame into two components referred to herein as Υ[i] and δ[i], including based on (a) parameters that may sometimes be interpreted as worst-case loss characteristics determining the acceptable range of value then (b) a method (e.g., an ML, or heuristic) to choose which value to pick for each data frame. Consequently, the fraction of symbols within each component can vary from data frame to data frame. Also, in some embodiments of CSIPB, the splitting into two different components (including the size and which symbols to place in which component) can be based on metadata (e.g., from compression if compression was used) of the data frames (if it exists).

The number of parity symbols allocated for data frame i is a function (e.g., a machine learning model or heuristic) based on the state of the system that includes the sizes of all prior data frames, the sizes of the first component of all prior data frames, the loss characteristics that have previously occurred, and application-level properties (e.g., for videoconferencing the distribution of sizes of future data frames given previous data frames). For example, it may be chosen as the number of symbols of the first component that can be lost in a partial burst.

Consequently, under CSIPB, the example choice of setting the number of parity symbols, pᵢ, to equal the number of lost symbols of the first component of the data frame from τ time slots before, l_{i-τ}u_{i-τ} ensures that all data frames are recovered as long as the packet losses are no worse than the adversarial model. In contrast, under Tambur, loss-recovery of certain data frames is more vulnerable to certain patterns of packet losses than others (e.g., certain losses lead to worse loss-recovery despite dropping the same amount of data, such as losses concentrated exactly τ time slots apart), and there are no formal guarantees of loss recovery given a model of packet losses.

In CSIPB, the symbols of the first component, Υ[i] are not included in the linear combinations of the parity symbols of the data frame, P[i]. In contrast, the symbols of Tambur's first component are included in the parity symbols of the data frame, P[i]. Hence, although similar notations are used in Tambur (e.g., U[i], V[i], P[i]) and CSIPB (e.g., Υ[i], Γ[i], P[i]), the notations mean different things. One consequence is that under Tambur, the parity symbols received under data frame j during a burst cannot be used to recover earlier data frames unless all lost symbols of data frame j are also recovered. In contrast, in CSIPB, the parity symbols received during a burst can be used for loss recovery of symbols of previous data frames when only the second component of the data frame, Γ[i], has been recovered (i.e., when Υ[i] has not yet been recovered).

Also, the number of packets transmitted per data frame, the sizes of these packets, and how symbols of Υ[i], Γ[i], and P[i] are spread over these packets differ in CSIPB from Tambur. Under CSIPB, any methodology wherein it is anticipated that approximately lᵢ fraction of the symbols of each of Υ[i], Γ[i], and P[i] might be lost is suitable. For example, CSIPB may involve spreading parity symbols evenly over the packets; alternatively CSTPB may send symbols of only one of (a) Υ[i], (b) Γ[i], or (c) P[i] in each packet. In Tambur, the parity symbols are sent in different packets from the data symbols and also it is the intention for packets containing data symbols to all contain the same ratio of symbols of U[i] and V[i].

Certain features are now described with reference to CSIPB. The following is a glossary for the CSTPB discussion:

| Term | Definition | Example |
|---|---|---|
| Call | A call refers to the entire sequence | |
| | of communication of data from a | |
| | sender to a receiver | |
| Symbol | An element of a finite field | The field of integers mod 4 comprises four |
| | | symbols: 0, 1, 2 and 3 |
| data frame | An ordered sequence of frames | A call of length 4 comprises data frame 0, |
| | constitutes the data that is to be | then data frame 1, then data frame 2, and |
| | communicated (e.g., they could be | then data frame 3 |
| | compressed frames) | |
| Time slot | A time slot, i, reflects the time | A call of length 4 comprises data frame 0, |
| (or | period corresponding to the ith | then data frame 1, then data frame 2, and |
| timeslot) | data frame | then data frame 3 wherein the sender |
| | | obtains data frame 0 during time slot 0, data |
| | | frame 1 during time slot 1, data frame 2 |
| | | during time slot 2, and then data frame 3 |
| | | during time slot 3 |
| D[i] | The data of the ith data frame, | Consider a call where data comprises |
| | which is a vector of symbols of a | symbols of the field of integers mod 4. |
| | field. | Suppose data frame 0 comprises the |
| | | following symbols: 0, then 1, then 2. Then |
| | | D[0] = [symbol] 0, 1, 2 [symbol] . |
| dᵢ | An integer that constitutes the | Consider a call where data comprises |
| | number of symbols of the ith data | symbols of the field of integers mod 4. |
| | frame | Suppose D[0] = [symbol] 0, 1, 2 [symbol] . Then d₀ = 3. |
| m | An integer that constitutes the | |
| | maximum number of symbols of a | |
| | data frame | |
| Vector | Consider any vector, V. Its length | Consider a length three vector over the field |
| notation | is given by v. It is zero-indexed | of integers mod 4, V = [symbol] 0, 1, 2 [symbol] . Then |
| | with a coefficient, where | V₁ = 1 and V_{1:2} = [symbol] 1, 2 [symbol] |
| | Vⱼ is its jth symbol for an integer j | |
| | between zero and (v − 1). For any | |
| | two integers i, j between zero and | |
| | (v − 1) where i is no more than j, | |
| | the vector of symbols of V | |
| | between these two positions (i.e., | |
| | [symbol] Vᵢ, . . . , Vj [symbol] ) is denoted as V_{i:j} | |
| Index | For any non-negative integer, i, | The meaning of [3] is {0, 1, 2, 3}. |
| notation [i] | the set of integers between 0 and i | |
| | inclusive (i.e., {0, . . . , i}) is denoted | |
| | as [i] | |
| Index | In various situations, an index | A reference to any i E [n] means that i may |
| variables, | variable, such as i, j, z, or r is | be any value out of 0 through n. |
| e.g., i, j, | defined to be taken from a set or | |
| z, and r | to iterate over multiple values | |
| Partition | To split into multiple disjoint parts | A vector V = [symbol] v_{0,} v₁, v₂, v₃, v₄ [symbol] is |
| | | partitioned into V₀ = [symbol] v₀, v₁, v₂ [symbol] and |
| | | V₁ = [symbol] v₃, v₄ [symbol] . |
| Data | A symbol of a data frame. Each | Consider the the ith data frame, D[i]. Then |
| symbol | data symbol can be transmitted | for any j ∈ [kᵢ], Dⱼ[i] is a data symbol. |
| | only once. | |
| packets | A group of symbols that are sent | |
| | from the sender to the receiver. | |
| | One possible implementation is to | |
| | use User Datagram Protocol | |
| | (UDP), wherein a packet refers to | |
| | the payload of the datagram. | |
| cᵢ | The number of packets sent during | Suppose the sender sends 4 packets to the |
| | the ith time slot | receiver during time slot 0. Then c₀ = 4. |
| cᵢ′ | One less than the number of | Suppose the sender sends 4 packets to the |
| | packets sent during the ith time | receiver during time slot 0. Then c₀′ = 3. |
| | slot (i.e., cᵢ − 1) | |
| ${c}_{i}^{v} , {c}_{i}^{γ} , {c}_{i}^{p}$ | cᵢ packets sent during time slot i in certain embodiments may be | |
| | $split into three pieces , {c}_{i}^{v} , {c}_{i}^{γ} ,$ | |
| | $and {c}_{i}^{p} , that ( a ) sum to {c}_{i} , and ( b )$ | |
| | correspond to the number of | |
| | packets sent for Υ[i], [Γ[i], and | |
| | P [i], respectively. | |
| M | The maximum number of packets | |
| | for a data frame | |
| [0, 1] ^{<z>} | The z-wise cartesian product of | [0, 1] ^{<2>} equals [0, 1] × [0, 1] |
| | the closed interval, [0, 1] | |
| MTU | The maximum possible size of a | |
| (Maximum | packet | |
| transmittable | | |
| unit) | | |
| S^{(j)}[i] | For any time slot, i, and any j ∈ | Suppose the sender sends 4 packets to the |
| | [cᵢ′], S^{(j)}[i] denotes the jth packet | receiver during time slot 0. Then these 4 |
| | sent during the ith time slot | packets are called S⁽⁰⁾[0], S⁽¹⁾[0], S⁽²⁾[0], |
| | | and S⁽³⁾[0], respectively. |
| Sᵢ^{(j)} | For any time slot, i, and any j ∈ | Consider a call where data comprises |
| | [cᵢ′], sᵢ^{(j)} denotes the size of | symbols of the field of integers mod 4. |
| | S^{(j)}[i]. | Suppose D[0] comprises three symbols, |
| | | [symbol] 0, 1, 2 [symbol] , which the sender sends over two |
| | | packets: S⁽⁰⁾[0] = [symbol] D₀[0] [symbol] and |
| | | S⁽¹⁾[0] = [symbol] D₁[0], D₂[0] [symbol] . Then s₀⁽⁰⁾ = 1 |
| | | and s₀⁽¹⁾ = 2. |
| Sᵢ | The total number of symbols sent | Consider a call where data comprises |
| | during the ith time slot; this is $computed as {s}_{i} = {\sum }_{j = 0}^{{c}_{i} ′} {{s}_{i}}^{( j )} .$ | symbols of the field of integers mod 4. Suppose D[0] comprises three symbols, [symbol] 0, 1, 2 [symbol] , which the sender sends over two packets: S⁽⁰⁾[0] = [symbol] D₀[0] [symbol] and |
| | | S⁽¹⁾[0] = [symbol] D₁[0], D₂[0] [symbol] . Then s₀ = 3. |
| Macropacket | The vector of packets during each | |
| | time slot | |
| S[i] | For any time slot, i, S[i] denotes | Suppose the sender sends 4 packets to the |
| | the vector of packets, | receiver during time slot 0, |
| | [symbol] S(0)[i], . . . , S^{(c}^{ᵢ}′⁾[i] [symbol] | S⁽⁰⁾[0], S⁽¹⁾[0], S⁽²⁾[0], and S⁽³⁾[0]. Then |
| | | S[i] = [symbol] S⁽⁰⁾[0], S⁽¹⁾[0], S⁽²⁾[0], S⁽³⁾[0] [symbol] . |
| Lost | A packet is called “lost” if it is | |
| | not received. | |
| Dropped | A packet is called “dropped” if | |
| | and only if it is lost. | |
| R^{(j)}[i] | For any time slot, i, and any j ∈ | Suppose the sender sends 4 packets to the |
| | [cᵢ′], R^{(j)}[i] denotes S^{(j)}[i] if the | receiver during time slot 0, the first 3 are |
| | jth packet sent during the ith time | received and the final one is lost. |
| | slot is received and otherwise | Then R⁽⁰⁾[0] = S⁽⁰⁾[0], R⁽¹⁾[0] = |
| | R^{(j)}[i] denotes that the jth packet | S⁽¹⁾[0], R⁽²⁾[0] = S⁽²⁾[0], and R⁽³⁾[0] |
| | sent during the ith time slot is lost. | indicates a lost packet (e.g., by setting |
| | One possible way to try to | R⁽³⁾[0] to equal a unique symbol not in the |
| | implement this is by adding a | finite field, *). |
| | small header to the packets with a | |
| | sequence number so as to identify | |
| | which packets were lost. One | |
| | possible way for R^{(j)}[i] to denote | |
| | that the jth packet sent during the | |
| | ith time slot is lost is to set R^{(j)}[i] | |
| | to be a unique symbol that does | |
| | not appear in the finite field (e.g., | |
| | *) which is reserved for the sole | |
| | purpose of reflecting a dropped | |
| | packet. | |
| Received | The packets that the receiver | For any time slot, i, the received packets |
| packets | obtains or infers to be lost. | are R⁽⁰⁾[i], . . . , R^{(c}^{ᵢ}′⁾[i]. |
| Reception | The vector of the received packets | |
| packet | | |
| R[i] | For any time slot, i, R[i] denotes | Suppose the receiver obtains 4 received |
| | the vector of received packets, | packets to the receiver during time slot 0, |
| | [symbol] R⁽⁰⁾[i], . . . , R^{(c}^{ᵢ}′⁾[i] [symbol] | R⁽⁰⁾[0], R⁽¹⁾[0], R⁽²⁾[0], and R⁽³⁾[0]. Then |
| | | R[i] = [symbol] R⁽⁰⁾[0], R⁽¹⁾[0], R⁽²⁾[0], R⁽³⁾[0] [symbol] . |
| Parity | The symbols that are sent in | Suppose the sender sends one packet to the |
| symbol(s) | packets which are not needed to | receiver during time slot 0 comprising n₀ = |
| | recover data symbols when (a) all | 3k₀ symbols where the first k₀ symbols are |
| | packets are received and (b) the | D[0], the next k₀ symbols are also D[0], |
| | decoder uses the earliest received | and the final k₀ symbols are uniformly |
| | symbols to decode a data frame. | randomly chosen from the field. Then all |
| | Under this definition, packets of | but the first k₀ symbols of the packet are |
| | lower index are viewed as being | parity symbols. |
| | sent sooner than those of a higher | In certain embodiments, the coding scheme |
| | index; similarly, symbols of a | is systematic (i.e., the data of video frames |
| | transmit packet of lower index are | is sent within packets directly) and the |
| | viewed as being sent sooner than | parity symbols are the non-systematic |
| | those of a higher index. | symbols (e.g., parity symbols are linear |
| | | combinations of data symbols). |
| P[i] | The vector of parity symbols sent | Consider a call where data comprises |
| | in packets of the ith data frame. | symbols of the field of integers mod 4. |
| | | Suppose for vectors V₁ and V₂ that two |
| | | packets are sent: S⁽⁰⁾[0] = [symbol] D[0], V₁ [symbol] |
| | | and S⁽¹⁾[0] = [symbol] D[0], V₂ [symbol] . Then the |
| | | symbols of V₁ and S⁽¹⁾[0] are parity |
| | | symbols, and P[0] = [symbol] V₁, S⁽¹⁾[0] [symbol] . |
| P^{R}[i] | The vector of received parity | Suppose P[i] = [symbol] P_{part 0}[i], P_{part 1} [i] [symbol] |
| | symbols during time slot | two packets are sent: S⁽⁰⁾[0] = |
| | i (i.e., P[i] after removing all | [symbol] D[0], P_{part 0}[i] [symbol] and S⁽¹⁾[0] = |
| | positions corresponding to a | P_{part 1}[i] . If the first packet (i.e., S⁽⁰⁾[0]) is |
| | symbol that was dropped) | lost then P^{R}[i] = P_{part 1}[i] |
| p^{R}ᵢ | The size of P^{R}[i] | Suppose P[i] = [symbol] P_{part 0}[i], P_{part 1}[i] [symbol] |
| | | where P_{part 0}[i] and P_{part 1}[i] comprise |
| | | two and three symbols, respectively. |
| | | Suppose two packets are sent: S⁽⁰⁾[0] = |
| | | [symbol] D[0], P_{part 0}[i] [symbol] and S⁽¹⁾[0] = |
| | | P_{part 1}[i]. If the first packet (i.e., S⁽⁰⁾[0]) is |
| | | lost then p^{R}ᵢ = 3 |
| P^{L}[i] | The vector of lost parity symbols | Suppose P[i] = [symbol] P_{part 0}[i], P_{part 1}[i] [symbol] |
| | during time slot i (i.e., P[i] after | two packets are sent: S⁽⁰⁾[0] = |
| | removing all positions | [symbol] D[0], P_{part 0}[i] [symbol] and S⁽¹⁾[0] = |
| | corresponding to a symbol that | P_{part 1} [i]. If the first packet (i.e., S⁽⁰⁾[0]) is |
| | was not dropped) | lost then P^{L}[i] = P_{part 0}[i] |
| p^{L}ᵢ | The size of P^{L}[i] | Suppose P[i] = [symbol] P_{part 0}[i], P_{part 1}[i] [symbol] |
| | | where P_{part 0} [i] and P_{part 1} [i] comprise |
| | | two and three symbols, respectively. |
| | | Suppose two packets are sent: S⁽⁰⁾[0] = |
| | | [symbol] D[0], P_{part 0}[i] [symbol] and S⁽¹⁾[0] = |
| | | P_{part 1}[i] . If the first packet (i.e., S⁽⁰⁾[0]) is |
| | | lost then p^{L}ᵢ = 2 |
| Frame rate | The number of frames per unit | A frame rate of 30 frames per second (FPS) |
| | time; the number of time slots per | means that on average there are |
| | unit time. | approximately 33.33 milliseconds (ms) |
| | | between frames/timeslots |
| Recovered/ | A symbol is recovered (or | |
| decoded | decoded) if (a) it is included in a | |
| | packet which is not lost obtained | |
| | by the receiver. A data frame is | |
| | recovered (or decoded) if its | |
| | symbols are all received or | |
| | obtained by the receiver. | |
| Decoding | The time slot by which a data | Suppose that a video occurs at 30 fps, each |
| deadline | frame must be decoded due to | data frame must be recovered within |
| | latency constraints; this is a | approximately 150 ms, and the one-way |
| | function of the frame rate (i.e., the | delay is 50 ms. Then if data frame 0 occurs |
| | time duration between time slots), | at time 0 ms, data frame 0 has a decoding |
| | the one-way delay (i.e., the time to | deadline of time slot 3; this reflects the end- |
| | for a sent packet to travel to the | to-end latency of (a) 50 ms for the one-way |
| | receiver), application-specific | delay, plus (b) waiting 3 extra time slots |
| | latency requirements, user | means waiting approximately 100 ms. |
| | preferences, etc. | |
| τ (tau) | The number of extra time slots the | Suppose that τ = 3. Then the ith data frame |
| | receiver can use to recover a data | must be recovered by time slot (i + 3) |
| | frame to meet the decoding | |
| | deadline | |
| Communi- | A methodology wherein the | |
| cation | sender obtains one data frame | |
| scheme | during each time slot, the sender | |
| | constructs packet(s) and sends | |
| | them to the receiver, and the | |
| | receiver attempts to use the | |
| | received packets to recover (or | |
| | decode) the data frames | |
| Partial | Refers to one or more consecutive | Suppose that four packets are sent during |
| burst | time slots that is no more than a | time slot i, eight packets are sent during |
| | parameter number (bᵢ, introduced | time slot (i + 1), and five transmit packets |
| | below) where during each of these | are sent during time slot (i + 2). Suppose |
| | time slots the number of packets | bᵢ = 3, lᵢ = 1/2, lᵢ₊₁ = 1/2, and lᵢ₊₂ = |
| | that may be lost is no more than a | ¼. Suppose there are no losses during |
| | parameter (lᵢ, introduced below) | time slots (i − τ) through (i − 1). Then if |
| | times the number of packets | there are losses during (a) time slot i, (b) |
| | (where the product is then rounded | time slots i and (i + 1), or (c) time slots |
| | up); there is a guard space (e.g., | i, (i + 1), and (i + 2), followed by no |
| | containing no losses) for the τ | losses in the next τ time slots after the final |
| | time slots after the end of a partial | of these time slots where a loss occurred, |
| | burst; similarly, there is a guard | and at most 2 (i.e., [8/2]) packets are lost |
| | space (e.g., containing no losses) | during time slot i, at most 4 (i.e., |
| | for the τ time slots before the start | [8/2]) packets are lost during time slot (i + |
| | of a partial burst | 1), and at most 2 (i.e., [5/4]) packets are |
| | | lost during time slot (i + 2), then a partial |
| | | burst occurred. |
| Guard | A sequence of at least τ | Suppose that a partial burst occurs over time |
| space (or | consecutive time slots | slots 0 through 2 and is followed by at least |
| guardspace) | immediately after a partial burst | τ consecutive time slots where all packets |
| | during which all packets are | are received. Then time slots 3 through |
| | received. | (2 + τ) are referred to as a guard space. |
| Worst-case | It is the intention to provide loss | Suppose that losses occur only as partial |
| delay | recovery within the decoding | bursts. Then for any data frame, i, it is |
| | deadline (i.e., of τ time slots) with | decoded by time slot (i + τ). For example, |
| | high probability as long as loss | data frame 0 is decoded by time slot τ. |
| | only occurs as partial bursts where | |
| | each partial burst. | |
| bᵢ | For any time slot i, the length of | Suppose that b₀ = 2. Then a partial burst |
| | the longest partial burst starting in | starting in time slot 0 ends strictly before |
| | time slot i for which loss recovery | time slot 2. |
| | will be guaranteed with high | |
| | probability is denoted as bᵢ. | |
| Bᵢ | Bᵢ denotes the set of time slots | Suppose that b₀ = 4, b₁ = 4, b₂ = 3, b₃ = |
| | where a partial burst starting in | 2, and b₄ = 2. Then B₄ = {1, 2, 3, 4}. |
| | one of these time slots may be | |
| | long enough to include time slot i | |
| lᵢ | For any time slot i, lᵢ reflects the | Suppose that l₁ = 0.5 and c₁ is an even |
| | largest fraction of packets that | integer. Then a partial burst that includes |
| | may be lost (before rounding up) | time slot 1 involves dropping at most half of |
| | in a worst-case partial burst. | the packets sent during time slot 1. |
| | Formally, suppose for any time | |
| | slot i that is part of a partial burst | |
| | that at most [lᵢcᵢ] packets are lost | |
| | during time slot i; then loss | |
| | recovery will be guaranteed with | |
| | high probability if the length of | |
| | the partial burst is at most bⱼ | |
| | where j is the first time slot of the | |
| | partial burst. Sometimes lᵢ is | |
| | written with a script (e.g., as “ [symbol] ”). | |
| qᵢ and hᵢ | It is the intention to sometimes | Suppose that l₀ = 0.5. Then qᵢ = 1 and |
| | restrict lᵢ to rational values, where | hᵢ = 2. |
| | the simplified form is lᵢ = qᵢ/hᵢ | |
| t | The largest time slot. | |
| Rate | The ratio of the amount of data to | |
| | send to the amount of data that is | |
| | $sent : Formally , it is ( {Σ}_{i = 0}^{t} {d}_{i} ) /$ | |
| | $( {Σ}_{i = 0}^{t} {s}_{i} )$ | |
| Zero | It may be assumed that the final | |
| padded | (τ + 1) data frames are of size | |
| data frames | zero; this can be accomplished | |
| | without loss of generality (without | |
| | impacting the rate) by appending | |
| | (τ + 1) time slots during which | |
| | the data frames all have size 0 | |
| Keyframe | An uncompressed frame whose | Under videoconferencing, an I-frame may |
| | data is self-sufficient (i.e., it is | be referred to as a keyframe because it can |
| | useful for the receiver even if all | be played without any other data. |
| | previous data has been lost) | |
| Reset | A reset is when the receiver | During time slot i the sender obtains a reset, |
| | informs the sender that it cannot | so D[i] is chosen to be a keyframe. |
| | decode one or more frames by | |
| | their decoding deadline(s) and | |
| | therefore to make the next a | |
| | uncompressed frame (and the | |
| | corresponding data frame) a | |
| | keyframe | |
| ηᵢ (eta) | A binary value that is 0 if and | |
| | only if there is no reset during the | |
| | ith time slot | |
| Feedback | It is the intention that the receiver | |
| | may send feedback to the sender | |
| | during any time slot to indicate | |
| | how to set bᵢ, lᵢ, and ηᵢ. It is the | |
| | intention that the receiver often | |
| | will not send feedback, in which | |
| | case the three parameters can take | |
| | the values from the last time slot | |
| | (i.e., set bᵢ, lᵢ, and ηᵢ to equal | |
| | bᵢ₋₁, lᵢ₋₁, and ηᵢ₋₁, respectively). | |
| | In certain embodiments, l_{i+b}_{ᵢ}₋₁ | |
| | is set during time slot i, and in the | |
| | absence of feedback, l_{i+b}_{ᵢ}₋₁ | |
| | may be set equal to l_{i+b}_{ᵢ}₋₂. These | |
| | parameters may be set in other | |
| | ways in various embodiments. | |
| Γ[i] | The first component of a split data | Suppose a partial burst occurs starting in |
| (Gamma) | frame, D[i], that corresponds to | time slot i. Then Γ[i], . . . , Γ[i + bᵢ − 1] are |
| | symbols that are encoded to be | recovered with high probability by time slot |
| | recovered together with the first | (i + τ − 1). |
| | component of the previous one or | |
| | more data frames and the next one | |
| | or more data frames. It is denoted | |
| | Γ[i]. If there are losses during the | |
| | ith time slot, is the intention to | |
| | recover [[]Γ[i] by time slot (i + τ − | |
| | 1). | |
| First | Another way to refer to Γ[i] is as | |
| component | the first component of data frame i | |
| Γ^{R}[i] | The vector of received symbols of | Suppose Γ[i] = [symbol] Γ_{part 0}[i], [Γ_{part 1}[i] [symbol] two |
| | the first component during time | packets are sent: S⁽⁰⁾[0] = [Γ_{part 0}[i] and |
| | slot i (i.e., Γ[i] after removing all | S⁽¹⁾[0] = [Γ_{part 1}[i]. If the first packet (i.e., |
| | positions corresponding to a | S⁽⁰⁾[0]) is lost then Γ^{R}[i] = [Γ_{part 1}[i] |
| | symbol that was dropped) | |
| γ^{R}ᵢ | The size of Γ^{R}[i] | Suppose Γ[i] = [symbol] Γ_{part 0}[i], [Γ_{part 1}[i] [symbol] two |
| | | packets are sent: S⁽⁰⁾[0] = [Γ_{part 0}[i] and |
| | | S⁽¹⁾[0] = [Γ_{part 1}[i] of sizes 2 and 3, |
| | | respectively. If the first packet (i.e., |
| | | S⁽⁰⁾[0]) is lost then γ^{R}ᵢ = 3. |
| Γ^{L}[i] | The vector of lost symbols of the | Suppose Γ[i] = [symbol] Γ_{part 0}[i], [Γₚₐᵣₜ ]ᵢ[[i] [symbol] two |
| | first component during time slot | packets are sent: S⁽⁰⁾[0] = [Γ_{part 0}[i] and |
| | i (i.e., Γ[i] after removing all | S⁽¹⁾[0] = [Γ_{part 1}[i] . If the first packet (i.e., |
| | positions corresponding to a | S⁽⁰⁾[0]) is lost then Γ^{L}[i] = [Γ_{part 0}[i] |
| | symbol that was not dropped) | |
| γ^{L}ᵢ | The size of Γ^{L}[i] | Suppose Γ[i] = [ [symbol] Γ_{part 0}[i], [Γ_{part 1}[i] [symbol] two |
| | | packets are sent: S⁽⁰⁾[0] = [Γ_{part 0}[i] and |
| | | s⁽¹⁾[0] = [Γ_{part 1}[i] of sizes 2 and 3, |
| | | respectively. If the first packet (i.e., |
| | | S⁽⁰⁾[0]) is lost then γ^{L}ᵢ = 2 |
| γᵢ (gamma) | The size of the vector Γ'[i] | For any time slot i, the size of Γ[i] is γᵢ |
| ${{γ}^{( max )}}_{i} or {γ}_{i}^{max} r {{γ}_{i}}^{′}$ | The largest admissible value of Yi under a particular communication scheme | |
| Υ[i] | The second component of a split | Suppose a worst-case partial burst occurs |
| (Upsilon) | data frame, D[i], that corresponds | starting in time slot i. Then for each j in |
| | to symbols that are encoded to be | {i, . . . , i + bᵢ − 1}, Υ[j] is recovered with |
| | recovered τ time slots later. It is | high probability during time slot (j + τ). |
| | denoted Υ[i]. If there are losses | |
| | during the ith time slot, is the | |
| | intention to recover Υ[i] during | |
| | time slot (i + τ). | |
| Second | Another way to refer to Υ[i] is as | |
| component | the second component of data | |
| | frame i | |
| υᵢ (upsilon) | The size of the vector Υ[i] | For any time slot i, the size of Υ[i] is υᵢ |
| Υ^{R}[i] | The vector of received symbols of | Suppose Υ[i] = [symbol] Υ_{part 0}[i], Υ_{part 1}[i] [symbol] |
| | the second component during time | two packets are sent: S⁽⁰⁾[0] = |
| | slot i (i.e., Υ[i] after removing all | Υ_{part 0}[i] and S⁽¹⁾[0] = Υ_{part 1}[i]. If the |
| | positions corresponding to a | first packet (i.e., S⁽⁰⁾[0]) is lost then |
| | symbol that was dropped) | Υ^{R}[i] = Υ_{part 1}[i] |
| υ^{R}ᵢ | The size of Υ^{R}[i] | Suppose Υ[i] = [symbol] Υ_{part 0}[i], Υ_{part 1}[i] [symbol] |
| | | two packets are sent: S⁽⁰⁾[0] = |
| | | Υ_{part 0}[i] and S⁽¹⁾[0] = Υ_{part 1}[i] of sizes |
| | | 2 and 3, respectively. If the first packet |
| | | (i.e., S⁽⁰⁾[0]) is lost then υ^{R}ᵢ = 3 |
| Υ^{L}[i] | The vector of lost symbols of the | Suppose Υ[i] = [symbol] Υ_{part 0}[i], Υ_{part 1}[[i] [symbol] |
| | second component during time | two packets are sent: S⁽⁰⁾[0] = |
| | slot i (i.e., Υ[i] after removing all | Υ_{part 0}[i] and S⁽¹⁾[0] = Υ_{part 1}[i]. If the |
| | positions corresponding to a | first packet (i.e., S⁽⁰⁾[0]) is lost then |
| | symbol that was not dropped) | Υ^{L}[i] = Y_{part 0}[i] |
| υ^{L}ᵢ | The size of Y^{L}[i] | Suppose Υ[i] = [symbol] Υ_{part 0}[i], Υ_{_{part 1}}[i] [symbol] |
| | | two packets are sent: S⁽⁰⁾[0] = |
| | | Υ_{part 0}[i] and S⁽¹⁾[0] = Υ_{part 1}[i] of sizes |
| | | 2 and 3, respectively. If the first packet |
| | | (i.e., S⁽⁰⁾[0]) is lost then υ^{L}ᵢ = 2 |
| Zero | Appending a non-negative integral | The vector V = [symbol] 0, 1, 2, 3 [symbol] is zero padded |
| padding | number of zeros to a vector to | to be of length 6, leading to [symbol] 0, 1, 2, 3, 0, 0 [symbol] |
| (symbols) | ensure it is of the desired length. | |
| 0 ^{<1>} | For any non-negative integer i, the | The vector V = [symbol] 0, 1, 2, 3 [symbol] is zero padded |
| | term 0 ^{<i>} refers to the vector of i | to be of length 6, leading to |
| | zeroes | [symbol] 0, 1, 2, 3, 0 ^{<2>} [symbol] |
| 1 ^{<i>} | For any non-negative integer i, the | The vector V = [symbol] 0, 1, 1, 1 [symbol] is equal to |
| | term 1^{<i>} refers to the vector of i | [symbol] 0, 1 ^{<3>} [symbol] |
| | ones | |
| Vector | Consider any time slots i and j | Consider a call where data comprises |
| notation | where i is no more than j. | symbols of the field of integers mod 4. |
| over time | Suppose V is selected from: (a) D, | Suppose that the first three data frames are |
| indices | (b) P, (c) Υ or (d) Γ. Then the | D[0]= [symbol] 0 [symbol] , D[1] = [symbol] 1, 1 [symbol] , and |
| | vector from concatenating the | D[2] = [symbol] 2, 2, 2 [symbol] . Then one can denote |
| | symbols of V or time slot i | concatenating the first three data frames in |
| | through j can be denoted as or | order (i.e., [symbol] 0, 1, 1, 2, 2, 2 [symbol] ) as D[0: 2] |
| | V[i: j] | or [symbol] D[0], D[1], D[2] [symbol] . |
| loss vector | During time slot i, let Lᵢ be a | |
| Lᵢ | length M vector where the jth | |
| | position is +1 if the jth packet is | |
| | received, −1 if the jth packet is | |
| | lost, and 0 for all but the first cᵢ | |
| | positions. | |
| uᵢ | The number of symbols worth of | |
| | information that are received in | |
| | the ith time slot; formally, the | |
| | entropy of the vector of received | |
| | symbols given all information | |
| | received in prior time slots | |
| | normalized by the entropy of a | |
| | random symbol of the finite field. | |
| p^{u}_{i, j} | Consider a partial burst starting in | |
| | time slot i and suppose each parity | |
| | symbol of P^{R}[z] for z = i, . . . , j is | |
| | used in order to recover one | |
| | missing and not yet recovered | |
| | symbol of the earliest symbol of | |
| | Γ^{L} [i: z]. Then p^{u}_{i, j} is the number | |
| | of symbols of P^{R}[[j] that are used | |
| | as such. Note that the notation | |
| | uses “u” to stand for “used.” | |
| [symbol] [i] | A vector over [0, 1] ^{<M+1>} whose | Suppose that dᵢ = 2, M = 4, and [symbol] [i] = |
| | jth position reflects the probability | [symbol] 25, .25, 0.5, 0, 0 [symbol] then γᵢ equals 0 with |
| | that γᵢ is to be set to j | probability ¼, γᵢ equals 1 with probability |
| | | ¼, and γᵢ equals 2 with probability ½. |
| uncompressed | The data to be displayed or used; | |
| frame | if compression was not used, this | |
| | is the same as the data frame | |
| U[i] | The uncompressed frame for time | |
| | slot i | |
| Decompressed | The result of uncompressing a | |
| frame | compressed frame (e.g., an | |
| | estimate of the uncompressed | |
| | frame using the current and/or | |
| | previous compressed frames and a | |
| | decompression method) | |
| Action | What the agent does during the | |
| | time slot | |
| Aᵢ | The action during time slot i | |
| Environment | Physical and or virtual world in | |
| | which the agent operates | |
| | (including the application) | |
| Reward | The value arising from the action, | |
| | the state of the system, and | |
| | (potentially) the environment | |
| Rᵢ (Aᵢ) | The reward from selecting action | |
| | Aᵢ during the ith time slot | |
| State | The current situation (e.g., of the | |
| | agent) | |
| σᵢ | The state of the system during | |
| | time slot i. Includes parameters of | |
| | the current and previous time | |
| | slots, characteristics of the call | |
| | like fps, etc. | |
| Policy | Method to map agent's state to | |
| | actions | |
| P (σᵢ) | During time slot i, the result of | |
| | applying the policy to the state is | |
| | the action taken (i.e., A^{<i>} = | |
| | P (σᵢ)) | |
| FEC | Forward erasure correction | |
| | (FEC)- an erasure code intended | |
| | to be used to recover data when | |
| | packet loss occurs | |
| D^{(j)}[i] | One can divide a data frame into | |
| | stripes of size s where the vector | |
| | of the jth position across all | |
| | stripes is D^{(j)}[i] (i.e., D[i] = | |
| | [symbol] D(j)[i] \| j ∈ [s − 1] [symbol] ) | |
| Side | extra information about decoding | |
| information | a stripe to help in decoding other | |
| | stripes (e.g., if decoding involves | |
| | solving a system of linear | |
| | equations by inverting a full-rank | |
| | matrix corresponding to the | |
| | system, then the side information | |
| | may be the inverse matrix) | |
| −1^{<i>} | −1^{<i>} for a non-negative integer i | For example, [symbol] |
| | is the vector of i positions each | |
| | containing −1. | |
| ${A}_{i}^{j}$ | a matrix used to encode symbols of the first component of data | |
| | frame j into the parity symbols of | |
| | data frame i | |
| ${B}_{i}^{i - τ}$ | a matrix used to encode symbols of the second component of data | |
| | frame i − τ into the parity | |
| | symbols of data frame i | |
| P⁺[i] | the vector of symbols to add to the | |
| | parity symbols P[i] to add the | |
| | failsafe | |

Rapidly recovering and decoding lost data packets is a requirement for providing high quality-of-experience (QoE), for real-time, digital communications. Despite streaming codes having not yet been commonly applied to real-time, digital communications, their framework is well-suited for videoconferencing applications (for example, where a sequence of a video frames are generated periodically, e.g., one every 33.3 milliseconds (ms) for a 30 frame/second video) for at least the following reasons: (a) it captures the streaming nature of incoming data via sequential encoding (where data symbols and parity symbols are sent for each video frame through the described erasure coding scheme, and with the parity symbols being a function of the data symbols from the current frame and previous frames that fall within a predefined window); (b) it incorporates the per-frame decoding latency that can be tolerated for real-time playback via sequential decoding; and (c) it enables optimizing for recovering bursty losses with minimal bandwidth overhead.

In certain embodiments, burst characteristics are periodically estimated by the receiver. This enables CSIPB to tune the bandwidth overhead based on the changing network conditions. The estimates comprise two sets of parameters to reflect the length of the partial burst and the fraction of packets lost per time slot. Specifically, for the ith time slot, the maximum length of a burst starting with time slot i is estimated as bᵢ, and the maximum fraction of packets lost for the ith time slot is estimated as lᵢ. Partial bursts are modeled as being followed by guard spaces of length at least τ time slots with no losses. Although loss recovery is not guaranteed if there are losses in the guard space, the code design will enable recovering from certain losses in the guard spaces when burst losses are not worst case. The feedback can be viewed as the receiver conservatively estimating how lossy the network conditions will be based on prior losses. In certain embodiments, when there is no feedback, the parameters do not change in which case bᵢ is set to bᵢ₋₁ and l_{i+b}_{ᵢ}₋₁ is set to l_{i+b}_{ᵢ}₋₂. However, in alternative embodiments, the streaming encoder may set these values in other ways even in the absence of feedback. When encoding the ith data frame, the sender has access to bⱼ for any j≤i and to h for any j≤(i+bⱼ−1). The value for each h is set exactly once.

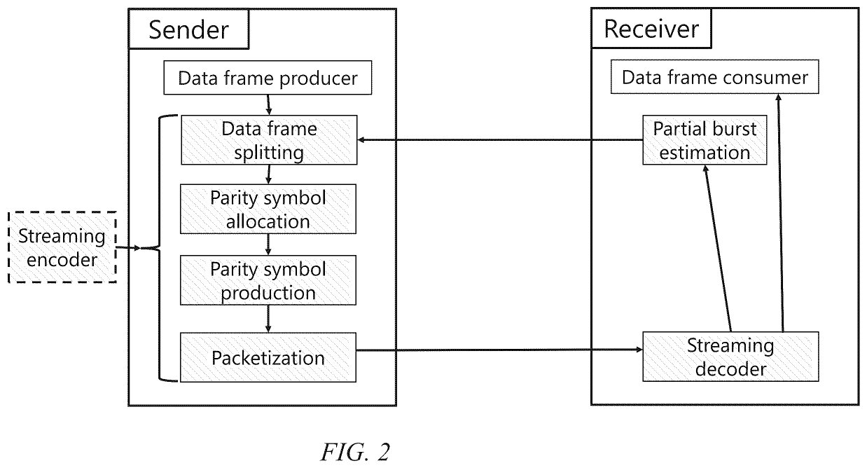

FIG. 2 is a schematic diagram showing logical elements of the streaming encoder for CSIPB, in accordance with certain embodiments.

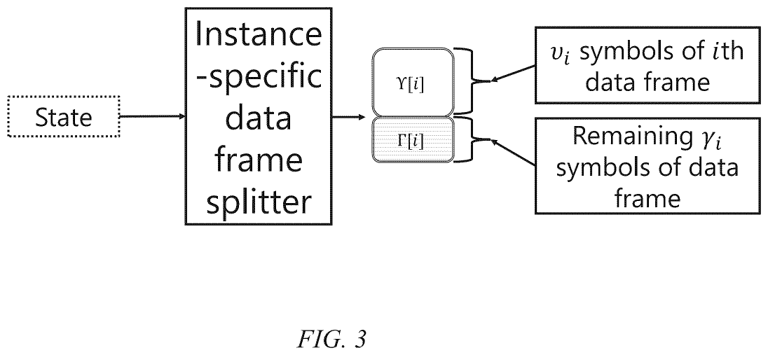

FIG. 3 is a schematic diagram showing the concept of data frame splitting for CSIPB, in accordance with certain embodiments. Here, the data frame splitter enables for each data frame to allocate as many as dᵢ or as few as 0 symbols to each of the two components. This is done using a methodology that can leverage information about the call (i.e., its inputs) as well as properties of the application, user preference, etc. Hence, this may be referred to as “instance specific” frame splitting. For example, it may be a machine learning model trained to optimize key metrics of the QoE (e.g., rate, freeze, fraction of rendered decompressed frames, latency of rendered decompressed frames, etc.); such a model may make use of properties of prior calls in the decision (e.g., if a very large data frame is likely to be followed by a smaller data frame, the model may exploit such a property). Another possible data frame splitter is a heuristic.

The ith data frame, D[i], is partitioned into two components: Υ[i] and [i]. In the event of a partial burst involving time slot i, it is the intention that (a) Γ[i:i+τ] will be recovered by timeslot (i+τ) (it suffices for Γ[i:i+τ−1] to be recovered by time slot (i+τ−1) and Γ[i+τ] to be recovered during time slot (i+τ)), and (b) for each j∈{i, . . . , i+bᵢ−1} that Υ[j] will be recovered within τ additional time slots (i.e., by time slot (j+τ)). In some cases, the size of Γ[i] ranges from 0 to some maximum value, γᵢ′ (sometimes called

$${γ}_{i}^{max} ) ,$$

set to be as large as possible subject to the following constraint. Consider any partial burst starting time slot j of length bⱼ that encompasses time slot i. Then the first component of data frames j through i can be recovered by time slot (j+τ−1) assuming that all symbols of data frames after data frame i have all of their symbols allocated to the second component (i.e., if γ_{z}=0 for z∈{i+1, . . . , j+bⱼ−1}). Then a procedure is used to select an integral value between 0 and

$${γ}_{i}^{′}$$

reflecting the number of symbols allocated to Γ[i]. For example, this procedure may be a learning-based approach.

The splitting of the data frame may depend on metadata of data frame such as its compression; for example, if certain symbols of D[i] are supplementary (i.e., the data frame is useful without them but even better with them), the size of the split and the decision of which symbols to allocate to the second component may be chosen so that the second component (i.e., Υ[i]) contains the supplementary information. The reason for this is that it is the intention that for certain partial bursts the symbols of the first component (i.e., Γ[i]) are recovered strictly before the symbols of the second component, so such a decision may improve the QoE. In some instances, no such metadata will be available (i.e., it may not be tracked under the state in certain embodiments), so this type of information about the compression may not come into play.

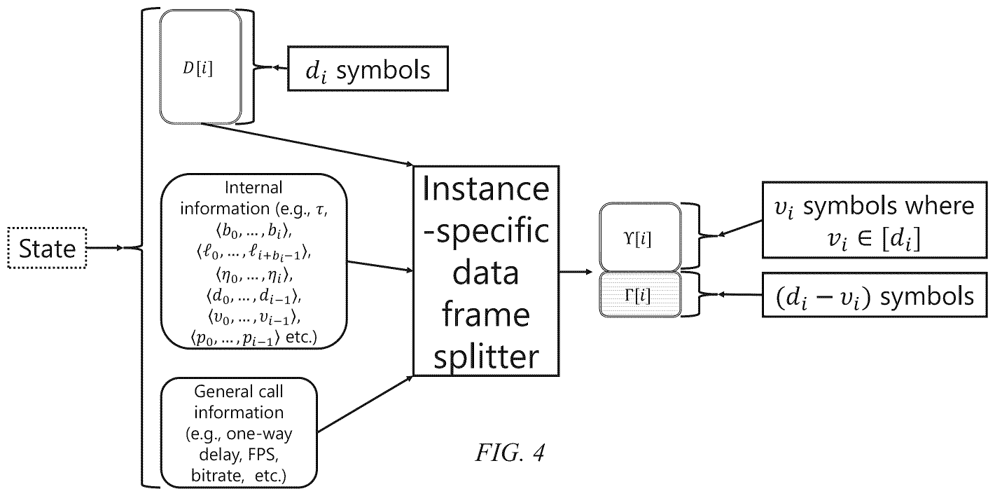

FIG. 4 is a schematic diagram showing one possible frame splitting scheme for CSIPB, in accordance with certain embodiments.

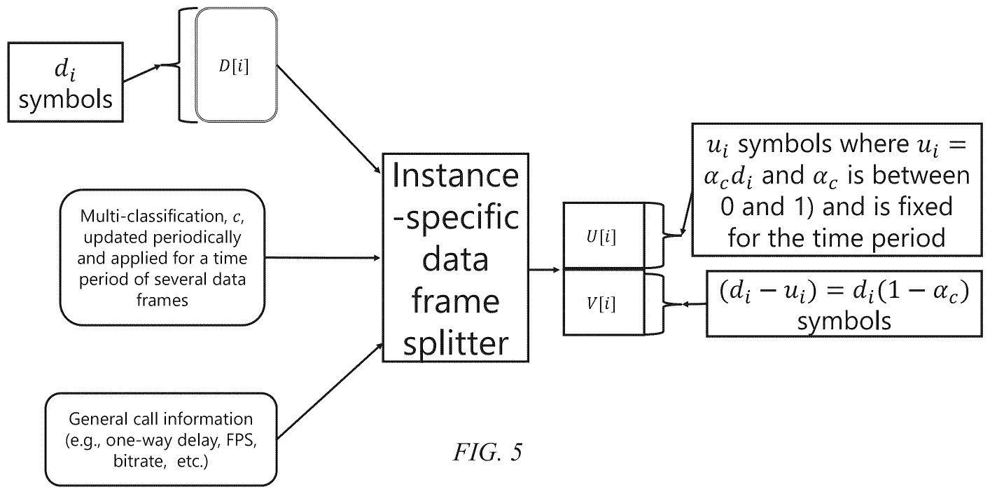

FIG. 5 shows data frame splitting from Tambur using this patent application's notation. Here, the receiver periodically updates the sender with a bandwidth overhead from a discrete set of possible bandwidth overheads forming a multi-classification, c. Then, for the next several data frames, the data frame is split into two components, called U[i] and V[i] (which are different from the two components in CSIPB). The split is to allocate a constant fraction, α_{c} of the data frame's symbols to U[i] where α_{c} is fixed for the time-period (i.e., until the next update is received, where a typical value would be approximately 2 seconds in certain embodiments). For example, in one embodiment, α_{c}=0.5, leading to allocating an equal amount of symbols to each of U[i] and V[i].

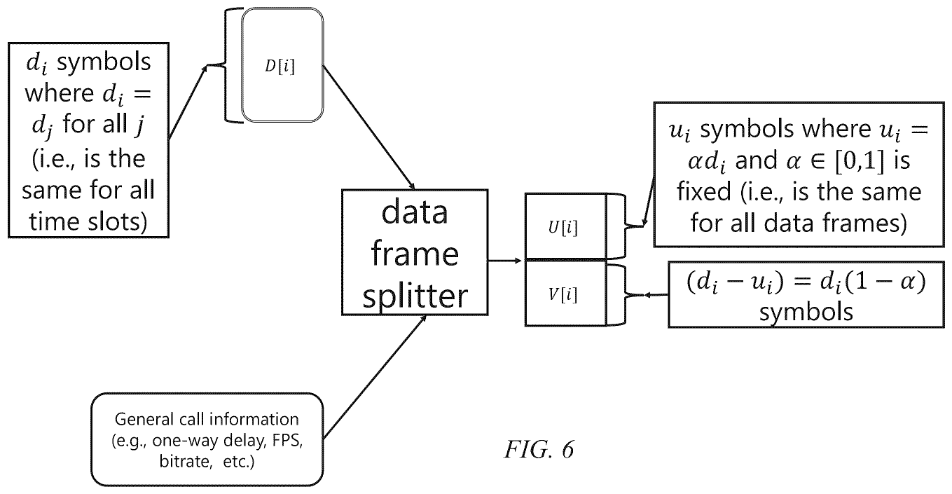

FIG. 6 shows data frame splitting under Cisco (U.S. Pat. No. 9,843,413, which is hereby incorporated herein by reference) patent example code 2 using this patent application's notation. Here, for each data frame, i, a fixed fraction of the symbols is allocated to each of V[i] and U[i] (two components that are different from the two components in CSIPB). In other words, the same fixed fraction of the symbols is allocated to the first component for all data frames.

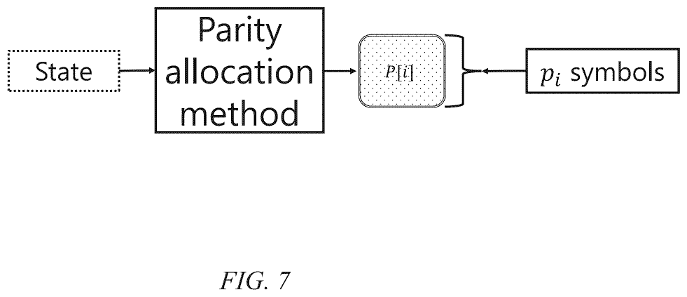

FIG. 7 is a schematic diagram showing the concept of parity allocation for CSIPB, in accordance with certain embodiments. Here, parity allocation enables for each data frame to allocate an arbitrary number of parity symbols. This is done using a methodology that can leverage information about the call (i.e., its inputs) as well as properties of the application, user preference, etc. For example, it may be a machine learning model trained to optimize key metrics of the QoE (e.g., rate, freeze, fraction of rendered decompressed frames, latency of rendered decompressed frames, etc.); such a model may make use of properties of prior calls in the decision (e.g., if a very large data frame is likely to be followed by a smaller data frame, the model may exploit such a property). Another possible parity allocation method is a heuristic. The parity allocation of the frame may depend on metadata of data frame such as its compression; for example, if certain symbols of D[i] are supplementary (i.e., the data frame is useful without them but even better with them), that information may be used. In some instances, no such metadata will be available (i.e., it may not be tracked under the state in certain embodiments), so this type of information about the compression may not come into play.

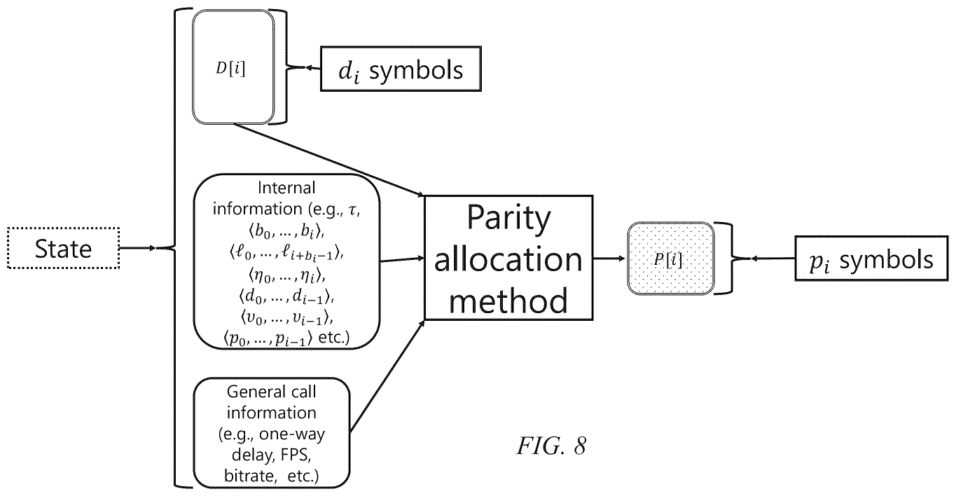

FIG. 8 is a schematic diagram showing one possible parity allocation scheme.

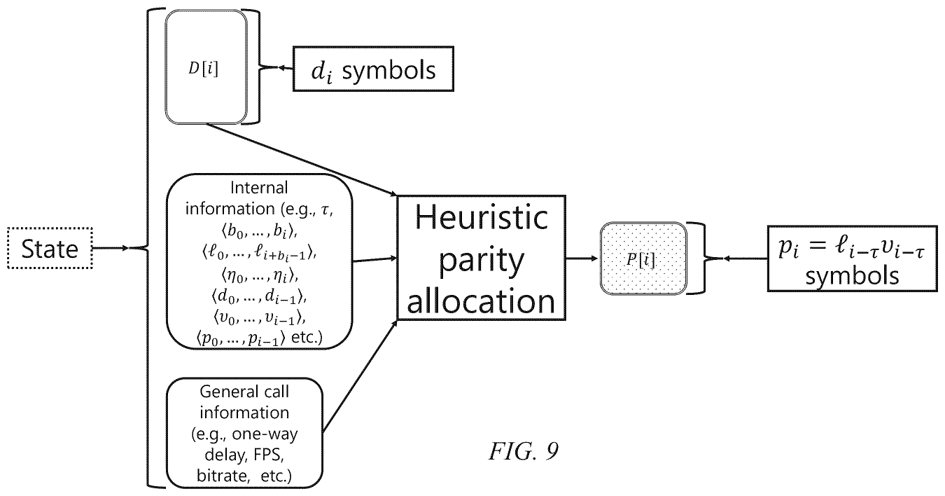

FIG. 9 is a schematic diagram showing another possible parity allocation scheme using a heuristic. Here, a heuristic is used to determine how to allocate parity symbols. A first example heuristic (Heuristic 1) splits data frames to minimize parity associated with each data frame. Specifically, the number of parity symbols to be sent with the data of data frame i may be allocated to be a function of the size of Υ[i−τ]; for example, the number of parity symbols could be set with the intention to equal the size of Υ[i−τ] times l_{i-τ}. A second example heuristic (Heuristic 2, not shown in FIG. 9) allocates enough symbols of P[i] to recover Γ[i] during time slot i.

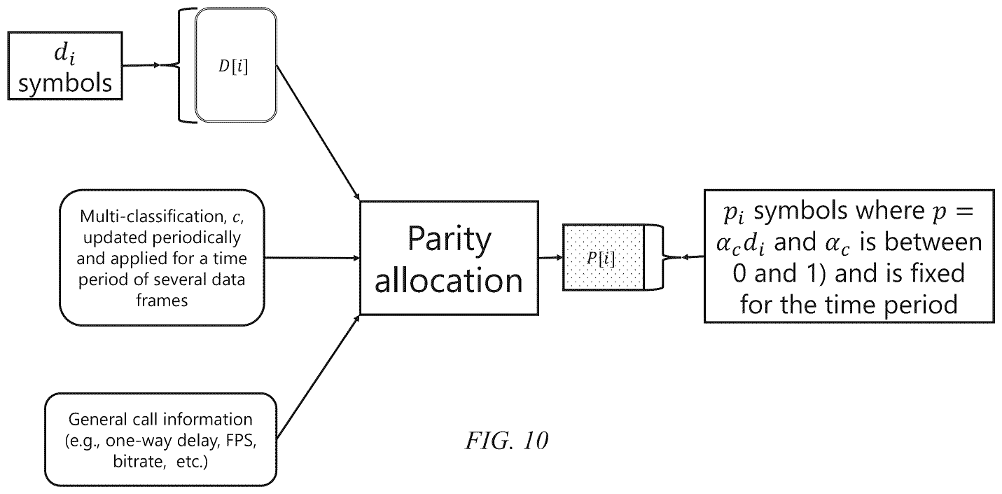

FIG. 10 shows parity allocation from Tambur using this patent application's notation. Under Tambur, the state of the system can be viewed as including a parameter from a small discrete set reflecting the bandwidth overhead (i.e., portion of bandwidth allocated to parity) for the time period (which typically would be approximately 2 seconds in certain embodiments) of several data frames. During this time period, the amount of parity symbols allocated per data frame is the product of this parameter and the size of the data frame. Thus, the fraction of sent symbols that are parity symbols is fixed for the period (i.e., it does not vary from data frame to data frame).

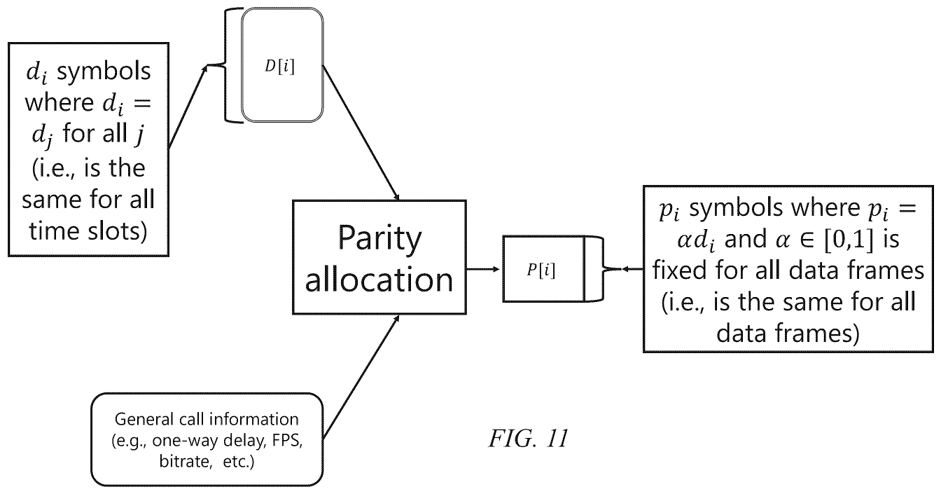

FIG. 11 shows parity allocation under Cisco patent example code 2 using this patent application's notation. Here, for each data frame, i, a fixed bandwidth overhead is used by sending αdᵢ parity symbols associated with data frame i. Thus, the amount of parity symbols sent is fixed for each data frame. Note that in this work, each data frame is of the same size.

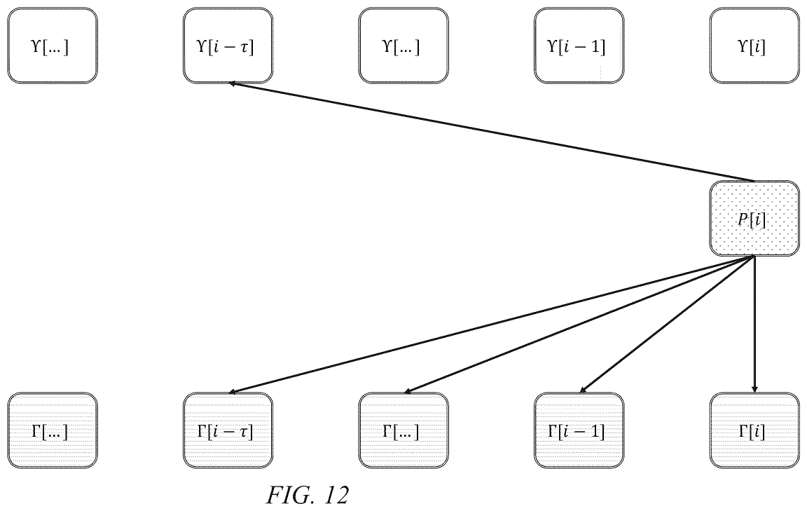

FIG. 12 is a factor graph of parity symbols for CSIPB that is complete for P[i]. Here, the parity symbols for data frame i are functions of (a) the first component of the current and previous τ data frames (i.e., Γ[i−τ:i]), and (b) the second component of the data frame from τ time slots before (i.e., Υ[i−τ]). For example, each symbol of P[i] may be a linear combination of the symbols from (a) and (b).

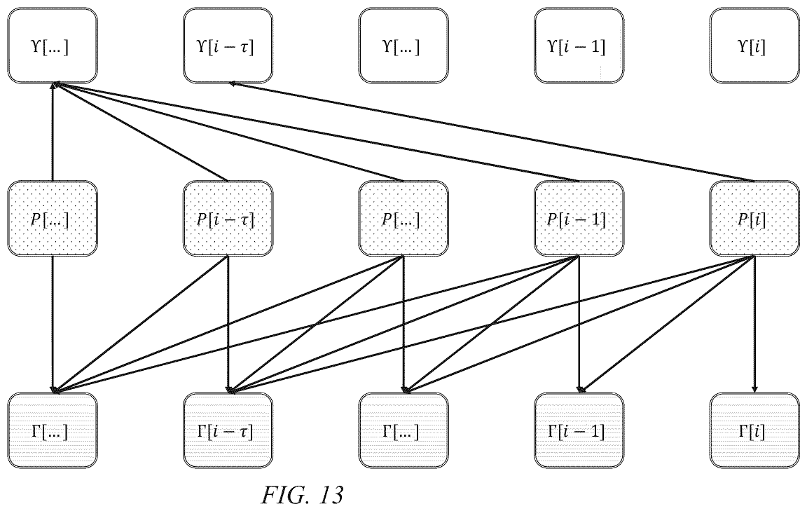

FIG. 13 is a factor graph of parity symbols for CSIPB for P[i] and all prior parities (i.e., P[j] for j<i). Here, the parity symbols for data frame i are functions of (a) the first component of the current and previous τ data frames (i.e., Γ[i−τ:i]), and (b) the second component of the data frame from τ time slots before (i.e., Υ[i−τ]). Thus, the parity symbols for data frame i are functions of Γ[i−τ] through Γ[i−1], Υ[i−τ], and Γ[i] but not Υ[i]. For example, each symbol of P[i] may be a linear combination of the symbols from (a) and (b).

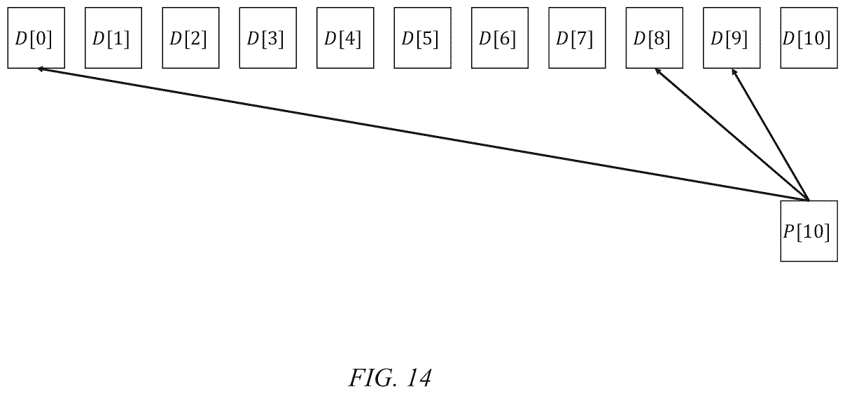

FIG. 14 shows an example factor graph for τ=10 under the Cisco patent example code 1 using this patent application's notation. Here, the parity symbols sent for the 10^{th} data frame are linear combinations of the data symbols of data frames 0, 8, and 9. Compared to CSIPB, P[10] is independent of D[10] (i.e., no connection from P[10] to D[10]), P[10] is independent of all symbols of D[1] through D[7] (i.e., no connection from P[10] to D[1] through D[7]), P[10] is a linear combination of all symbols of D[8] and D[9] (i.e., connected to D[8] and D[9] rather than connected to a subset of their symbols), and each data frame is presumed to be the same size.

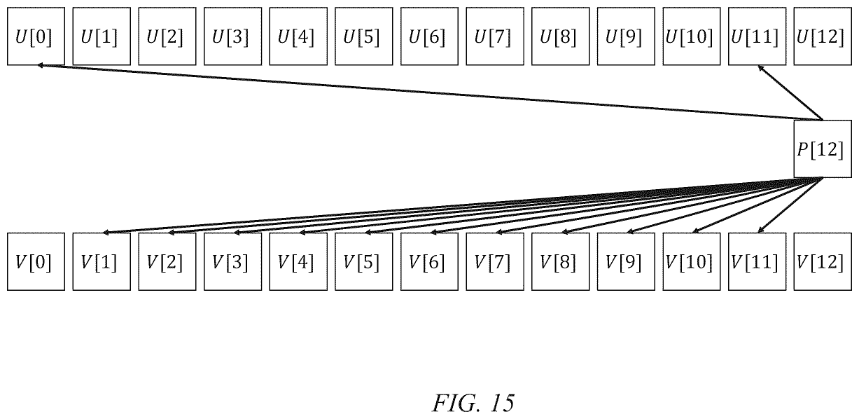

FIG. 15 shows an example factor graph for τ=12 under the Cisco patent example code 2 using this patent application's notation. Here, parity symbols sent for the 12^{th} data frame are linear combinations of the two components of data frame 11, the first component of data frames 0 through 10 and the first component of data frame 0 Compared to CSIPB, P[10] is independent of D[10] (i.e., no connection from P[10] to D[10]), P[10] is independent of certain symbols of D[0] (i.e., V [0]) (i.e., no connection from P[10] to V[10]), P[10] is a linear combination of all symbols of D[11] (i.e., connected to U[11] and V[11]) rather than connected to a subset of its symbols, and each data frame is presumed to be the same size.

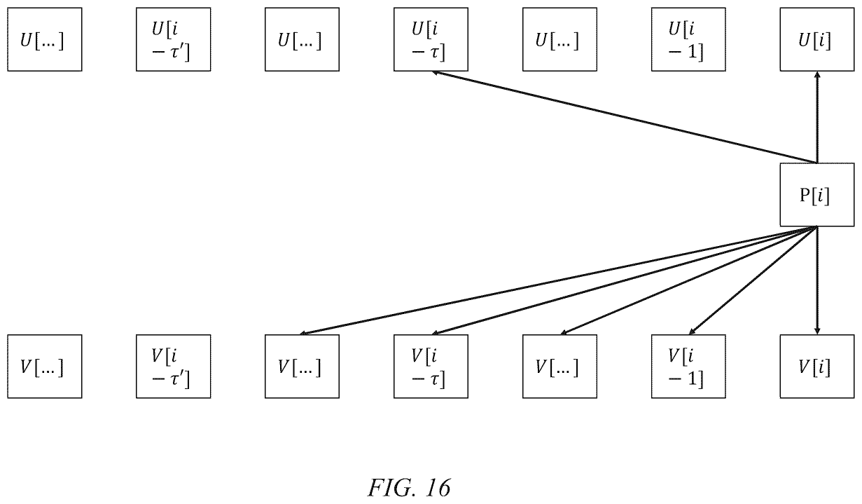

FIG. 16 shows an example factor graph from Tambur using this patent application's notation. Here, the parity symbols for data frame i are functions of (a) the first component of the current and previous τ data frames (i.e., Γ[i−τ:i]), (b) the second component of the data frame from τ time slots before (i.e., Υ[i−τ]), and (c) the second component of the current data frame (i.e., Υ[i]). Compared to CSIPB, all symbols of P[i] depend on all symbols of D[i] (i.e., connection from P[i] to each of U[i] and V[i]) and there is no connection from P[i] to symbols of D[j] for j<(i−τ), whereas, for example, there is a connection for CSIPB construction when the failsafe is applied. As a reminder, the size of P[i] under CSIPB is set differently than the size of P[i] under Tambur even though the factor graph may not highlight this fact.

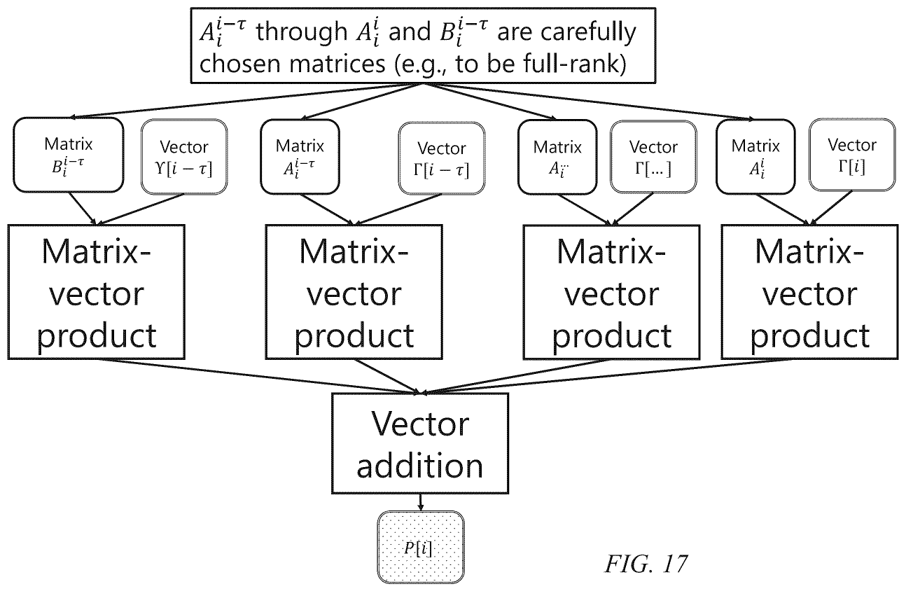

FIG. 17 shows parity symbol generation for the ith data frame in accordance with CSIPB, in accordance with certain embodiments. Here, the symbols of P[i] are linear combinations of the symbols of the current data frame and previous τ data frames. Specifically, the symbols of P[i] are designed linear combinations of (a) the first component of the current and previous τ data frames, and (b) the second component of the frame from τ time slots earlier. All linear combinations are carefully chosen to be linearly independent linear equations (e.g., to be full rank).

One way to construct the matrices is for (a)

$${B}_{i}^{i - τ}$$

to be the panty check matrix of a systematic MDS code (e.g., Reed-Solomon) and (b) for

$${A}_{i}^{i - τ}$$

through

$${A}_{i}^{i}$$

to be a parity check matrices of a systematic m-MDS convolutional code. Alternatively,

$${A}_{i}^{i - τ}$$

through

$${A}_{i}^{i}$$

(and perhaps

$${B}_{i}^{i - τ} )$$

can be matrices with each entry drawn independently and uniformly at random over the elements of the field; in this case, loss recovery can be shown with a high probability for a sufficiently large field size, as opposed to being guaranteed with probability of 1.

More generally, CSIPB can be characterized as including any structure for encoding parity symbols for the current data frame, i, that is a function of the symbols of Γ[i−τ:i], and Υ[i−τ] so that, for any partial burst, the symbols of first component of data frames are all recovered by τ time slots after the start of the burst (e.g., one method to accomplish this is to ensure recovery by τ−1 time slots after the start of the burst of the first component of all frames in the partial burst and guard space up to τ−1 time slots after the start of the burst) and the symbols of the second component of each data frame are recovered i time slots later (i.e., frame Υ[i−τ] is recovered during time slot i; in certain embodiments, D[i] is also recovered during time slot i, although it may not be necessary to recover D[i] during time slot i in other embodiments such as if a non-systematic scheme is used). For example, linear combinations of the symbols of Γ[i−τ:i] can be chosen according to a sliding window rateless code to create a vector of symbols, P′[i]. Then, linear combinations of the symbols of Υ[i−τ] may be chosen according to an MDS code, leading to the vector of symbols P*[i]. Adding P*[i] to P′[i] can then form the parity symbols to be sent, P[i]=P′[i]+P*[i]. The number of parity symbols may be chosen to be high enough so that loss recovery occurs with high probability. This may involve allocating extra parity symbols compared to how many are needed when the linear combinations of symbols of the first component are full rank. Using such a rateless code may improve the complexity of encoding/decoding but require sending extra parity symbols.

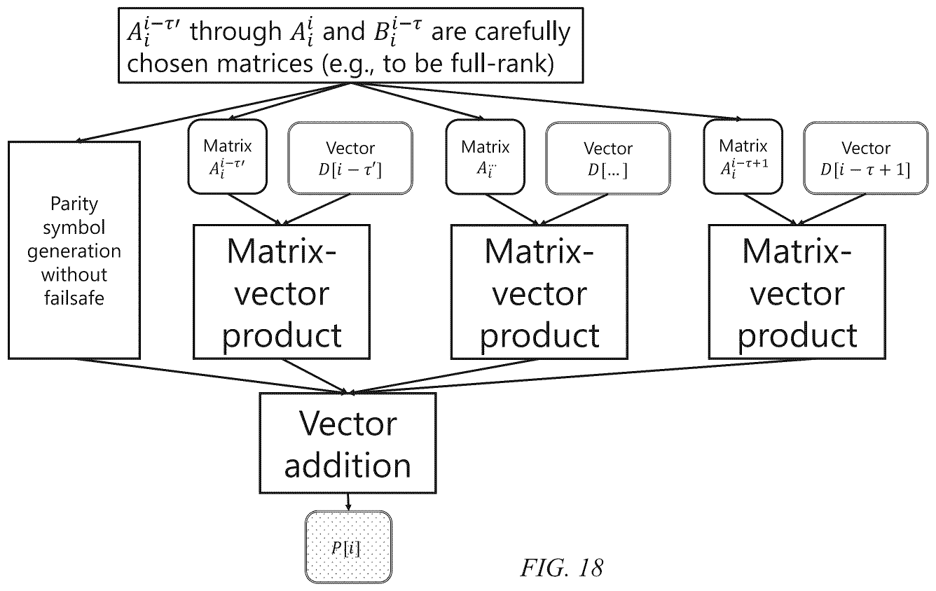

It should be noted that alternate embodiments of CSIPB can include a failsafe mechanism, e.g., by including earlier data frames into the parity symbols. FIG. 18 shows parity symbol generation for the ith data frame for CSIPB with fail safe, in accordance with certain embodiments. CSIPB's loss-recovery mechanism provides guarantees as long as losses are no worse than the type of loss that is admissible under the channel parameters (i.e., bᵢ and lᵢ, for each data frame i). Embodiments can include a failsafe mechanism (which applies to CSIPB or to CSIPB under variations of the coding matrices) by which information from one or more additional prior data frames are added to parity symbols of the current data frame. This enables loss recovery even in cases where losses are worse than the anticipated values (i.e., a burst of length bᵢ starting in data frame i where lᵢ fraction of the packets are lost for each data frame j in the burst) For example, if P[i] is the parity symbols as defined under CSIPB, the parity symbols to be sent may be P[i]+P⁺[i] where P⁺[i] can be random linear combinations of the symbols of data frames (i−τ′) through (i−τ−1) for some τ′ larger than τ. Formally,

$${P}^{+} [ i ] = {Σ}_{j = i = τ′}^{i - τ - 1} = {A}_{i}^{j} D [ j ] ,$$

where each

$${A}_{i}^{j}$$

is a matrix with entries drawn uniformly at random from the field, although it should be noted that embodiments are not limited to linear combinations but instead could use other techniques to incorporate information about prior frames into the parity symbols (e.g., if each symbol is over an extension field, they could include information about only part of certain symbol(s)). Even if CSIPB might not be able to recover certain lost packets, the failsafe mechanism on top of CSIPB may lead to loss recovery (albeit with a latency of more than τ). Recovering data frames after their deadline can be useful due to inter-frame dependencies, as later uncompressed frames are playable once all prior data frames have been recovered. A complementary failsafe of sending feedback from the receiver to the sender to generate a keyframe (i.e., an uncompressed frame that does not depend on prior uncompressed frames) can be applied on top of the new failsafe by triggering the new keyframe when frame i has not been recovered, e.g., by some number of time slots, such as (i+τ′+1). The keyframe may also be requested sooner if frame i is deemed unlikely to be recovered, e.g., if the fraction of packets lost during time slot i greatly exceeds lᵢ.

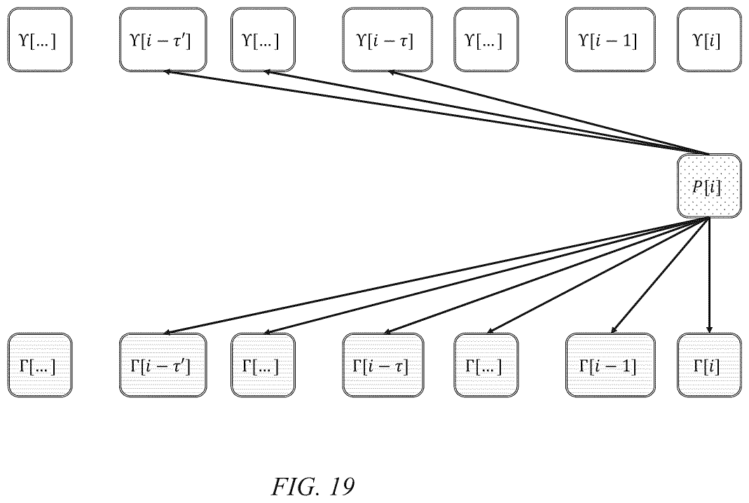

FIG. 19 is a factor graph of parity symbols for CSIPB with failsafe, in accordance with certain embodiments. Here, the parity symbols for data frame i are functions of (a) the first component of the current and previous τ data frames (i.e., Γ[i−τ:i]), (b) the second component of the data frame from τ time slots before (i.e., Υ[i−τ]), and (c) the data symbols of the remaining data frames among the τ′ data frames before data frame i (i.e., D[i−τ′:i−τ−1]). For example, each symbol of P[i] may be a linear combination of the symbols from (a), (b), and (c).

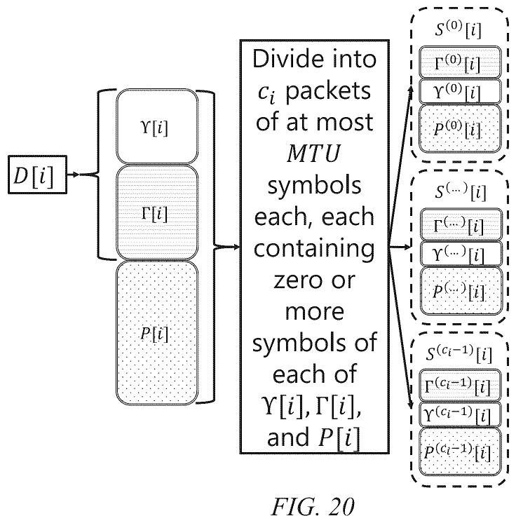

FIG. 20 shows the concept of packetization in accordance with CSIPB. Here, packetization involves distributing the symbols of Υ[i], Γ[i], and P[i] over some number, cᵢ, of packets such that (a) each packet has size at most MTU symbols, and (b) losses under a partial burst channel are recoverable such that each data frame is recovered within i time slots. In certain embodiments, it suffices to receive approximately (1−lᵢ) fraction of each of Υ[i], Γ[i], and P[i]. Each packet may contain symbols from one, two, or three of: Υ[i], Γ[i], and P[i].

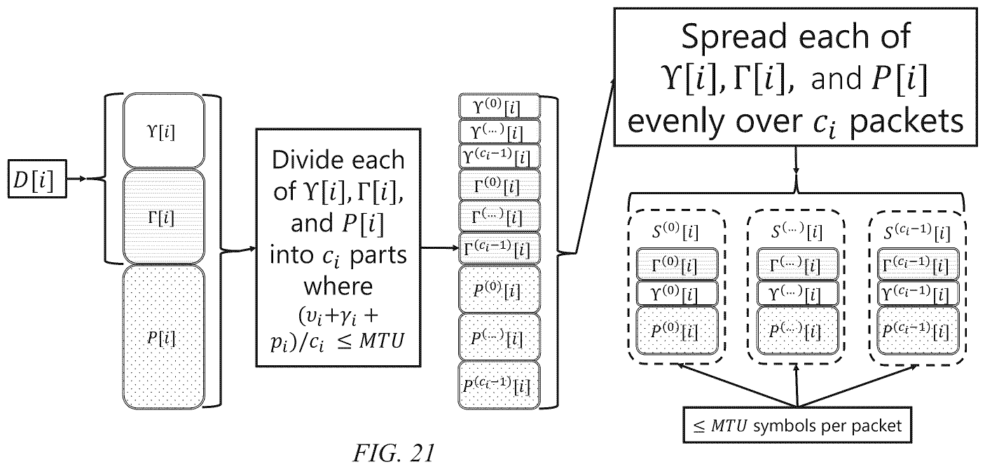

FIG. 21 shows one way for packetizing the ith data frame in accordance with CSIPB (referred to herein as Packetization #1). Here, as few packets, cᵢ, are transmitted as possible so that when the data and parity symbols of a data frame are spread evenly over these packets, the following conditions hold: (a) each packet's size does not exceed the maximum transmittable unit (for example, 1500 bytes), and (b) the number of packets times lᵢ is an integer (or, it is slightly less than an integer where the difference is deemed sufficiently small relative to the number of packets). Then, Υ[i] and Γ[i] are zero-padded and the size of P[i] is increased, each by as little as possible to ensure the sizes of Υ[i], Γ[i], and P[i] are evenly divisible by cᵢ. Each of Υ[i], Γ[i], and P[i] are then evenly distributed over the cᵢ packets. This approach deviates from Tambur, in which all parity symbols are sent in separate packets from data symbols and the number of packets is not chosen based on loss-recovery characteristics. Also, in Tambur, the parity packets are generally sent after the data packets, whereas certain embodiments of the present invention perform packetization in other, more flexible, ways.

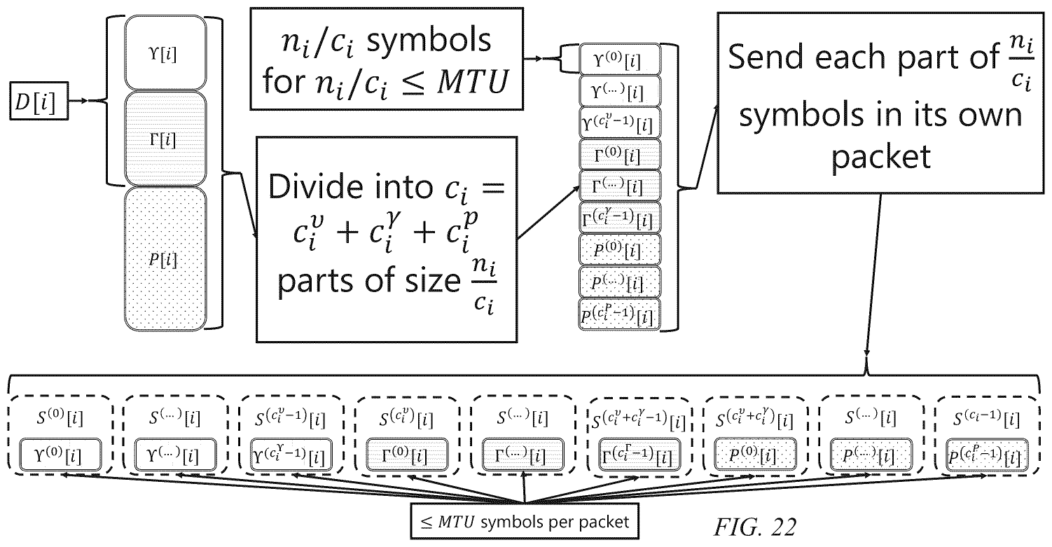

FIG. 22 shows a second way for packetizing the ith data frame in accordance with CSIPB. Here, Γ[i] is divided into

$${c}_{i}^{γ}$$

packets of size

$$\frac{{n}_{i}}{{c}_{i}}$$

where

$$\frac{{n}_{i}}{{c}_{i}} \leq MTU , Y [ i ]$$

is divided into

$${c}_{i}^{υ}$$

packets of size

$$\frac{{n}_{i}}{{c}_{i}}$$

where

$$\frac{{n}_{i}}{{c}_{i}} \leq MTU ,$$

and P[i] is divided into

$${c}_{i}^{p}$$

packets of size

$$\frac{{n}_{i}}{{c}_{i}}$$

where

$$\frac{{n}_{i}}{{c}_{i}} \leq MTU ;$$

then

$${c}_{i} = ( {c}_{i}^{υ} + {c}_{i}^{γ} + {c}_{i}^{p} )$$

packets are sent. Packetizing may involve zero padding and or pushing the boundary between Υ[i] and Γ[i]. This approach deviates from Tambur where two components (which are different, U[i] and V[i]) are intended to be sent in together in the same packets and the number of packets is not chosen based on loss-recovery characteristics.

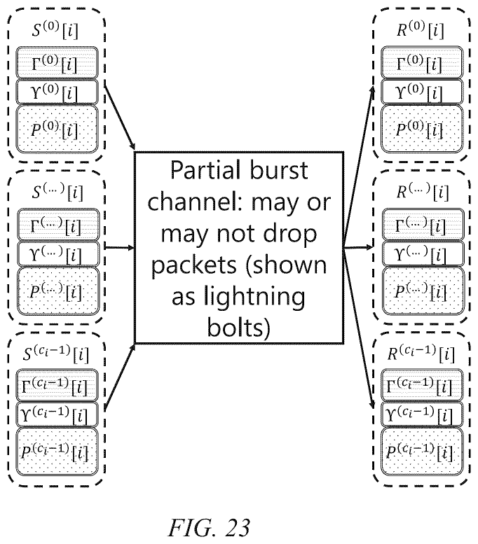

FIG. 23 illustrates how transmission switching is reflected from sent packets to received packets (e.g., based on packet loss/reception).

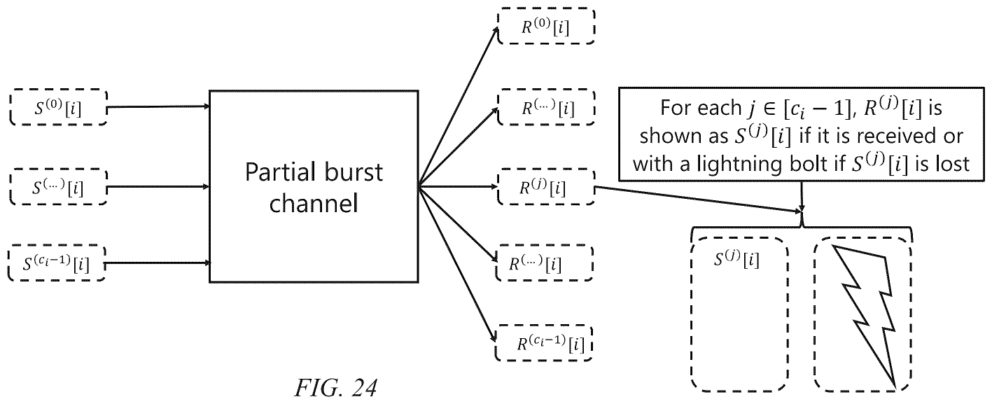

FIG. 24 provides a simplified illustration of how transmission switching is reflected from sent packets to received packets (e.g., based on packet loss/reception).

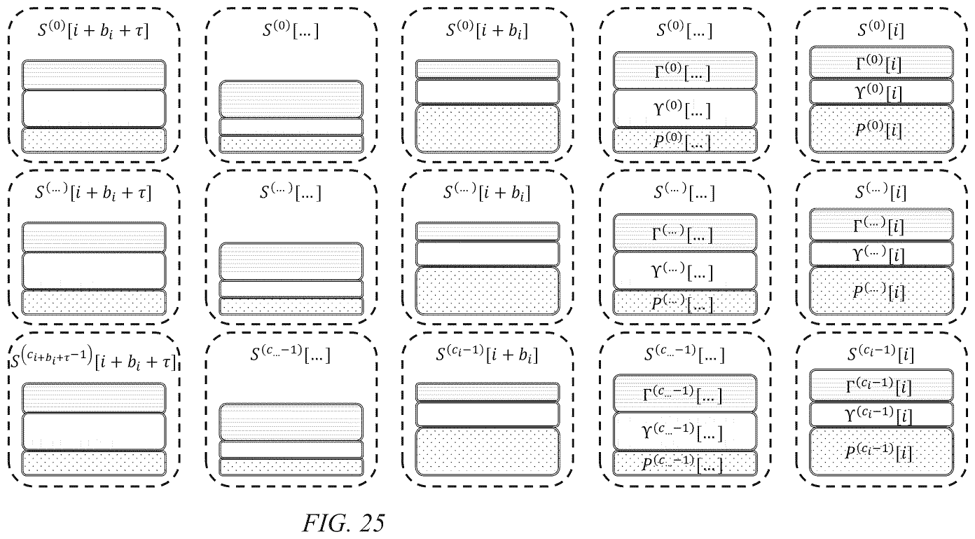

FIG. 25 shows an example of what is sent for time slots i through (i+bᵢ+τ) for non-negative integers i, bᵢ, and τ. Here, for each j∈{i+bᵢ, . . . , i+bᵢ+τ} and each z∈[cⱼ−1], (a) the box with horizontal lines inside of S^{(z)} [j] is Γ^{(z)}[j], (b) the box with vertical lines inside of S^{(z)}[j] is Υ^{(z)}[j], and (c) the box with black dots inside of S^{(z)}[j] is P^{(z)}[j]. This notation is applicable to other figures with similar boxes (unless otherwise specified).

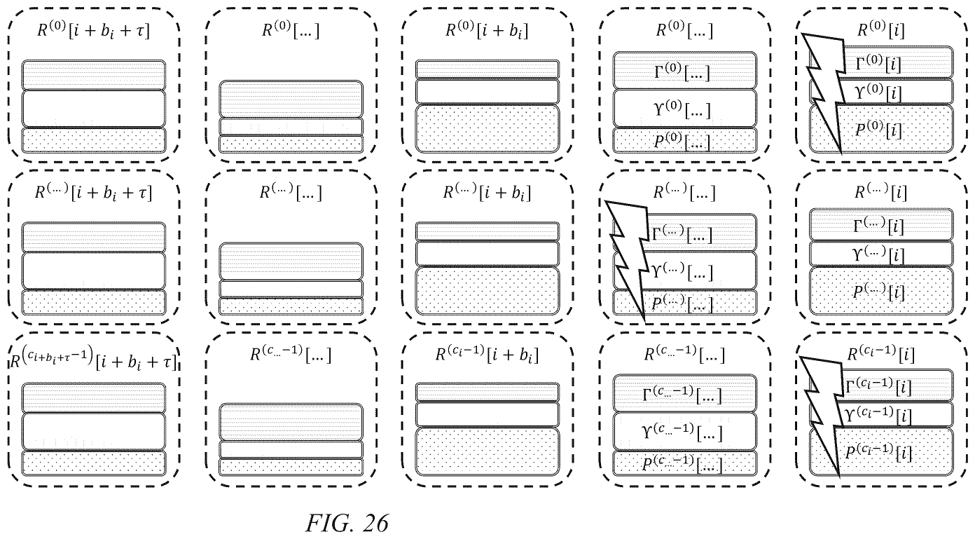

FIG. 26 shows an example of what may be received for time slots i through (i+bᵢ+τ) for non-negative integers i, bᵢ, and τ. Here, for each j∈{i+bᵢ, . . . , i+bᵢ+τ} and each z∈[cⱼ−1], (a) the box with horizontal lines inside of S^{(z)}[j] is Γ^{(z)}[j], (b) the box with vertical lines inside of S^{(z)}[j] is Υ^{(z)}[j], and (c) the box with black dots inside of S^{(z)}[j] is P^{(z)}[j]. This notation is applicable to other figures with similar boxes (unless otherwise specified).

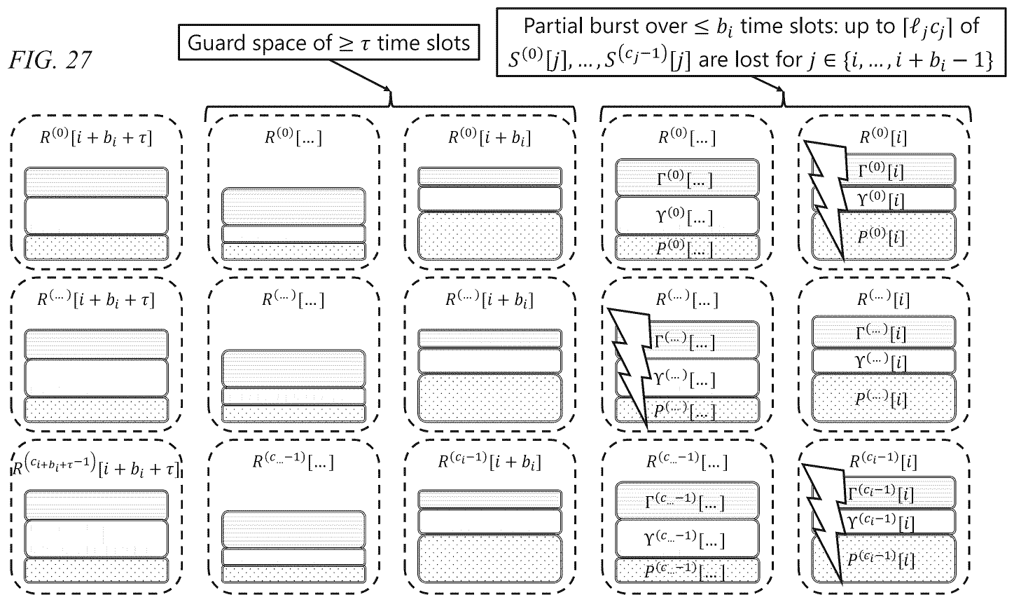

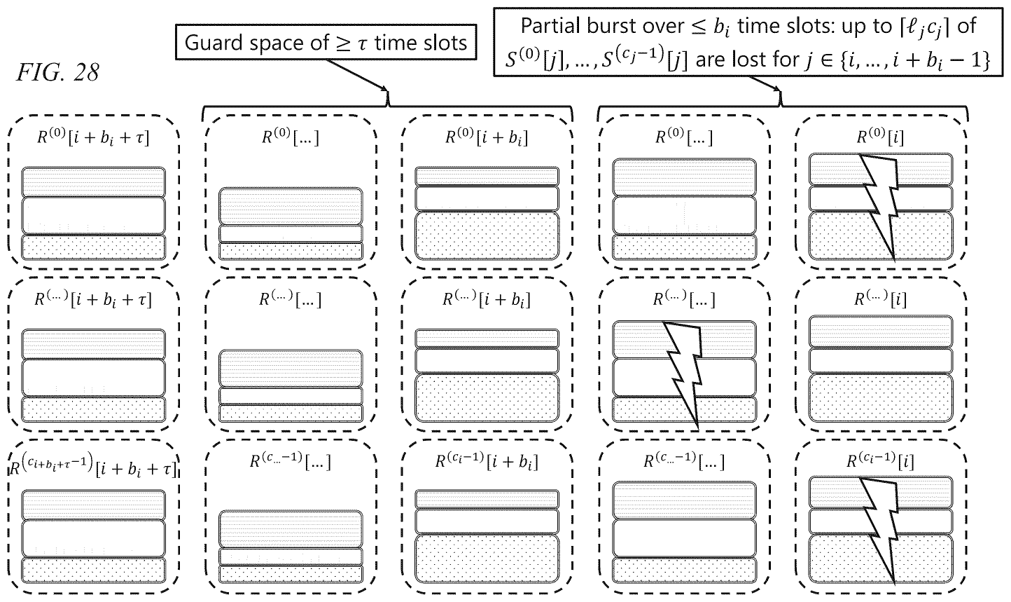

FIGS. 27 and 28 illustrate the streaming loss model in which a partial burst loss over ≤bᵢ time slots (up to [lᵢcⱼ] of S⁽⁰⁾[j], . . . , S^{(c}^{ⱼ}⁻¹⁾[j] are lost for j∈{i, . . . , i+bᵢ−1}) is followed by a guard space of ≥τ time slots (FIG. 28 removes some notation from FIG. 27) for non-negative integers i, cⱼ, bᵢ, and τ and real number between 0 and 1 (inclusive) lⱼ.

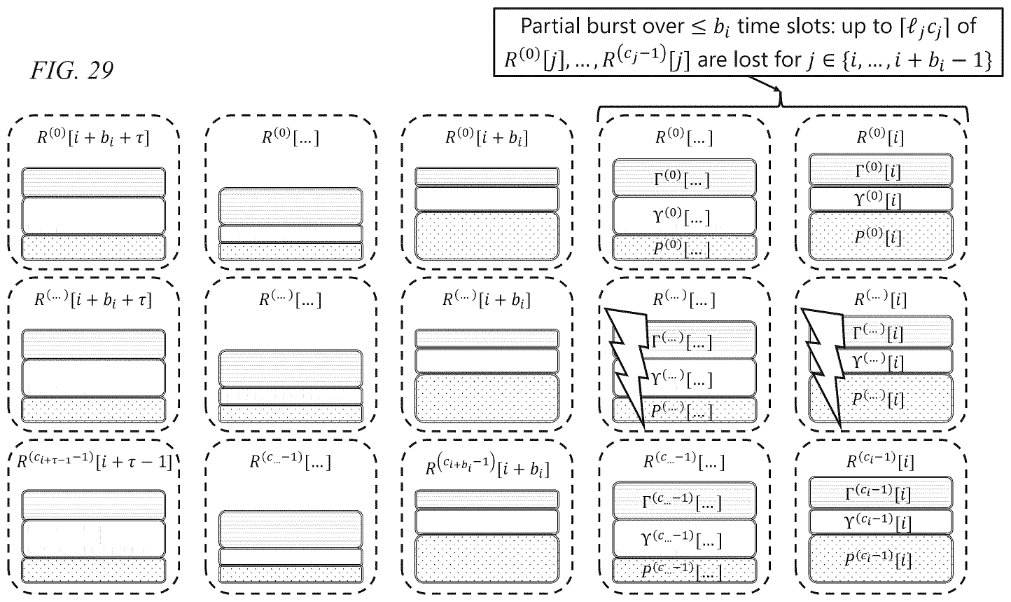

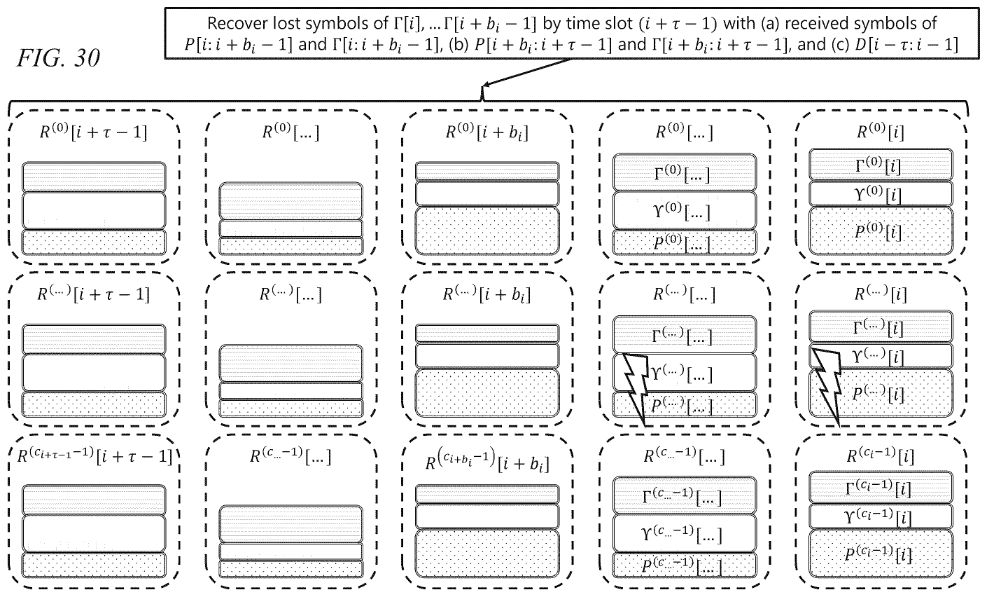

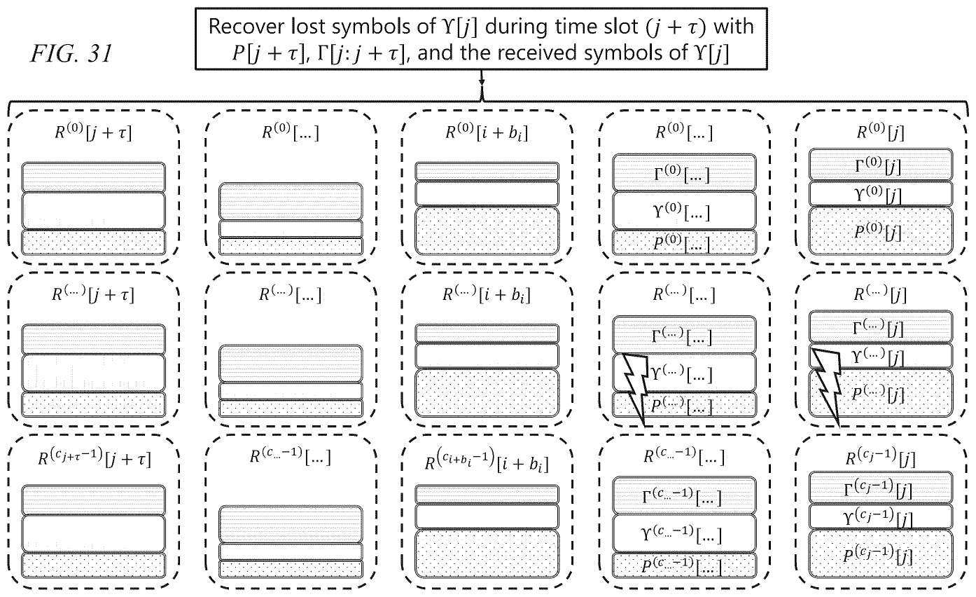

The intended loss recovery of a partial burst loss using CSIPB is now described with reference to FIGS. 29-33. Note that sometimes lightning bolts are changed to no longer overlap a vector (e.g., Γ⁻[i]) once it has been recovered. FIG. 29 shows an example of a partial burst over ≤bᵢ time slots: up to [lⱼcⱼ] of R⁽⁰⁾[j], . . . , R^{(c}^{ⱼ}⁻¹⁾[j] are lost for j∈{i, . . . , i+bᵢ−1}. In accordance with CSIPB, lost symbols of Γ[i], . . . Γ[i+bᵢ−1] are recovered by time slot (i+τ−1) using (a) received symbols of P[i:i+bᵢ−1] and Γ[i:i+bᵢ−1], (b) P[i+bᵢ:i+τ−1] and Γ[i+bᵢ:i+τ−1], and (c) D[i−τ:i−1], as depicted schematically in FIG. 30, where the symbols of D[i−τ:i−1] are assumed to already be decoded by time slot (i+τ−1). Also, lost symbols of Υ[j] are recovered during time slot (j+τ) with P[j+i], Γ[j:j+τ], and the received symbols of Υ[j], as depicted schematically in FIG. 31, where the symbols of Γ[j:i+bᵢ−1] are assumed to already be decoded by time slot (i+τ−1)≤(j+τ); also, the symbols of Γ[i+bᵢ:j+τ] and P[j+τ] are received.

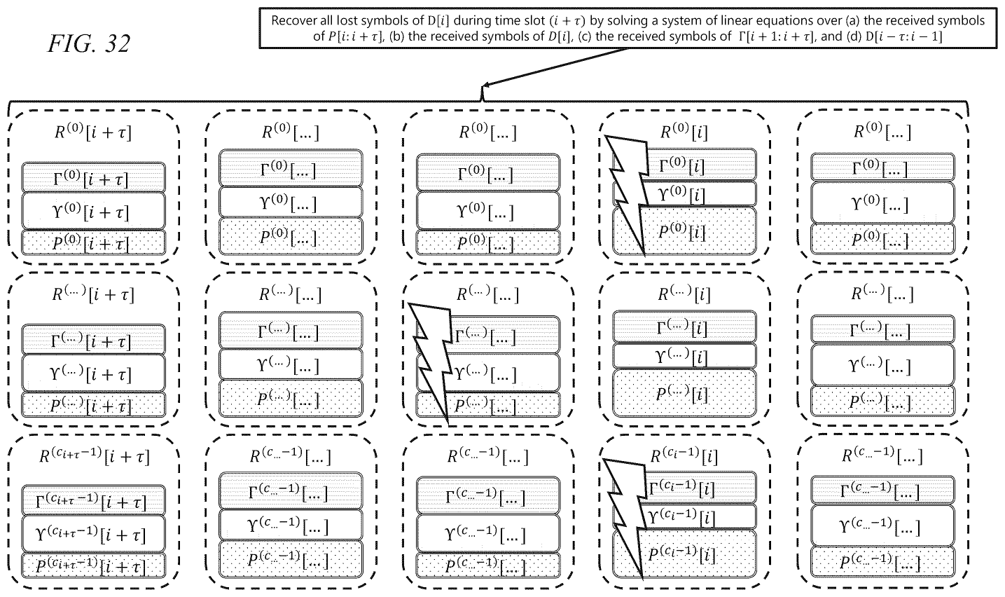

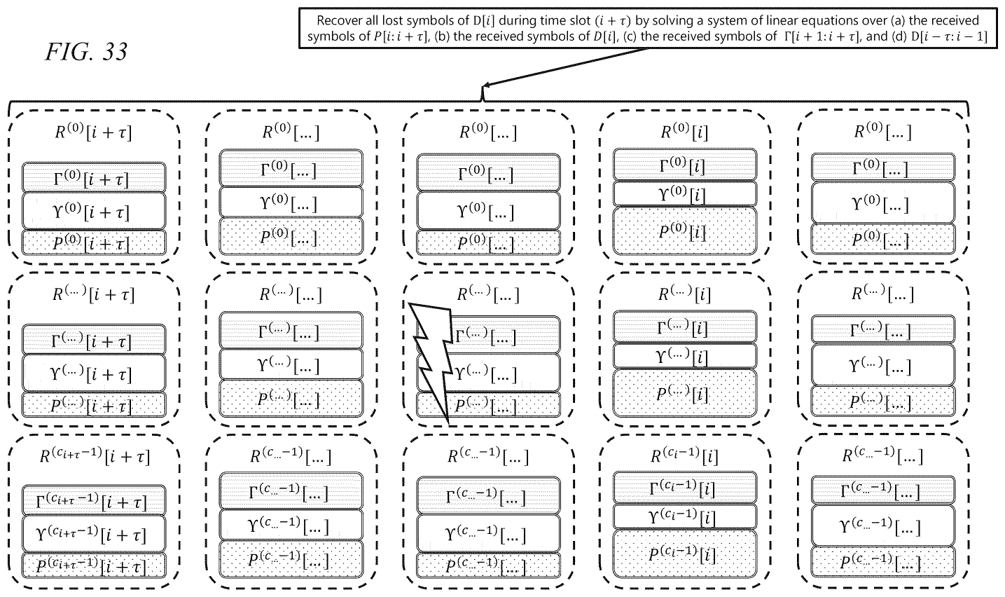

The intended loss recovery from the perspective of a single frame i is now described with reference to FIGS. 32-33. FIG. 32 shows an example of a partial burst loss. In accordance with CSIPB, all lost symbols of D[i] are recovered during time slot (i+τ) by solving a system of linear equations over (a) the received symbols of P[i:i+τ], (b) the received symbols of D[i], (c) the received symbols of Γ[i+1:i+τ], and (d) D[i−τ:i−1]. The symbols of D[i−τ:i−1] are assumed to already be decoded by time slot (i+τ). In summary, as depicted schematically in FIG. 33, loss recovery can be viewed as follows. Recover all lost symbols of D[i] during time slot (i+τ) by solving a system of linear equations over (a) the received symbols of P[i:i+τ], (b) the received symbols of D[i], (c) the received symbols of Γ[i+1:i+τ], and (d) D[i−τ:i−1]. One way to do so is to use Gaussian Elimination to solve the system of linear equations. Here, the lightning bolt reflects that symbols of R[i+1:i+bᵢ−1] may be lost; however, it is possible that the symbols of Γ[i+1:i+bᵢ−1] are already decoded by time slot (i+τ−1) for certain embodiments.

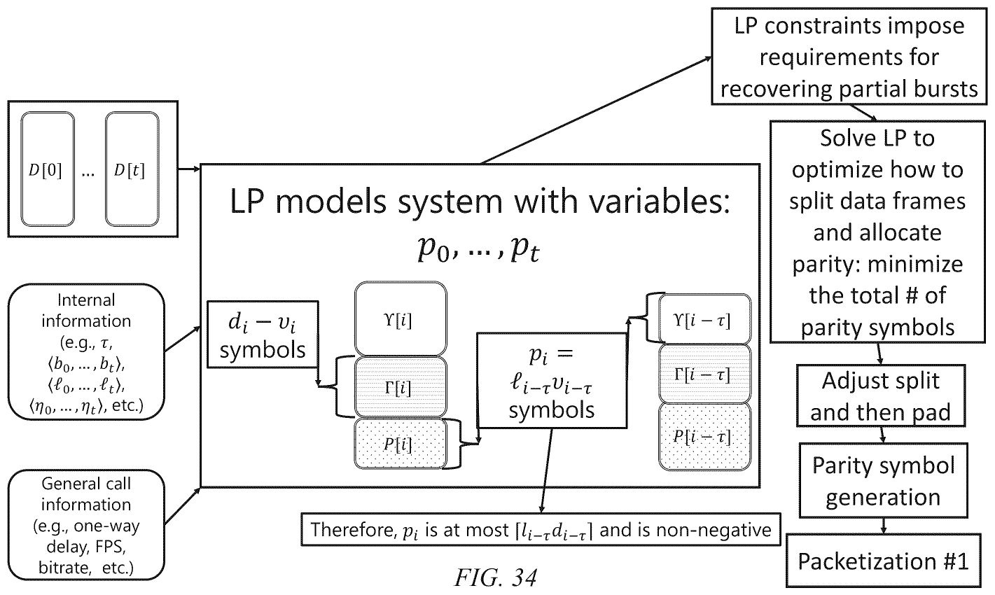

In an offline setting, where sizes of future frames are available, an offline optimization can be used to find splits and parity allocation, e.g., via a linear program. FIGS. 34-46 schematically show an offline optimization to find splits and parity allocation via a linear program, in accordance with one embodiment.

FIG. 34 shows a general linear program model to be solved for offline optimization, in accordance with one embodiment. In this example the total number of parity symbols is just the summation over all time slots, i, of pᵢ, where t is the length of the call in this example.

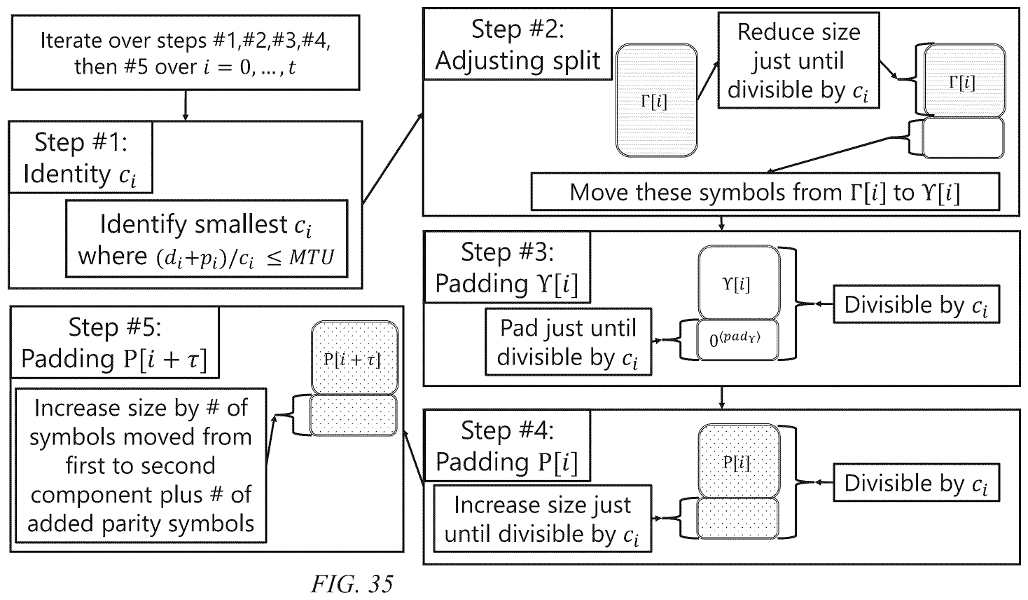

FIG. 35 shows the general steps for using the variables computed as part of the offline optimization using the linear program model of FIG. 34 to then determine the sizes of νⱼ, γⱼ, pⱼ for each time slot j, in accordance with one embodiment. In this example, padding is added, and the number of parity symbols is padded, parity symbol generation is applied, and then packetization #1 is applied. This ensures (a) the packetization is well defined while (b) maintaining the intended recovery properties for partial bursts (i.e., for a partial burst starting in time slot i with high probability (a) for each time slot i that Γ[i:i+bᵢ−1] are recovered by time slot (i+τ−1) and (b) each Υ[j] is recovered by time slot (j+τ) for j∈{i, . . . , i+bᵢ−1}.

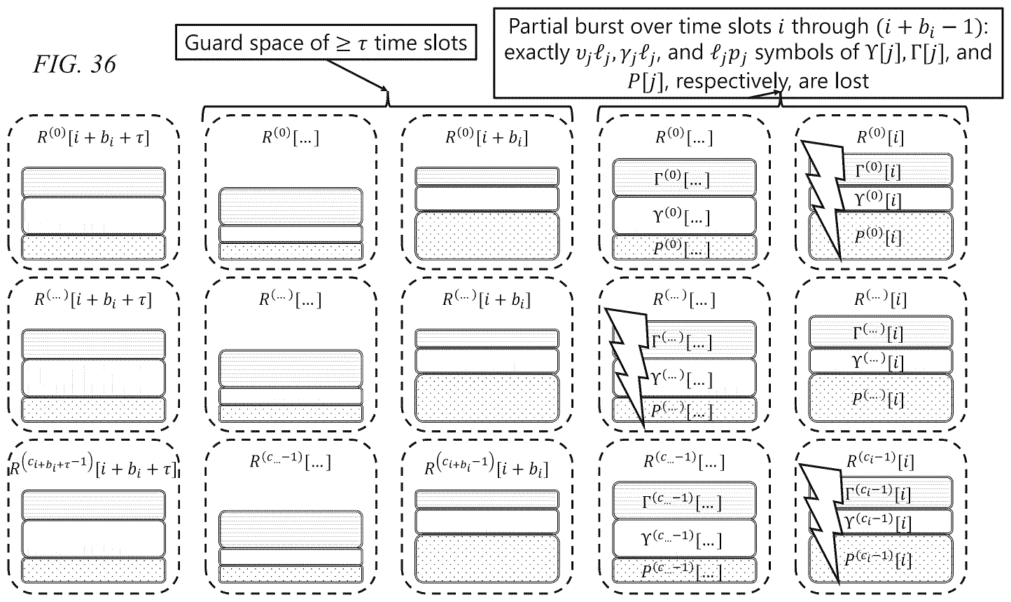

FIG. 36 models a partial burst starting in time slot i for constraints on loss recovery (under a relaxation of lᵢ fraction of the symbols of Υ[i], Γ[i], and P[i] are modeled as being lost). Note that the steps shown in FIG. 35 address the relaxation.

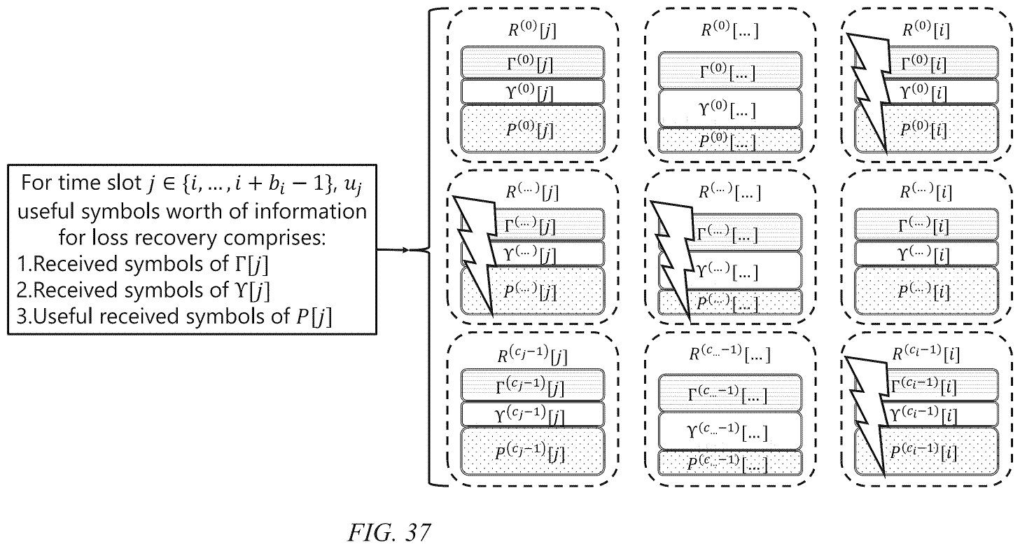

FIG. 37 shows useful symbols for loss recovery in time slot j∈{i, . . . , i+bᵢ−1}, in accordance with one embodiment.

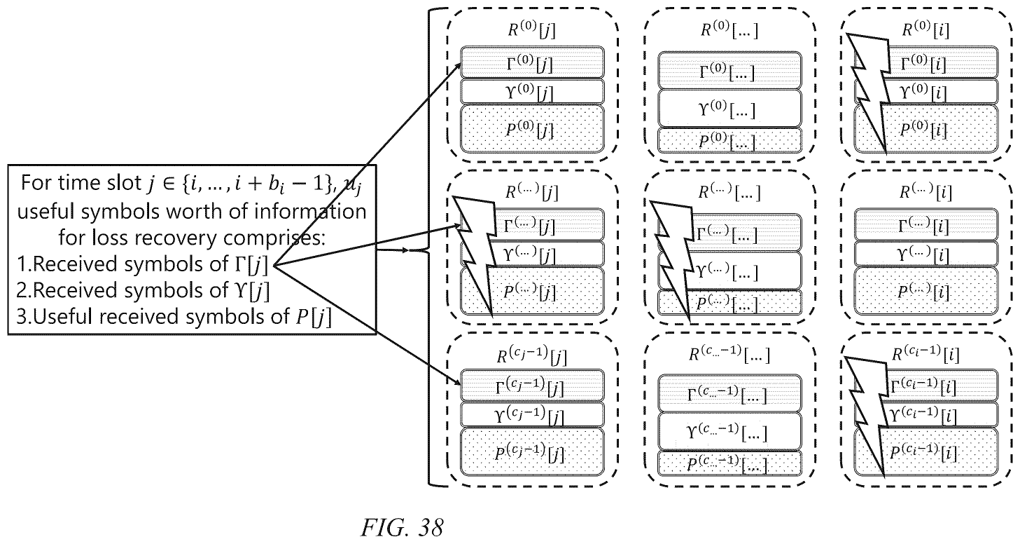

FIG. 38 highlights received symbols Γ[j].

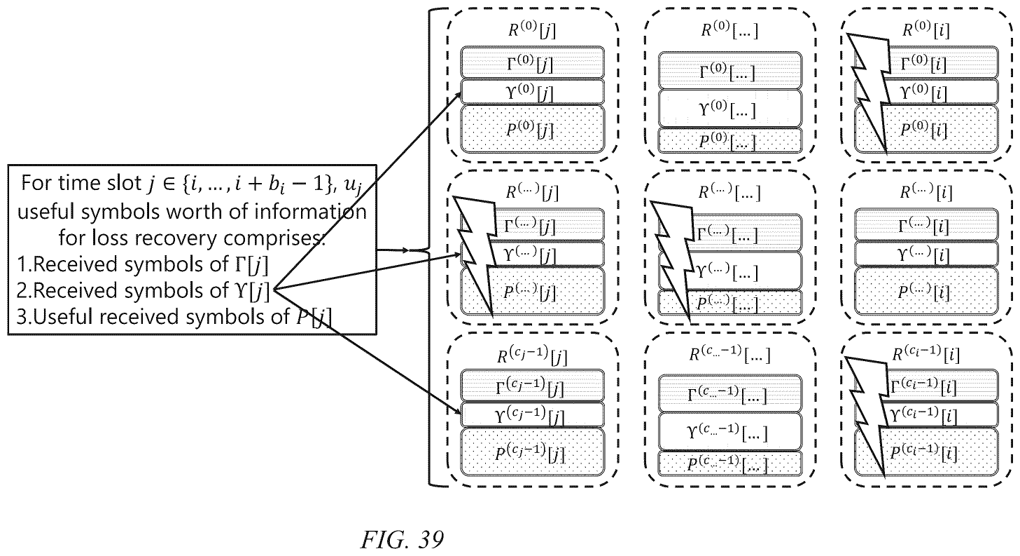

FIG. 39 highlights received symbols Υ[j].

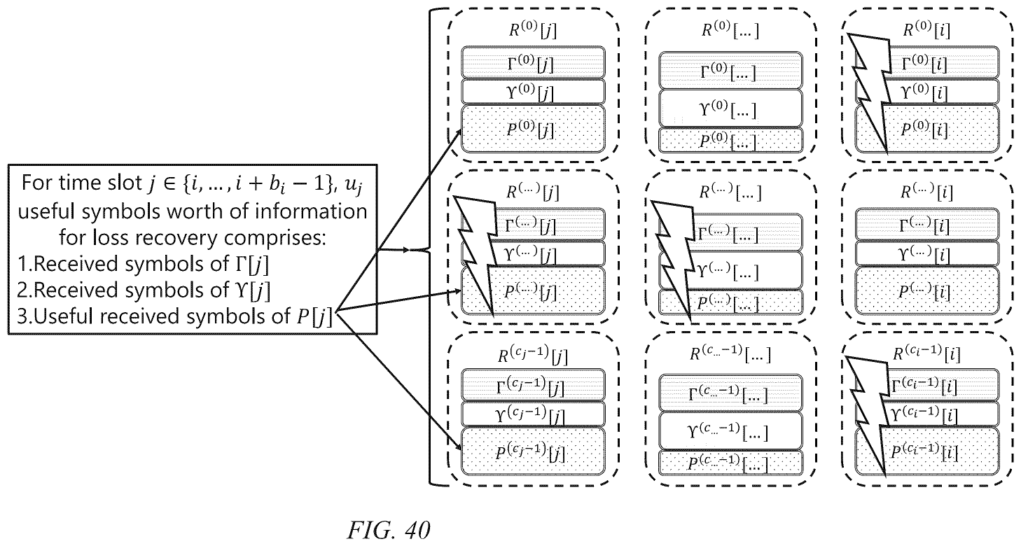

FIG. 40 highlights received symbols P[j].

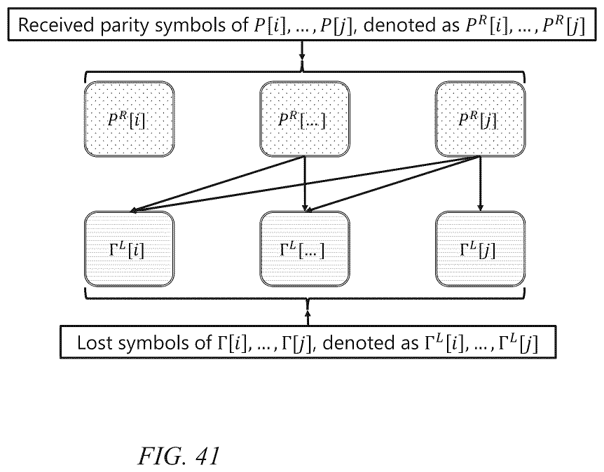

FIG. 41 shows useful parity symbols for loss recovery, in accordance with this example.

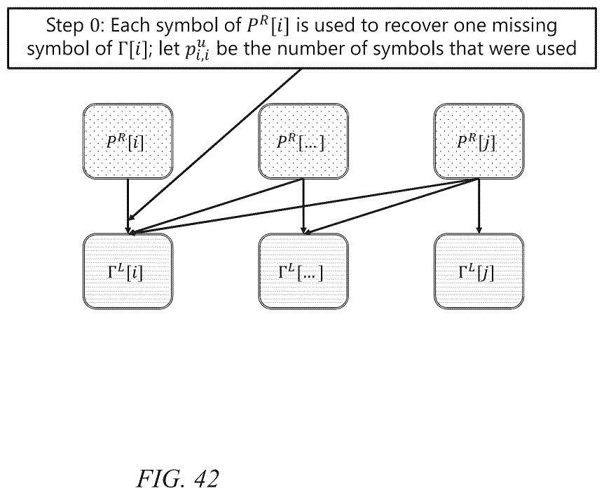

FIG. 42 shows an initial step for loss recovery in accordance with this example.

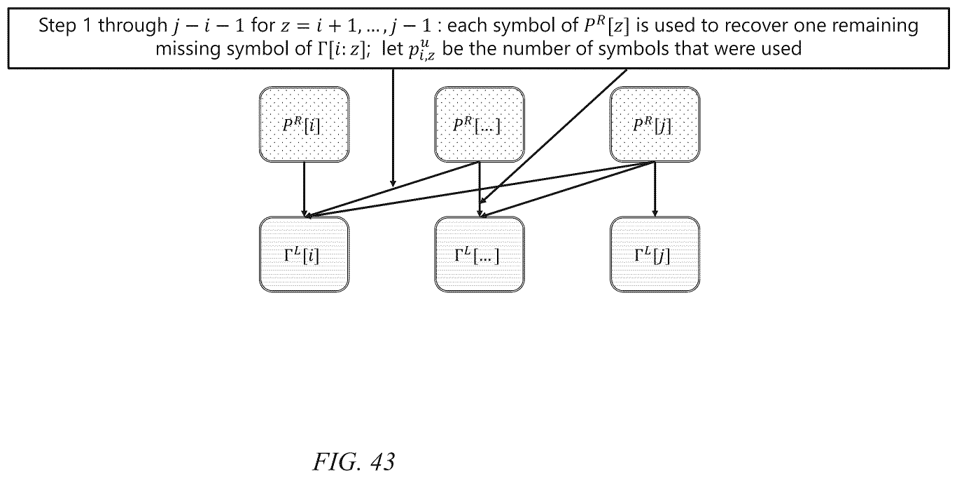

FIG. 43 shows intermediate steps for loss recovery in accordance with this example.

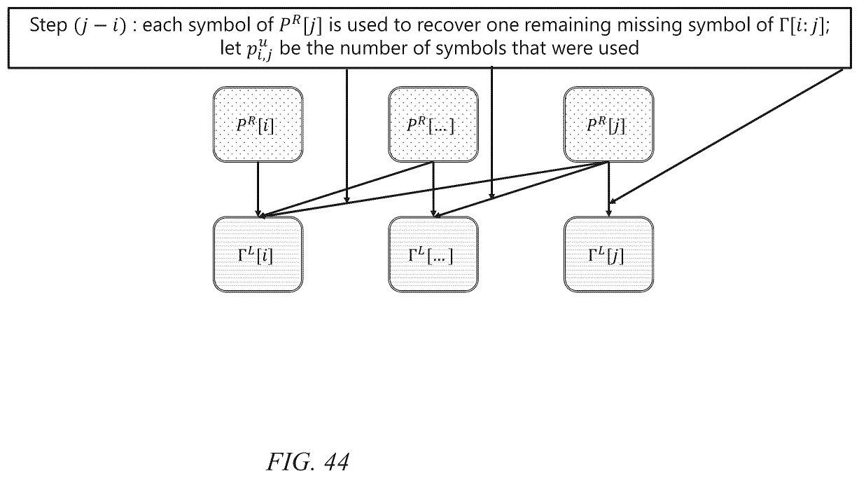

FIG. 44 shows the final step for loss recovery of the first component of frames from the partial burst in accordance with this example.

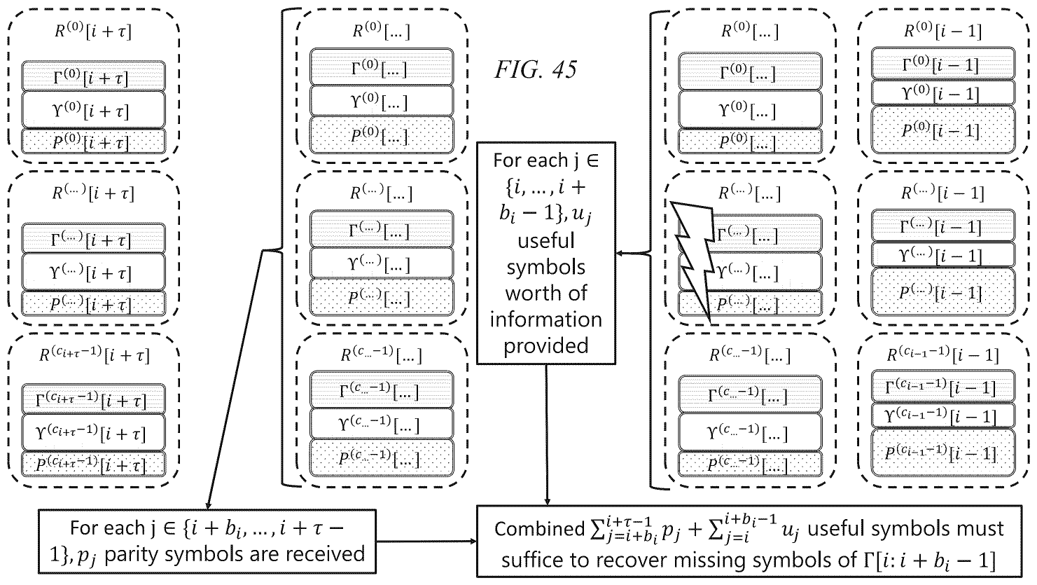

FIG. 45 shows how an upper bound on how many useful symbols are available to recover missing symbols of Γ[i:i+bᵢ−1] by times lot (i+τ−1). Then recall for a partial burst starting in time slot i and each j∈{i, . . . , i+bᵢ−1} that the number of lost symbols of Υ[j] equals p_{j+τ}. So, the optimization is accomplished by minimizing

$${Σ}_{i = 0}^{t} {p}_{i}$$

subject to (a) the loss recovery constraint shown in the lower right box of FIG. 45, (b) bounding the size of each pᵢ to be at least 0 and for i>τ to be at most ┌d_{i-τ},l_{i-τ}┐, and (c) (optionally) add the constraint that the first τ−1 time slots involve sending 0 parity symbols using a linear program. Then, padding is performed if needed to ensure divisibility by cᵢ of sizes of Υ[i], Γ[i], and P[i] as discussed herein and then the sizes of Υ[i], Γ[i], and P[i] are matched (i.e., handling splitting and allocating parity symbols) and the parity symbol generation/loss recovery is performed. To deal with resets, for each time slot i where there is a reset among time slots (i+1), . . . , (i+τ), dᵢ is modeled as being of size 0 in the linear program and split so that Υ[i]=D[i] and p_{i+τ}=0.

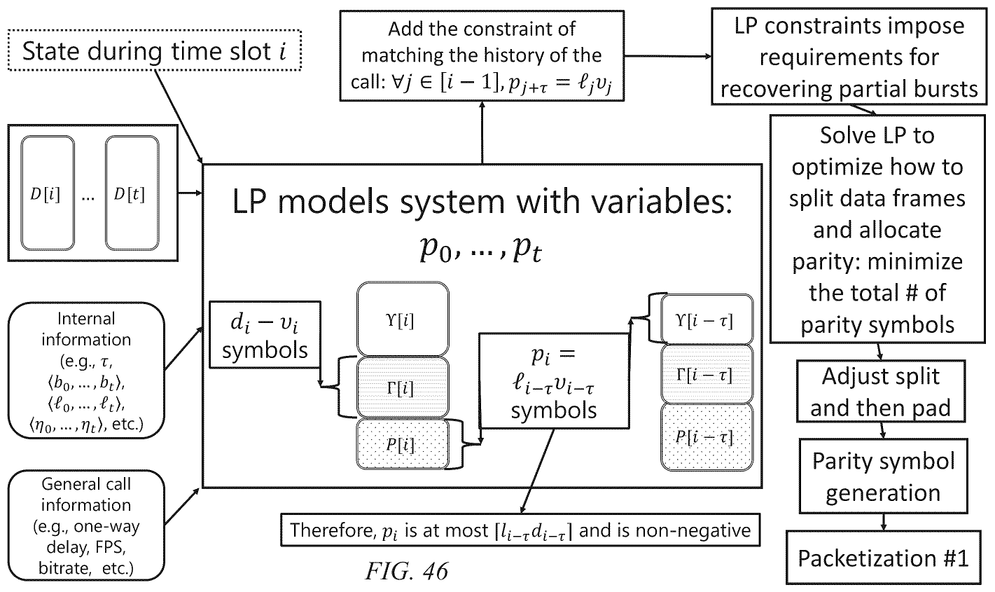

FIG. 46 shows that the optimization can be modified to apply during time slot i (i.e., after packets have been sent for previous time slots) by adding constraints to reflect the actions from earlier in the call (e.g., how much parity was allocated) and then using the offline linear program solver to determine the splits for the remainder of the call, where the total number of parity symbols is just the summation over all time slots, i, of pᵢ (where the length of the call is represented by t). For convenience, this optimization may be referred to herein as the “offline solver”).

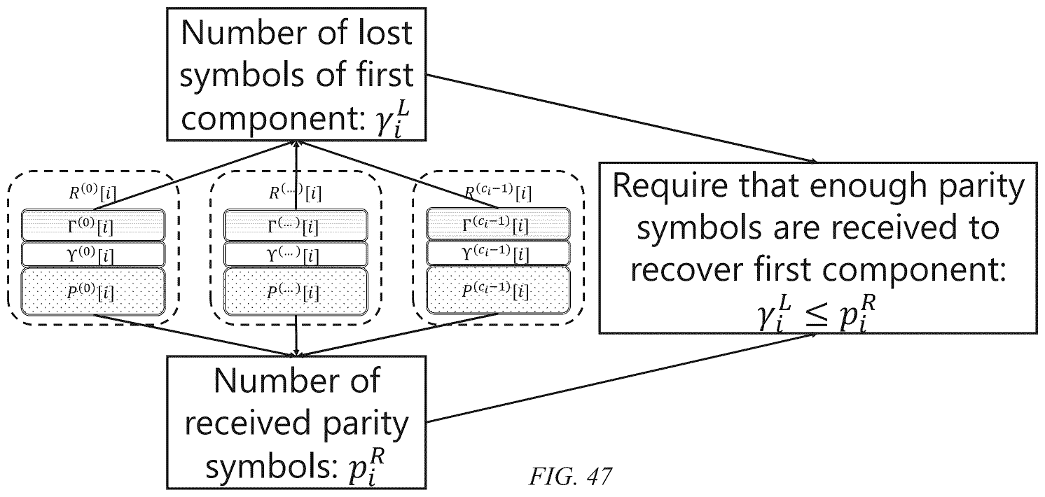

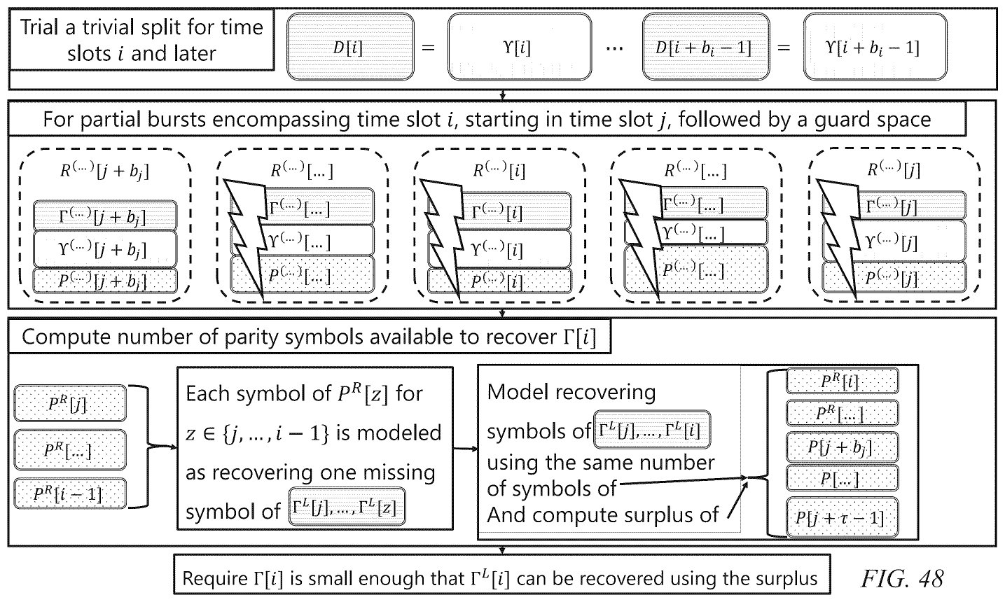

One way to split data frames is to use a heuristic. FIG. 47 is a schematic diagram representing a heuristic for splitting video frames to recover type “Γ” immediately for any partial burst, in accordance with one embodiment. FIG. 48 is a schematic diagram representing a process for splitting video frames using the heuristic of FIG. 47. One heuristic determines the size of the first component should be as large as possible subject to ensuring that it is recoverable using the received parity of the same time slot with high probability. Another heuristic determines the size of the first component should be as large as possible subject to the following constraint. Suppose the first component is empty for the next i time slots. For any partial burst that includes the current time slot, then all symbols of the first component that are lost in the partial burst are recovered by τ−1 time slots after the start of the partial burst with high probability (which may be referred to herein as a “max heuristic”). The value of the heuristic for time slot i is γᵢ^{max}.

Another way to split data frames is to treat splitting as a reinforcement learning problem. As is generally known, reinforcement learning is a type of machine learning technique in which the system learns through training to make decisions (e.g., using trial-and-error) based on feedback from a reward function.

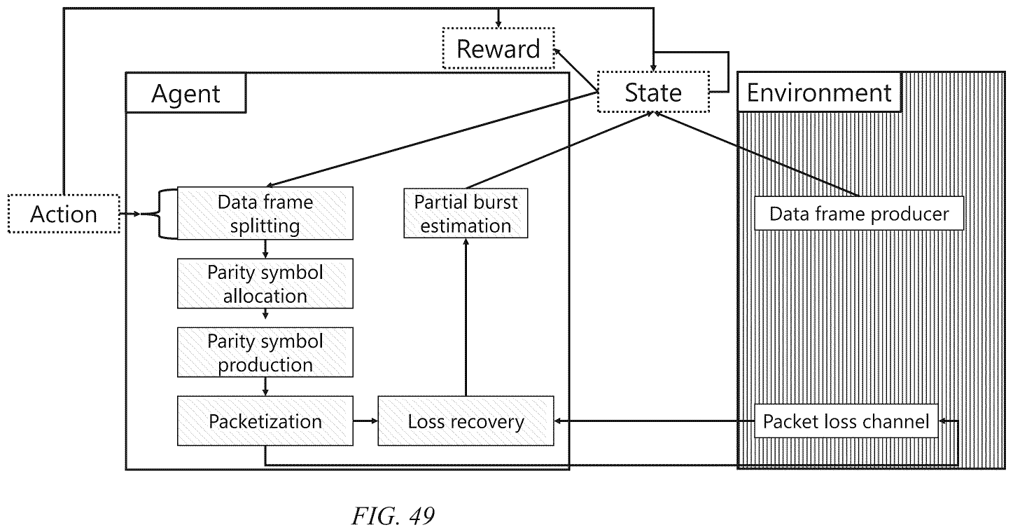

FIG. 49 illustrates a general methodology for splitting frames using reinforcement learning, in accordance with certain embodiments. Here, the key intuition is that the choice of how to split a data frame changes the state of the system and potentially incurs a cost (e.g., requiring that more parity symbols are sent). The total cost must account for both the change in state and the incurred cost. Our approach enables optimizing the policy for splitting based on both factors with the goal of minimizing how many symbols are sent in total to reliably communicate the sequence of data frames in real time.

To do so, splitting within a framework can be modeled in a way that is reminiscent of reinforcement learning. An agent applies a communication scheme (e.g., CSIPB) to communicate the data frame from one or more sender(s) to one or more receiver(s). The action can be viewed as the decision of how to split the data frame. A reward is obtained based on the action and state of the system. For example, the reward may involve costs such as bandwidth usage (including parity symbols sent under the communication scheme) and consequences arising from this usage (e.g., sending too much data may incur loss by overflowing the buffer(s) of network router(s)), and metrics to estimate the QoE of the received video, such as PSNR, SSIM, or LPIPS. The environment reflects (a) how an application produces data frames, and (b) how packets may be lost. The state reflects the situation and may include information like previous data frames, how many packets have been sent, what sizes were the packets that have been sent, etc. Then one can use methods from reinforcement learning to solve for a suitable policy for how the data frame should be split.

The general methodology of FIG. 49 can be extended to encompass frame splitting and/or parity symbol allocation using reinforcement learning.

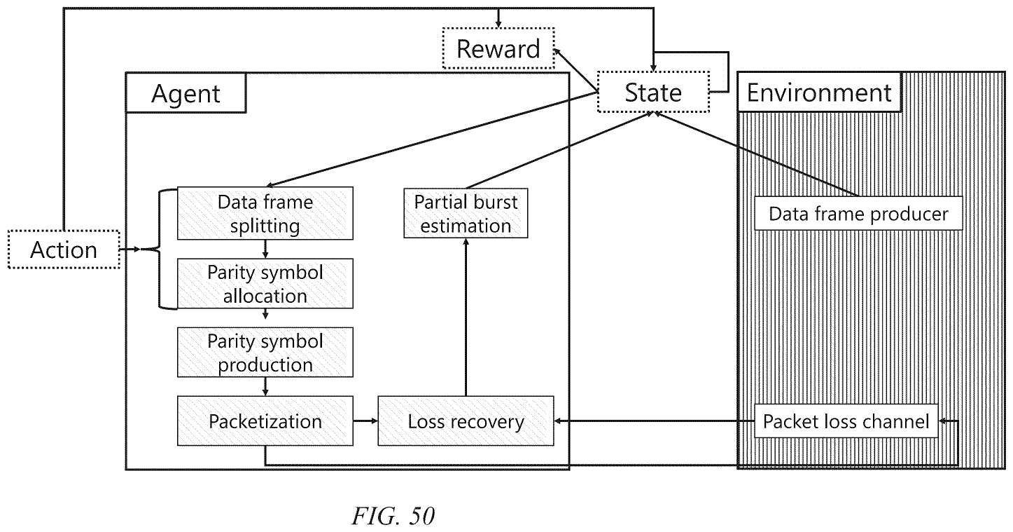

FIG. 50 illustrates a general methodology for splitting frames and allocating parity symbols using reinforcement learning, in accordance with certain embodiments. Here, the key intuition is that the choices of how to split and allocate parity for a data frame change the state of the system and potentially incur a cost (e.g., requiring that more parity symbols are sent). The total cost can account for both the change in state and the incurred cost. In one embodiment, the approach enables optimizing the policy for splitting based on both factors with the goal of minimizing how many symbols are sent in total to reliably communicate the sequence of data frames in real time.

To do so, splitting within a framework can be modeled in a way that is reminiscent of reinforcement learning. An agent applies a communication scheme (e.g., CSIPB) to communicate the data frame from one or more sender(s) to one or more receiver(s). The action can be viewed as the decision of how to split and allocate parity for a data frame. A reward is obtained based on the action and state of the system. For example, the reward may involve costs such as bandwidth usage (including parity symbols sent under the communication scheme) and consequences arising from this usage (e.g., sending too much data may incur loss by overflowing the buffer(s) of network router(s)), and metrics to estimate the QoE of the received video, such as PSNR, SSIM, or LPIPS. The environment reflects (a) how an application produces data frames, and (b) how packets may be lost. The state reflects the situation and may include information like previous data frames, how many packets have been sent, what sizes were the packets that have been sent, etc. Then, methods from reinforcement learning can be used to solve for a suitable policy for how the data frame should be split and how much parity should be allocated for the data frame.

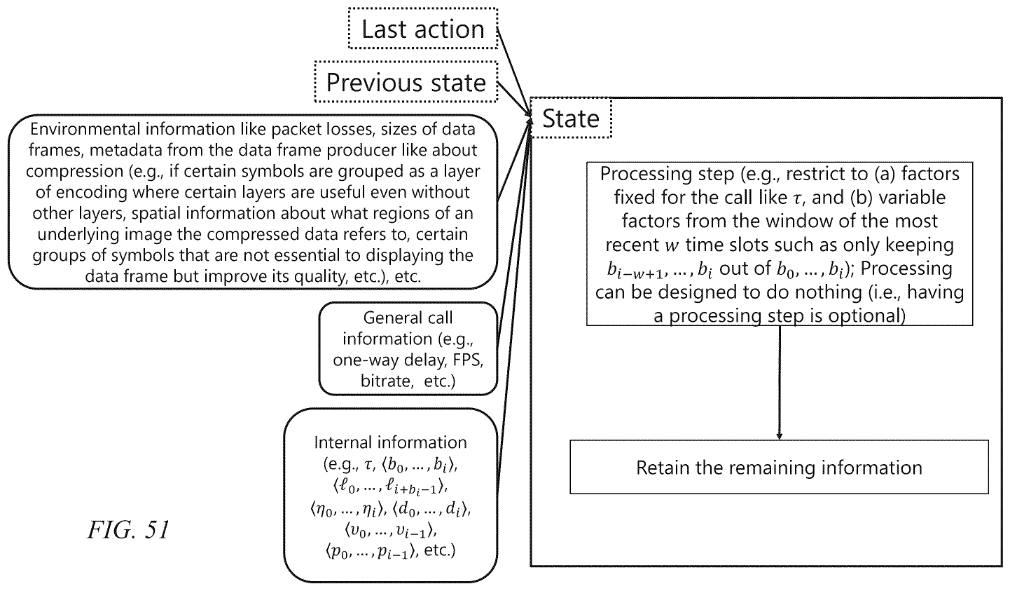

FIG. 51 schematically illustrates the concept of “state” for reinforcement learning, in accordance with certain embodiments. Here, the state is meant to capture the situation; by assumption, the state can track any piece of information pertaining to the system, although some may not be tracked in certain embodiments (as can be accomplished via an additional processing step). To aid in the compute costs of reinforcement learning (e.g., to avoid the curse of dimensionality), some information may be dropped. Also, one may reduce the number of possible states by reducing the granularity of information (e.g., list the number of symbols of each component and/or parity symbols sent per time slot as integral multiples of a number, like 100, and applying rounding).

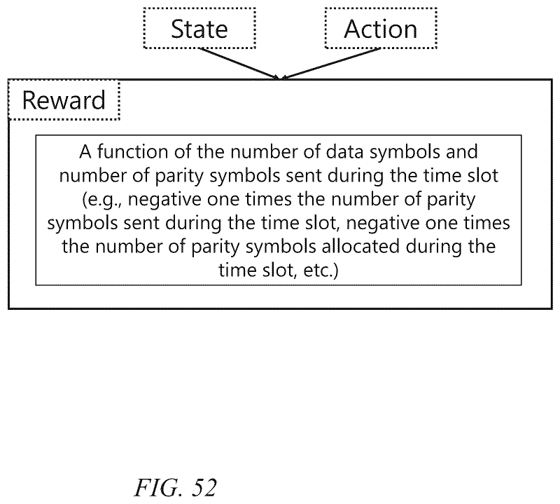

FIG. 52 shows one example of a reward function for training frame splitting and/or parity allocation, in accordance with certain embodiments. Here, the reward is given once per time slot after the action is taken. It is given as input (a) the state of the system and (b) the action that was taken. The reward is meant to encourage a high-rate code with loss recovery capabilities and/or perhaps metric(s) pertaining to QoE such as PSNR, SSIM, or LPIPS. The reward is only given once per time slot after the action has been taken. One example of how to do so is to give a negative reward based on the number of parity symbols sent during each time slot to encourage sending fewer parity symbols.

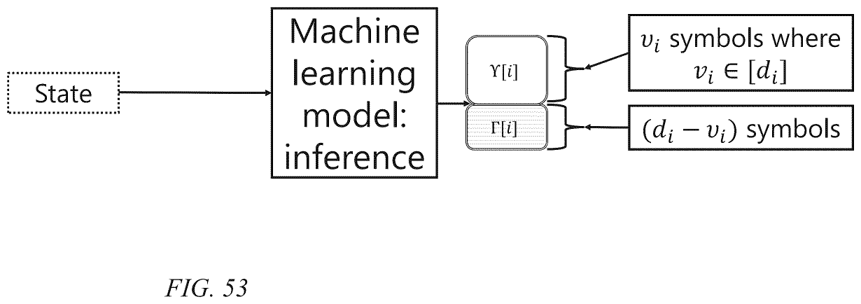

As depicted in FIG. 53, a machine learning model such as a reinforcement learning model can be applied at inference time, e.g., at the time of deciding how to split frames and/or allocate parity symbols.

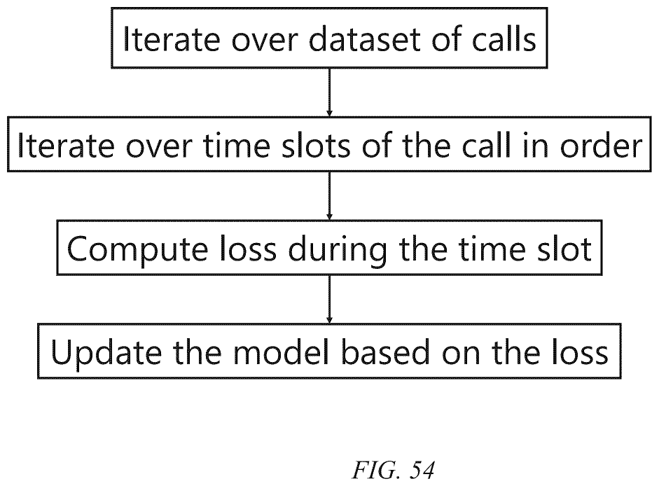

As depicted in FIG. 54, in certain embodiments, a machine learning model generally would be trained offline using actual and/or simulated data (e.g., data representing a number of calls) and generally involves iterating over the dataset, computing the loss during each time slot, and updating the model using the loss. Embodiments can allow for human feedback such as to fine-tune the model.

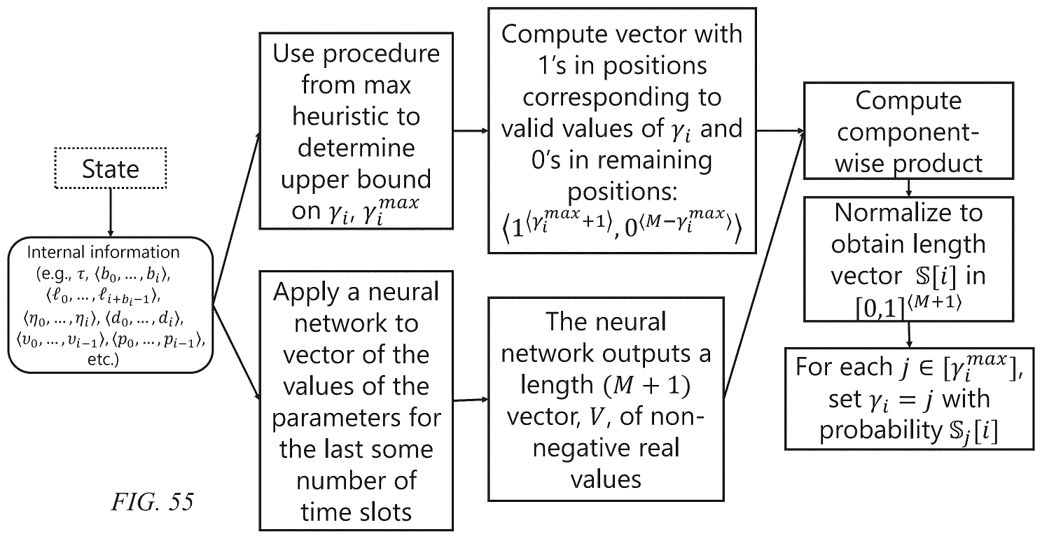

FIG. 55 shows one example of neural network (NN) model for training frame splitting, in accordance with certain embodiments. In this example, the neural network architecture is a 2-layer fully connected feedforward NN with ReLU activations in the hidden layer and a softmax activation on the outer layer. This shows the probability that each split should be chosen. Then the size of the first component is bounded, e.g., based on the max heuristic, which eliminates some possible choices of the split. The remaining values are then normalized to create a distribution of how large the split should be, and the size is sampled from this distribution.

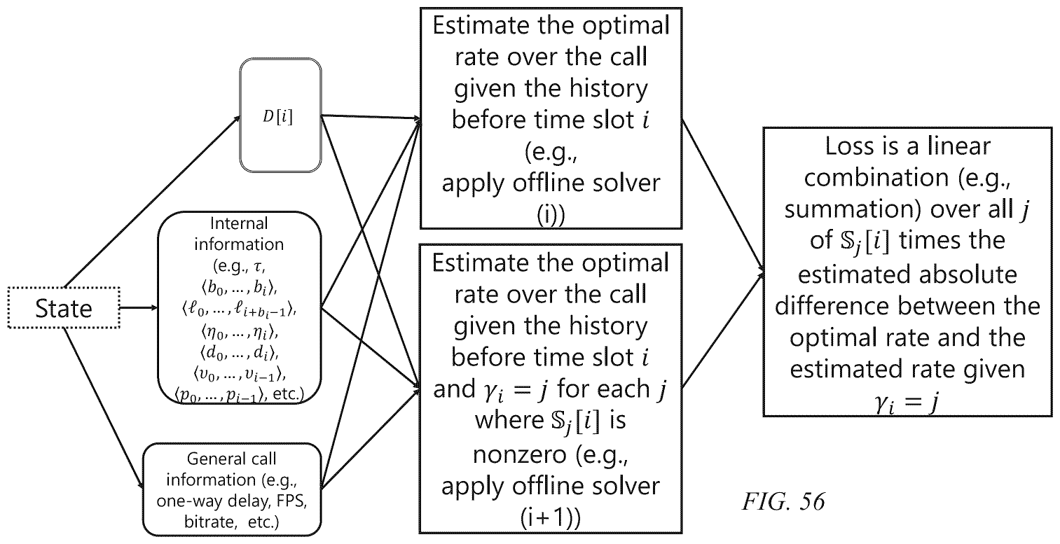

FIG. 56 shows one possible loss function (referred to herein as “loss function 1”), in accordance with certain embodiments. Here, to train the neural network, the system determines the loss incurred from its output. To do so, the optimal rate that can be obtained over any choice for how to split data frames is estimated (e.g., by applying the offline solver up to the current time slot, i, and given the next action applying the offline solver up to the next time slot, i+1). Then this rate is compared to the optimal rate given each choice for splitting that can be selected based on the neural network's output. This loss of this particular choice of splitting is weighted based on the probability it is selected.

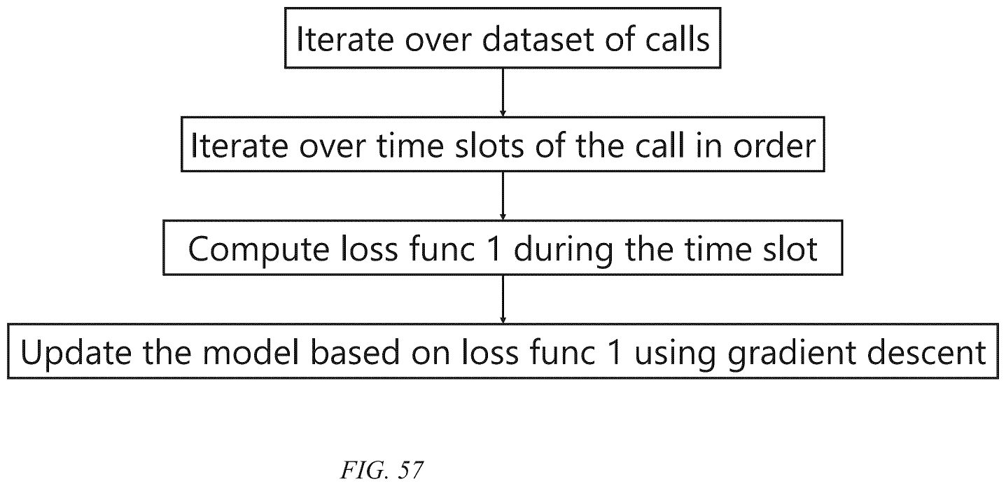

FIG. 57 shows one possible way to train the NN during jth call and ith time slot, in accordance with certain embodiments. Here, the system takes a dataset of calls, iterates over the dataset, computes the loss during the time slot using loss function 1, then updates the model using the loss.

Additionally or alternatively, the partial burst parameters can be set using reinforcement learning.

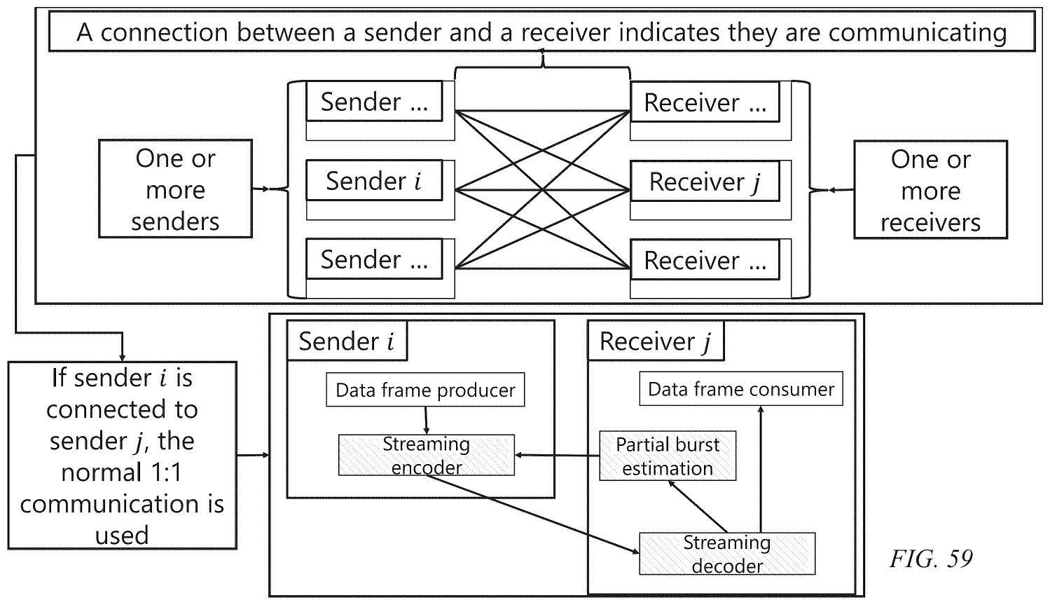

FIG. 59 shows how communication can occur between one or more senders and one or more receivers in certain embodiments by employing the 1:1 communication scheme between each pair of sender and receiver.

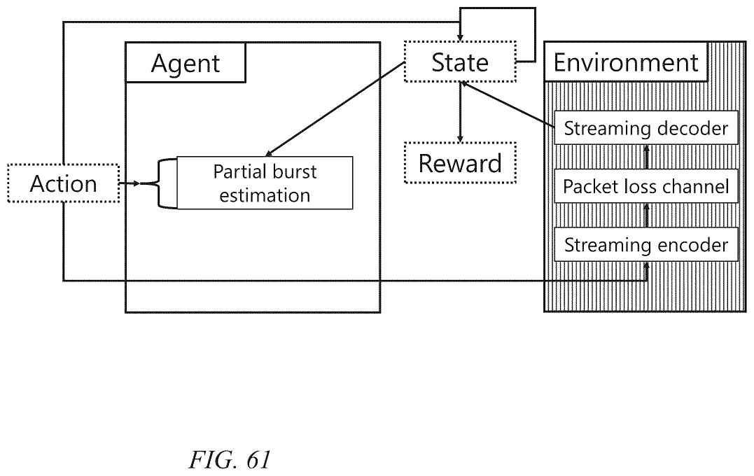

FIG. 61 provides an overview of how one can model estimating the partial burst parameters using a model conducive to reinforcement learning, in accordance with certain embodiments. Here, calling the parameters lᵢ, bᵢ “burst parameters” or similar notation is meant to explain one way the embodiment of the communication schemes could be. Another (more general) viewpoint is that these parameters can be considered knobs to tune the communication scheme, e.g., they may be based on explicit characteristics of packet loss, or they may just be used to tweak the communication scheme until it behaves as desired (e.g., scores high on average on certain metrics of QoE). Thus, these parameters impact the code construction itself, which varies from data frame to data frame; these parameters do not merely change the bandwidth overhead (although that is one thing they will impact).

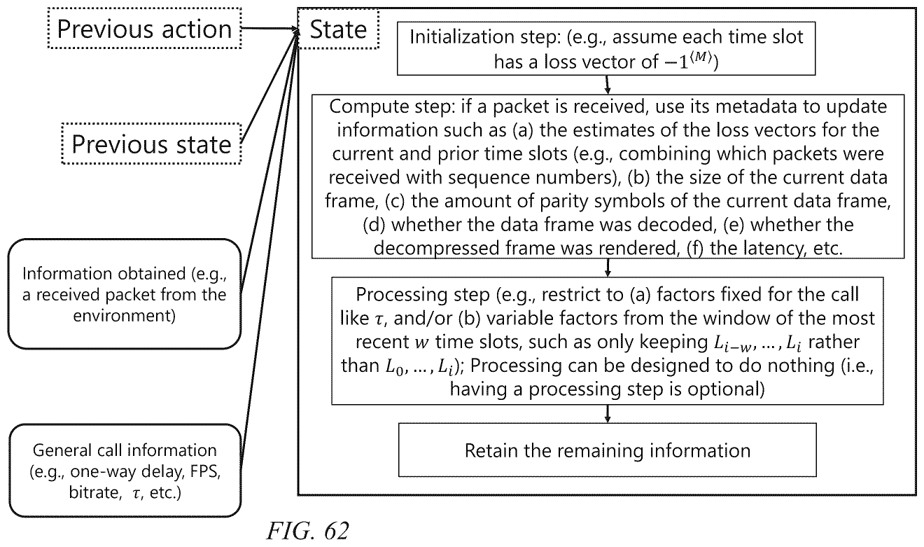

FIG. 62 illustrates the concept of “state” for the modeling of FIG. 61, in accordance with certain embodiments. Here, the state is meant to capture the situation; by assumption, the state can track any piece of information pertaining to the system, although some may not be tracked in certain embodiments (as can be accomplished via the processing step). To aid in the compute costs of reinforcement learning (e.g., to avoid the curse of dimensionality), some information may be dropped. Also, one may reduce the granularity of information such as by bucketing the number of parity symbols sent per time slot (e.g., list the number of symbols sent per time slot as integral multiples of a number, like 100, and applying rounding).

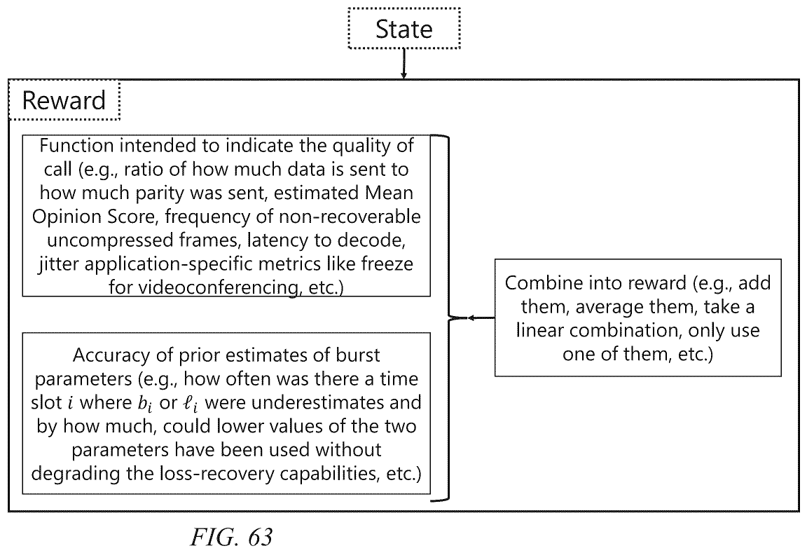

FIG. 63 shows one example of a possible reward function for the modeling of FIG. 62, in accordance with certain embodiments. One approach is to only give a reward when a packet is received (otherwise give 0 reward). Then one might consider two main intrinsic sources of reward (a) the quality of the call, and (b) the quality of the estimates. For each of these values, a function can be applied to score the performance (e.g., output a value between 0 and 1 where 1 is the optimal and 0 is the worst possible). Certain embodiments use a reward function that combines these three factors in a predetermined manner. For example, create a function (e.g., a metric) to measure the value/costs of an action for each metric. Then, create a second function to combine these three factors into a reward. One way is to add them. Another way is to ignore one and just use the other; for example, it may be much easier computationally just to use (b) to aim to select parameters that are intended to be upper bounds on how lossy the packet losses will be with reasonably high probability. Instead, another example is that one may ignore the “accuracy” of prior estimates and/or view these parameters not as estimates of future packet loss but as knobs for how to run the Streaming Encoder/Decoder; in this case, one can tune these parameters simply to optimize only for metrics of the quality of the call (e.g., frequency of video freeze if the desired application is videoconferencing).

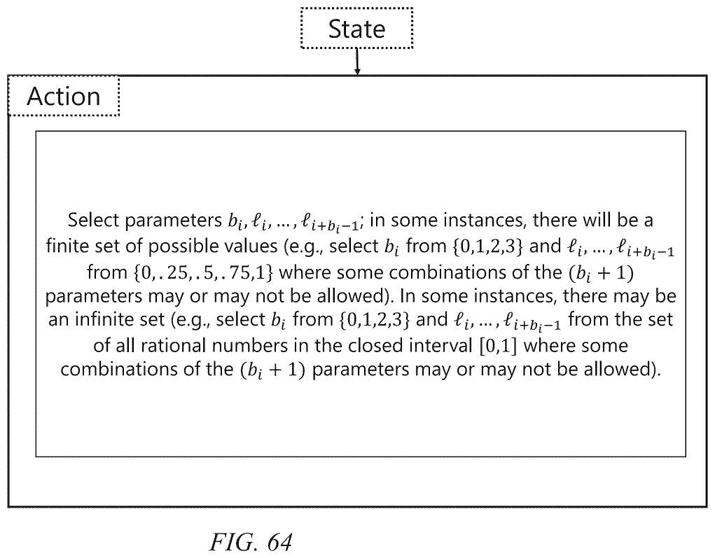

FIG. 64 shows one example for the action block of FIG. 61, in accordance with certain embodiments. The action may be taken as often as once a time slot. It may instead be less frequent; one example is to be periodic (e.g., every some fixed number of time slots), in which case feedback may or may not be returned to the streaming encoder that time slot (i+1) should maintain the estimate of bᵢ (e.g., bᵢ₊₁=bᵢ) and likewise not change the estimated parameter for the fraction of packets lost (e.g., l_{i+b}_{ᵢ₊₁}=l_{i+b}_{ᵢ₊₁}₋₁).

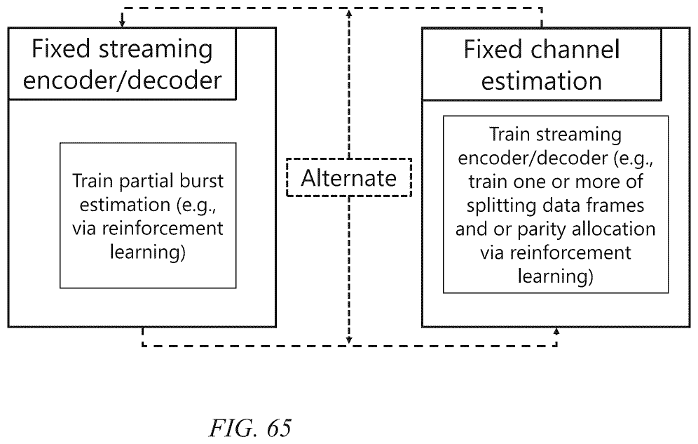

FIG. 65 shows an example of alternating training of (a) estimating the partial burst, and (b) the streaming code (e.g., splitting and/or parity allocation), in accordance with certain embodiments. Here, one methodology is introduced to synergize the actions for estimating the partial burst parameters and the streaming code (e.g., splitting, spreading, splitting and spreading, etc.), specifically by alternating between (a) fixing partial burst estimation and optimizing the policy for communication (e.g., how to split data frames), and (b) fixing streaming encoder/decoder and optimizing the policy for estimating partial burst parameters. The optimization can be done using techniques from reinforcement learning. This can continue until the user is satisfied with performance.

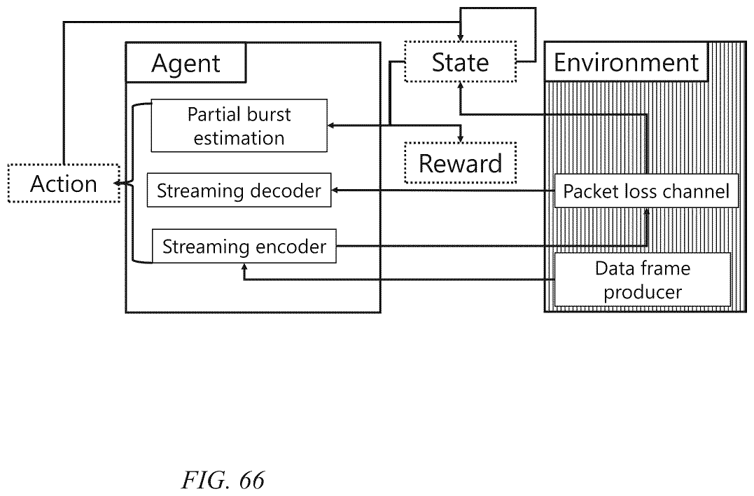

FIG. 66 shows an example of jointly training (a) estimating the partial burst, and (b) the streaming code (e.g., splitting and/or parity allocation), in accordance with certain embodiments. Here, the system jointly trains both (a) partial burst estimation and (b) the streaming encoder/decoder (e.g., splitting data frames and/or parity allocation by using the state to track all information tracked by the (a) state from the partial burst estimation and (b) the state from the streaming encoder, combining their two rewards (e.g., adding them), and letting actions be the combination of actions of the partial burst estimation and the streaming encoder/decoder. Reward might still only occur every time a packet is received. Or it may be once per time slot now that complete information about what packets were lost is now available.

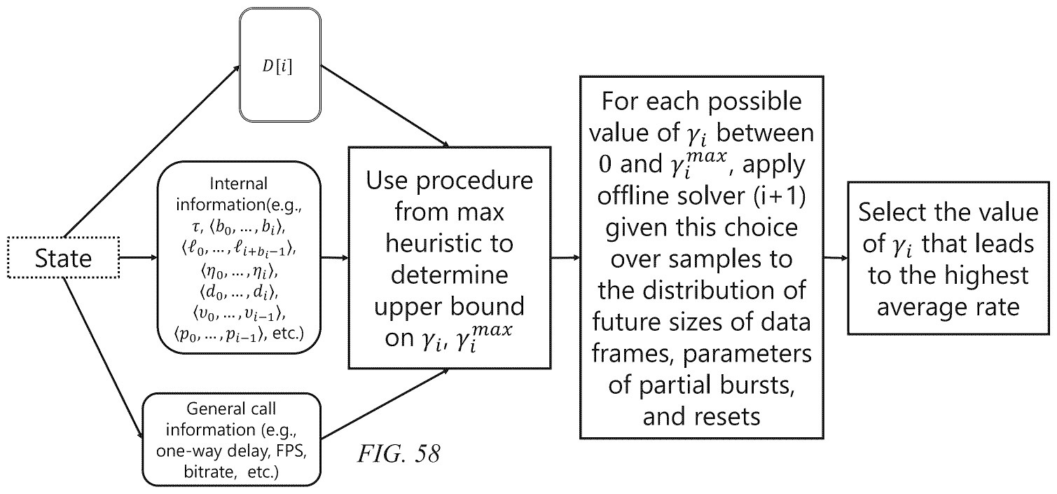

Another way to split frames is using stochastic optimization to split frames on-the-fly, for example, as depicted schematically in FIG. 58. Here, one methodology to split data frames is to (a) first determine the range of suitable values of the size of the first component using the procedure from the max heuristic, (b) estimate the expected optimal offline rate given each possible choice of how to split the data frame by determining the empirical offline optimal rate over samples to the distribution of future information (e.g., sizes of future frames, parameters of partial bursts and partial guard spaces, etc.), and (c) choosing the value that has the highest empirical rate.

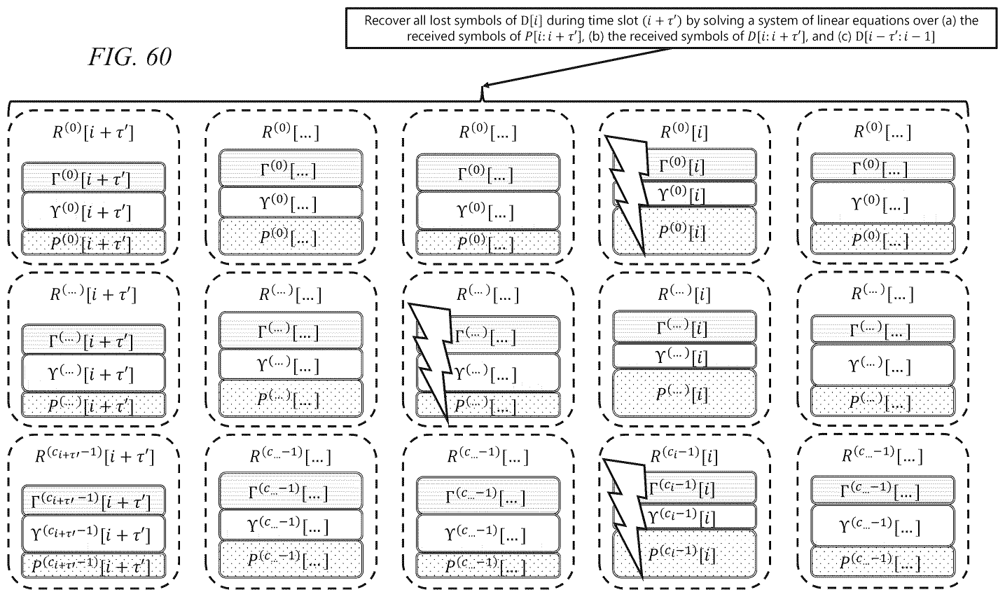

FIG. 60 shows an example of intended loss recover from the perspective of a frame when using a failsafe for CSIPB, in accordance with certain embodiments. Here, the goal is to recover all lost symbols of D[i] during time slot (i+τ′) by solving a system of linear equations over (a) the received symbols of P[i:i+τ′], (b) the received symbols of D[i:i+τ], and (c) D[i−τ′:i−1]. One way to do so is to use Gaussian Elimination to solve the system of linear equations. The symbols of D[i−τ′:i−1] are assumed to already be decoded by time slot (i+τ′).

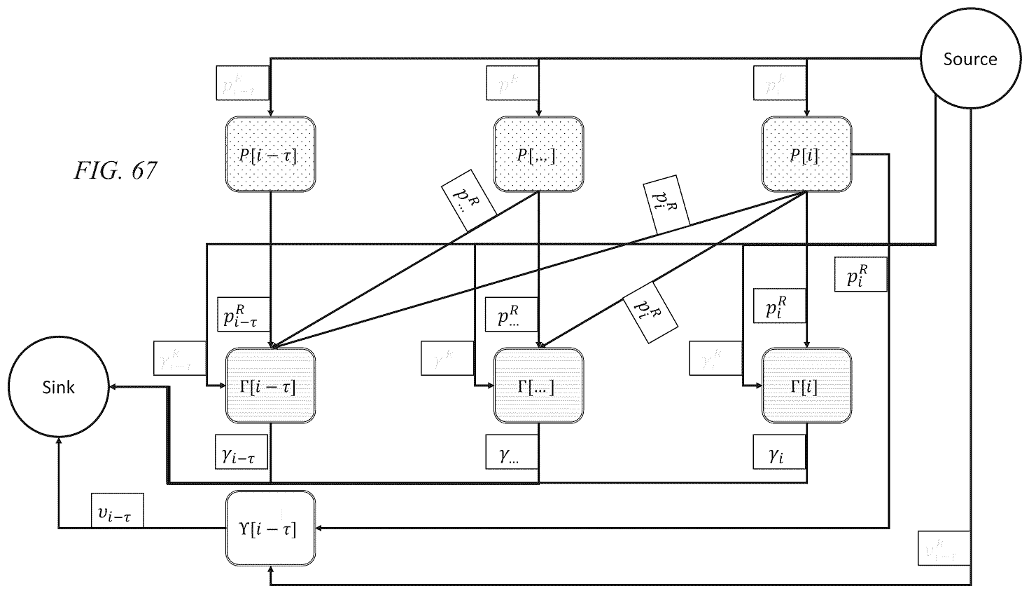

Certain embodiments can include a method to quickly determine if a data frame cannot be decoded, which can be used to avoid the expensive decoding operation (e.g., using Gaussian Elimination to solve a system of linear equations) unless the data frame is able to be decoded. FIG. 67 is a schematic diagram for a method to determine whether the lost data of the ith data frame can be recovered assuming the prior τ data frames have been recovered, in accordance with one embodiment. A maxflow can be computed (e.g., by using the Ford-Fulkerson algorithm) to determine whether decoding is possible. Essentially, the flow may reflect whether enough relevant parity symbols are received to decode each of Γ[i] and Υ[i]; based on the code's structure, this also necessitates recovering Γ[i+1] through Γ[i+τ]. For example, there may be three vertices (labeled as Υ[i], Γ[i], and P[i]) for each data frame to reflect the three quantities Υ[i], Γ[i], and P[i], respectively. A Source is connected to all vertices reflecting parity for data frames i through i+τ, all vertices reflecting the first component of data frames i through (i+τ), and the first component of data frame i. Edge capacities are shown in the graph; for edges between Source and vertices representing a first or second component of a data frame, the capacity is the number of received symbols of that component of that data frame. For edges between the Source and vertices representing the parity symbols of a data frame, the edge capacity is the number of received parity symbols of that data frame. Vertices representing parity are connected to the vertices reflecting data that was used to create the parity (i.e., if there was an edge between corresponding components of the factor graph). All vertices representing the first or second component of a data frame are connected to the Sink; the capacity of the edge from one such vertex to the Sink is the size of the corresponding component. A maxflow is computed (e.g., by using the Ford-Fulkerson algorithm). Decoding of data frame i−τ is deemed possible if and only if the flow to Sink is at least the sum of (a) the sizes of the first component of data frames i−τ through i plus (b) the size of the second component of fame (i−τ).

It should be noted that embodiments can be applied to batch encoding and decoding with striping.

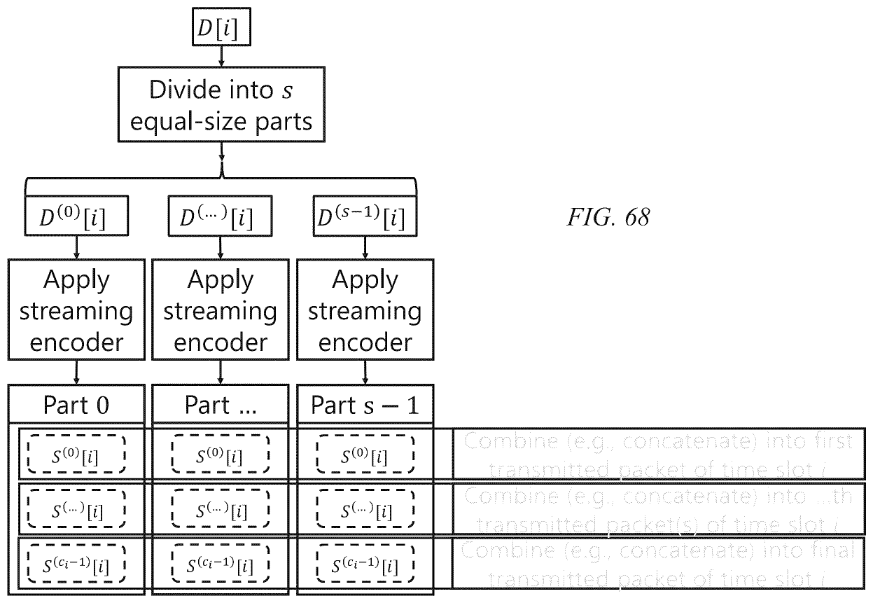

FIG. 68 is a schematic diagram showing a representation of encoding with stripes, in accordance with one embodiment. The idea of batching symbols into stripes is well-known in the coding theory literature. Generally speaking, striping is a methodology for (a) how linear combinations of symbols are taken and (b) how they are spread over packets so that decoding is more efficient/requires less computational resources. In the context of certain embodiments, striping provides a mechanism by which each of Γ[i], Υ[i], and P[i] are split into so-called “stripes” of s symbols each. To generate the parity symbols of a stripe, the same function (e.g., taking a linear combination) is used to create the symbol of each position by applying the function to different inputs. For example, to create the jth parity symbol of the stripe, one may apply the function to the jth position of all relevant stripes of Γ[i−τ:i] and Υ[i−τ] (the inputs may also include the jth position stripes of Γ[i−τ′:i−τ−1] and Υ[i−τ′:i−τ−1] too if the failsafe is used as discussed herein).

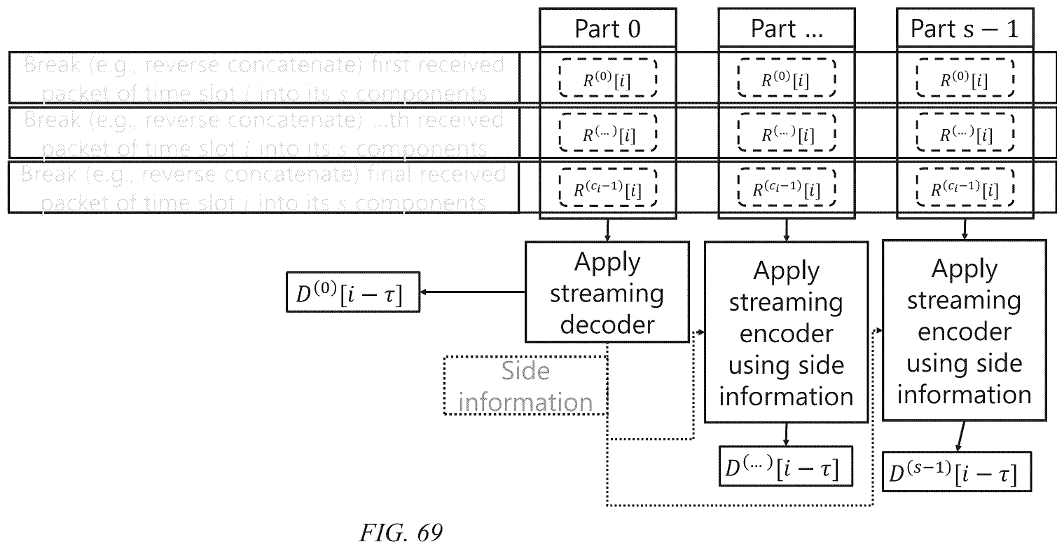

In certain embodiments, packetization for striping would be performed in a manner that distributes symbols such that all symbols of each stripe are always placed in the same packet. One way to do packetization is shown in FIG. 68 (and may involve using a smaller “MTU” by dividing the true MTU by s). One advantage is that after solving a system of linear equations to recover any one position of a stripe, j, the solution to the system of linear equations can be reused to decode each remaining position of the stripe. This reduces the complexity of decoding, as depicted in FIG. 69. In the step of dividing D[i] into s equal-size parts, one may add zero padding of up to (s−1) symbols to ensure the number of symbols is divisible by s. As with zero-padding discussed herein, embodiments could optimize to not send these symbols and instead have the receiver infer them.

FIG. 69 is a schematic diagram showing a representation of decoding with stripes in accordance with FIG. 68. Here, the decoder essentially undoes the combination step from encoding with stripes to obtain the received packets as if part 0 was the entire communication. This can involve applying the streaming decoder in order to solve for the data of the (i−τ)th data frame when restricted to part 0 and stores the useful information computed during decoding (referred to herein as “side information”) for use when decoding parts 1 through (s−1). Specifically, since decoding follows from solving a system of linear equations by inverting a matrix, one possibility for using the side information is to set the side information to be this matrix such that that decoding parts 1 through (s−1) will be able to reuse this matrix inverse rather than computing it again. By using stripes of size s, the size of matrix that is inverted in part 0 is much smaller than if no stripes had been used (and the underlying streaming encoder/decoder were used directly). Then, each additional part can be decoded as if the part was the entire communication but using the side information in the decoding to reduce computational complexity. The computational complexity of decoding all data is intended to be much less than if stripes were not used (i.e., if the underlying streaming encoder/decoder were used directly). Alternatively, instead of using side information, one could decode each of the s parts in parallel.

It should be noted that the same streaming encoder/decoder could be applied to all parts. For example, the streaming encoder may be the variant of CSIPB with packetization #1, heuristic #1 for splitting data frames, and a heuristic parity allocation (e.g., allocate roughly vᵢlᵢ parity symbols for p_{i+τ}). Alternatively, a different streaming encoder/decoder could be used for each stripe (e.g., different randomly generated encoding matrices) such that both encoding and decoding can be done in parallel (i.e., at the sender and receiver, respectively); in this case, the “side information” generally would not be needed or used.

It also should be noted that CSIPB can be extended to include frame splitting into more than two components.

### Exemplary Embodiments Based on CSIPBRAL

Certain features are now described with reference to CSIPBRAL. The following is a glossary provides some additional and/or modified terms for the CSIPBRAL discussion:

| Term | Definition | Example |
|---|---|---|
| Partial | A sequence of τ or more time slots | A burst occurs across time slots 0 and 1 |
| guard | after a partial burst wherein | where half the packets are lost. Then a |
| space | another partial burst is not | partial guard space occurs over time slots 2 |
| | intended to start but rather for each | through τ + 1 = 4 (i.e., τ = 3) where only |
| | $such time slot , j , at most ⌈ {l}_{j}^{( G )} {c}_{j} ⌉ of$ | 1/10 packets are lost. |
| | the packets are expected to be lost. | In this example, there are 10 packets sent |
| | $In essence , if {l}_{i}^{( G )} is always set to$ | for each of the first five time slots. |
| | 0, CSIPBRAL essentially | |
| | degenerates to the CSIPB model. | |
| ${l}_{i}^{( G )}$ | $For any time slot i , {l}_{i}^{( G )} is intended$ | $Suppose that {l}_{1}^{( G )} = 0.25 and {c}_{1} is an$ |
| | to reflect the largest fraction of | integer divisible by 4. Then up to a quarter |
| | packets that may be lost during | of the packets sent during time slot 1 may |
| | time slot i (before rounding up) if | be lost even not as part of a partial burst and |
| | there is no partial burst | loss recovery is still meant to apply |
| | encompassing time slot i for which | |
| | loss recovery is needed. Formally, | |
| | $for any time slot , i , up to ⌈ {l}_{i}^{( G )} {c}_{i} ⌉$ | |
| | packets may be lost and loss | |
| | recovery will be guaranteed with | |
| | high probability (provided the only | |
| | time that a greater number of | |
| | packets are lost during any such | |
| | time slot, i, is part of a partial | |
| | $burst ) . Sometimes {l}_{i}^{( G )} is written$ | |
| | with a script (e.g., as “ [symbol] ”). | |
| G[i] | The vector of parity symbols of | |
| | the ith data frame that depend on | |
| | the symbols of the second | |
| | component of the ith data frame | |
| G^{R}[i] | The vector of received parity | |
| | symbols of G[i] (i.e., G[i] after | |
| | removing all positions | |
| | corresponding to a symbol that | |
| | was dropped). Vector notation | |
| | may be used where G[i: j] | |
| | represents G[i], ... , G[j] for non- | |
| | negative integers i, j where i ≤ j. | |
| g^{R}ᵢ | The size of P^{R}[i] | |
| G^{L}[i] | The vector of lost parity symbols | |
| | of G[i] during time slot i (i.e., G[i] | |
| | after removing all positions | |
| | corresponding to a symbol that | |
| | was not dropped) | |
| g^{L}ᵢ | The size of G^{L}[i] | |
| Pre- | During time slot i − τ, some | |
| allocated | number of symbols, pᵢ^{pre} are pre- | |
| symbols | allocated such that the size of P[i] | |
| pᵢ^{pre} | will be at least pᵢ^{pre} (although it | |
| | may be higher). These symbols are | |
| | intended to ensure loss recovery of | |
| | D[i − τ] by time slot i in the event | |
| | of a partial burst | |
| Aᵢ^{j} | a matrix used to encode symbols | |
| | of the first component of data | |
| | frame j into the first type parity | |
| | symbols of data frame i | |
| Bᵢ^{i-τ} | a matrix used to encode symbols | |
| | of the second component of data | |
| | frame i − τ into the first type parity | |
| | symbols of data frame i | |
| Cᵢ^{i,2} | a matrix used to encode symbols | |
| | of the second component of data | |
| | frame i into the second type parity | |
| | symbols of data frame i | |
| Cᵢ^{j} | a matrix used to encode symbols | |
| | of the jth data frame into the | |
| | second type parity symbols of data | |
| | frame i; may be full rank or zero in | |
| | one or more positions to remove | |
| | the effect of the first and or second | |
| | component. | |
| G⁺[i] | a matrix used to encode symbols | |
| | of the jth data frame into the | |
| | second type parity symbols of data | |
| | frame i; may be full rank or zero in | |
| | one or more positions to remove | |
| | the effect of the first and or second | |
| | component. | |
| First type | symbols of P[i] that are intended | |
| of parity | to be used to recover (a) earlier | |
| symbol | data frames and/or (b) the first | |
| | component of the ith data frame in | |
| | the event of a partial burst that | |
| | ends within t time slots before | |
| | time slot i | |
| Second | symbols of G[i] that are intended | |
| type of | to be used to recover symbols of | |
| parity | the second component of the | |
| symbol | current data frame when at most | |
| | $⌈ {c}_{i} {l}_{i}^{( G )} ⌉ of its packets are lost$ | |
| ${c}_{i}^{v} , {c}_{i}^{γ} , {c}_{i}^{p} , {c}_{i}^{g}$ | cᵢ in certain embodiments can be | |
| | $split into four parts , {c}_{i}^{v} , {c}_{i}^{γ} , {c}_{i}^{p} , and$ | |
| | ${c}_{i}^{g} , corresponding to packets sent$ | |
| | for Y[i], Γ[i], P[i], and G[i], | |
| | respectively. | |

The following is a summary of changes from the CSJPB glossary:

| | | |
|---|---|---|
| Partial | Refers to one or more consecutive | A burst occurs across time slots 0 and 1 |
| burst (now | time slots that is no more than a | where half the packets are lost. Then a |
| generalized | parameter number (bᵢ) where | guard space occurs over time slots 2 |
| from the | during each of these time slots the | through τ + 1 = 4 (i.e., τ = 3) where only |
| definition | number of packets that may be lost | 1/10 packets are lost. |
| with guard | is no more than a parameter (lᵢ) | In this example, there are 10 packets sent |
| spaces) | times the number of packets | for each of the first five time slots. Then a |
| | (where the product is then rounded | partial guard space occurred |
| | up); there is a partial guard space | |
| | (e.g., where for time slot j of the | |
| | partial guard space the number of | |
| | packets that may be lost is no more | |
| | $than a parameter ( {l}_{i}^{( G )} , defined$ | |
| | below) times the number of | |
| | packets (where the product is then | |
| | rounded up) for the t time slots | |
| | after the end of a partial burst; | |
| | similarly, there is a partial guard | |
| | space for the t time slots before | |
| | the start of a partial burst | |
| P[i] | The vector of parity symbols of | |
| | the ith data frame that do not | |
| | depend on the symbols of the | |
| | second component of the ith data | |
| | frame | |
| P^{R}[i] | The vector of received symbols of | |
| | P[i] during time slot i (i.e., P[i] | |
| | after removing all positions | |
| | corresponding to a symbol that | |
| | was dropped) | |
| p^{R}ᵢ | The size of P^{R}[i] | |
| P^{L}[i] | The vector of lost parity symbols | |
| | of P[i] during time slot i (i.e., P[i] | |
| | after removing all positions | |
| | corresponding to a symbol that | |
| | was not dropped) | |
| p^{L}ᵢ | The size of P^{L}[i] | |
| P⁺[i] | the vector of symbols to add to the | |
| | first type parity symbols P[i] to | |
| | add the failsafe | |

CSIPBRAL addresses the issue of loss recovery when there are losses during τ time slots under a partial burst. CSIPBRAL addresses this challenge in two ways. First, a new extra type of parity symbol, G[i], is added. These parity symbols are sent with the ith data frame. This ensures that (a) some parity symbols of a data frame can be used to recover the first component of the same data frame and some parity symbols of a data frame can be used to recover the second component of the same data frame, and (b) some parity symbols of a data frame cannot be used to recover the second component of the data frame. Thus, a different form of parity symbols is used (e.g., a distinct factor graph). Second, the mechanism for allocating parity is changed. These changes will likely lead to different frame splitting (e.g., versus what would occur under CSIPB).

Specifically, an additional parameter

$${l}_{i}^{( G )}$$

is added and will impact how many parity symbols are allocated to P[i] and how many are allocated to the new additional type of parity symbol, G[i], which is structurally different from P[i] and requires another step of allocating gᵢ symbols (i.e., the size of G[i]) during time slot i. Another novelty is a two-stage parity allocation of (a) pre-allocating p_{i+τ} during time slot i for robustness to partial bursts then (b) increasing the size of pᵢ during time slot i for robustness to loss in the partial guard space.

In certain embodiments, burst characteristics may be periodically estimated by the receiver and used to set frame splitting, parity generation, and other operating parameters, although, as discussed above, frame splitting, parity generation, and other operating parameters may be set in other ways including by the sender. This enables tuning the bandwidth overhead based on the changing network conditions. In certain embodiments, the estimates comprise three sets of parameters to reflect the length of the partial burst, fraction of packets lost per data frame during the period of high loss of the partial burst, and fraction of packets lost outside of the highly lossy period of a partial burst. Specifically, for the ith data frame, the maximum length of a burst starting with data frame i is estimated as bᵢ, the maximum fraction of packets lost for the ith data frame is estimated as lᵢ, and during any time slot up to

$${l}_{i}^{G}$$

fraction of the packets sent during time slot i may be lost. In certain embodiments, partial bursts are modeled as being followed by partial guard spaces of length at least i data frames; during these time slots, the worst-case losses of a partial burst cannot occur; so for time slot j of the partial guard space up to

$${l}_{j}^{G}$$

fraction of the packets may be lost. In certain embodiments, feedback from the receiver can be viewed as the receiver conservatively estimating how lossy the network conditions will be based on prior losses. In certain embodiments, when there is no feedback, the parameters do not change; formally, bᵢ is set to bᵢ₋₁, l_{i+b}_{ᵢ}₋₁ is set to l_{i+b}_{ᵢ}₋₂, and

$${l}_{i}^{( G )}$$

is set to

$${l}_{i - 1}^{( G )} .$$

When encoding the ith data frame, the sender has access to bⱼ and

$${l}_{j}^{( G )}$$

for any j≤i and to lⱼ for any j≤(i+bⱼ−1). In some embodiments, the values for each lⱼ and

$${l}_{j}^{( G )}$$

are each set exactly once.

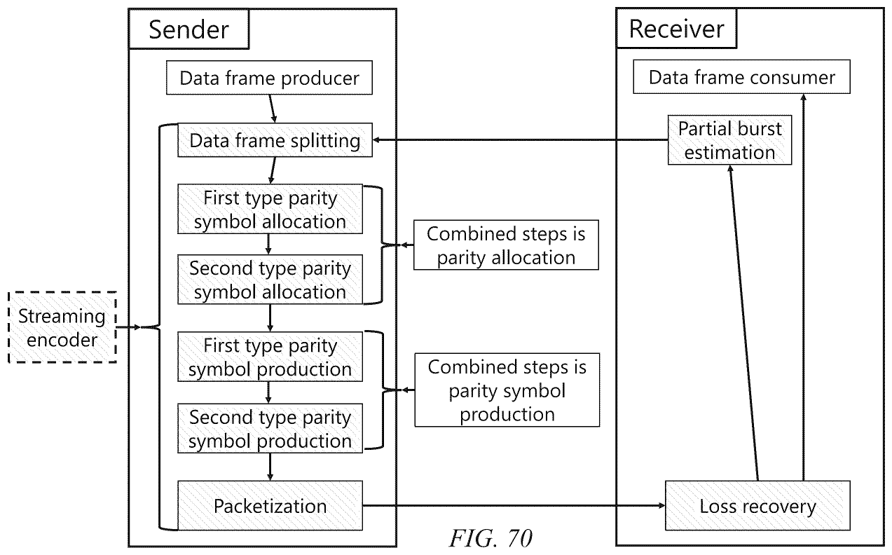

FIG. 70 is a schematic diagram showing logical elements of the streaming encoder for CSIPBRAL, in accordance with certain embodiments. CSIPBRAL involves sending two different types of parity symbols where the second type did not exist under CSIPB. These symbols are both allocated and created. The construction is similar to CSIPB in the meaning of the two components of a data frame formed by splitting (e.g., can be defined with similar terminology in terms of loss-recovery) for partial bursts, although the definition of partial bursts is different than under the model considered for CSIPB.

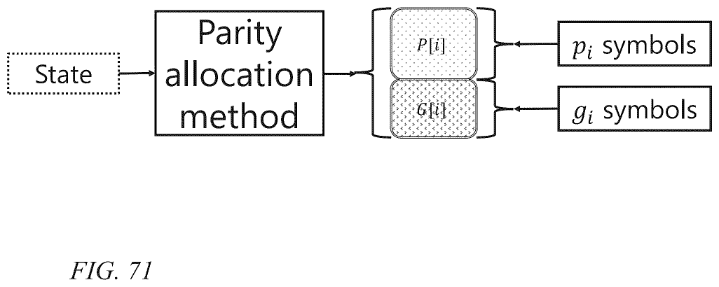

FIG. 71 is a schematic diagram showing the concept of parity allocation for CSIPBRAL, in accordance with certain embodiments. Here, parity allocation enables for each data frame to allocate an arbitrary number of parity symbols into two types. This is done using a methodology that leverages information about the call (i.e., its inputs) as well as properties of the application, user preference, sizes of prior frames, sizes of the first and second components of prior frames, etc. For example, it may be a machine learning model trained to optimize key metrics of the QoE (e.g., rate, freeze, fraction of rendered decompressed frames, latency of rendered decompressed frames, PSNR, SSIM, LPIPS, etc.); such a model may make use of properties of prior calls in the decision (e.g., if a very large data frame is likely to be followed by a smaller data frame, the model may exploit such a property). Another possible parity allocation method is a heuristic.

The parity allocation of the data frame may depend on metadata of data frame such as its compression; for example, if certain symbols of D[i] are supplementary (i.e., the data frame is useful without them but even better with them), that information may be used (e.g., they may be placed in Υ[i] so that the non-supplementary symbols fit into Γ[i] to be recovered sooner). In some instances, no such metadata will be available (i.e., it may not be tracked under the state in certain embodiments), so this type of information about the compression may not come into play.

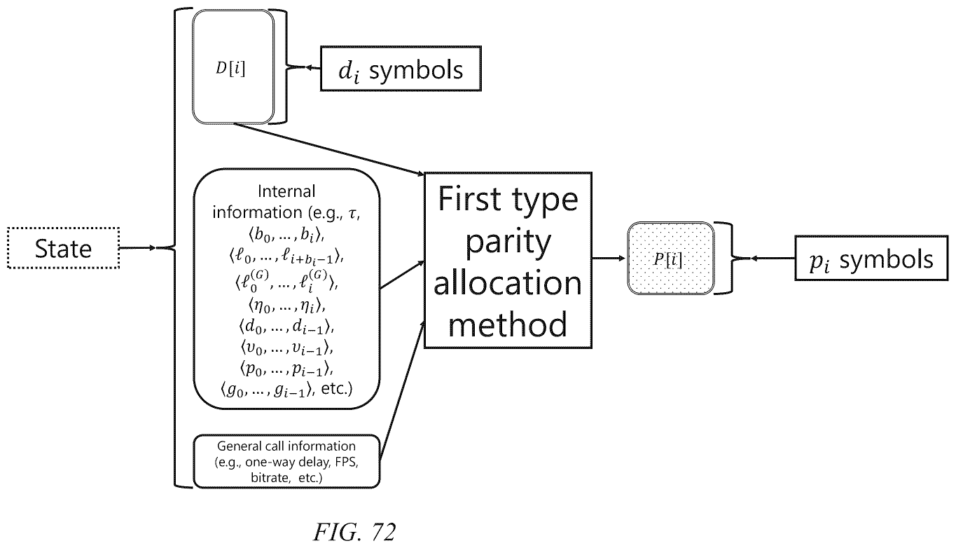

FIG. 72 is a schematic diagram showing the concept of a parity allocation scheme for the first type of parity symbols in accordance with CSIPBRAL.

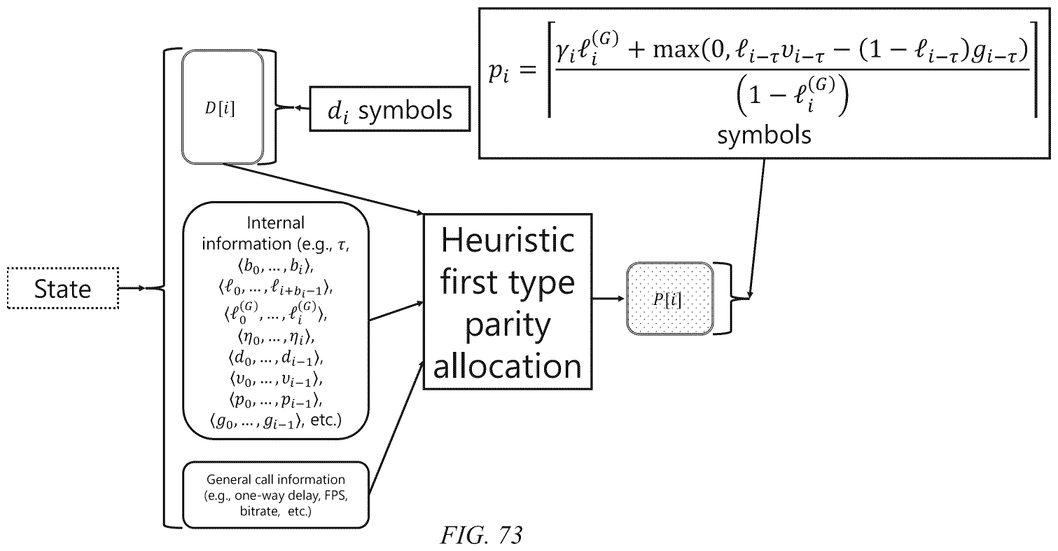

FIG. 73 is a schematic diagram showing a first heuristic to allocate first type parity symbols, in accordance with certain embodiments. A first example heuristic (Heuristic 1) splits data frames to minimize parity associated with each data frame. Specifically, the number of parity symbols to be sent with the data of data frame i may be allocated to be a function of the size of Υ[i−τ] and Γ[i]; for example, the number of parity symbols could be set with the intention that when

$${l}_{i}^{( G )}$$

fraction of them are lost, the number of received ones

$$( i . e . , {p}_{i}^{R} )$$

is to equal (a) the number of missing symbols Γ[i] plus (b) the number of missing symbols of Υ[i−τ] less the number of received symbols of G[i−τ] (where this subtraction is bounded below by 0); in other words:

$${p}_{i} ( 1 - {l}_{i}^{( G )} ) = {γ}_{i} {l}_{i}^{( G )} + max ( 0 , {l}_{i - τ} {v}_{i - τ} - ( 1 - {l}_{i - τ} ) {g}_{i - τ} ) ,$$

leading to:

$${p}_{i} = ⌈ \frac{{γ}_{i} {l}_{i}^{( G )} + max ( 0 , {l}_{i - τ} {v}_{i - τ} - ( 1 - {l}_{i - τ} ) {g}_{i - τ} )}{( 1 - {l}_{i}^{( G )} )} ⌉ .$$

Note that one must take the ceiling as well to ensure pᵢ is an integer.

A second example heuristic (Heuristic 2, not shown) allocates enough symbols of P[i] to recover Γ[i] during time slot i

$$( i . e . , {p}_{i} = ⌈ \frac{{l}_{i} {γ}_{i}}{1 - {l}_{i}^{( G )}} ⌉ ) .$$

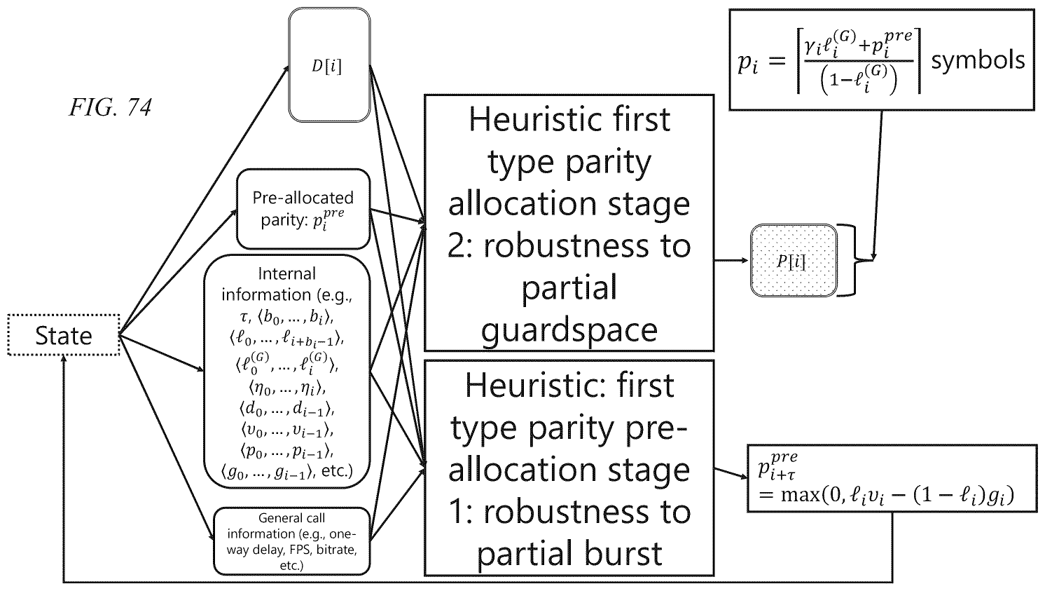

FIG. 74 is a schematic diagram showing a second heuristic to allocate first type parity symbols, in accordance with certain embodiments. Here, the heuristic is modeled as occurring in two stages. First, during time slot i−τ, some number of symbols,

$${p}_{i}^{pre}$$

are pre-allocated in that at least

$${p}_{i}^{pre}$$

symbols will be sent in P[i] (which would suffice to ensure loss recovery of D[i−τ] if no packets can be lost in time slot i if a partial burst occurred encompassing time slot (i−τ), such as if

$${l}_{i}^{( G )} = 0 ) .$$

Then some additional number of symbols may be allocated during time slot i to add robustness to losing

$${l}_{i}^{( G )}$$

fraction of the packets sent during time slot i (e.g., a partial guard space).

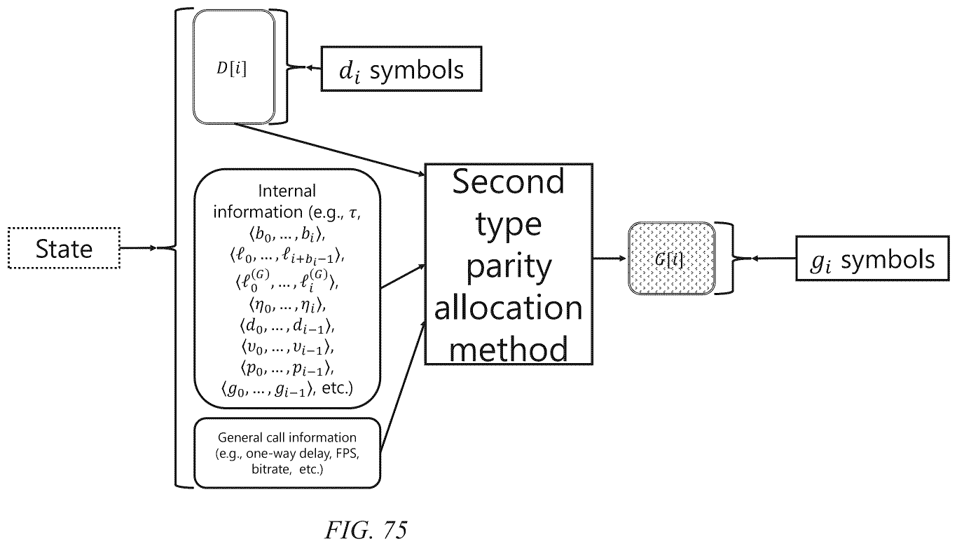

FIG. 75 is a schematic diagram showing the concept of a heuristic to allocate second type parity symbols, in accordance with certain embodiments.

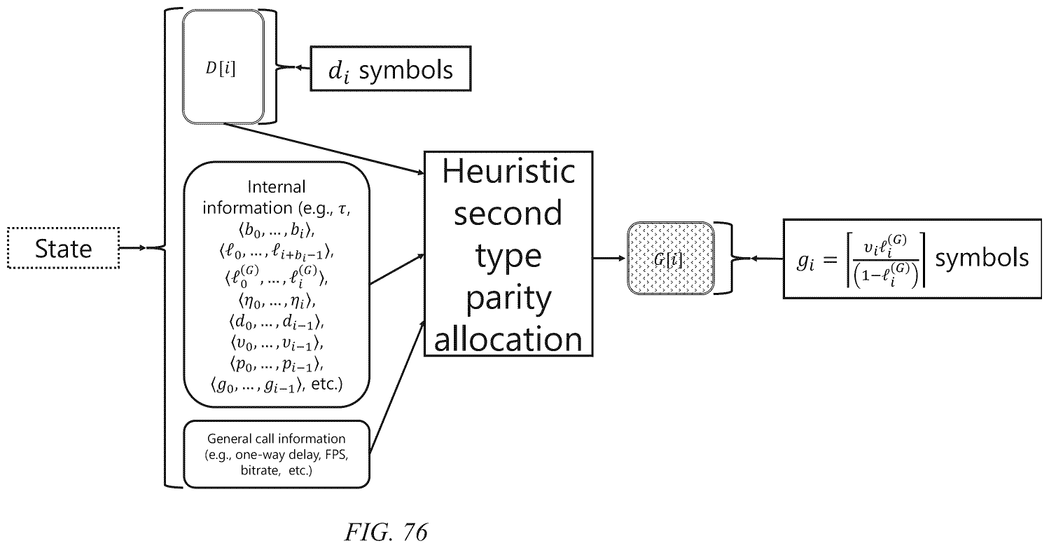

FIG. 76 is a schematic diagram showing a heuristic to allocate second type parity symbols, in accordance with certain embodiments. Here, the heuristic is to recover the partial guard space by sending just enough second type parity symbols that the number that are received suffice to recover the lost symbols of the second component if a partial burst has not occurred in the previous τ time slots; formally, this may look like

$${g}_{i} ( 1 - {l}_{i}^{( G )} ) = {v}_{i} {l}_{i}^{( G )}$$

(but may also be slightly increased to address rounding and or packetization issues).

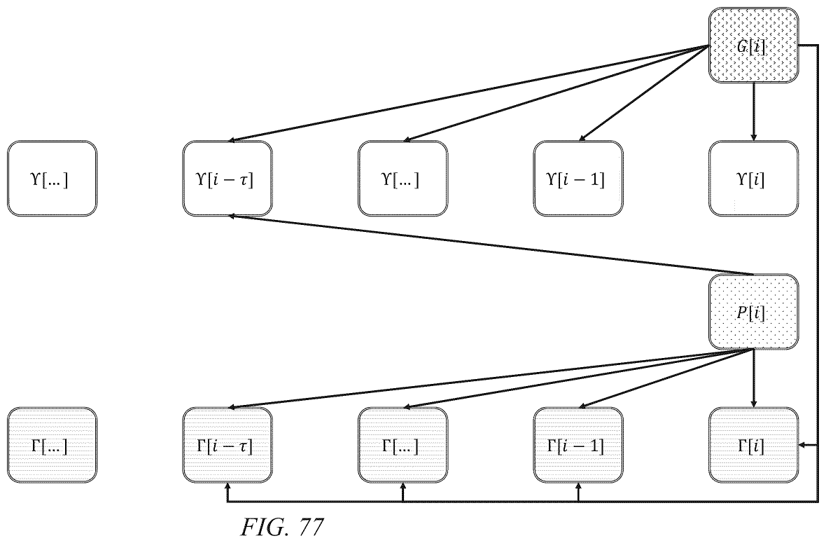

FIG. 77 is a factor graph of parity symbols for CSIPBRAL complete for parity symbols of ith data frame, in accordance with certain embodiments. Here, the first type parity symbols for data frame i are functions of (a) the first component of the current and previous i data frames (i.e., Γ[i−τ:i]), and (b) the second component of the data frame from τ time slots before (i.e., Υ[i−τ]). For example, each symbol of P[i] may be a linear combination of the symbols from (a) and (b). The second type parity symbols for data frame i are meant to be functions of the second component of the data frame. They also may or may not be functions of the first component of the same data frame and/or data of previous data frames (so these connections are shown in grey because each of them may or may not exist, i.e., depending on the embodiment, such connections may or may not be included).

For example, each symbol of G[i] may be a linear combination of the symbols from the second component of data frame i and may or may not also be linear combinations of the symbols of the first component of data frame i and/or the first and/or second components of the previous τ data frames. Note that it is the intention in certain embodiments that second type parity symbols are used to recover lost symbols of the second component; it is the intention that this convention can hold without loss of generality if losses only occur as if the partial bursts then partial guard spaces. The concept is that other parity symbols will be used to recover all symbols corresponding to components that the grey arrows point to. Hence, actions like adding linear combinations of these symbols to the symbols of G[i] will not harm loss recovery. One may add the grey edges and then use second type parity symbols to recover other quantities in certain scenarios where the partial bursts then partial guardspaces do not occur (e.g., when all grey lines are included, in some instances when the fraction of losses during some time slot i is greater than lᵢ but then no losses occur during time slots (i+bᵢ) to (i+τ), the symbols of G[i+bᵢ:i+τ] may be used to recover lost symbols of D[i] within τ time slots). Adding one or more of these grey edges is optional and may be done in certain embodiments and not in others.

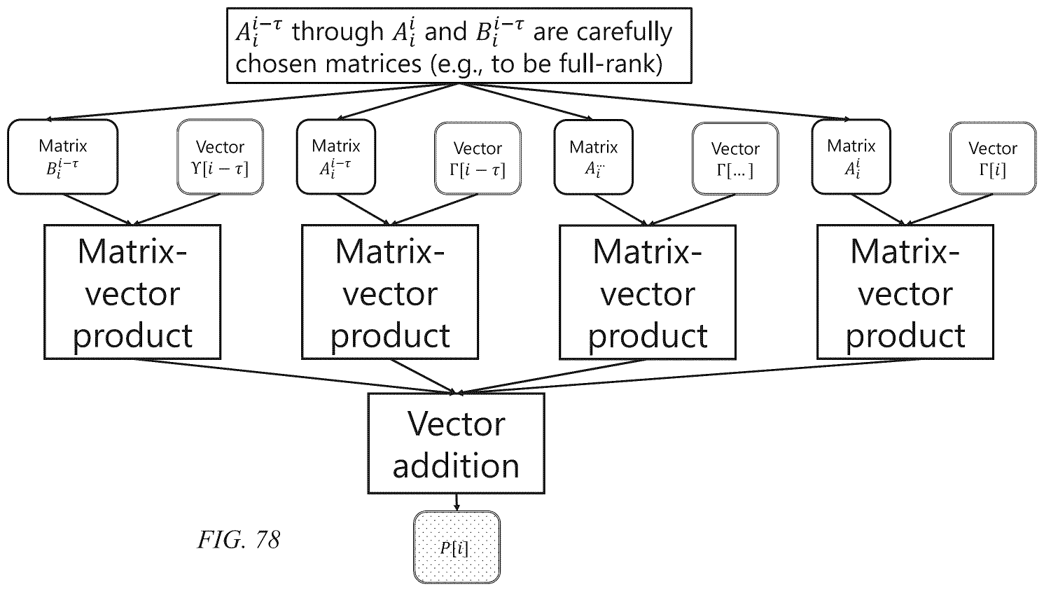

FIG. 78 shows first type parity symbol generation for the ith data frame in accordance with FIG. 77, in accordance with certain embodiments. Here, the symbols of P[i] are linear combinations of the symbols of the current data frame and previous τ data frames. Specifically, the symbols of P[i] are designed linear combinations of (a) the first component of the current and previous τ data frames, and (b) the second component of the data frame from τ time slots earlier. All linear combinations are carefully chosen to be linearly independent linear equations (e.g., to be full rank).

One way to construct the matrices is for (a)

$${B}_{i}^{i - τ}$$

and (b) for

$${A}_{i}^{i - τ}$$

through

$${A}_{i}^{i}$$

to be matrices with each entry drawn independently and uniformly at random over the elements of the field; in this case, loss recovery is shown with a high probability for a sufficiently large field size instead of being guaranteed with probability 1.

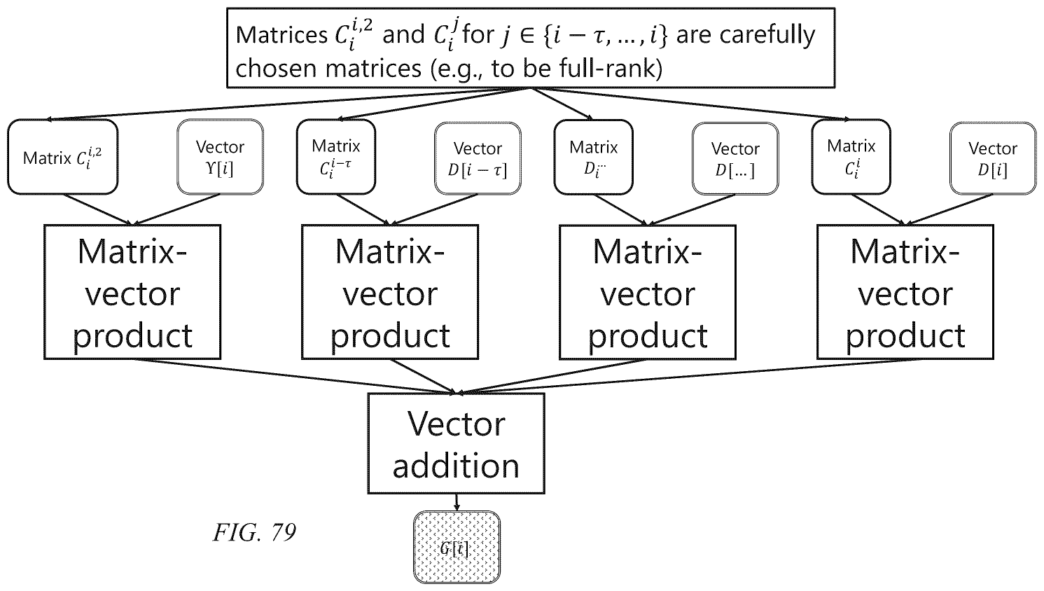

FIG. 79 shows second type parity symbol generation for the ith data frame in accordance with FIG. 77, in accordance with certain embodiments. Here, the symbols of G[i] are linear combinations of the symbols of the second component of the current data frame. The symbols may or may not be functions of the first component of the current data frame and/or the first/or second components of the previous τ data frames; this is reflected by adding additional matrix-vector products. One can remove any combination of these optional matrix-vector products by setting the relevant matrices among

$${C}_{i}^{i} , … , {C}_{i}^{i - τ}$$

to be all-zeroes matrices.

One way to construct the matrices is for (a)

$${C}_{i}^{i , 2}$$

to have each entry drawn independently and uniformly at random over the elements of the field, and (b) each submatrix of

$${C}_{i}^{j}$$

that will be multiplied by a coordinate of D[j] corresponding to the first component of data frame j is either the all-zeroes matrix (if this component is not included) or has each entry drawn independently and uniformly at random over the elements of the field, and (c) each submatrix of

$${C}_{i}^{j}$$

that will be multiplied by a coordinate of D[j] corresponding to the second component of data frame j is either the all-zeroes matrix (if this component is not included) or has each entry drawn independently and uniformly at random over the elements of the field; in this case, loss recovery is shown with a high probability for a sufficiently large field size instead of being guaranteed with probability 1.

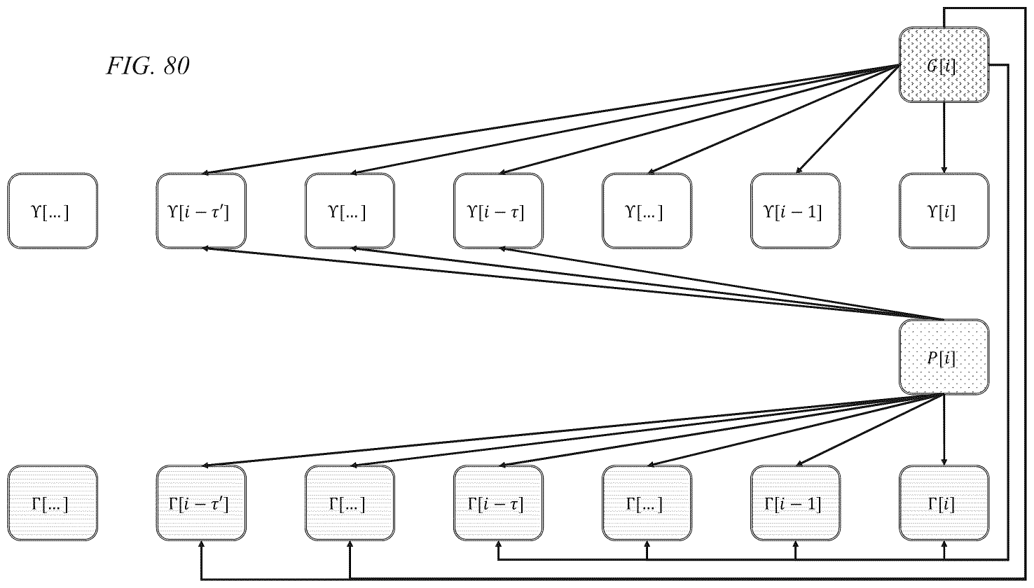

As in CSIPB, CSIPBRAL can include a failsafe mechanism, e.g., by including earlier data frames into the parity symbols. FIG. 80 is a factor graph of parity symbols for CSIPBRAL with failsafe, in accordance with certain embodiments. Here, the parity symbols for time slot i can now also be functions of some or all of both components of data frames i−τ−1 through i−τ′ in addition to being functions of the same data from without the failsafe. This change occurs for both P[i] and G[i] (i.e., for the first and second type parity symbols). One way to reflect this is by adding linear combinations of the symbols of the first and second components of data frames i−τ−1 through i−τ′ to the parity symbols compared to what would be there without the failsafe.

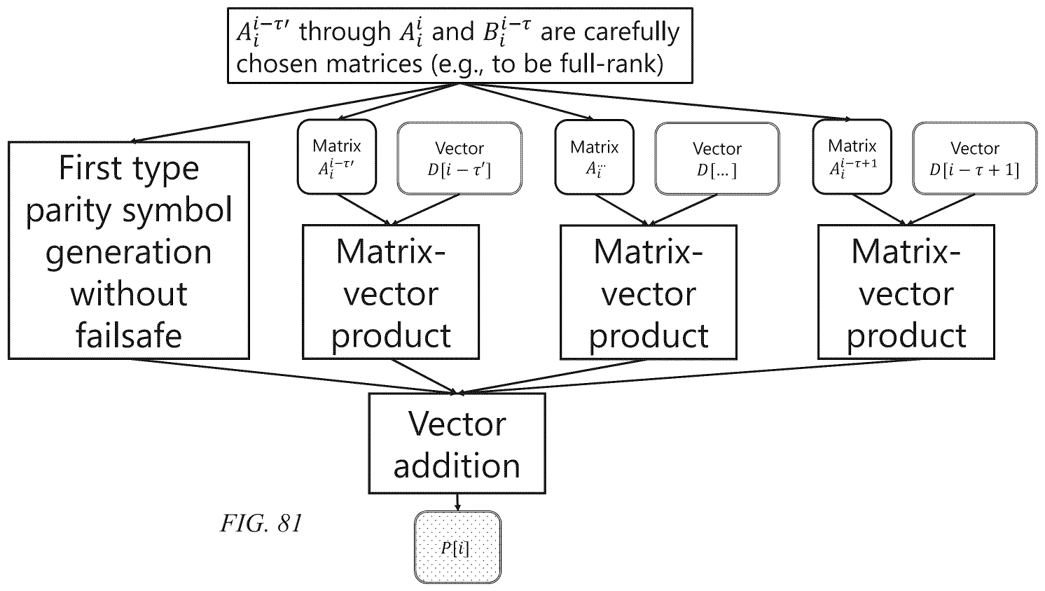

FIG. 81 shows first type parity symbol generation for the ith data frame in accordance with FIG. 80, in accordance with certain embodiments. Here, the parity symbols for time slot i can now also be functions of some or all of both components of data frames (i−τ−1) through (i−τ′) in addition to being functions of the same data from without the failsafe. Here, linear combinations of the symbols of data frames more than data frames earlier are added to parity symbols of the current data frame. This enables loss recovery even in cases where losses are worse than the anticipated values (e.g., a burst of length bᵢ starting in data frame i where more than lᵢ fraction of the packets are lost for each data frame j in the burst might be recovered, albeit after over more than τ time slots). For example, if P[i] is the parity symbols as defined under CSIPBRAL, the parity symbols to be sent may be P[i]+P⁺[i] and G[i]+G⁺[i] where each of P⁺[i] and G⁺[i] comprises random linear combinations of the symbols of data frames (i−τ′) through (i−τ−1) for some τ′ larger than τ; formally,

$${P}^{+} [ i ] = {\sum }_{j = i - τ}^{i - τ - 1} , {A}_{i}^{j} D [ j ] and {G}^{+} [ i ] = {\sum }_{j = i - τ}^{i - τ - 1} , {C}_{i}^{j} D [ j ] ,$$

where each

$${A}_{i}^{j} and {C}_{i}^{j}$$

are matrices with entries drawn uniformly at random from the field.

Even if CSIPBRAL might not be able to recover certain lost packets, the failsafe mechanism on top of CSIPBRAL may lead to loss recovery (albeit with a latency of more than r). Recovering data frames after their deadline is still useful due to inter-frame dependencies, as later data frames are playable once all prior data frames have been recovered. A complementary failsafe can be used either in combination or instead of the aforementioned failsafe as follows: feedback can be sent from the receiver to the sender to generate a keyframe (i.e., an uncompressed frame that does not depend on prior uncompressed frames), e.g., by triggering the new keyframe when data frame i has not been recovered by some threshold number of time slots later (e.g., by time slot (i+τ′+1)). The keyframe may also be requested sooner if frame i is deemed unlikely to be recovered, e.g., if the fraction of packets lost during time slot i greatly exceeds lᵢ.

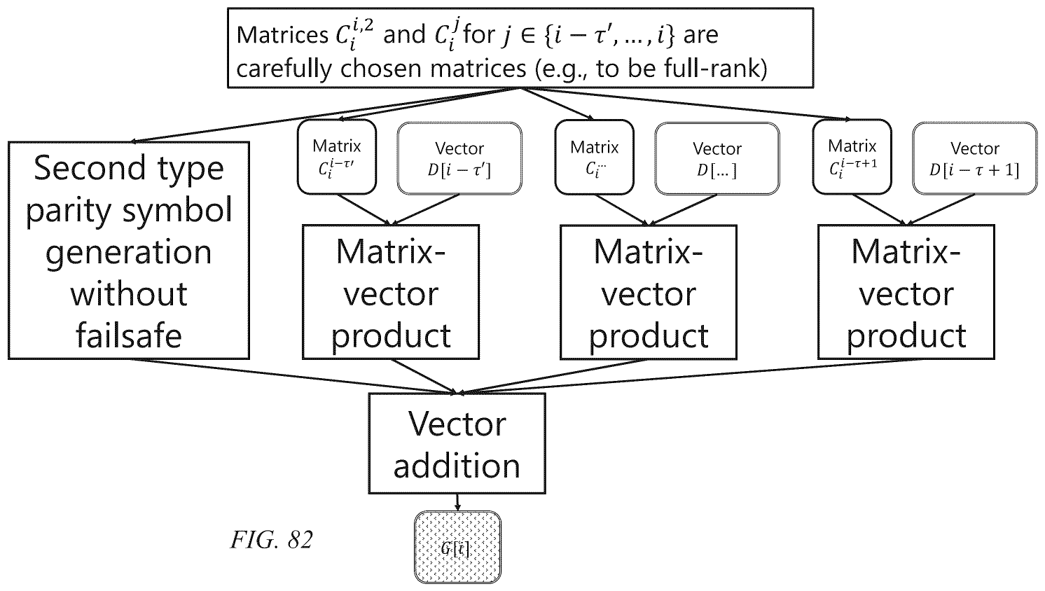

FIG. 82 shows second type parity symbol generation for the ith data frame in accordance with FIG. 80, in accordance with certain embodiments. Here, the parity symbols for time slot i can now also be functions of some or all of both components of data frames (i−τ−1) through (i−τ′) in addition to being functions of the same data from without the failsafe.

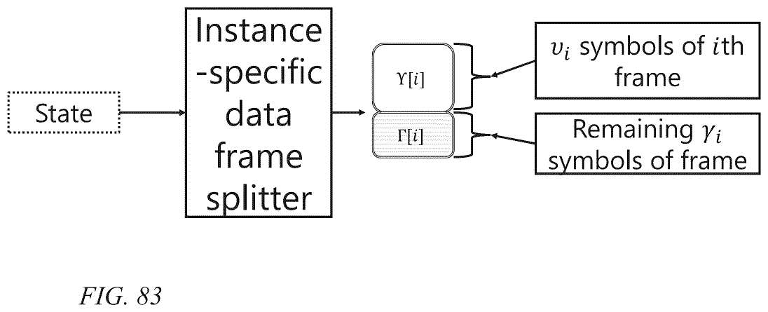

FIG. 83 illustrates data frame splitting for CSIPBRAL using an analogous process to CSIPB. Here, the data frame splitter enables for each data frame to allocate as many as dᵢ or as few as 0 symbols to each of the two components. This is done using a methodology that can leverage information about the call (i.e., its inputs) as well as properties of the application, user preference, etc. Hence, this may be referred to as “instance specific” frame splitting. For example, it may be a machine learning model trained to optimize key metrics of the QoE (e.g., rate, freeze, fraction of rendered decompressed frames, latency of rendered decompressed frames, PSNR, SSIM, LPIPS, etc.); such a model may make use of properties of prior calls in the decision (e.g., if a very large data frame is likely to be followed by a smaller data frame, the model may exploit such a property). Another possible data frame splitter is a heuristic.

The ith data frame, D[i], is partitioned into two components: Υ[i] and Γ[i]. In the event of a partial burst involving time slot i, t is the intention that (a) Γ[i:i+τ] will be recovered by timeslot (i+τ) (it suffices for Γ[i:i+τ−1] to be recovered by time slot (i+τ−1) and Γ[i+τ] to be recovered during time slot (i+τ), and (b) Υ[i] will be recovered within i additional data frames. In some cases, the size of Γ[i] ranges from 0 to some maximum value, γᵢ′ (sometimes called γᵢ^{max}) set to be as large as possible subject to the following constraint. Consider any partial burst starting in time slot j of length bⱼ that encompasses data frame i. Then the first component of data frames j through i can be recovered by time slot (j+τ−1) assuming that all symbols of data frames after data frame i have all of their symbols allocated to the second component (i.e., if γ_{z}=0 for z∈{i+1, . . . , j+bⱼ−1}). Then a procedure is used to select an integral value between 0 and

$${γ}_{i}^{′}$$

reflecting the number of symbols allocated to Γ[i]. For example, this procedure may be a learning-based approach.

The splitting of the data frame may depend on metadata of frame such as its compression; for example, if certain symbols of D[i] are supplementary (i.e., the data frame is useful without them but even better with them), the size of the split and the decision of which symbols to allocate to the second component may be chosen so that the second component (i.e., Υ[i]) contains the supplementary information. The reason for this is that it is the intention that for certain partial bursts the symbols of the first component (i.e., Γ[i]) are recovered strictly before the symbols of the second component, so such a decision may improve the QoE. In some instances, no such metadata will be available (i.e., it may not be tracked under the state in certain embodiments), so this type of information about the compression may not come into play.

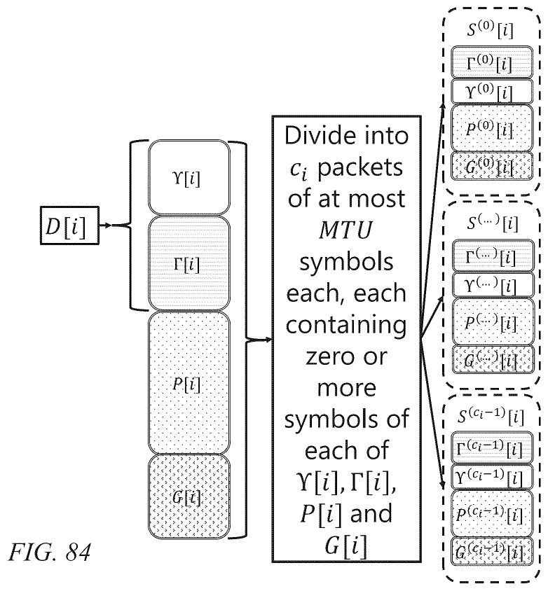

FIG. 84 shows the concept of packetization in accordance with CSIPBRAL. Here, packetization involves distributing the symbols of Υ[i], Γ[i], P[i], and G[i] over some number, cᵢ, of packets such that (a) each packet has size at most MTU symbols, and (b) losses under a partial burst channel are recoverable such that each data frame is recovered within τ time slots. It suffices to receive approximately (1−lᵢ) fraction of each of Υ[i], Γ[i], P[i], and G[i]. Each packet may contain symbols from one, two, three, or four of: Υ[i], Γ[i], P[i], and G[i].

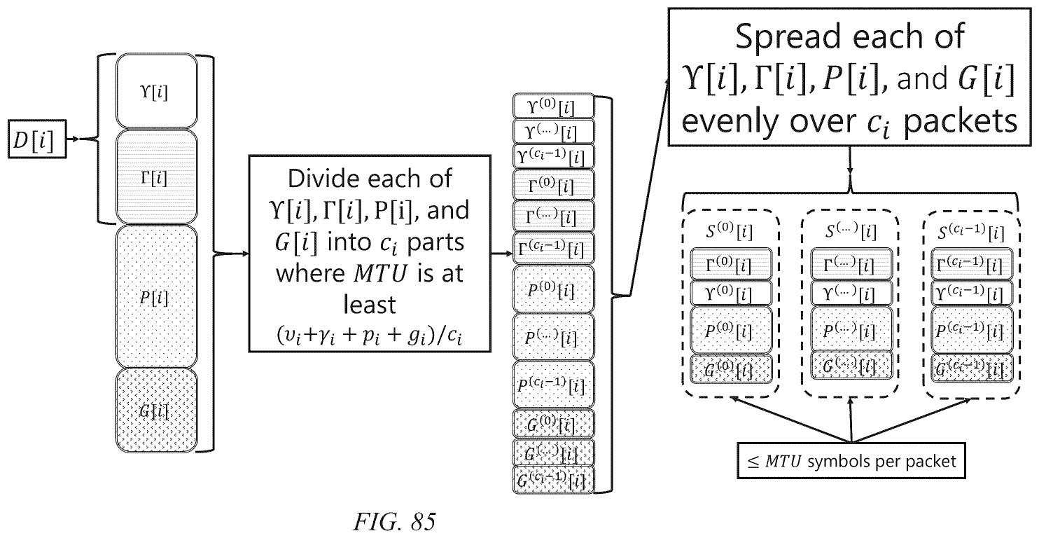

FIG. 85 shows one way for packetizing the ith data frame in accordance with CSIPBRAL (referred to herein as Packetization #2). Here, as few packets, cᵢ, are transmitted as possible so that when the data and parity symbols of a time slot are spread evenly over these packets, the following conditions hold: (a) Each packet's size does not exceed the maximum transmittable unit (for example, 1500 bytes), (b) the number of packets times lᵢ is an integer (or, it is slightly less than an integer where the difference is deemed sufficiently small relative to the number of packets). Optionally, there may be another condition that the number of packets times

$${l}_{i}^{( G )}$$

is an integer (or slightly less than an integer where the difference is deemed sufficiently small relative to the number of packets). Then Υ[i] and Γ[i] are zero-padded and the sizes of P[i] and G[i] are increased, each by as little as possible to ensure the sizes of Υ[i], Γ[i], P[i] and G[i] are divisible by cᵢ. Each of Υ[i], Γ[i], P[i] and G[i] are evenly distributed over the cᵢ packets. Again, this solution deviates from Tambur where all parity symbols are sent in separate packets from data symbols and number of packets is not chosen based on loss-recovery characteristics.

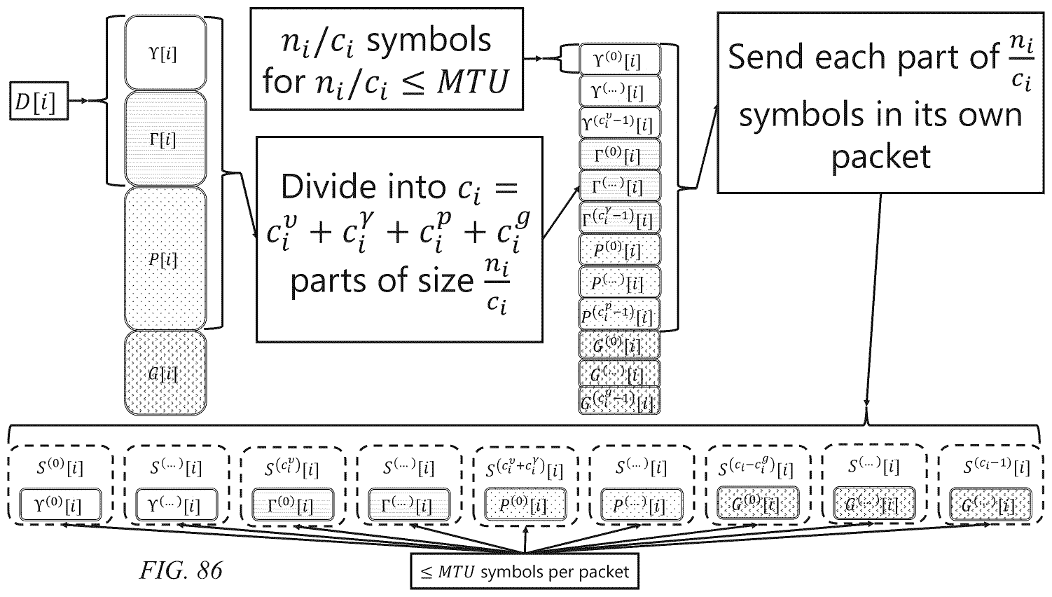

FIG. 86 shows a second way for packetizing the ith data frame in accordance with CSIPBRAL. Here, Γ[i] is divided into

$${c}_{i}^{γ}$$

packets of size

$$\frac{{n}_{i}}{{c}_{i}}$$

where

$$\frac{{n}_{i}}{{c}_{i}} \leq MTU ,$$

Υ[i] is divided into

$${c}_{i}^{v}$$

packets of size

$$\frac{{n}_{i}}{{c}_{i}}$$

where

$$\frac{{n}_{i}}{{c}_{i}} \leq MTU ,$$

P[i] is divided into

$${c}_{i}^{p}$$

packets of size

$$\frac{{n}_{i}}{{c}_{i}}$$

where

$$\frac{{n}_{i}}{{c}_{i}} \leq MTU ,$$

and G[i] is divided into

$${c}_{i}^{g}$$

packets of size

$$\frac{{n}_{i}}{{c}_{i}}$$

where

$$\frac{{n}_{i}}{{c}_{i}} \leq MTU ;$$

then

$${c}_{i} = ( {c}_{i}^{v} + {c}_{i}^{γ} + {c}_{i}^{p} + {c}_{i}^{g} )$$

packets are sent with each part in its own packet Note that the width is reduced in some cases for reasons of space. Also note that this solution may involve zero padding and or pushing the boundary between Υ[i] and Γ[i] so as to fill each packet with

$$\frac{{n}_{i}}{{c}_{i}}$$

symbols while minimizing zero padding.

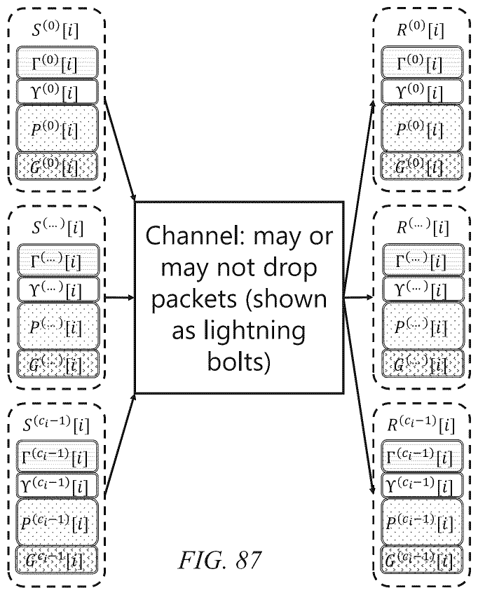

FIG. 87 illustrates how transmission switching is reflected from sent packets to received packets (e.g., based on packet loss/reception).

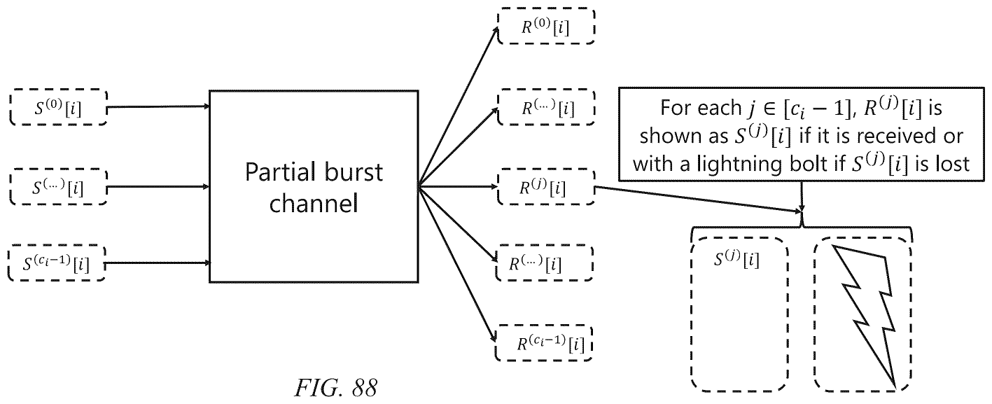

FIG. 88 provides a simplified illustration of how transmission switching is reflected from sent packets to received packets (essentially same as CSIPB) (e.g., based on packet loss/reception).

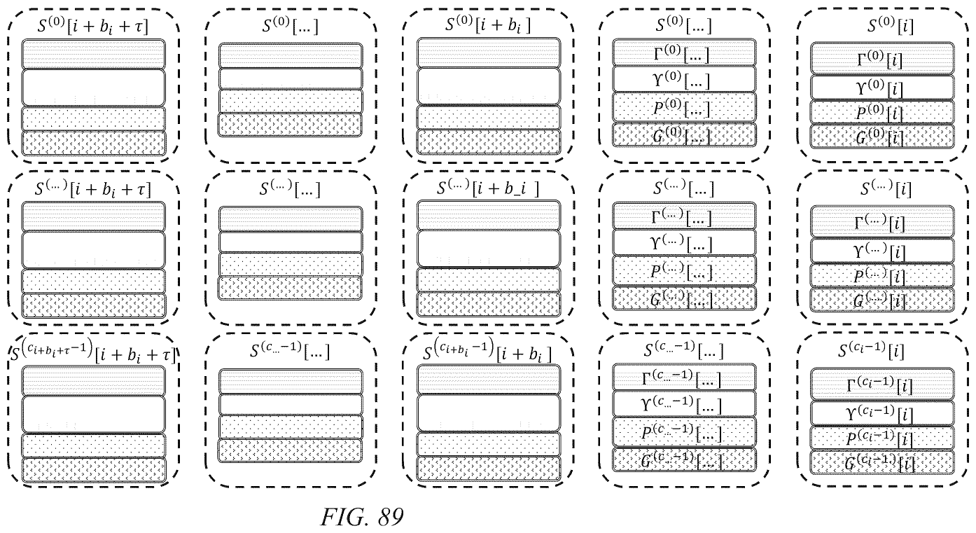

FIG. 89 shows an example of what is sent for time slots i through (i+bᵢ+τ). Here, for each j∈{i+bᵢ, . . . , i+bᵢ+τ} and each z∈[cⱼ−1], (a) the box with horizontal lines inside of S^{(z)}[j] is Γ^{(z)}[j], (b) the box with vertical lines inside of S^{(z)}[j] is Υ^{(z)}[j], (c) the box with black dots inside of S^{(z)}[j] is P^{(z)}[j], and (d) the box with black divots inside of S^{(z)}[j] is G^{(z)}[j]. An analogous convention can be defined by substituting R^{(z)}[j] for S^{(z)}[j]. The conventions are assumed to hold elsewhere unless otherwise specified.

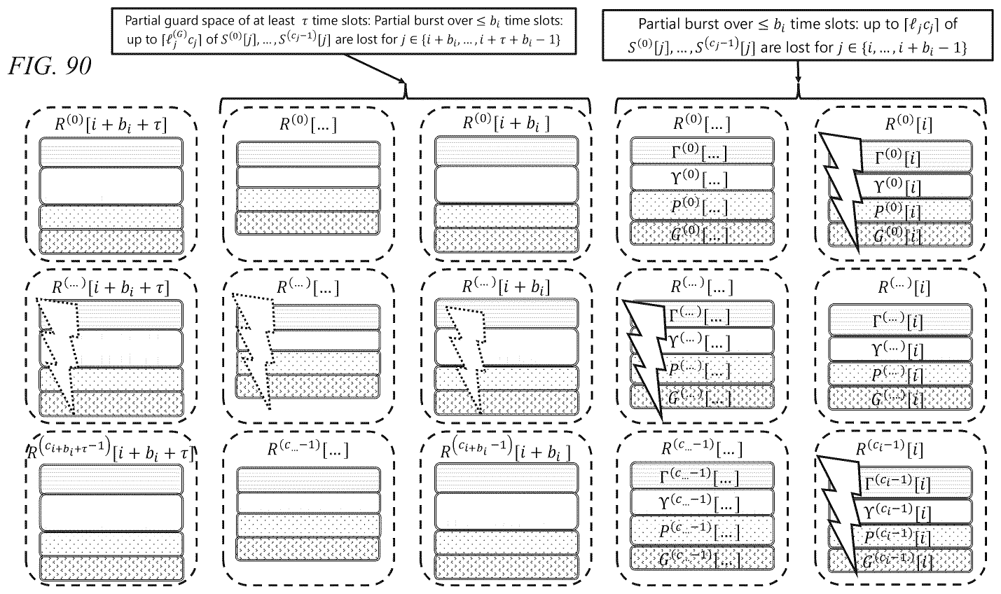

The intended loss recovery of a partial burst loss using CSIPBRAL is now described with reference to FIGS. 90-96. Note that lightning bolts sometimes will change to no longer overlap a vector (e.g., Γ[i]) once it has been recovered.

FIG. 90 shows an example of what may be received for time slots i through (i+bᵢ+τ) for non-negative integers i, bᵢ, and τ. Here, for each j∈{i+bᵢ, . . . , i+bᵢ+τ} and each z∈[cⱼ−1], (a) the box with horizontal hashes inside of R^{(z)}[j] is F^{(z)}[j], (b) the box with vertical lines inside of R^{(z)}[j] is Y^{(z)}[j], (c) the box with black dots inside of R^{(z)}[j] is P^{(z)}[j], and (d) the box with black divots inside of R^{(z)}[j] is G^{(z)}[j]. In order to distinguish (a) time slots j of a partial burst wherein up to ┌lⱼcⱼ┐ packets are lost from (b) time slots j′ of a partial guard space wherein up to

$$⌈ {l}_{{j}^{′}}^{( G )} {c}_{{j}^{′} ⌉}$$

packets are lost, the convention is used of showing a lightning bolt with (a) a thick outline, and (b) an outline with dashes of squares to reflect the two respective type of losses.

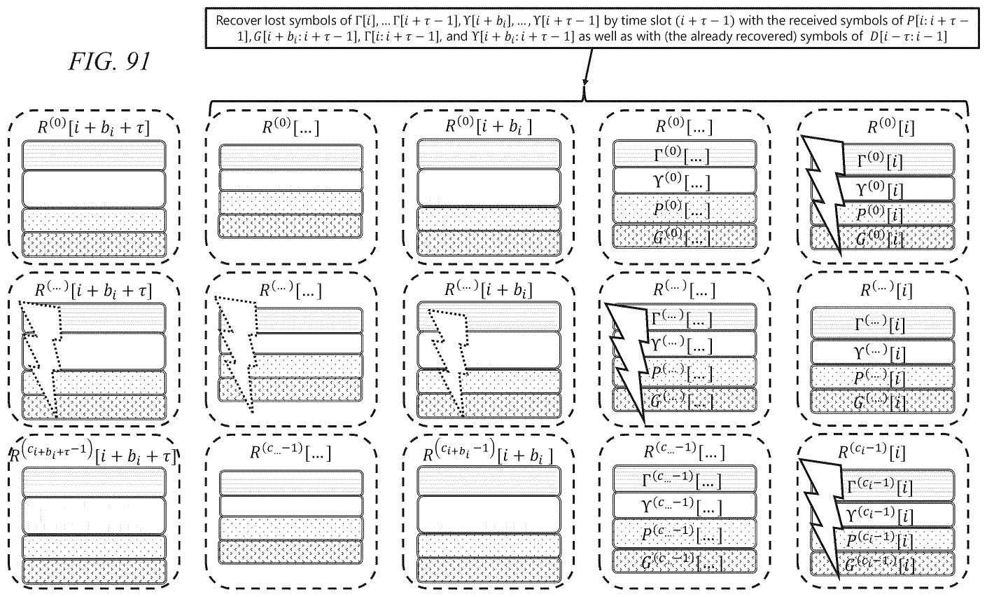

FIG. 91 illustrates recovery of lost symbols of Γ[i], . . . Γ[i+τ−1] and Υ[i+bᵢ], . . . Υ[i+τ−1] by time slot (i+τ−1) with the received symbols of P[i:i+τ−1], G[i+bᵢ:i+τ−1], Γ[i:i+τ−1], and Υ[i+bᵢ:i+τ−1] as well as with (the already recovered) symbols of D[i−τ:i−1]. It is assumed that the symbols of D[i−τ:i−1] are already decoded by time slot (i+τ−1). Note that such recovery is not necessarily a requirement but is feasible with certain embodiments. For ease of presentation, we show an embodiment where Γ[i:i+τ−1] and Υ[i+bᵢ:i+τ−1] are recovered during time slot (i+τ−1); in other embodiments, Γ[i:i+τ−1] may not be recovered until time slot (i+τ) and Υ[j] for j∈{i+bᵢ, . . . , i+τ−1} may not be recovered until time slot (j+x).

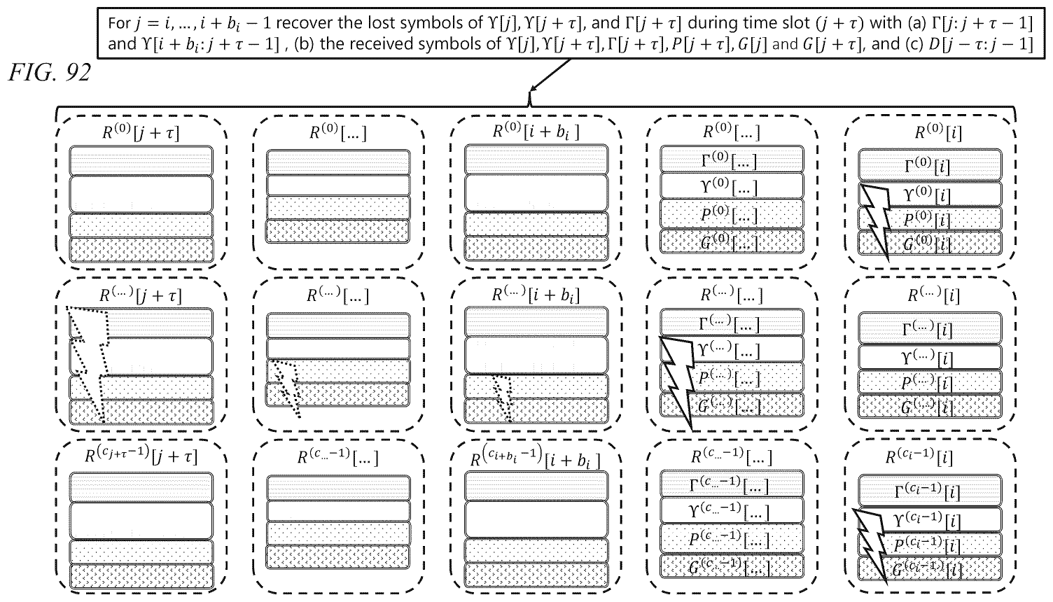

FIG. 92 illustrates for j∈{i, . . . , i+bᵢ−1} recovery of the lost symbols of Υ[j], Υ[j+τ], and Γ[j+τ] during time slot (j+τ) with (a) Γ[j:j+τ−1] and Υ[i+bᵢ:j+τ−1], and (b) the received symbols of Υ[j], Γ[+τ], Υ[j+τ], G[j+τ], P[j+τ], and G[j]. It is assumed that the symbols of (a) are already decoded by time slot (i+τ−1)≤(j+τ). It is also assumed that D[j−τ:j−1] have been decoded before time slot (j+τ). We note that in certain other embodiments (e.g., where G[j] is defined to use the optional grey arrows in FIGS. 77 and 80), Υ[i+bᵢ:i+bᵢ−1+τ] may not be recoverable until time slot (i+bᵢ−1+τ).

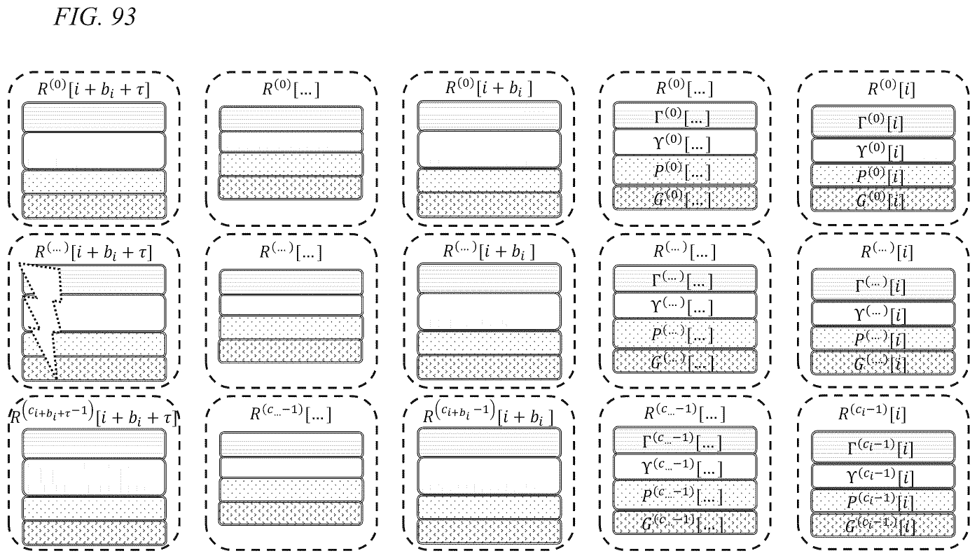

FIG. 93 shows a representation of one possible state of the system following the recovery of FIG. 92 (wherein up to l_{i+b}_{ᵢ}_{+τ}^{(G)} fraction of the packets sent during time slot (i+bᵢ+τ) are lost). In embodiments where G[i] is only used to recover Υ[i] (i.e., grey arrows not used), it can be assumed that Υ[j+τ] is recovered with Υ[j] during time slot (j+τ). It also can be assumed during time slot (i+bᵢ+τ−1) that Υ[i+bᵢ:j+τ−1] is recovered.

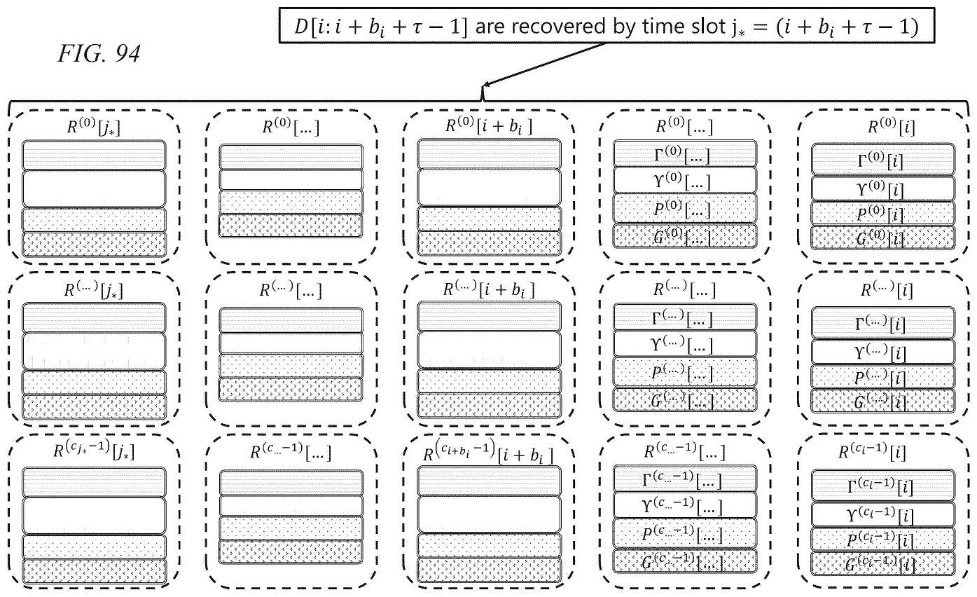

In FIG. 94, D[i:i+bᵢ+τ−1] are recovered by time slot (i+bᵢ+τ−1). This means it is also possible to compute P[i:i+bᵢ+τ−1] and G[i:i+bᵢ+τ−1] (so they are shown as recovered, even though one typically would not in practice compute the lost parity symbols).

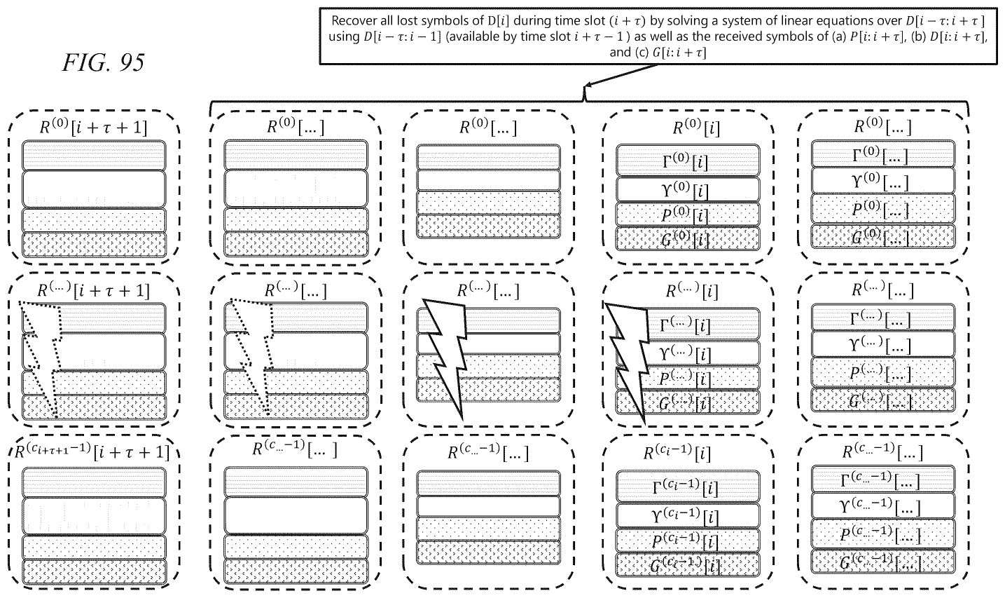

FIG. 95 illustrates recovery of all lost symbols of D[i] during time slot (i+τ) by solving a system of linear equations over D[i−τ:i+τ] using the recovered symbols of D[i−τ:i−1] (available by time slot (i+τ−1)) as well as the received symbols of (a) P[i:i+τ], (b) D[i:i+τ], and (c) G[i:i+τ]. It is assumed that the symbols of D[i−τ:i−1] are assumed to already be decoded by time slot (i+τ). The figure includes symbols of Υ[i+1:i+τ] and G[i+1:i+τ], which can be used in solving the system of linear equations but is not necessary in certain embodiments. Generally speaking, such loss recovery can be viewed as follows. Recover all lost symbols of D[i] during time slot (i+τ) by solving a system of linear equations over (a) the received symbols of P[i:i+τ], (b) the received symbols of D[i], (c) the received symbols of G[i], (d) the received symbols of Γ[i+1:i+τ], and (e) D[i−τ:i−1]. One way to do so is to use Gaussian Elimination to solve the system of linear equations.

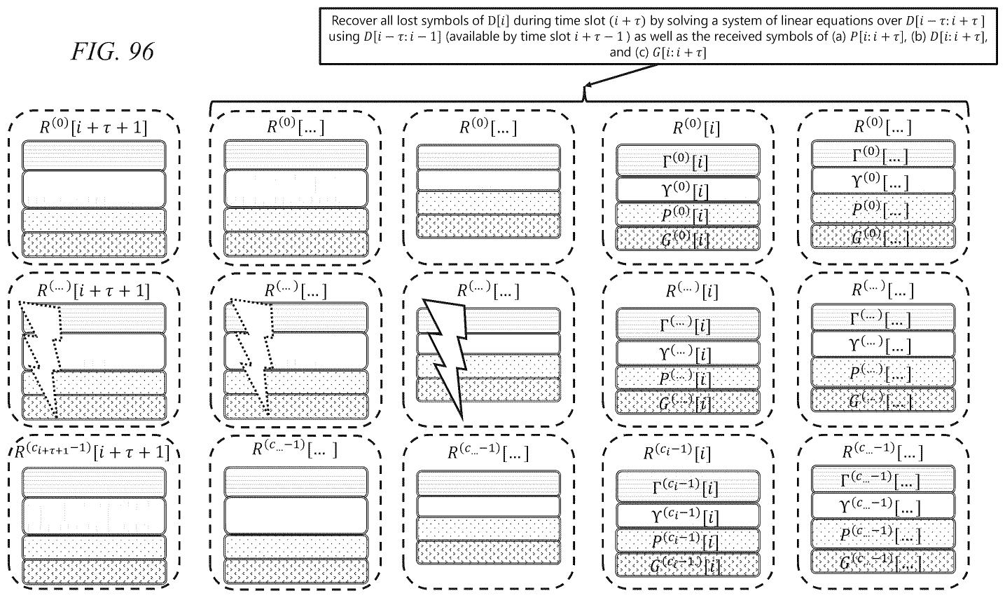

FIG. 96 shows lightning bolts reflecting that symbols of R[i+1:i+τ−1] may be lost (the convention is used of showing a lightning bolt with (a) a thick outline and (b) an outline with dashes of squares to reflect the loss in a partial burst vs. a partial guard space, respectively); however, it is possible that some of these symbols have been recovered (e.g., the symbols of Γ[i+1:i+τ−1] and Υ[i+bᵢ:i+τ−1] may already decoded by time slot (i+τ−1) in certain embodiments).

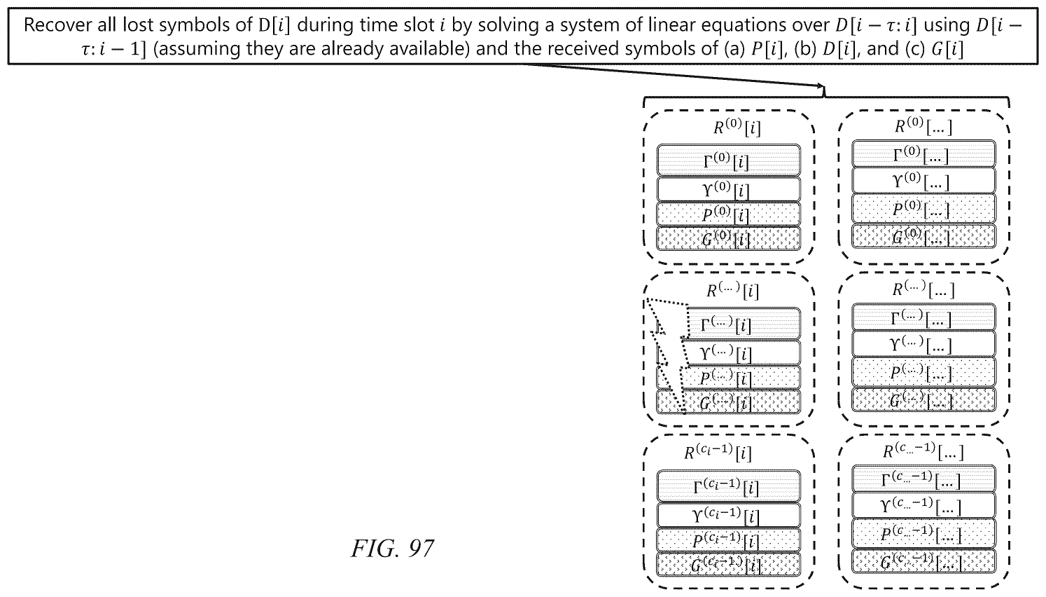

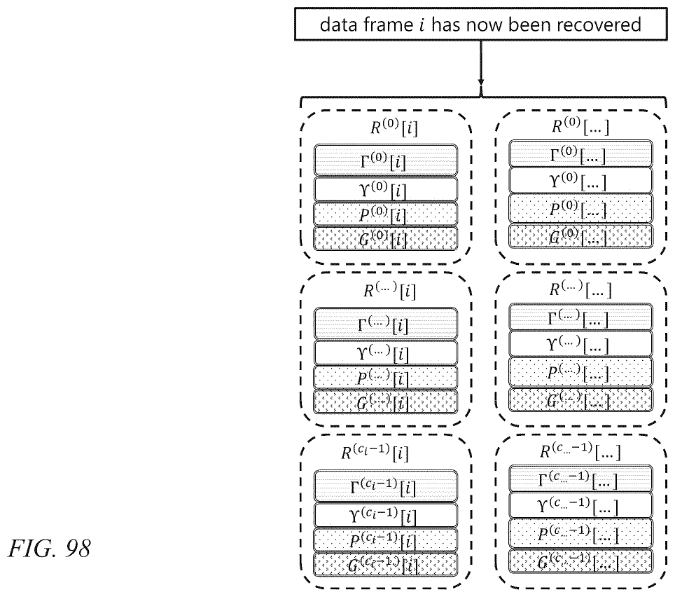

FIGS. 97-98 illustrate intended loss recovery if all prior data frames have been decoded (e.g., only guardspace loss or an earlier partial burst has been decoded along with all prior data frames). FIG. 97 illustrates recovery of all lost symbols of D[i] during time slot i by solving a system of linear equations over D[i−τ:i−1] as well as the received symbols of (a) P[i], (b) D[i], and (c) G[i]. FIG. 98 illustrates the system after data frame i has been recovered. In FIGS. 97-98, it is assumed that failsafe is not used. If failsafe is used, it would be assumed that D[i−τ′:i−1] are available.

In an offline setting, where sizes of future frames are available, an offline optimization can be used to find splits and parity allocation, e.g., via a linear program.

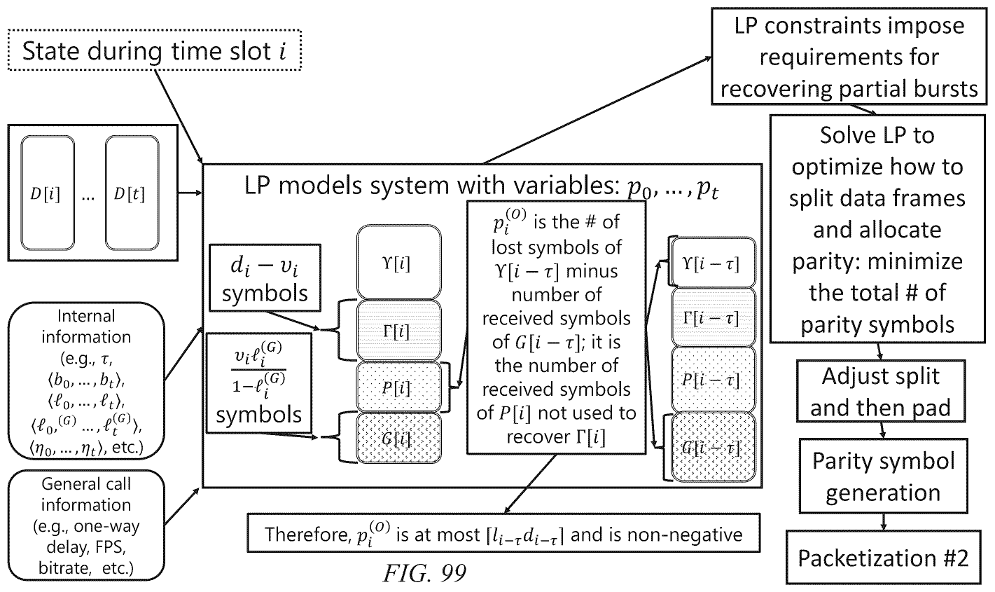

FIG. 99 schematically shows an offline optimization to find splits and parity allocation via a linear program, in accordance with one embodiment.

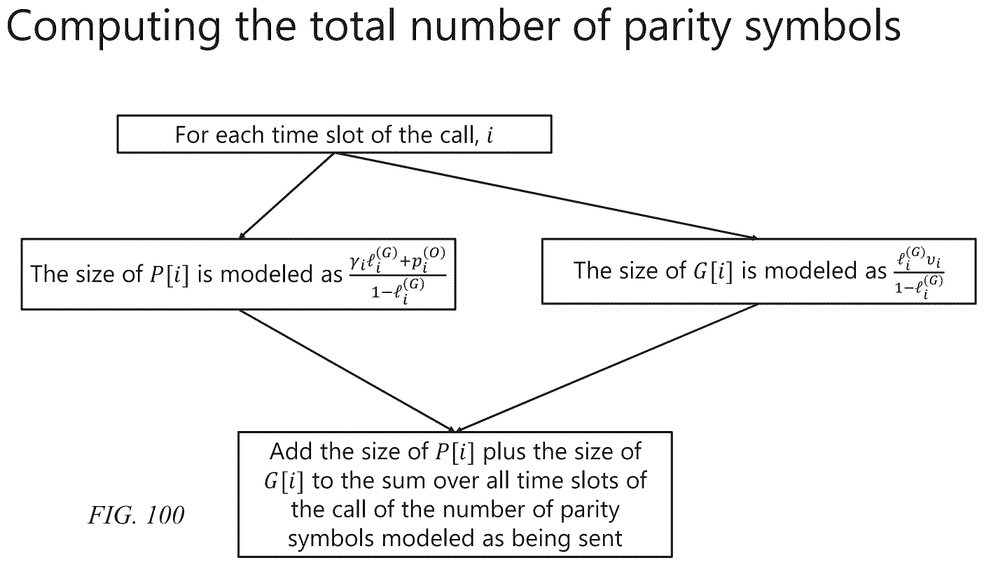

In FIG. 100, the system computes the total number of parity symbols. Here,

$${p}_{i}^{( O )}$$

is modeled as the number of received parity symbols of P[i] that are useful to recover earlier data frames, i.e.,

$$( 1 - {l}_{i}^{( G )} ) {p}_{i} ;$$

this is the size of the parity of time slot i that would have occurred if

$${l}_{j}^{( G )} = 0$$

for all j (i.e., this is the pre-allocated parity). Here, this is modeled as adjusting the amount of parity sent during time slot i only during time slot i and doing so by (a) increasing the number of parity symbols by factor of

$$\frac{1}{1 - {l}_{i}^{( G )}} ,$$

(b) adding

$$\frac{{d}_{i} {l}_{i}^{( G )}}{1 - {l}_{i}^{( G )}} = \frac{{γ}_{i} {l}_{i}^{( G )}}{1 - {l}_{i}^{( G )}} + \frac{{v}_{i} {l}_{i}^{( G )}}{1 - {l}_{i}^{( G )}}$$

extra parity symbols. This ensures if a partial burst occurs and includes time slot (i−τ) that after the partial guard space losses occur, there remain enough received parity symbols to have (a)

$${ip}_{( O )}^{}$$

to recover the remaining missing symbols of Υ[i−τ] (i.e., the second component from i frames before), (b)

$$\frac{{γ}_{i} {l}_{i}^{( G )}}{1 - {l}_{i}^{( G )}}$$

panty symbols to recover the missing symbols of Γ[i] (i.e., the first component of the current frame), and (c)

$$\frac{{v}_{i} {l}_{i}^{( G )}}{1 - {l}_{i}^{( G )}}$$

parity symbols to recover the missing symbols of Υ[i] (i.e., the second component of the current frame).

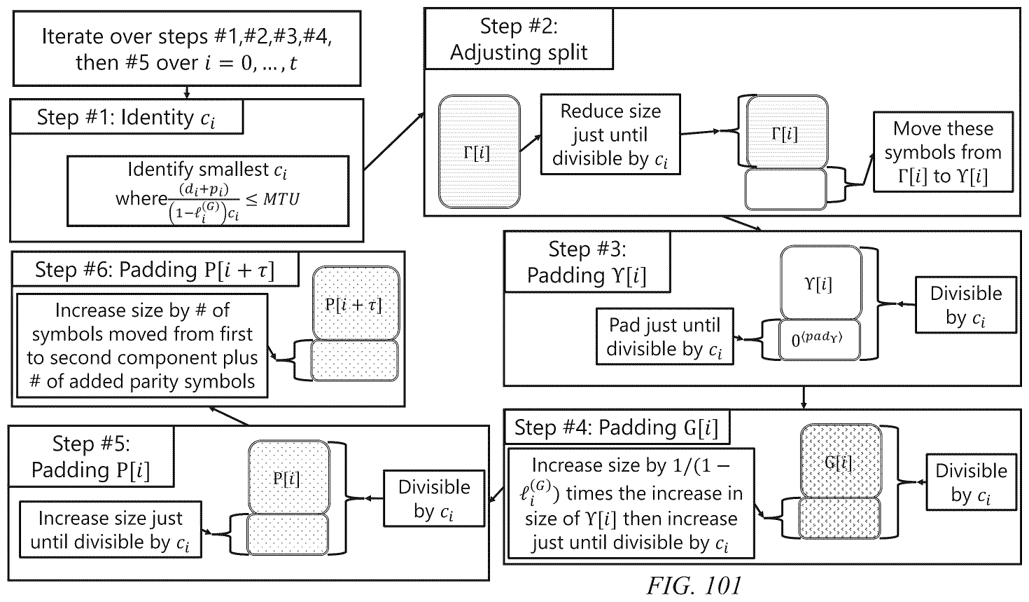

FIG. 101 shows one way to adjust the split and add padding to convert the variables from a solution to the linear program into quantities that can be used for communication. Here, the system ensures (a) the packetization is well defined while (b) maintaining the intended recovery properties for partial bursts (i.e., for a partial burst starting in time slot i with high probability (a) Γ[i:i+bᵢ−1] are recovered by time slot (i+τ−1) and (b) each Υ[j] is recovered by time slot (j+τ) for j∈{i, . . . , i+b_{g}−1}, and (c) after recovering D[i:i+bᵢ−1], D[i+bᵢ:i+bᵢ−1+τ] are recoverable.

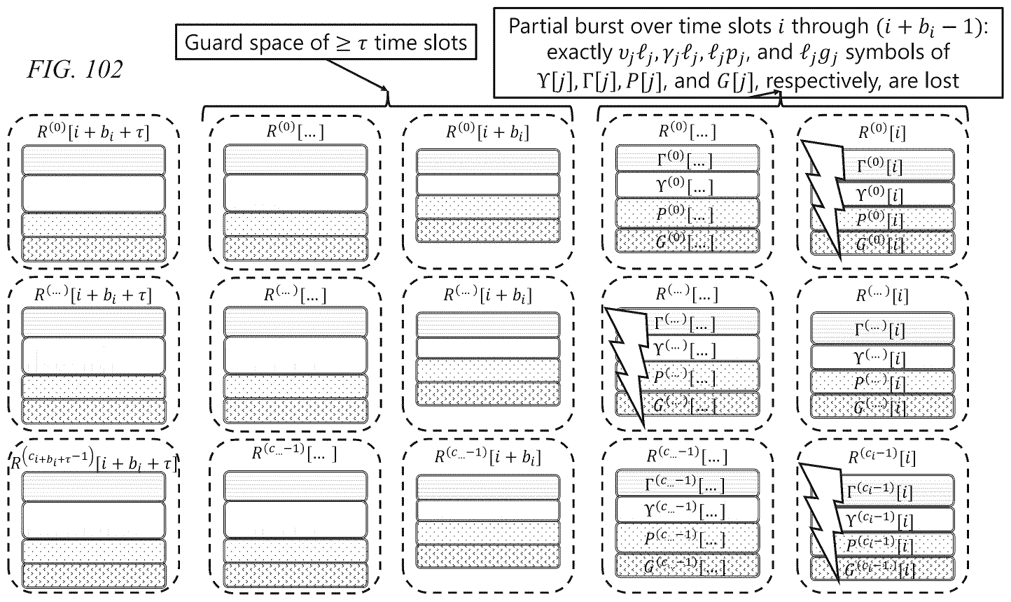

FIG. 102 illustrates modeling a partial burst starting in time slot i for constraints on loss recovery and modeling as a guard space (not a partial guard space) after the burst by assuming

$${l}_{j}^{( G )} > 0$$

for j∈{i+bᵢ, . . . , i+bᵢ+τ−1} for this modeling. If it turns out that

$${l}_{j}^{( G )} = 0$$

for such a j, loss recovery only gets harder; but the system also models even more parity symbols as being sent; specifically, after the system accounts for the losses in the guard space and parity symbols that are used to recover D[i+bᵢ:i+bᵢ+τ−1] (where these parity symbols are necessary and sufficient to recover those data symbols), the number of remaining parity symbols for each such frame, j, is pⱼ; this is shown in FIG. 100, where G[j] is allocated to be large enough to ensure the received symbols of G[j] can be used to recover lost symbols of Υ[j] and extra parity symbols are allocated to P[j] to ensure some of the received symbols of P[j] can be used to recover the lost symbols of Γ[j] and then the remaining pⱼ symbols are available to recover Y[j−τ]. A relaxation is used to assume that the fraction of symbols lost for Γ[j], Υ[j], P[j], and G[j] is lⱼ, but any rounding issue can be handled by the process outlined in FIG. 101.

FIG. 100 also shows the number of parity symbols modeled as being sent during each time slot.

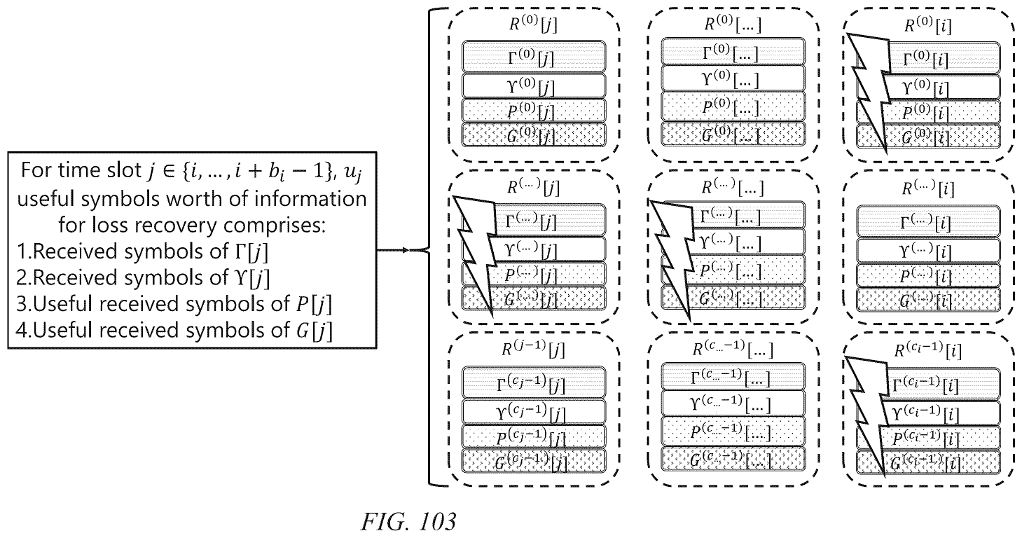

FIG. 103 shows useful symbols for loss recovery in time slot j∈{i, . . . , i+bᵢ−1} in accordance with one embodiment.

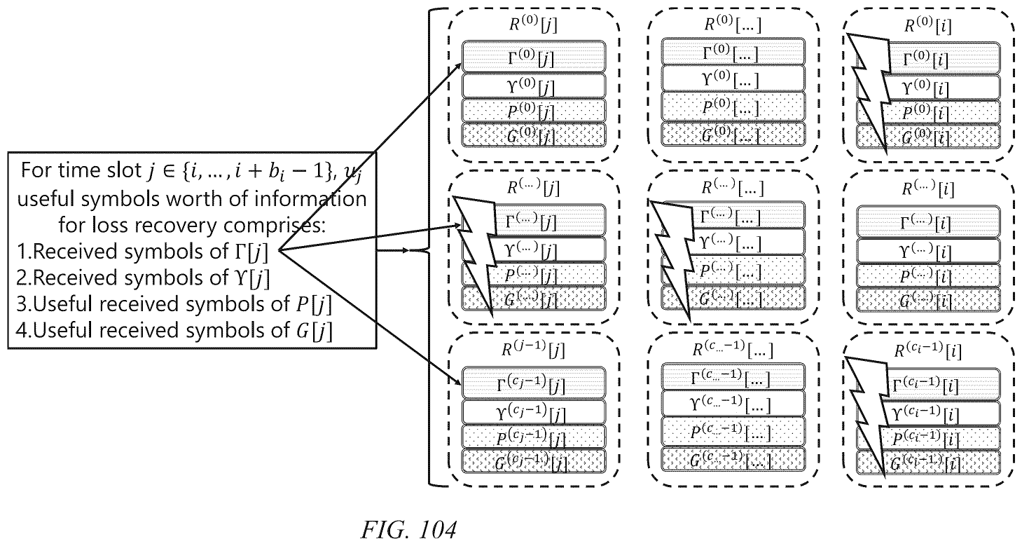

FIG. 104 highlights received symbols Γ[j].

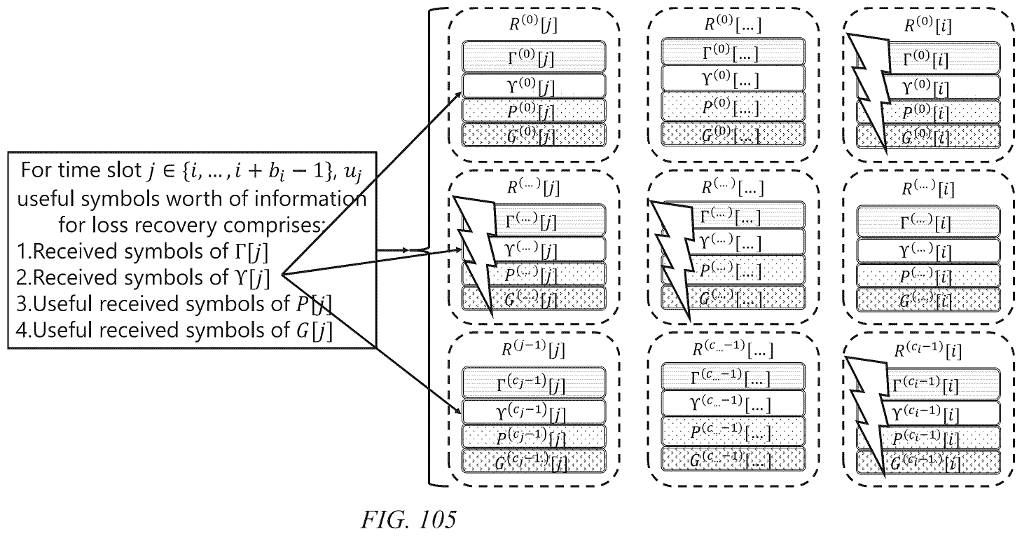

FIG. 105 highlights received symbols Υ[j].

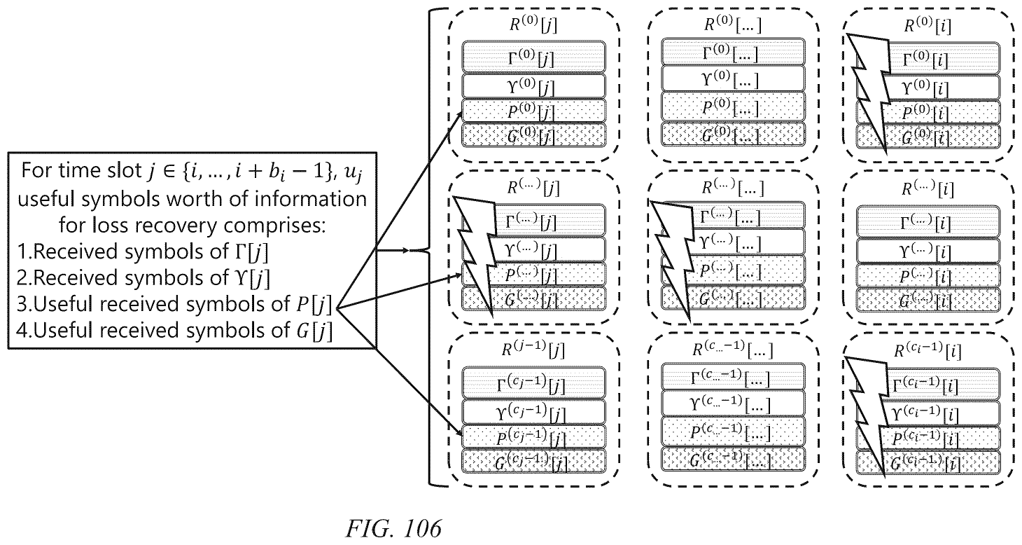

FIG. 106 highlights received symbols P[j].

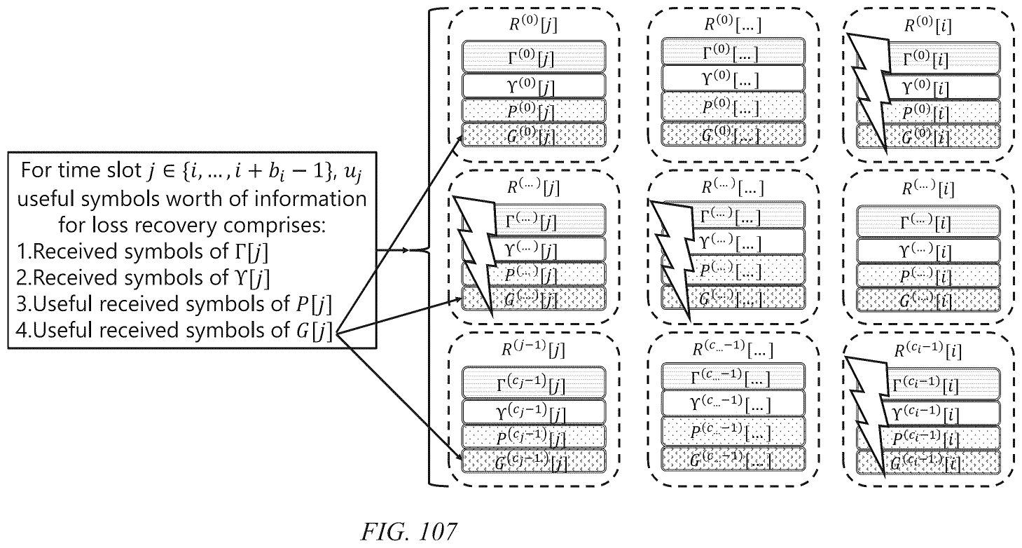

FIG. 107 highlights received symbols G[j].

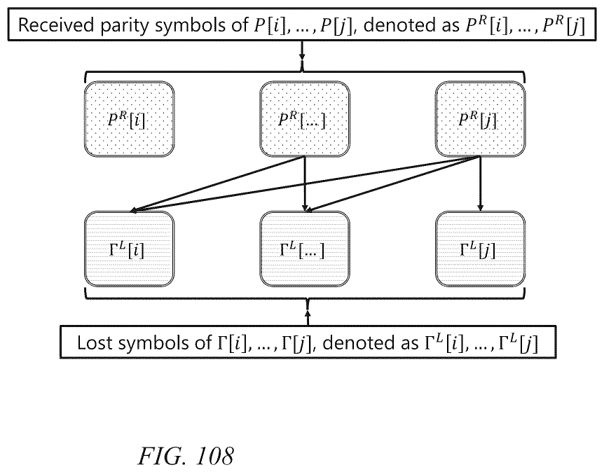

FIG. 108 shows useful parity symbols for loss recovery, in accordance with this example.

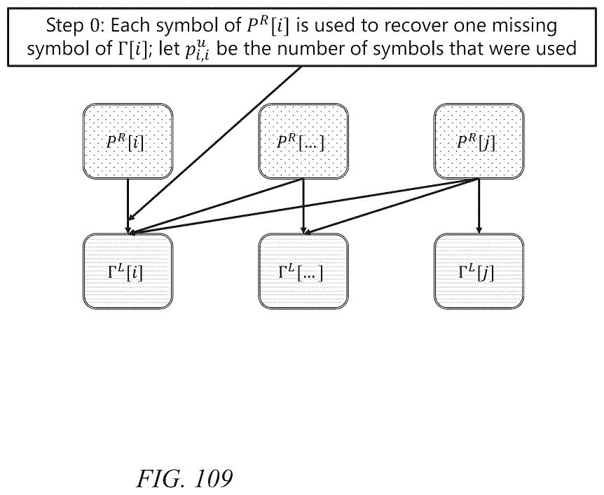

FIG. 109 shows an initial step for first type loss recovery in accordance with this example.

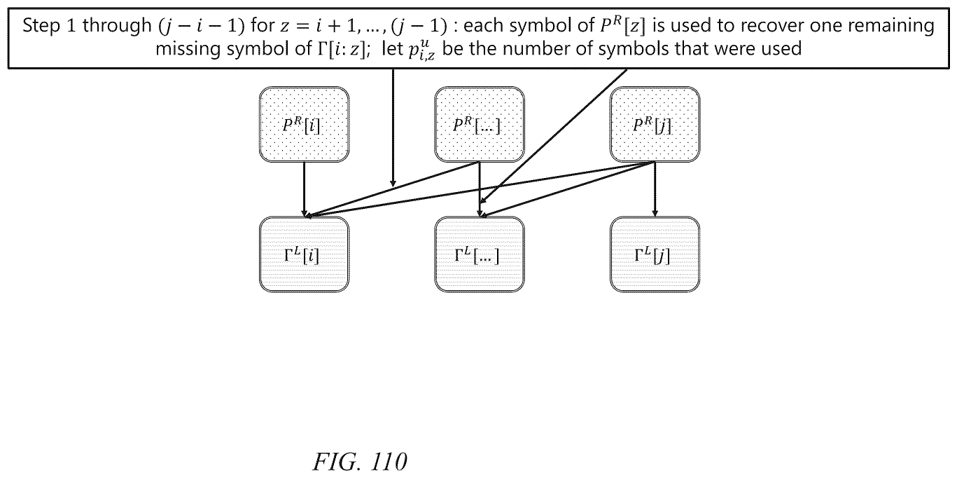

FIG. 110 shows intermediate steps for first type loss recovery in accordance with this example.

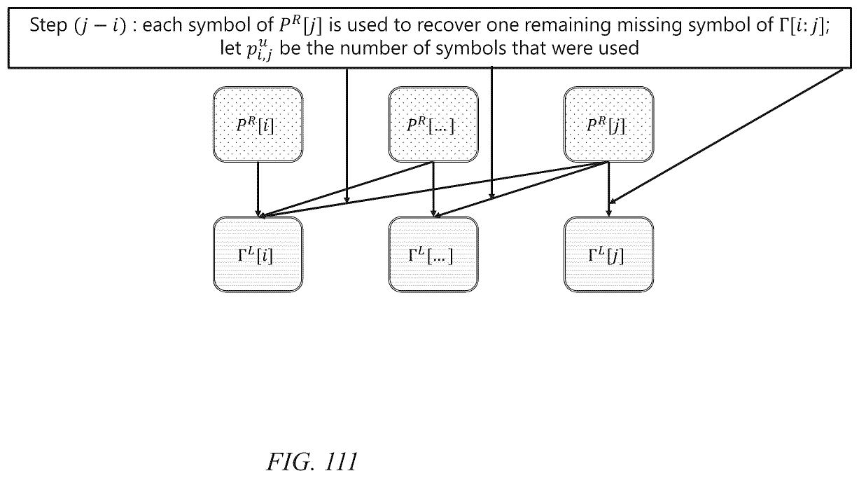

FIG. 111 shows the final step for first type loss recovery in accordance with this example.

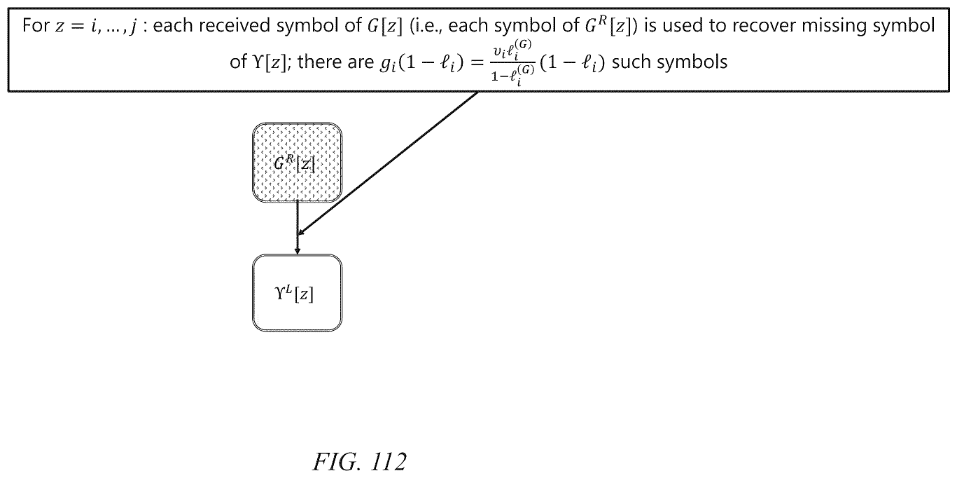

FIG. 112 shows second type loss recovery in accordance with this example.

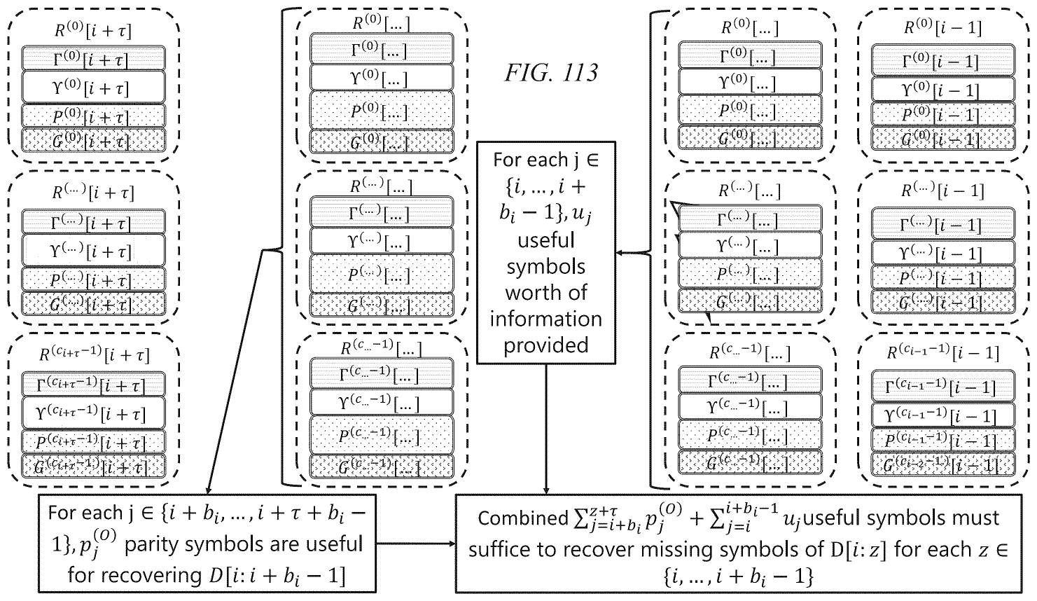

FIG. 113 shows how a sufficient number of useful symbols can be used to recover missing symbols of D[i:z] by times lot (z+τ) for each time slot z of the partial burst. Here, optimization is accomplished by minimizing

$${\sum }_{i = 0}^{t} \frac{{p}_{i}^{( O )}}{1 - {l}_{i}^{( G )}} + \frac{{d}_{i}}{1 - {l}_{i}^{( G )}}$$

where t is the length of the call subject to (a) the above loss recovery constraint, (b) bounding the size of each

$${p}_{i}^{( O )}$$

to be at least 0 and for i>τ to be at most ┌d_{i-τ}l_{i-τ}┐, and (c) (optionally) add the constraint that the first τ−1 time slots involve sending 0 parity symbols using a linear program. Then, padding is performed to ensure divisibility by cᵢ of sizes of Υ[i], Γ[i], P[i], and G[i] as discussed herein and then the sizes of Υ[i], Γ[i], P[i], and G[i] are matched (i.e., handling splitting and allocating parity symbols) and the parity symbol generation/loss recovery is performed. To deal with resets, for each time slot i where there is a reset among time slots (i+1), . . . , (i+τ), dᵢ is modeled as being of size 0 in the linear program and is split so that Υ[i]=D[i] and p_{i+τ}=0.

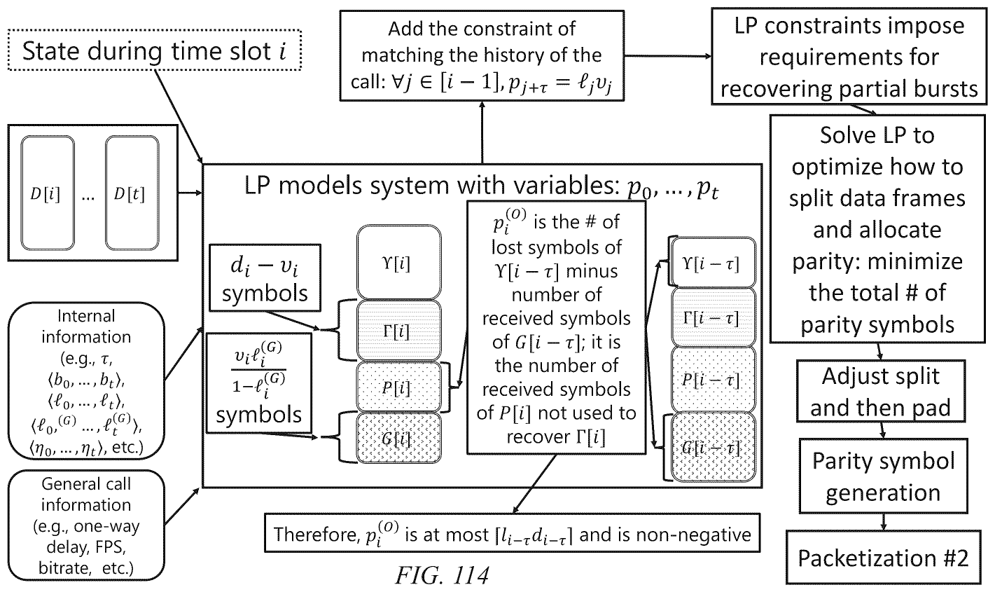

FIG. 114 shows that the optimization can be modified to apply during time slot i (i.e., after packets have been sent for previous time slots) by adding constraints to reflect the actions from earlier in the call (e.g., how much parity was allocated for the first and second type of parity symbols and the sizes of the two components) and then using the offline linear program solver to determine the splits for the remainder of the call, where, without loss of generality, the system assume

$${l}_{i}^{( G )} \leq {l}_{i}$$

for all i (since otherwise lᵢ is just set to equal

$${l}_{i}^{( G )} .$$

For convenience, this optimization may e referred to herein as the “offline solver”). One way to split data frames is to use a heuristic.

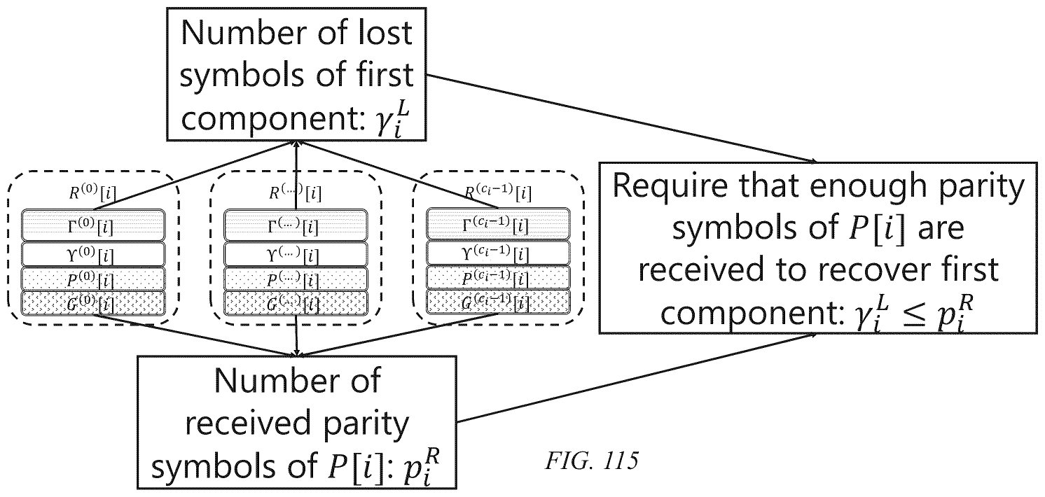

FIG. 115 is a schematic diagram representing a heuristic for splitting video frames to recover type “Γ” immediately for any partial burst, in accordance with one embodiment. This heuristic determines the size of the first component should be as large as possible subject to ensuring that it is recoverable using the received parity of the same time slot with high probability.

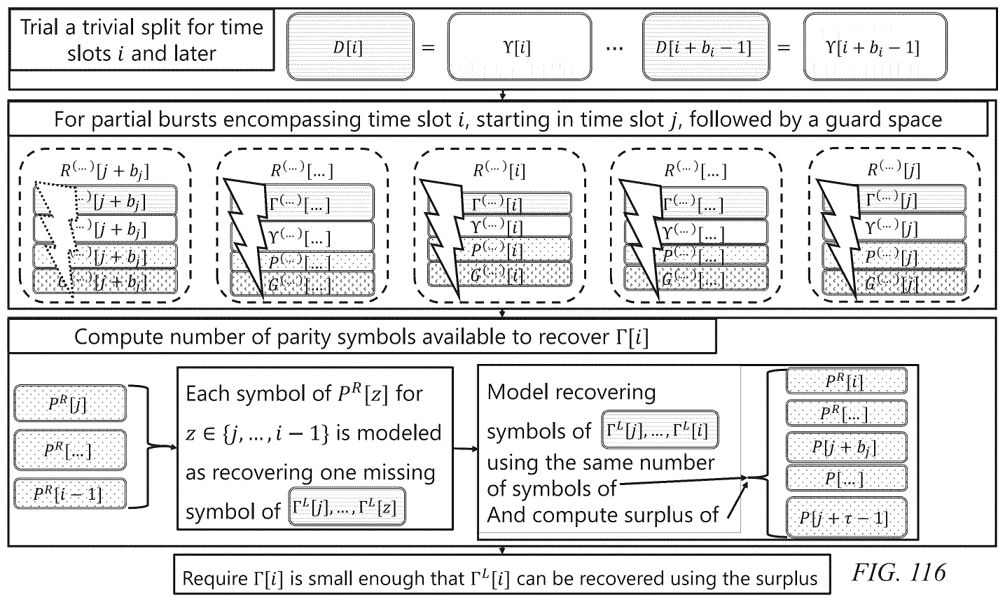

FIG. 116 is a schematic diagram representing a process for splitting video frames to minimize parity associated with each data frame i (referred to herein as “max heuristic PG,” where PG is for partial guardspace). This heuristic determines the size of the first component should be as large as possible subject to the following constraint. Suppose the first component is empty for the next c time slots (i.e., all data symbols are allocated to Υ). For any partial burst that includes the current time slot, then all symbols of the first component that are lost in the partial burst are recovered by τ−1 time slots after the start of the partial burst with high probability. The maximum value that the first component can be for time slot i under this heuristic is sometimes called γᵢ^{max}. Here, a guard space, not a partial guard space, is assumed; the reason is that a partial guard space would lead to only using the pre-allocated parity symbols of P[z] in time slots z=i+1, . . . , j+τ−1 and would assume that they are all received; in the event that

$${l}_{z}^{( G )} > 0 ,$$

then the number of parity symbols of P[z] would be increased until the number that are received that are useful for recovering Γ[i] match the number that are pre allocated under certain embodiments.

Another way to split data frames is to treat splitting as a reinforcement learning problem. As is generally known, reinforcement learning is a type of machine learning technique in which the system learns through training to make decisions using trial-and-error based on feedback from a reward function.

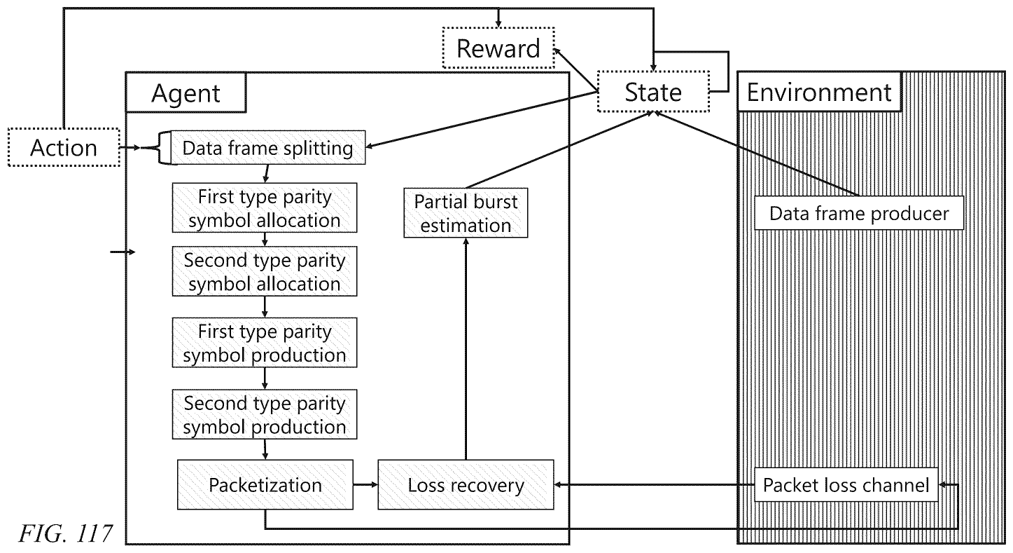

FIG. 117 illustrates a general methodology for splitting frames using reinforcement learning, in accordance with certain embodiments. The concept here is the same as in CSIPB.

The general methodology of FIG. 117 can be extended to encompass frame splitting and/or parity symbol allocation using reinforcement learning.

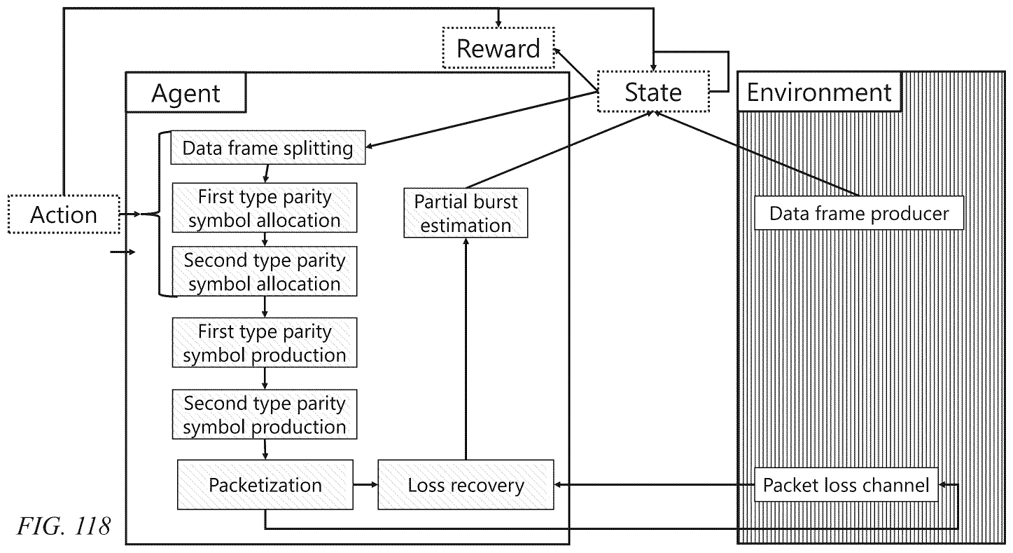

FIG. 118 illustrates a general methodology for splitting frames and allocating parity symbols for CSIPBRAL using reinforcement learning, in accordance with certain embodiments. The concept here is the same as in CSIPB except for the addition of second type parity symbol allocation and production.

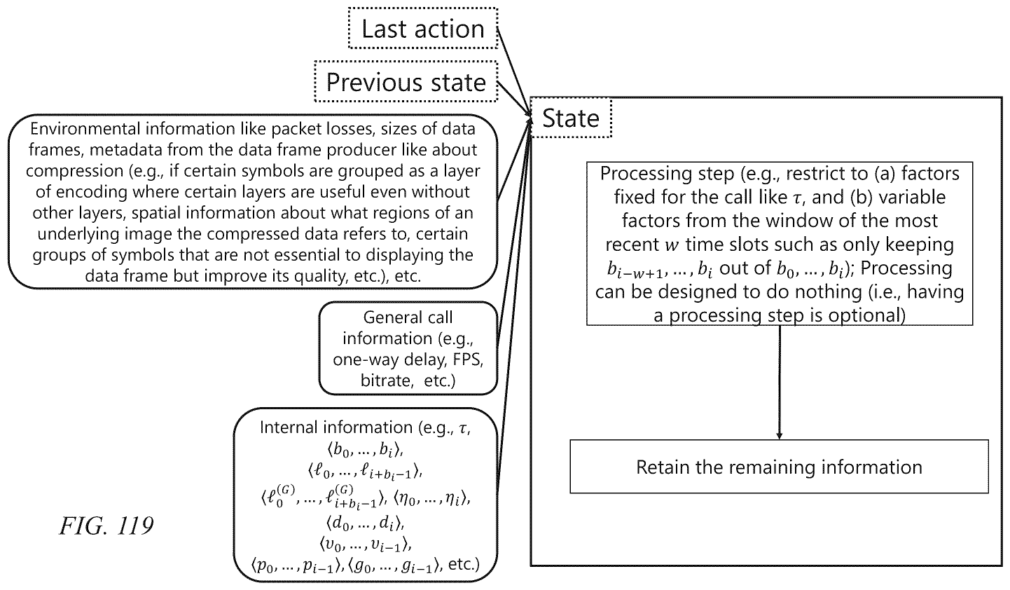

FIG. 119 schematically illustrates the concept of “state” for reinforcement learning, in accordance with certain embodiments. The concept here is the same as in CSIPB except for the additional internal information.

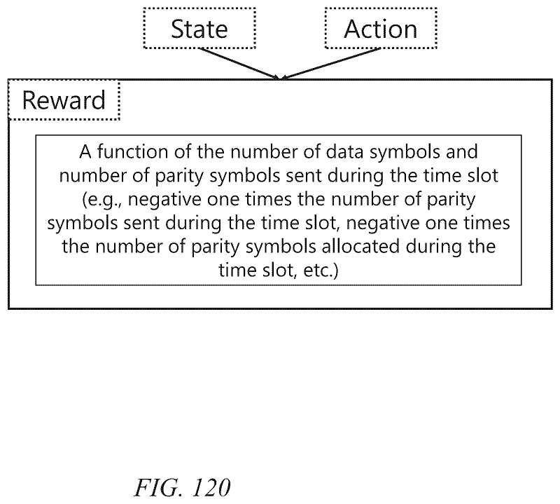

FIG. 120 shows one example of a reward function for training frame splitting and/or parity allocation, in accordance with certain embodiments.

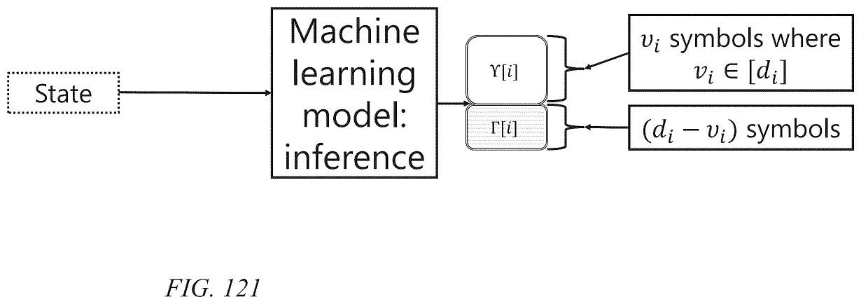

As depicted in FIG. 121, a machine learning model can be applied at inference time, e.g., at the time of deciding how to split frames and/or allocate parity symbols.

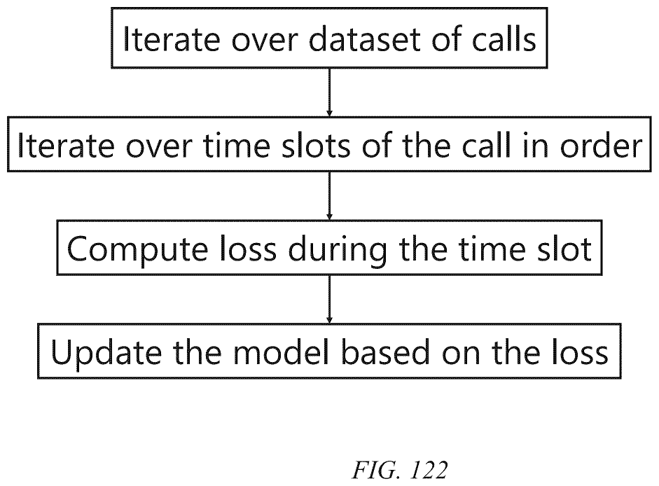

FIG. 122 depicts one way a machine learning model would be trained offline using actual and/or simulated data (e.g., data representing a number of calls) and could involve iterating over the dataset, computing the loss during each time slot, and updating the model using the loss. Embodiments can allow for human feedback such as to fine-tune the model. The concept here is the same as in CSIPB.

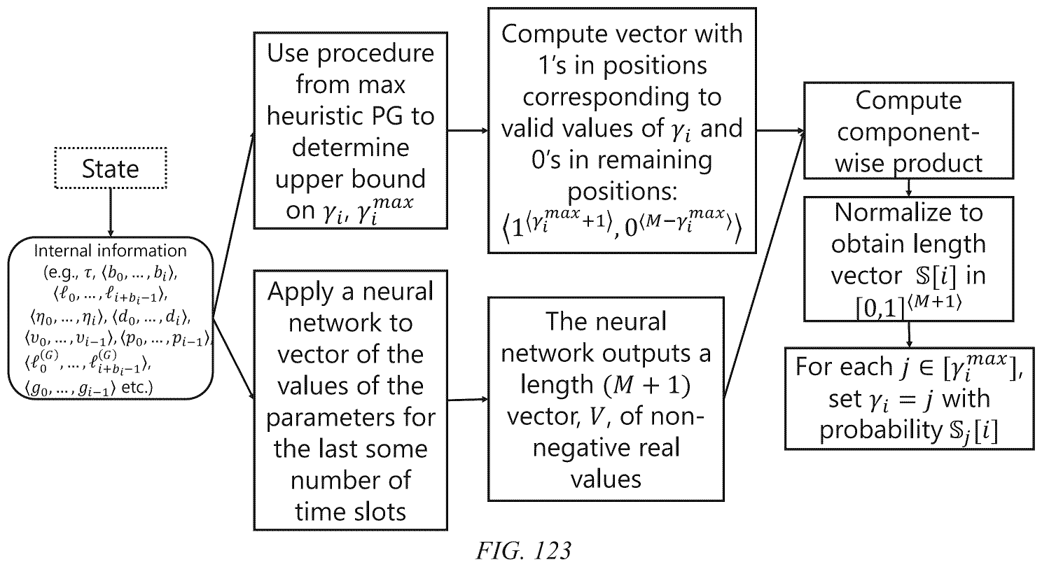

FIG. 123 shows one example of neural network (NN) model for training frame splitting, in accordance with certain embodiments. The concept here is the same as in CSIPB except for the additional internal information and the use of the CSIPBRAL offline solver and “max heuristic PG” heuristic.

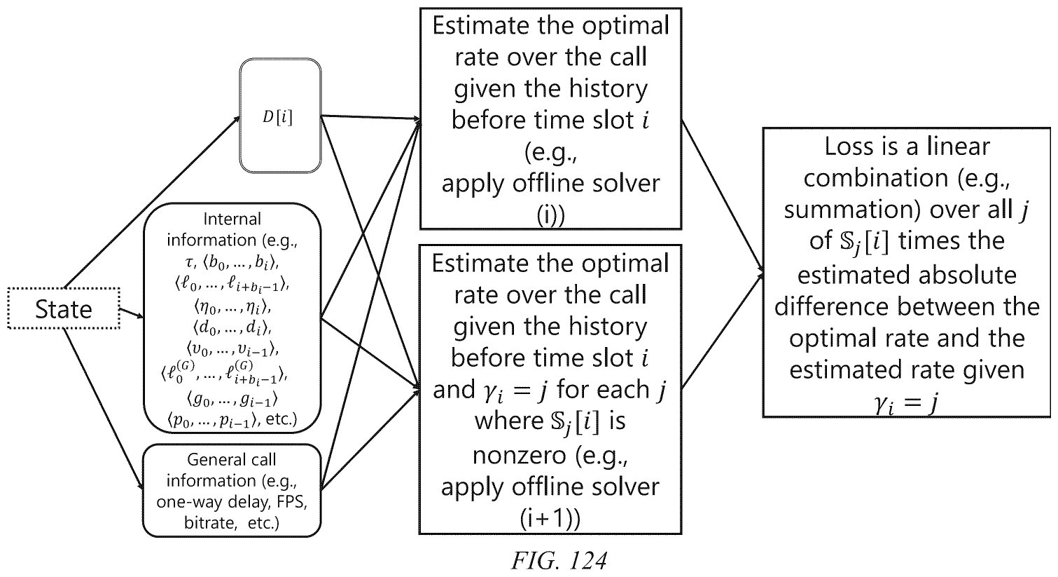

FIG. 124 shows one possible loss function (referred to herein as “loss function 2”), in accordance with certain embodiments. The concept here is the same as in CSIPB, except for the added internal information and the use of the “offline solver (i)” solver (i.e., the offline solver computed during time slot i).

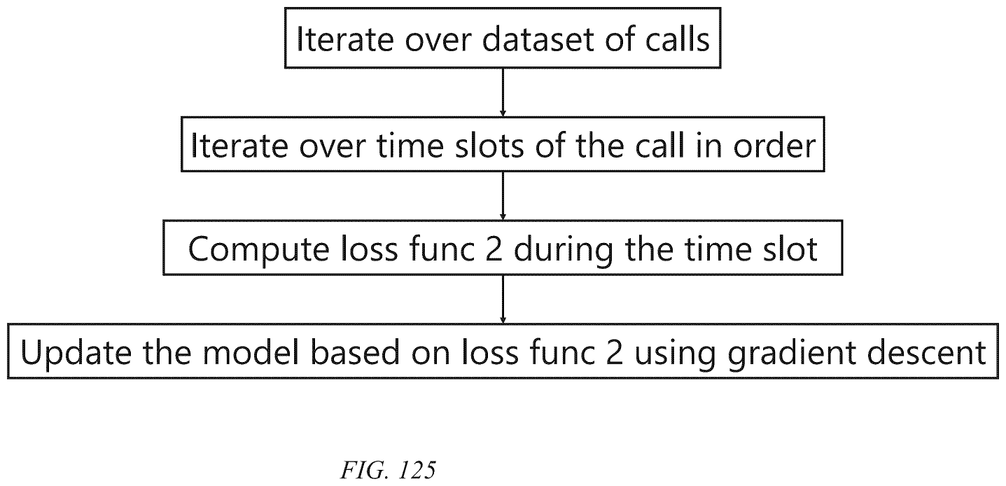

FIG. 125 shows one possible way to train the NN during jth call and ith time slot, in accordance with certain embodiments. The concept here is the same as in CSIPB, except for the use of the “loss function 2” loss function. Additionally or alternatively, the partial burst parameters can be modeled using reinforcement learning.

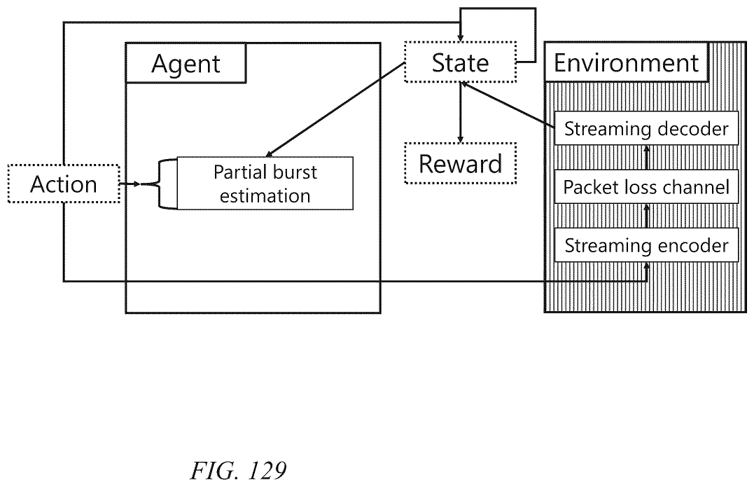

FIG. 129 provides an overview of how one can model estimating the partial burst parameters using a model conducive to reinforcement learning, in accordance with certain embodiments. Here, calling the parameters lᵢ, bᵢ,

$${l}_{i}^{( G )}$$

“burst parameters” or similar notation is meant to explain one way the embodiment of the communication schemes could be. Another (more general) viewpoint is that these parameters can be considered knobs to tune the communication scheme, e.g., they may be based on explicit characteristics of packet loss, or they may just be used to tweak the communication scheme until it behaves as desired (e.g., scores high on certain metrics of QoE). Thus, these parameters impact the code construction itself, which varies from data frame to data frame; these parameters do not merely change the bandwidth overhead (although that is one thing they will impact).

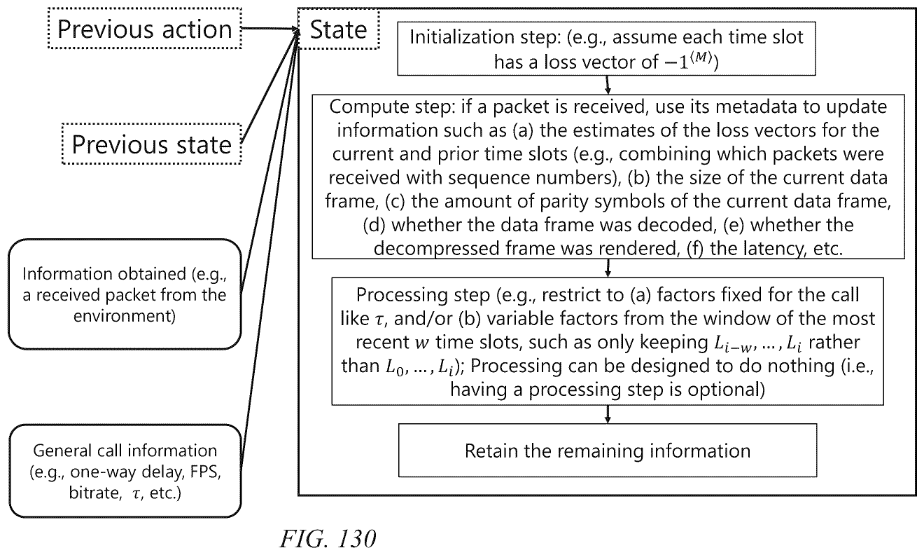

FIG. 130 illustrates the concept of “state” for the modeling of FIG. 129, in accordance with certain embodiments. Here, the state is meant to capture the situation; by assumption, the state can track any piece of information pertaining to the system, although some may not be tracked in certain embodiments (as can be accomplished via the processing step). To aid in the compute costs of reinforcement learning (e.g., to avoid the curse of dimensionality), some information may be dropped. Also, one may reduce the granularity of information such as by bucketing the number of parity symbols sent per time slot (e.g., list the number of symbols sent per time slot as integral multiples of a number, like 100, and applying rounding).

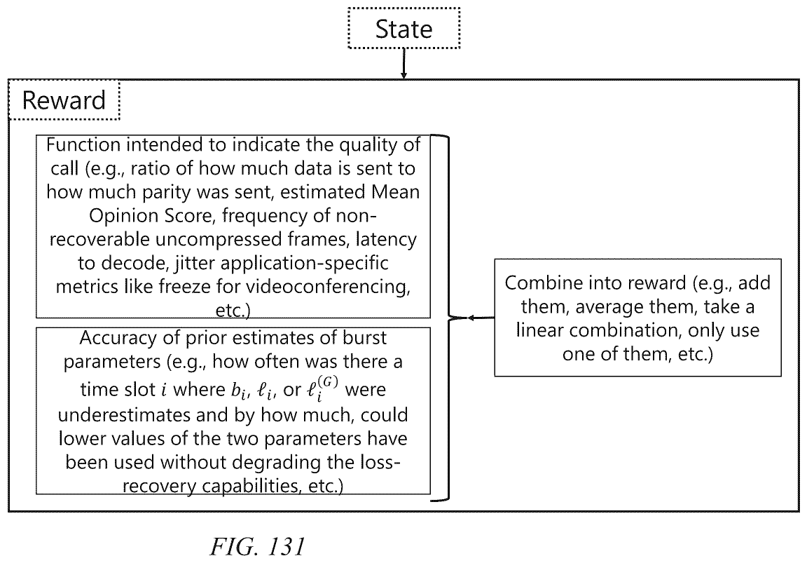

FIG. 131 shows one example of a possible reward function for the modeling of FIG. 130, in accordance with certain embodiments. One approach is to only give a reward when a packet is received (otherwise give 0 reward). Then one might consider two main intrinsic sources of reward (a) the quality of the call, and (b) the quality of the estimates. For each of these values, a function can be applied to score the performance (e.g., output a value between 0 and 1 where 1 is the optimal and 0 is the worst possible. Certain embodiments use a reward function that combines these three factors in a predetermined manner. For example, create a function (e.g., a metric) to measure the value/costs of an action for each metric. Then, create a second function to combine these three factors into a reward. One way is to add them. Another way is to ignore one and just use the other; for example, it may be much easier computationally just to use (b) to aim to select parameters that are intended to be upper bounds on how lossy the packet losses will be with reasonably high probability. Instead, another example is that one may ignore the “accuracy” of prior estimates and/or view these parameters not as estimates of future packet loss but as knobs for how to run the Streaming Encoder/Decoder; in this case, one can tune these parameters simply to optimize only for metrics of the quality of the call (e.g., frequency of video freeze, PSNR, SSIM, or LPIPS if the desired application is videoconferencing).

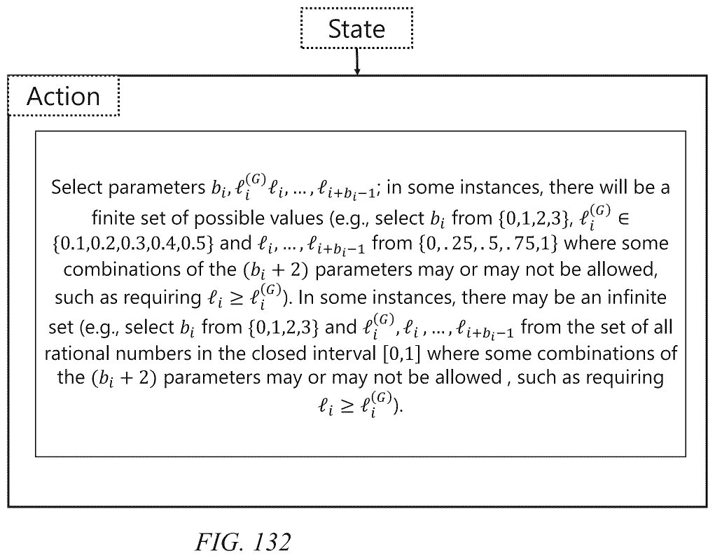

FIG. 132 shows one example for the action block of FIG. 129, in accordance with certain embodiments. The action may be taken as often as once a time slot. It may instead be less frequent; one example is to be periodic (e.g., every some fixed number of time slots), in which case feedback may or may not be returned to the streaming encoder that time slot (i+1) should maintain the estimate of bᵢ (e.g., bᵢ₊₁=bᵢ) and of

$${l}_{i}^{( G )} ( e . g . , {l}_{i + 1}^{( G )} = {l}_{i}^{( G )} )$$

and likewise not change the estimated parameter for the fraction of packets lost (e.g., l_{i+b}_{ᵢ₊₁}=l_{i+b}_{ᵢ₊₁}₋₁).

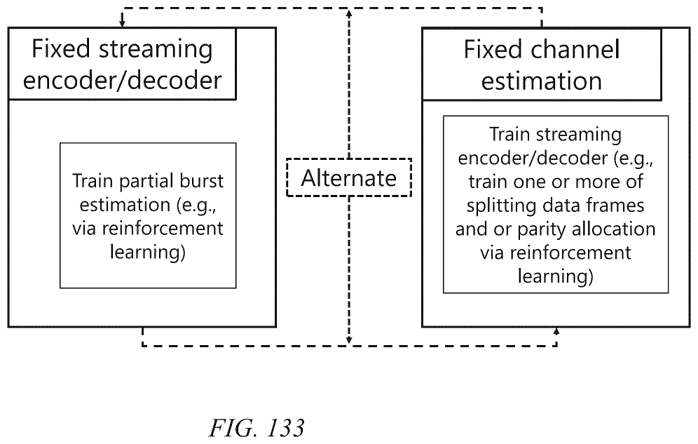

FIG. 133 shows an example of alternating training of (a) estimating the partial burst, and (b) the streaming code (e.g., splitting and/or parity allocation), in accordance with certain embodiments. Here, one methodology is introduced to synergize the actions for estimating the partial burst parameters and the streaming code (e.g., splitting). communication (e.g., splitting, spreading, splitting, and spreading, etc.). Alternate between (a) fixing partial burst estimation and optimizing the policy for communication (e.g., how to split data frames), and (b) fixing streaming encoder/decoder and optimizing the policy for estimating partial burst parameters. The optimization can be done using techniques from reinforcement learning. This can continue until the user is satisfied with performance.

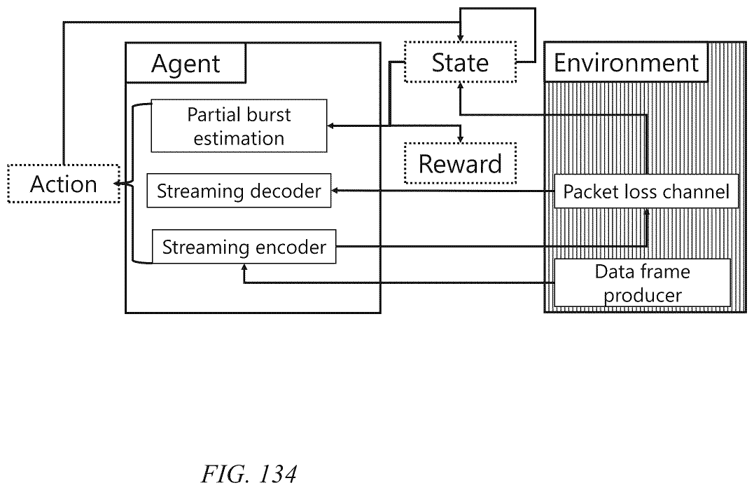

FIG. 134 shows an example of jointly training (a) estimating the partial burst, and (b) the streaming code (e.g., splitting and/or parity allocation), in accordance with certain embodiments. Here, the system jointly trains both (a) partial burst estimation and (b) the streaming encoder/decoder (e.g., splitting data frames and/or parity allocation by using the state to track all information tracked by the (a) state from the partial burst estimation and (b) the state from the streaming encoder, combining their two rewards (e.g., adding them), and letting actions be the combination of actions of the partial burst estimation and the streaming encoder/decoder. Reward might still only occur every time a packet is received. Or it may be once per time slot now that complete information about what packets were lost is now available.

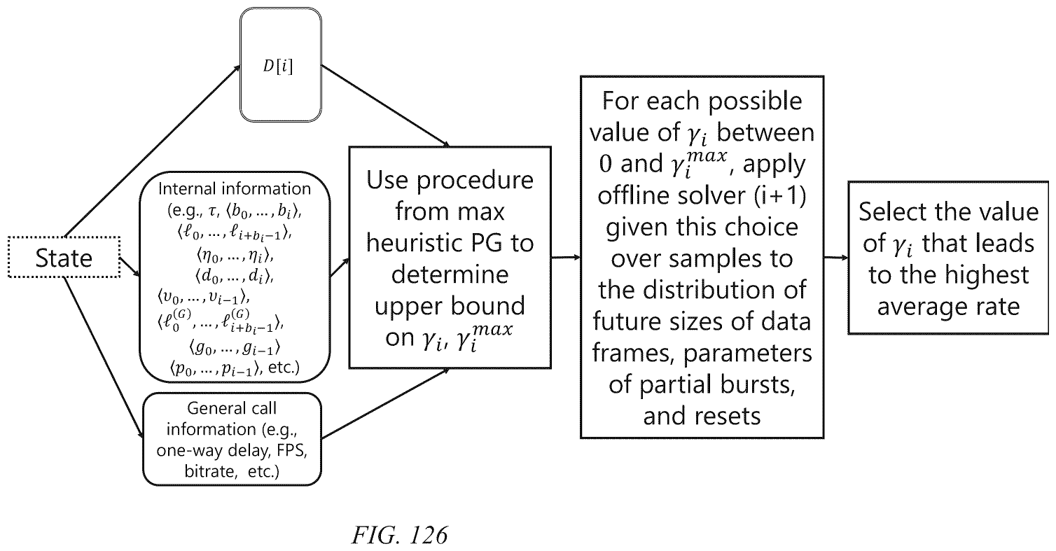

Another way to split frames is using stochastic optimization to split frames on-the-fly, for example, as depicted schematically in FIG. 126. The concept here is the same as in CSIPB, except for the additional internal information and the use of the CSIPBRAL offline solver and “max heuristic PG” heuristic.

Another way to split frames is using stochastic optimization to split frames on-the-fly, for example, as depicted schematically in FIG. 126. The concept here is the same as in CSIPB, except for the additional internal information and the use of the CSIPBRAL offline solver and “max heuristic PG” heuristic. In detail, one methodology to split data frames is to (a) first determine the range of suitable values of the size of the first component using the procedure from the max heuristic PG, (b) estimate the expected optimal offline rate given each possible choice of how to split the data frame by determining the empirical offline optimal rate over samples to the distribution of future information (e.g., sizes of future frames, parameters of partial bursts and partial guard spaces, etc.), and (c) choosing the value that has the highest empirical rate.

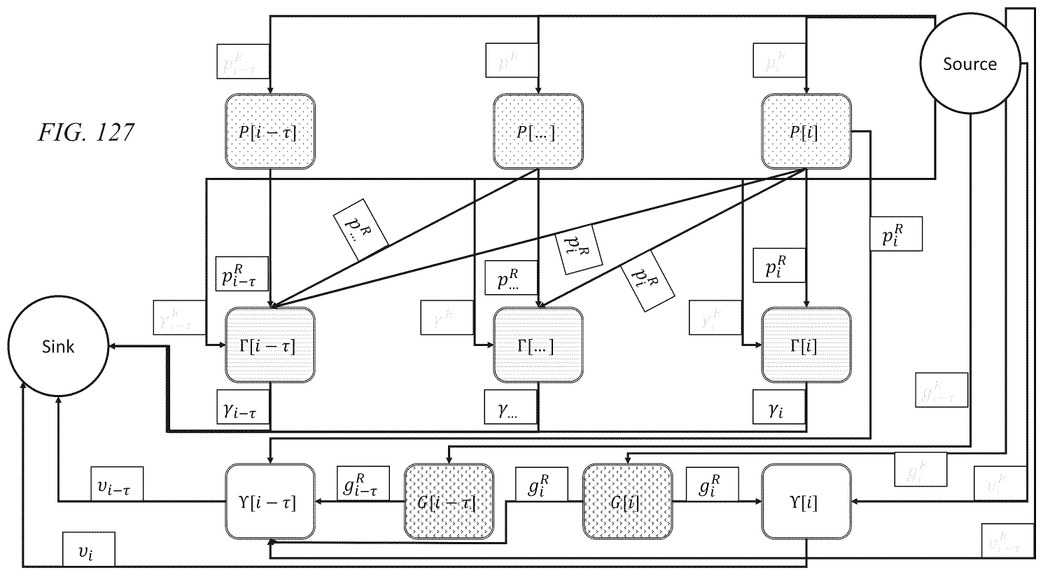

Certain embodiments can include a method to quickly determine if a data frame cannot be decoded, which can be used to avoid the expensive decoding operation (e.g., using Gaussian Elimination to solve a system of linear equations) unless the data frame is able to be decoded. FIG. 127 is a schematic diagram for a method to determine whether the lost data of the ith data frame can be recovered assuming the prior τ data frames have been recovered, in accordance with one embodiment. Here, decoding is represented using a flow graph. A maxflow can be computed (e.g., by using the Ford-Fulkerson algorithm) to determine whether decoding is possible. Essentially, the flow may reflect whether enough relevant parity symbols are received to decode each of Γ[i] and Υ[i]; based on the code's structure, this also necessitates recovering Γ[i+1] through Γ[i+τ] and Υ[i+τ]. For example, there may be four vertices (labeled as Υ[i], Γ[i], P[i], and G[i]) for each data frame to reflect the four quantities Υ[i], Γ[i], P[i], and G[i], respectively. A Source is connected to all vertices reflecting first type parity symbols for data frames i through i+τ, the vertices reflecting second type parity symbols for data frames i and i+τ, all vertices reflecting the first component of data frames i through (i+τ), and the first component of data frame i. Edge capacities are shown in the graph; for edges between Source and vertices representing a first or second component of a data frame, the capacity is the number of received symbols of that component of that data frame. For edges between the Source and vertices representing the first type parity symbols of a frame, the edge capacity is the number of received first type parity symbols of that data frame. For edges between the Source and vertices representing the second type parity symbols of a frame, the edge capacity is the number of received second type parity symbols of that data frame. Vertices representing parity are connected to the vertices reflecting data that was used to create the parity (i.e., if there was an edge between corresponding components of the factor graph). All vertices representing the first or second component of a data frame are connected to the Sink; the capacity of the edge from one such vertex to the Sink is the size of the corresponding component. A maxflow is computed (e.g., by using the Ford-Fulkerson algorithm). Decoding of data frame (i−τ) is deemed possible if and only if the flow to Sink is at least the sum of (a) the sizes of the first component of data frames i−τ through i plus (b) the sum of the size of the second components of data frames (i−τ) and data frame i.

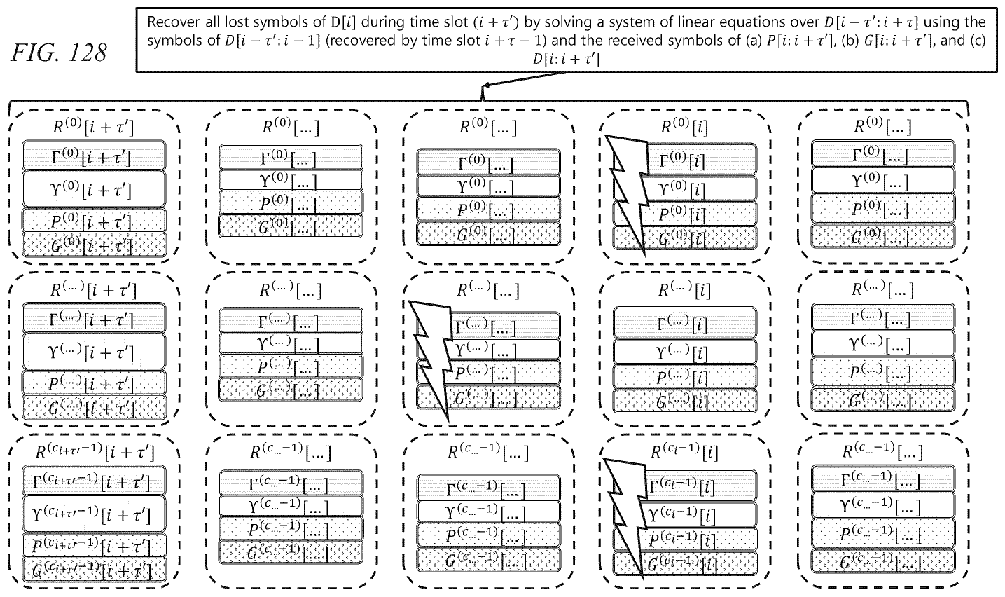

FIG. 128 shows an example of intended loss recover from the perspective of a frame when using a failsafe for CSIPBRAL, in accordance with certain embodiments. Here, the goal is to recover all lost symbols of D[i] during time slot (i+τ′) by solving a system of linear equations over D[i−τ′:i+τ′] using D[i−τ′:i−1] and the received symbols of (a) P[i:i+τ′], (b) G[i:i+τ′], and (c) D[i:i+τ′]. One way to do so is to use Gaussian Elimination to solve the system of linear equations. The symbols of D[i−τ′:i−1] are assumed to already be decoded by time slot (i+τ′). A complementary failsafe of sending feedback from the receiver to the sender to generate a keyframe (i.e., an uncompressed frame that does not depend on prior uncompressed frames) can be applied on top of the new failsafe by triggering the new keyframe when frame i has not been recovered (e.g., by some number of time slots, such as by time slot (i+τ′+1))—this extra failsafe is similarly applied as in CSIPB.

It should be noted that embodiments can be applied to batch encoding and decoding with striping, similar to CSIPB. For example, the same streaming encoder may be applied to all parts; for example, the streaming encoder may be the variant of CSIPBRAL with packetization #2, the heuristic for splitting data frames to minimize parity associated with each data frame, and a heuristic parity allocation (e.g., allocate roughly just enough parity symbols for p_{i+τ} to recover the missing symbols of Υ[i] when also using the received parity symbols of G[i] in the first type parity symbol allocation). Alternatively, a different streaming encoder/decoder could be used for each stripe (e.g., different randomly generated encoding matrices) such that both encoding and decoding can be done in parallel (i.e., at the sender and receiver, respectively); in this case, the “side information” generally would not be needed or used. Striping can be added to CSIPBRAL analogously to how striping is added to CSIPB (where striping is applied to G[i] under CSIPBRAL analogously to how striping was applied to P[i] under CSIPB).

It also should be noted that CSIPBRAL can be extended to include frame splitting into more than two components and/or to more than two types of parity symbols.

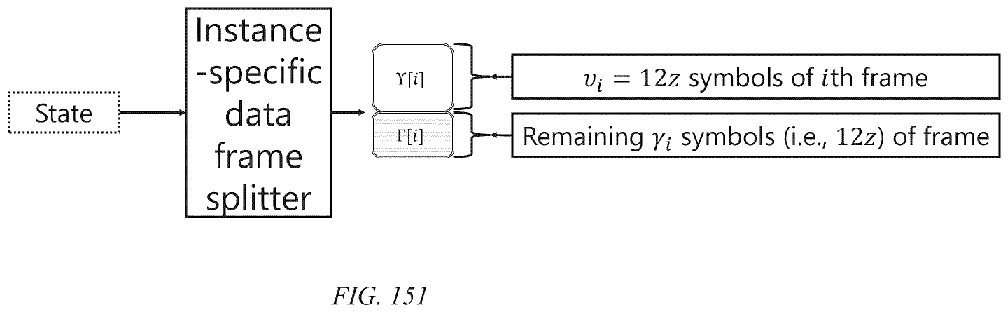

FIGS. 151-163 provide an example of frame splitting, parity generation, and packetization under CSIPBRAL, in accordance with certain embodiments. Merely for the sake of demonstration, it is assumed for this example that we intend loss recovery of one possible partial burst starting slot i=4 of length bᵢ=2 time slots followed by a partial guard space of τ=3 time slots. In this example, for all w∈{0,1,2,3,4,5,6,7,8,9,10,11}, b_{w}=2, lᵢ=⅔,

$${l}_{w}^{( G )} = 1 / 3$$

and for i∈{4,5,6,7,8}, the size of the ith frame is 24z for some positive integer z.

FIG. 151 shows an example frame splitting scheme for i∈{4,5,6,7,8} in which, for the sake of simplicity, it has been determined that 12z symbols are allocated to Υ[i] and the remaining 12z symbols are allocated to Γ[i]. Of course, the frames could be split differently including variably based on any criteria discussed herein (e.g., feedback from receiver, predictive analytics, etc.).

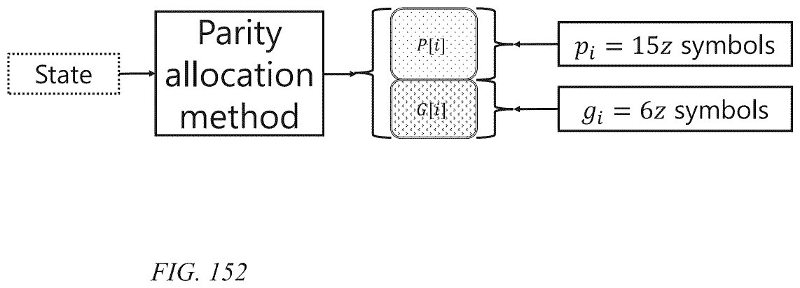

FIG. 152 shows an example of parity allocation for i∈{4,5,6,7,8} in which it has been determined that 15z symbols are allocated to P[i] and 6z symbols are allocated to G[i]. Of course, parity could be generated differently including variably based on any of the criteria discussed herein.

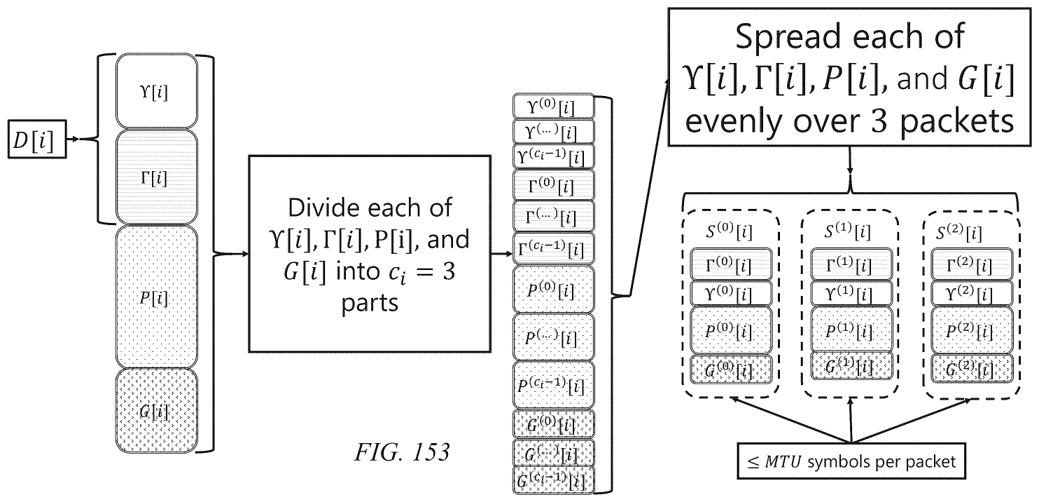

FIG. 153 shows an example of packetization for i∈{4,5,6,7,8}. In this example, it is assumed that 15z MTU. Three packets are sent (i.e., S⁽⁰⁾[i], S⁽¹⁾[i], and S⁽²⁾[i]), where each packet contains one-third of the symbols of each of Υ[i], Γ[i], P[i], and G[i]. This totals 15z symbols, which is assumed to be no more than MTU (to simplify the example). Under this packetization, the following conditions hold: (a) each packet's size does not exceed the maximum transmittable unit, (b) the number of packets times lᵢ is an integer (i.e., ⅔*3=2), and (c) the number of packets times

$${l}_{i}^{( G )}$$

is an integer (i.e., ⅓*3=1).

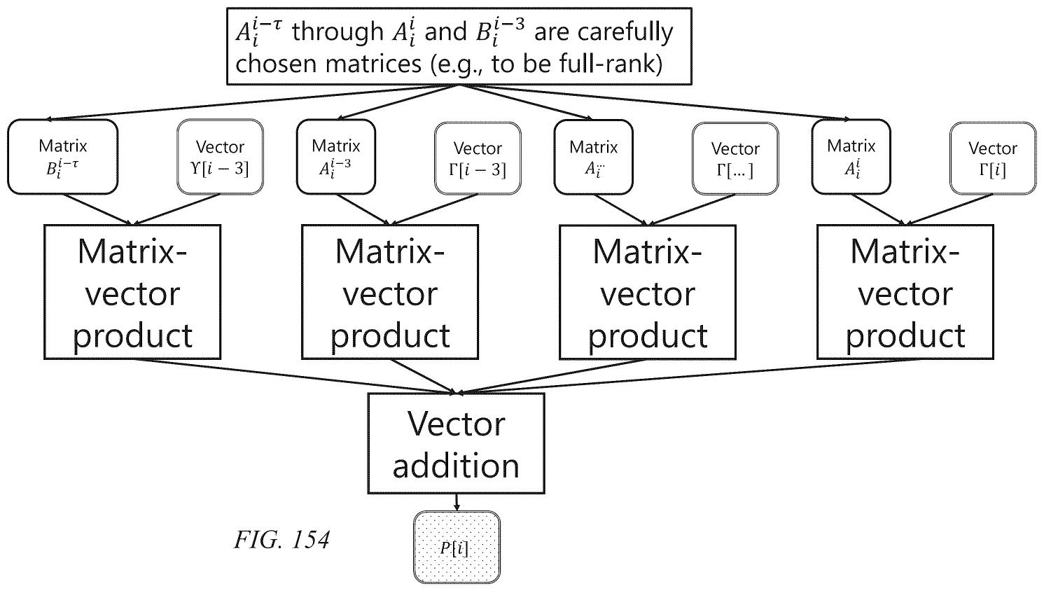

FIG. 154 shows an example of first type parity symbol generation for the ith time slot for i∈{4,5,6,7} with no failsafe.

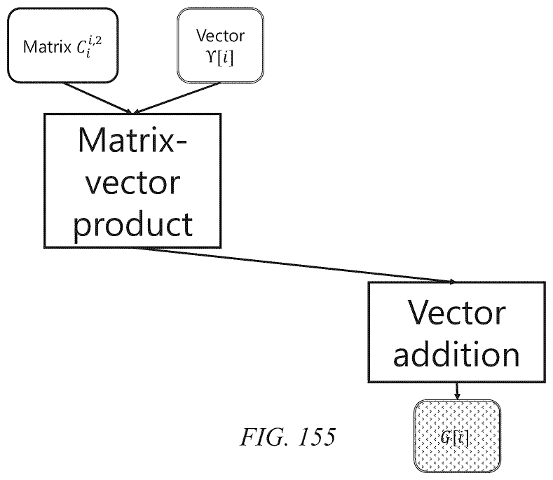

FIG. 155 shows an example of second type parity symbol generation for the ith time slot for i∈{4,5,6,7} with no failsafe. In this example, all Cᵢ^{j} i for j∈{i−τ, . . . , i} are the all-zero matrices and are not shown (i.e., the calculation is reflective of what is shown in FIG. 79 except with Cᵢ^{j} as the all-zero matrix for each j in {i−τ, . . . , i}).

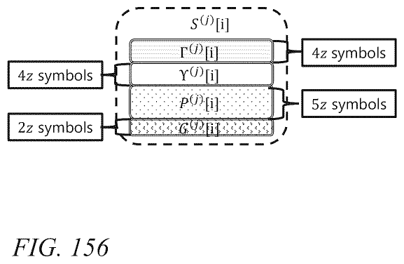

FIG. 156 shows an example of the sizes of the parts of the jth transmitted packet for frame i for i∈{4,5,6,7,8} and for j∈{0,1,2}. In this example, Γ[i] contains 4z symbols, Υ[i] contains 4z symbols, P[i] contains 5z symbols, and G[i] contains 2z symbols. Note that all frames are the same size in this example for simplicity of presentation. The sizes of the transmitted packets are each 15z where z is assumed to be a positive integer so that 15z is no more than one MTU. Stripes are not used in this example for simplicity, but stripes may be used (e.g., for any divisor of z).

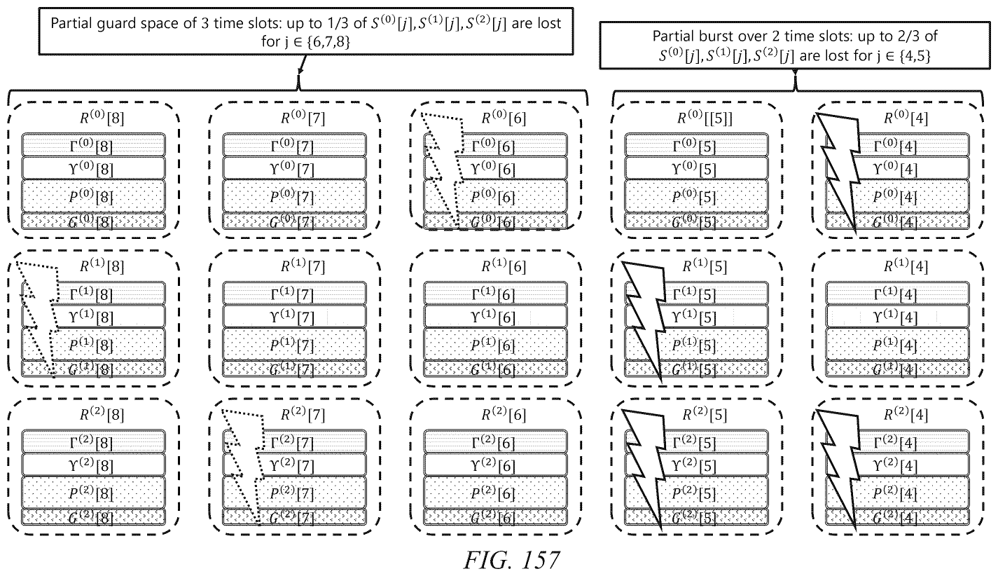

FIG. 157 shows an example partial burst loss for the above example in which there has been a partial burst over two time slots (i.e., time slots 4 and 5) where up to lᵢ packets are lost per time slot followed by a partial guard space of three time slots (i.e., time slots 6 through 8) where up to

$${l}_{w}^{( G )}$$

packets are lost per time slot. The convention is used of showing a lightning bolt with (a) a thick outline, and (b) an outline with dashes of squares to reflect the two respective types of losses (in partial burst vs in partial guardspace).

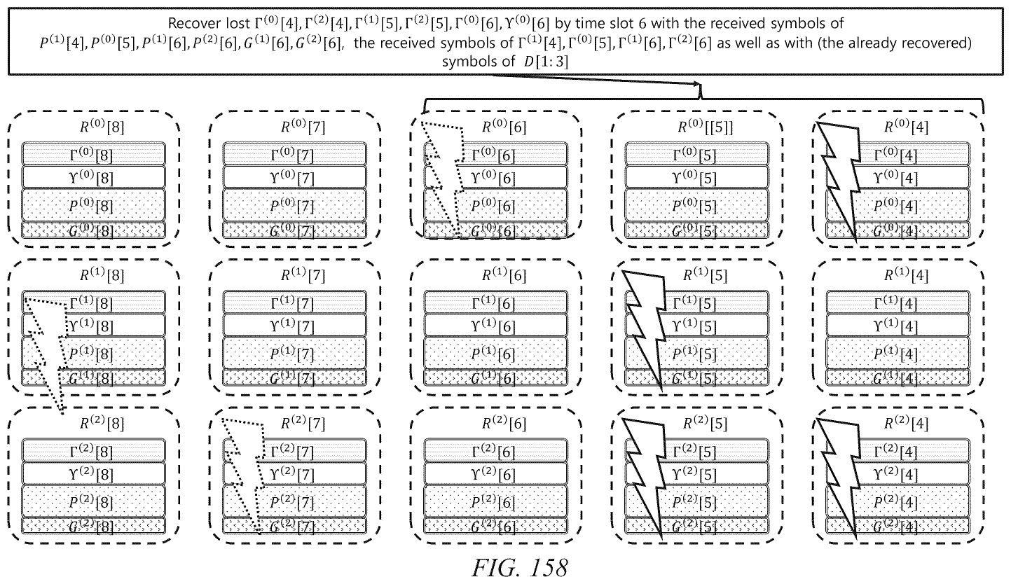

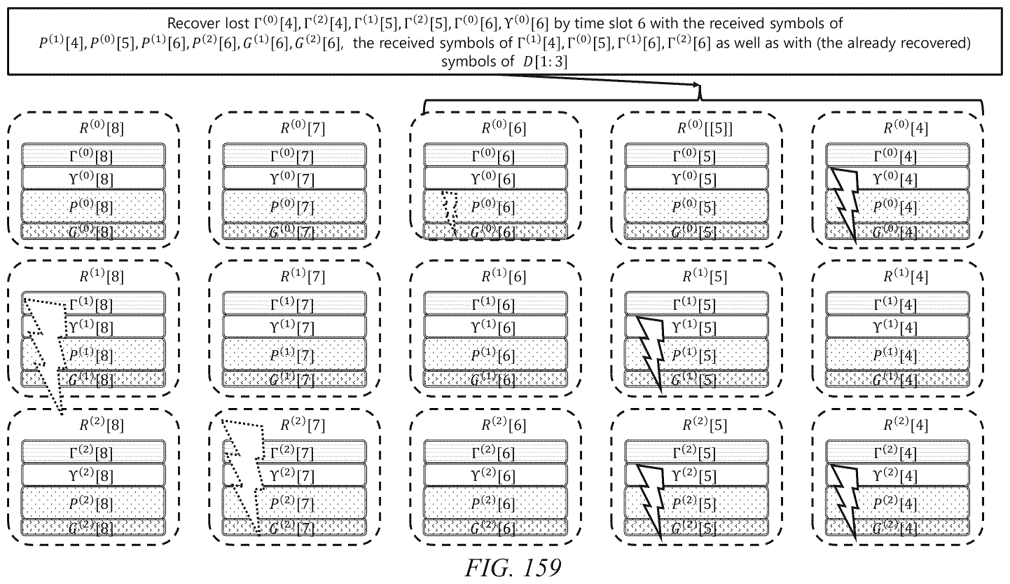

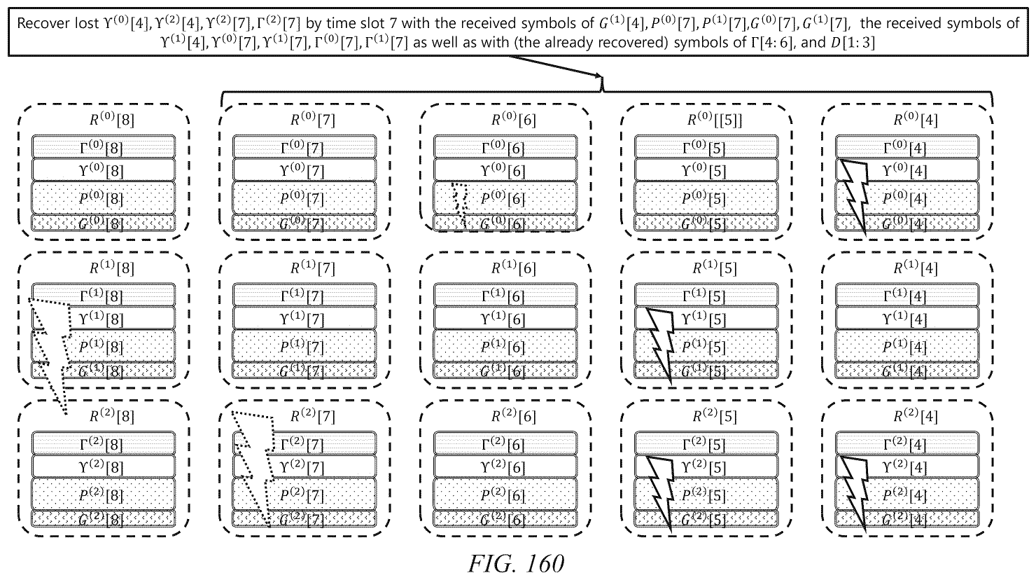

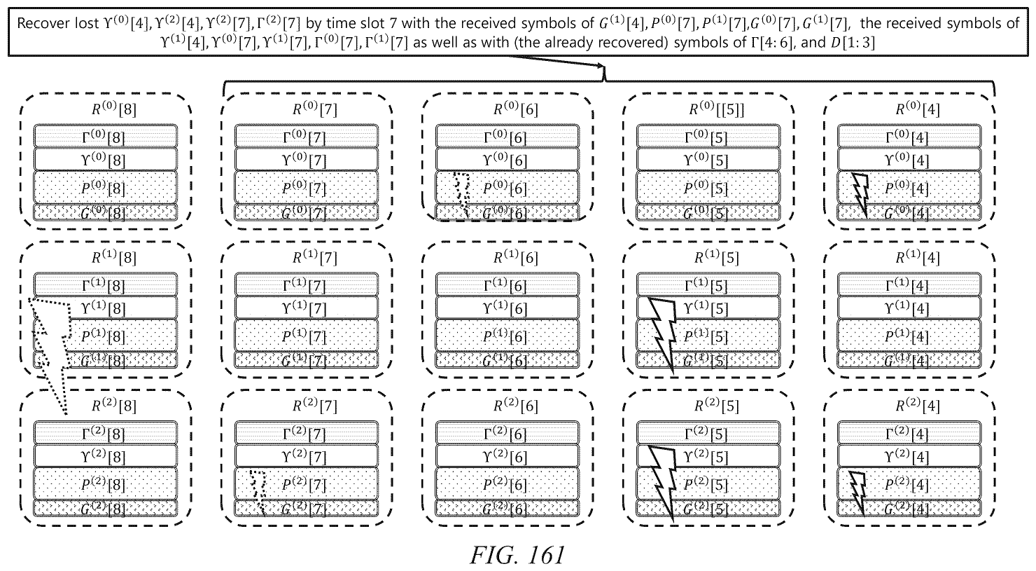

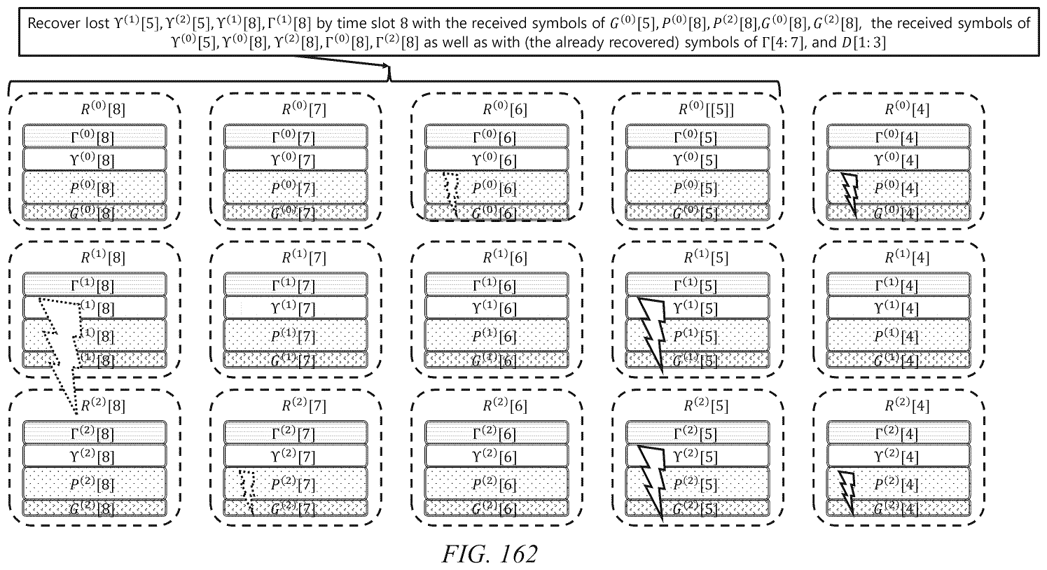

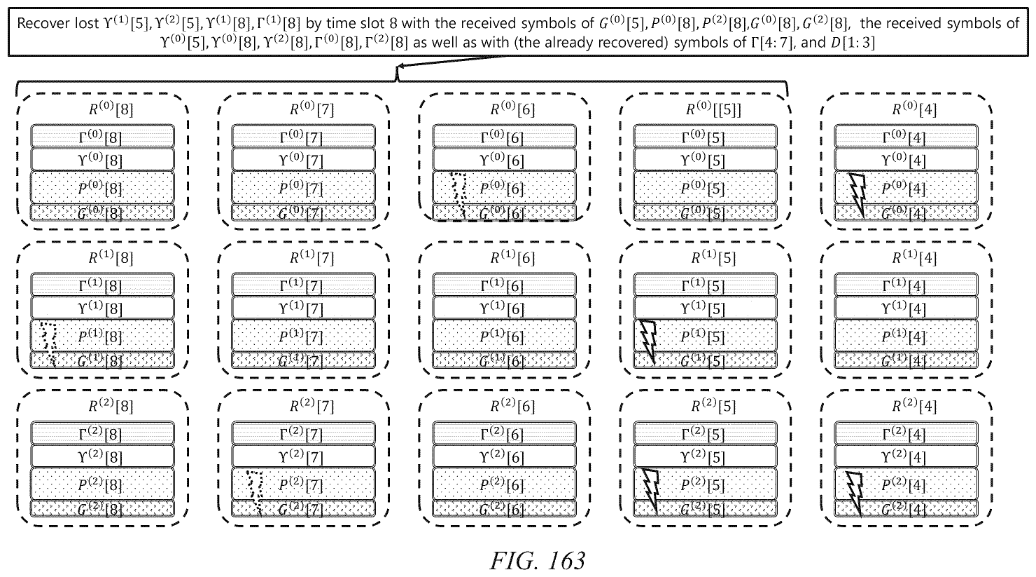

FIG. 158 shows an example of recovery of 24z missing symbols of the first components of frames 4, 5, and 6 (i.e., Γ[4:6]) and second component of frame 6 (i.e., Υ[6]) during time slot 6 using 24z received parity symbols (i.e., from P[4:6] and G[6]). After recovery during time slot 6, the remaining missing symbols (sent by time slot 6) are (a) lost parity symbols of P[4:6] and G[4:6], and (b) lost data symbols of Υ[4:5], as depicted in FIG. 159. As depicted in FIG. 160, there are 12z missing symbols of the second components of frames 4 and 7 (i.e., 8z from Υ[4] and 4z from Υ[7]) and 4z missing symbols of the first component of frame 7 (i.e., Γ[7]) which are recovered during time slot 7 using 16z received parity symbols of P[7], G[7], and G[4] (which provide 10z, 4z, and 2z symbols, respectively). After recovery during time slot 7, the remaining missing symbols (through time slot 7) are (a) lost parity symbols of P[4:7] and G[4:7] and (b) lost data symbols of Υ[5], as depicted in FIG. 161. Additionally, there are 12z missing symbols of the second components of frames 5 and 8 (i.e., 8z from Υ[5] and 4z from Υ[8]) and 4z missing symbols of the first component of frame 8 (i.e., Γ[8]) which are recovered during time slot 8 using 16z received parity symbols of P[8], G[8], and G[5] (which provide 10z, 4z, and 2z symbols, respectively), as depicted in FIG. 162. As depicted in FIG. 163, by the end of time slot 8, all data has been recovered for D[4:8]. Note that some of the parity symbols may be recoverable from the recovered data but are still marked as missing for simplicity in this example.

Heuristic with No Second Component

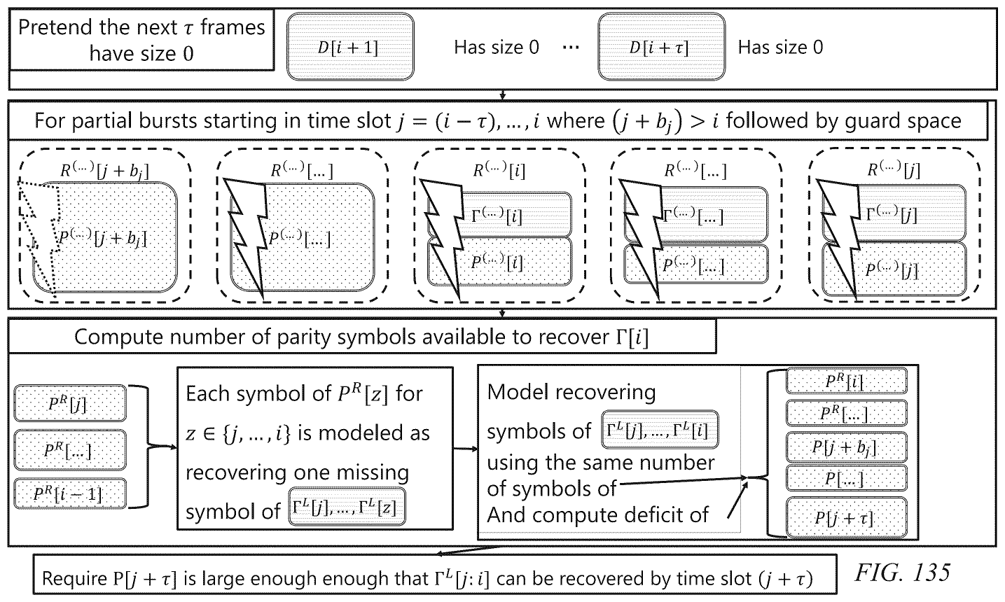

FIG. 135 illustrates another heuristic for encoding data frames to minimize parity associated with each data frame i by allocating all symbols to the first component (i.e., Γ[i]=D[i] for each time slot i). This heuristic can be applied to both CSIPB and CSIPBRAL, i.e., to both scenarios of (a) guard spaces, and (b) partial guard spaces.

This heuristic may be combined with the following heuristic for allocating parity symbols with guardspaces: temporarily set p_{i+τ}=0 and assume that kᵢ₊₁, . . . , k_{i+τ} are all zero. For each time slot i, for each time slot j between (i−τ) and i (inclusive), increase the number of parity symbols to be sent at the deadline (p_{j+τ}) by as little as possible so that the following holds. For any partial burst starting in time slot j, the number of received data symbols during the partial burst, plus the number of useful parity symbols received during the partial bursts, plus the number of parity symbols received after the partial burst by time slot (j+τ) is at least the number of data symbols from frames j through i

$$( i . e . , {Σ}_{z = j}^{i} {k}_{z} ) .$$

One way to determine how to encode data frames is to use a heuristic that determines the size of the first component contains all symbols of a frame. Then the heuristic for pre-allocating parity symbols can be as follows. Here, the system essentially pretends that the next τ frames are of size 0 (i.e., kᵢ₊₁=0= . . . =k_{i+τ}) and that p_{i+τ}=0. Next, for each time slot j=i−τ, . . . , i where a partial burst starting in time slot j can encompass time slot i, consider a burst starting in time slot j should be as large as possible subject to the following constraint. Suppose the next τ frames have size 0. For any partial burst that includes the current time slot, then all symbols of the first component that are lost in the partial burst are recovered by τ time slots after the start of the partial burst with high probability.

Note that in the scenario of a partial guard space, a guard space (not a partial guard space) is assumed; the reason is that a partial guard space would lead to only using the pre-allocated parity symbols of P[z] in time slots z=i+1, . . . , j+τ−1 and that they are all received; in the event that

$${l}_{z}^{( G )} > 0$$

then the number of parity symbols of P[z] would be increased until the number that are received and available to recover D[i] (i.e., not used to recover lost symbols of D[z]) match the number that are pre-allocated under certain embodiments.

### Multimodal CSIPBRAL

As discussed above, CSIPBRAL has been designed to address the issue of loss recovery when there are losses during τ time slots under a partial burst, for example, by adding a new extra type of parity symbol, G[i], and by implementing a two-stage parity allocation process. However, similar to the ability to use lᵢ, bᵢ as “tuning knobs” in CSIPB, parameters such as lᵢ, bᵢ,

$${l}_{i}^{( G )}$$

can be used as “tuning knobs” in CSIPBRAL rather than as merely parameters of burst. Among other things, such tuning would allow implementations of CSIPBRAL to effectively support or switch between a CSIPBRAL mode in which the second (or third, fourth, fifth, etc.) type of parity is used and a CSIPB mode in which only the first type of party is used (e.g., by setting

$${l}_{\dot{t}}^{( G )} = 0 ∀ i$$

and gᵢ=0 for all i, the partial guard space of CSIPBRAL effectively becomes a guard space as in CSIPB with the encoder operating substantially as a CSIPB encoder). Such multimodal operation can be controlled, for example, based on feedback from the receiver indicating whether or not protection for partial guard space losses is needed.

More generally, embodiments can support any of the various frame splitting mechanisms (e.g., heuristics) and/or any of the various parity allocation mechanisms to address virtually any performance goal, e.g., actual losses, predicted losses, bandwidth constraints, or other performance goals.

### FEC-Aware Compression and Compression-Aware FEC

Consider a call comprising a sequence of t uncompressed frames, U[0:t]. Suppose during time slot i=0, . . . , t that the uncompressed frame is compressed into data frame D[i], and then some protocol is used to communicate D[i] reliably (with sufficiently high probability) over a lossy channel. Suppose that the protocol for reliably communicating D[i] typically involves sending a number of symbols that depends on the size of D[i], the sizes of one or more prior data frames, and the number of symbols sent during one or more previous time slots. For example, D[i] might be communicated directly, plus some additional parity symbols might be send to ensure loss-recovery of the symbols of D[i] in a timely manner with high probability

This scenario is common in a large class of coding schemes, including but not limited to CSIPB and CSIPBRAL. Under existing methods, one would typically compress the uncompressed frames independently of the protocol used to communicate reliably. For example, this could be done for an application like videoconferencing using CSIPB combined with a video codec.

Certain embodiments coordinate the two components of (a) compression, and (b) reliable communication, particularly by designing the compression to fit into the reliable communication scheme. The intuition is as follows. Consider CSIPB and during time slot i allocating parity symbols to be sent i time slots later so that just enough are received to recover symbols of the second component of data frame i that may be lost in a partial burst. If one increases the size of some data frames, the second component of those data frames will be increased by some amount, causing the number of parity symbols allocated during time slot i to increase. But increasing the size of other data frames may lead to increasing only the size of the first component (i.e., maintaining the size of the second component); this can mean that no extra parity symbols are allocated (e.g., if the future frames are small and also can allocate all data to the first component without sending additional parity symbols). Increasing the sizes of some data frames and decreasing others may lead to (a) the same amount of data being sent while (b) less parity symbols are sent. Either these savings in bandwidth could be realized, or the extra bandwidth could be reallocated to increase the sizes of other data frames, leading to more data being sent with the same bandwidth usage overall. Alternatively, given that the process leads to lower bandwidth utilization overall, one could then send additional parity symbols (e.g., by setting the channel parameters more conservatively) to attain higher reliability without increasing the overall bandwidth utilization.

Therefore, certain embodiments enable optimizing compression to synergize with FEC for real-time communication. One example of how this can be done includes optimizing for the amount of transmitted data after FEC is applied rather than optimizing for size of data frames, e.g., by selecting the size of a data frame based on properties of the FEC scheme. To do so, one could leverage results from existing work on compression (e.g., “Learned Video Compression”), which has designed “spatial rate control” where one can specify for a data frame what the bitrate should be for compressing different spatial regions of the data frame.

Another example of how this can be done includes optimizing for a sequence of data frames that lead to a high QoE after packet loss followed by FEC decoding.

Another example of how this can be done includes informing the FEC scheme about how to tune its parameters (knobs) to best synergize with compression (e.g., under CSIPB and/or CSIPBRAL, indicating to the encoder which parts of the data frame are needed sooner and should be allocated or the first component to have the potential to be recovered sooner, versus which parts are acceptable to recover later and might comprise the second component.

Another example of how this can be done includes spreading information over one or more additional time slots. For example, the spreading of information content could involve creating a compression to provide a less refined version of the data now and during one or more later time slots sending along extra information to refine the prior information. One way to do this is to send a compression that is decompressed to a blurry image now and later send extra information that can fill in the blurry parts to make them crisp. This is known, as sometimes compression can lead to multiple layers where some layers are more important than others and/or some layers are not needed to decode an estimate of the uncompressed frame (these layers merely refine the estimate). Another way is to defer compressing some information now and instead compress it later (making the data frame smaller and a later data frame bigger); for example, for a video, during compression, leave a spatial portion of the image (e.g., the upper rightmost part) to be blurry for the ith data frame but then during compression of the (i+1)th uncompressed frame ensure that the compression provides information about this previously-blurry spatial portion (e.g., refining that portion so that its image is clear); then for later uncompressed frames (e.g., uncompressed frame (i+2)) the added information about that spatial location for uncompressed frame (i+1) will be used in compression. Another technique is to build upon existing work (e.g., “Learned Video Compression”), which has designed “spatial rate control,” by allocating the data for one or more stable and/or less important region(s) to be sent later. This spreading can be applied under any FEC scheme and packet loss channel, including CSIPB with partial bursts then guard spaces and/or CSIPBRAL with partial bursts then partial guard spaces wherein only some packets per time slot may be lost.

Prior work of the inventor has shown how to spread some number of symbols of each data frame over the transmission of its time slot and one or more additional time slots (in particular, up to τ_{L} time slots, where the model assumes that one can wait up to τ_{L} extra time slots to recover any data of a data frame even when there are no losses); this involved selecting the symbols to be spread without regard to the structure of the compression, which is why all such symbols may need to be recovered before obtaining any information about the current data frame. This approach of spreading has only been applied to a setting where all or no data of a data frame is received based on packet losses. Also, this prior work did a different (less general) form of spreading where it spread arbitrary symbols (or the first or final bunch of symbols) rather than spreading information. The approach applies on top of existing compression/decompression methods to tune them to make them synergize well with FEC.

The following is a supplemental glossary for the following data compression discussion:

| Term | Definition |
|---|---|
| Target size | The objective for the size of the data frame |
| | (e.g., D[i]) |
| Primary | The objective for how many symbols should be sent |
| target size | for the current uncompressed frame in the data frame |
| Secondary | The objective for how many symbols should be created |
| target size | to be sent over one or more later time slots to |
| | provide additional information about the current |
| | uncompressed frame |
| D′[i] | The combination (e.g., concatenation) of two |
| | components of a compression of the current |
| | uncompressed frame (and potentially previous |
| | uncompressed frames): the primary target size symbols |
| | that are to be sent during the current time slot and |
| | the secondary target size symbols that are to be sent |
| | later |

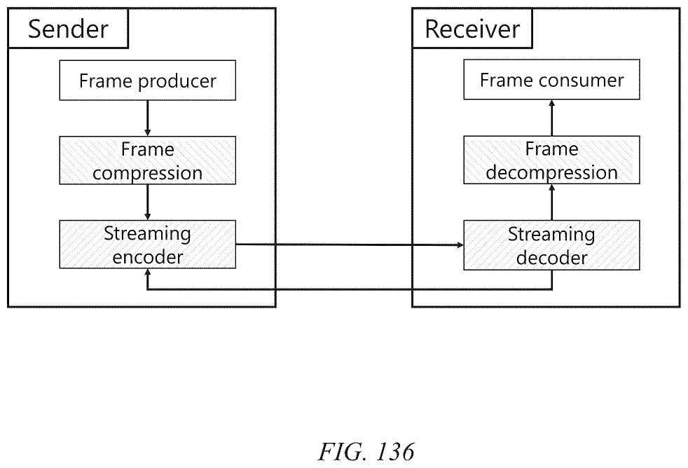

FIG. 136 is a schematic diagram of a data compression system, in accordance with certain embodiments. Under existing works, the following is standard. First, uncompressed frames are created by an application (e.g., shown as frame producer), then they are compressed independently of the communication scheme. The communication scheme (i.e., streaming encoder/decoder) is applied. Afterwards, at the receiver, decompression is applied to the (recovered) data frames. Hence, compression is usually viewed by the streaming code communication scheme as a black box. Often lossy compression is used, resulting in a decompressed frame that only approximates the original uncompressed frame.

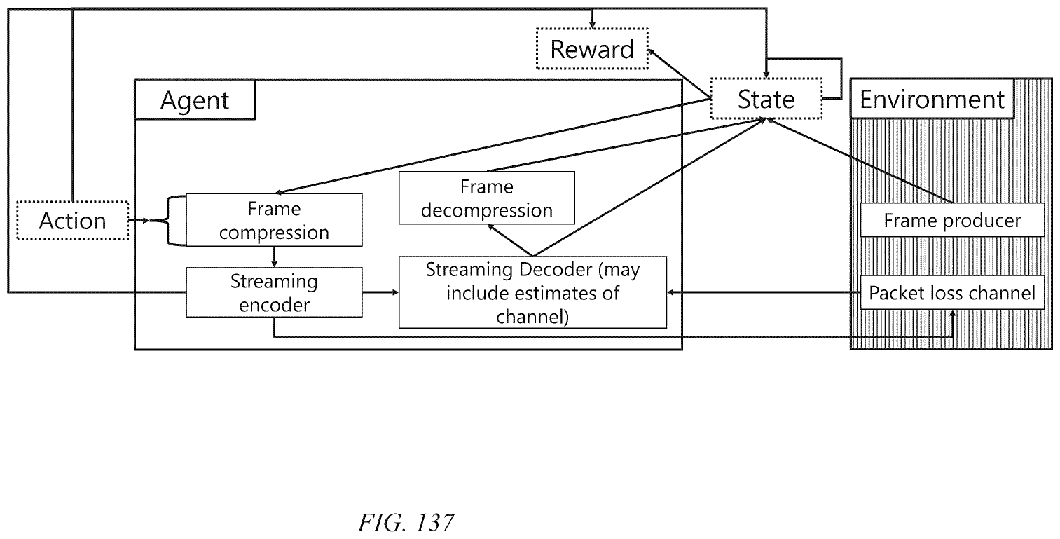

FIG. 137 illustrates treatment of compression as a reinforcement learning problem, in accordance with certain embodiments. Here, a new methodology is introduced to combine frame compression-especially lossy frame compression—with the communication scheme (e.g., erasure code). The key intuition is that (a) the marginal value of an extra symbol in a data frame (i.e., a data frame) can vary from frame to frame and/or within each frame, and (b) the marginal cost in terms of the number of extra parity symbol(s) sent as a result of increasing the size of a data frame (i.e., size of a data frame) also can vary from frame to frame and/or within each frame. Our approach enables synergizing compression with the communication scheme (e.g., parity symbol allocation), leading to more useful information being communicated per bandwidth consumed (i.e., the number of symbols sent).

To do so, compression is modeled here within a framework reminiscent of reinforcement learning. An uncompressed frame is created and then compressed by an agent as its action; the compression may cause the data frame to depend on earlier data frame or not (e.g., make the new data frame from compressing a new keyframe). Then a communication scheme (e.g., CSIPB) is applied to communicate the (now compressed) data frame from one or more sender(s) to one or more receiver(s). A reward is obtained based on the action and state of the system. For example, the reward may combine (a) application-level benefits of having extra symbols within the data frame with (b) costs such as bandwidth usage (including data and parity symbols sent under the communication scheme) and consequences arising from this usage (e.g., sending too much data may incur loss by overflowing the buffer(s) of network router(s)). In certain embodiments, the application-level benefits may be measured using metrics of QoE like freeze rate, latency, PSNR, SSIM, or LPIPS (where freeze rate may be reduced by allocating some of the bandwidth savings to sending extra redundancy via setting more conservative estimates of channel parameters). The environment reflects (a) how an application produces uncompressed frames (e.g., the underlying world that is being captured by the video), and (b) how packets may be lost. The state reflects the situation and may include information like previous uncompressed and data frames, how many packets have been sent, what sizes were the packets that have been sent, etc. Then one can use methods from reinforcement learning to solve for a suitable policy for how the uncompressed frame should be compressed (e.g., what size to target for the compression).

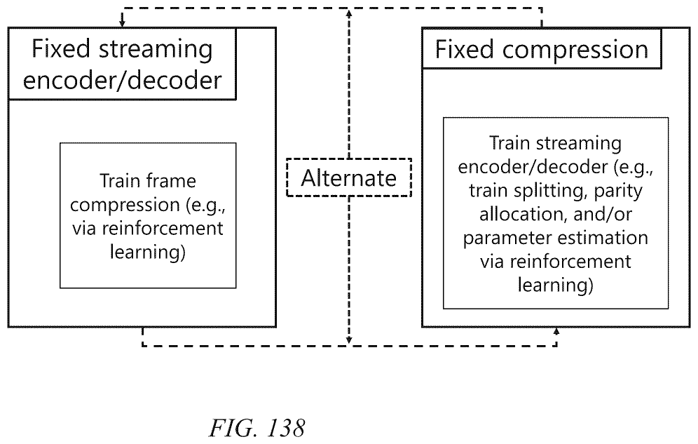

FIG. 138 shows the concept of alternating training of compression and streaming code (e.g., splitting, parity allocation, etc.), in accordance with certain embodiments. Here, a second methodology is introduced to synergize the actions for compressing frames and communication (e.g., splitting, parity allocation, etc.). Alternate between (a) fixing compression and optimizing the policy for communication (e.g., how to split data frames, how to allocate parity symbols, etc.), and (b) fixing communication and optimizing the policy for compression. The optimization can be done using techniques from reinforcement learning. This can continue until the user is satisfied with performance.

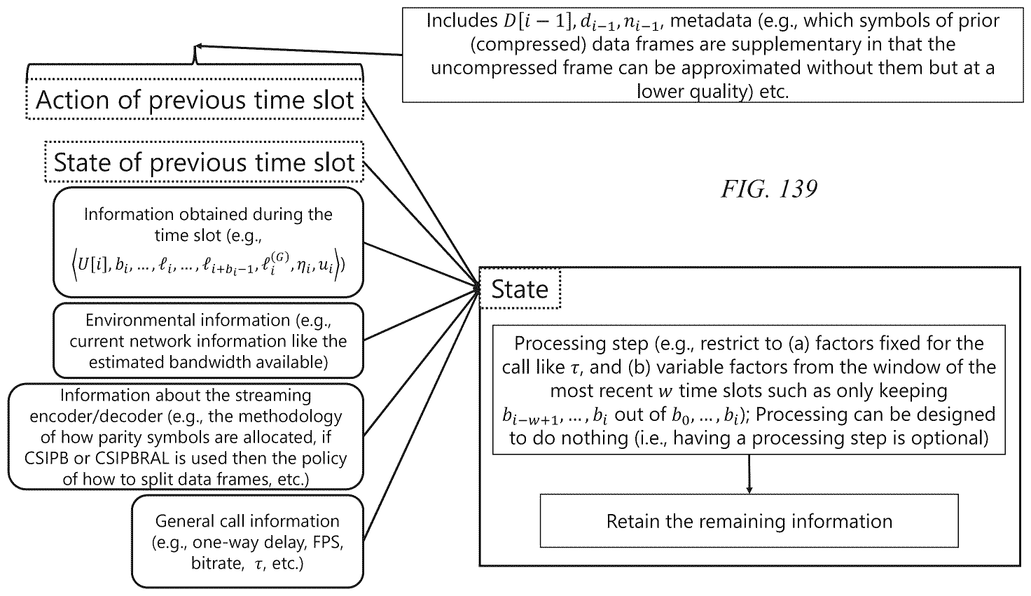

FIG. 139 illustrates updating the state during the ith time slot, in accordance with certain embodiments. Here, the state is meant to capture the situation; by assumption, the state can track any piece of information pertaining to the system, although some may not be tracked in certain embodiments (as can be accomplished via the processing step). To aid in the compute costs of reinforcement learning (e.g., to avoid the curse of dimensionality), some information may be dropped. Also, one may reduce the number of possible states by reducing the granularity of information (e.g., list the number of symbols of each component and/or parity symbols sent per time slot as integral multiples of a number, like 100, and applying rounding). The Action of previous time slot (i−1) includes D[i−1] and dᵢ₋₁.

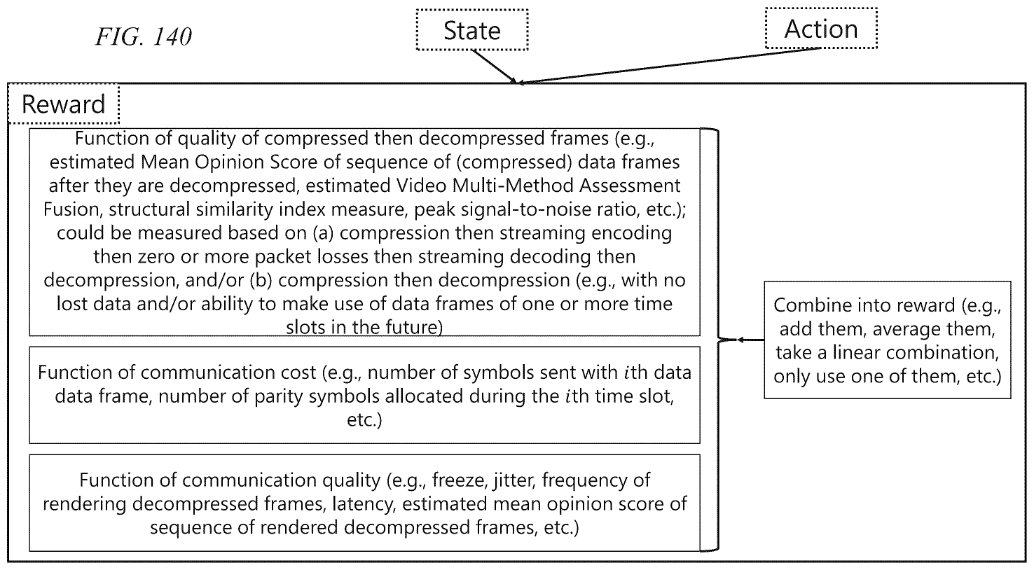

FIG. 140 shows an example of a possible type of reward function, in accordance with certain embodiments. Here, there are three main intrinsic sources of reward (a) the quality of the compression then decompression (with and/or without the added component of decompressing occurring after streaming encoding, packet losses, then streaming decoding), (b) the communication cost, and (c) the quality of the received data (which can include measures of the QoE like latency of recovered frames). Here, a reward function is used that somehow combines these three factors. For example, a function (e.g., a metric) can be created to measure the value/costs of an action for each metrics. Then, a second function can be created to combine these three factors into a reward.

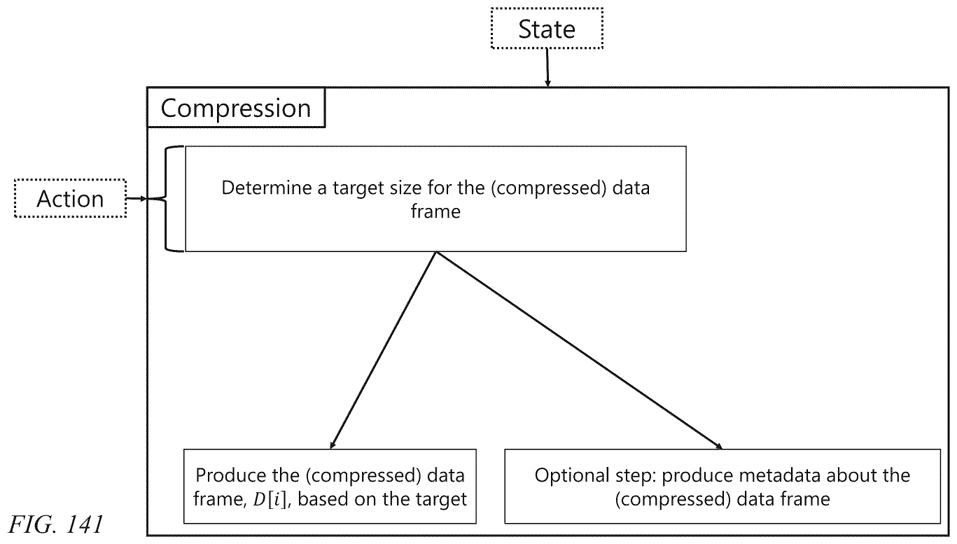

FIG. 141 shows one possible compression scheme, in accordance with certain embodiments. Compression may follow in two main stages: first, identifying a target size for how large the (compressed) data frame should be. Second, compressing the data frame to obtain D[i] based on the target size. One possibility is to estimate the reward for each possible target size and to take the best option. Determining the target may involve examining the state and anticipated reward. For example, considering the bandwidth estimate of the network, how many symbols were sent over the last several time slots, parity allocated for future data frames, point of diminishing returns for how many symbols it takes to accurately compress the uncompressed frame, etc.

There is an optional stage of determining metadata about the compression. For example, if certain symbols reflect a layer of encoding that is supplementary to the rest of the symbols but not needed, identifying them may be useful for the streaming encoder/decoder. One methodology this may be useful for the streaming encoder/decoder occurs under CSIPB or CSIPBRAL wherein the supplementary symbols may be placed in the second component rather than the first to lead the non-supplementary symbols to take up the first component; in certain scenarios, this will lead to the non-supplementary symbols being recovered sooner (e.g., when the first component is recovered sooner). This metadata could be included in D[i] itself and/or in some sort of header so that it can be used (a) in the streaming encoder/decoder (e.g., if CSIPB or CSIPBRAL it may be used to ensure the symbols of earlier data frames are placed in the first component), and/or (b) in the decompression step. To avoid this step (if electing to not do the optional step), one can simply make the metadata empty.

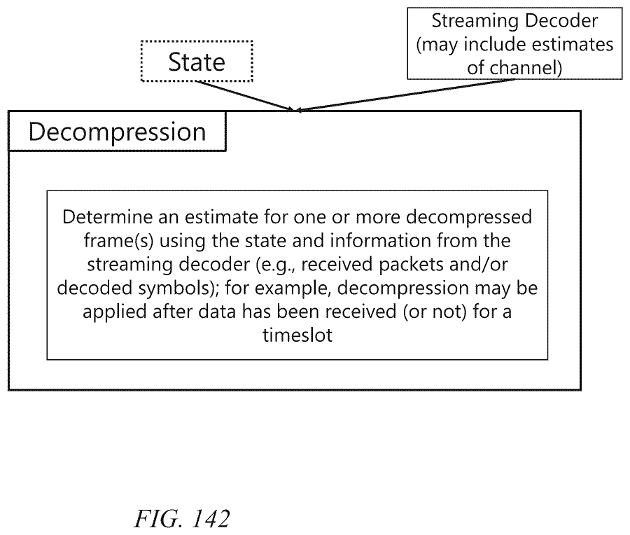

FIG. 142 shows one possible decompression, in accordance with certain embodiments.

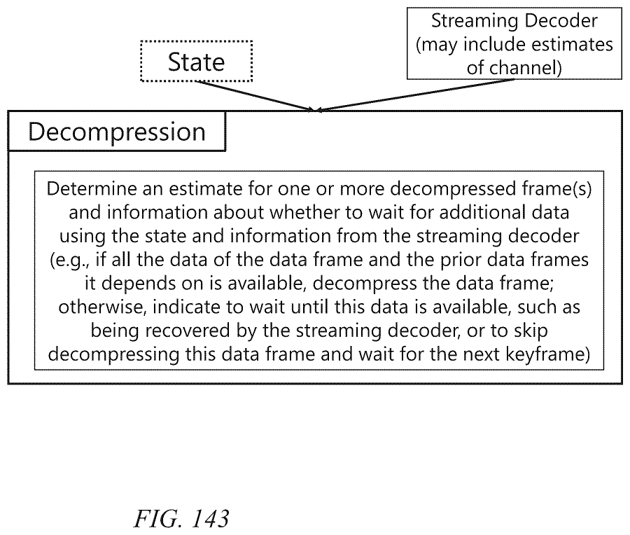

FIG. 143 shows another possible decompression allowing for flagging to wait to decompress until more data is available (e.g., decoded), in accordance with certain embodiments.

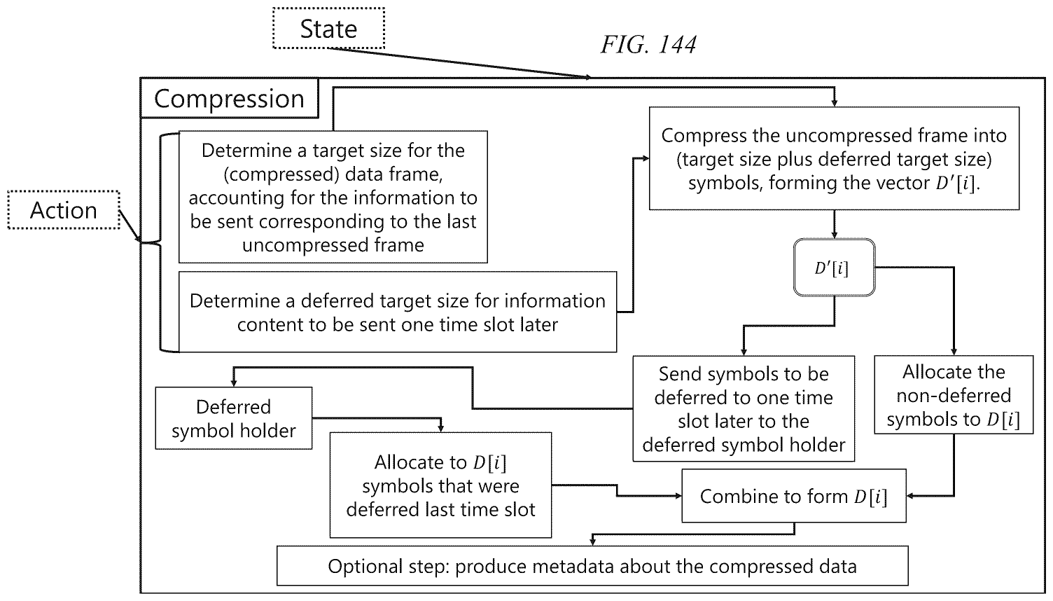

FIG. 144 illustrates spreading information content as a simplified approach, in accordance with certain embodiments. The idea here is to compress a frame into (a) a part to be sent now of some size and (b) a part to be sent later to help refine the decompression of the frame given the other part. Then the second part is spread to the next time slot and the current part is sent during the same time slot. This spreads information content, not just symbols, as the first part is useful on its own. One example from video is to send a pixilated version of the image as the first part and then the second part is used to refine the image (i.e., reduce the pixilation); in the literature, this may be referred to as compression with multiple layers where one more (less important) layer(s) are allocated to the second part and the rest is/are allocated to the first part.

Here, the example for spreading information content over one additional time slot is shown, but the general approach may defer this information over multiple time slots; When using CSIPB or CSIPBRAL, one may select the deferred target size so that those symbols can fit into the first component and use the metadata to indicate to place the deferred symbols into the first component; one benefit of doing so for certain embodiments is that information content is available by the playback deadline of the current uncompressed frame.

There is an optional step of producing metadata; for example, it may provide information about the divide between new and old information content in D[i]; This metadata could be included in D[i] itself and/or in some sort of header so that it can be used (a) in the streaming encoder/decoder (e.g., if CSIPB or CSIPBRAL it may be used to ensure the symbols of earlier data frames are placed in the first component) and/or (b) in the decompression step.

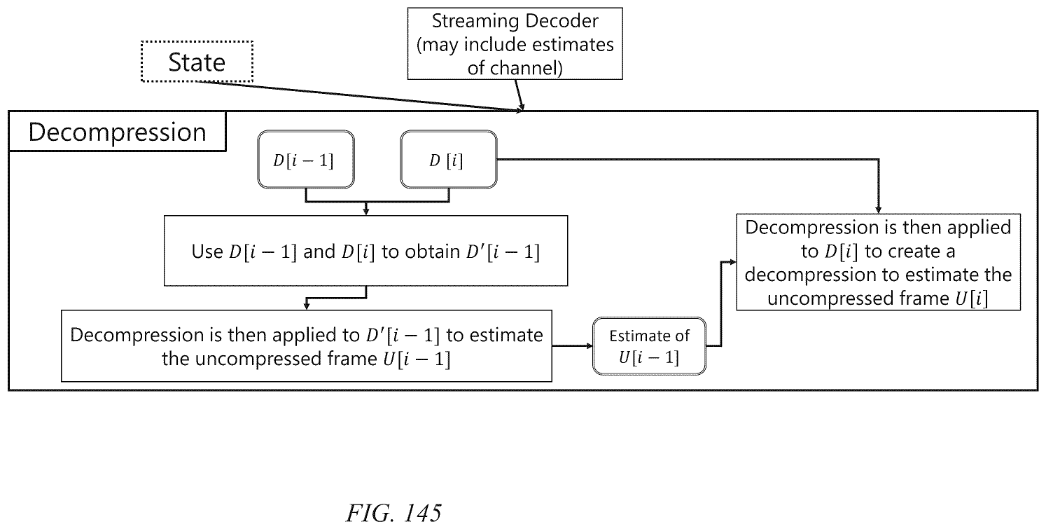

FIG. 145 illustrates decompression after spreading information content. Decompression first improves the decompression of the previous data frame and then uses it to have a better estimate when decompressing the current data frame. This is the decompression step during time slot i; due to loss recovery, this may be applied just before one or more decompressed frames prior to i are rendered. Here, the example for decompressing information content that was spread over one additional time slot is shown, but the general approach may be used for decompression when the information is deferred over multiple time slots.

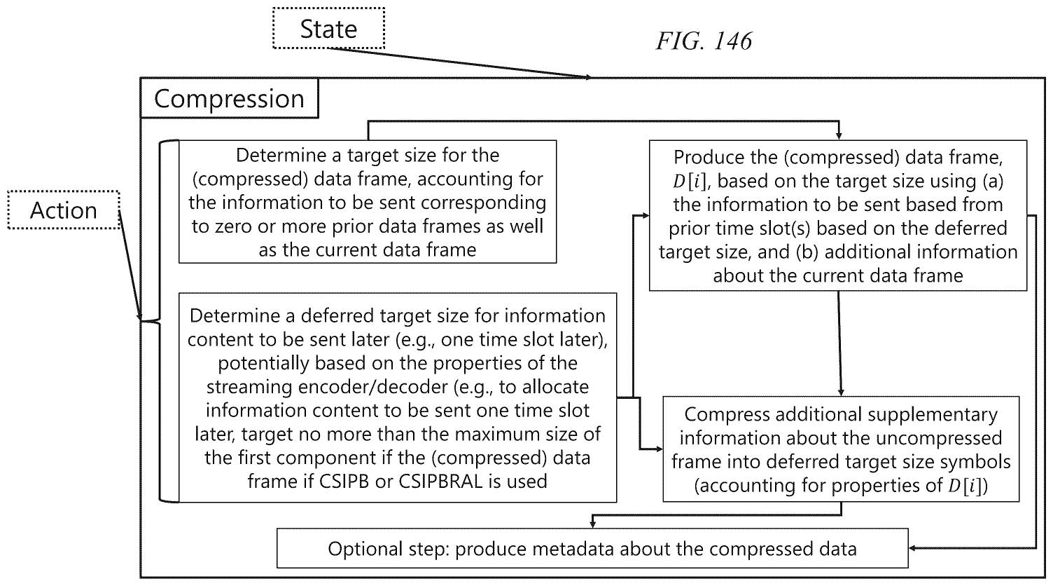

FIG. 146 shows one possible compression to spread information content: create information and then spread some of it until later by deferring sending it. Compression may involve (a) compressing information about the current uncompressed frame into symbols to be sent during the same time slot, and (b) compressing information about the current uncompressed frame to be sent at one or more later time slot(s) (e.g., during the next time slot). This may occur in two stages: (1) identifying a target size number of symbols to form the current data frame D[i] and identifying a deferred target size number of symbols to use to compress information about the current uncompressed frame (to be sent later), (2) creating D[i] by combining a subset of the symbols created earlier (including the empty subset or the subset containing all symbols of the set) with extra symbols where the number of symbols is dictated by the target size; these symbols are combined into D[i]. Then creating additional symbols reflecting the compression of the current uncompressed frame that are meant to be sent later (e.g., during the next time slot).

There is an optional step of producing metadata; for example, to provide information about the divide between new and old information content in D[i]. This metadata could be included in D[i] itself and/or in some sort of header so that it can be used (a) in the streaming encoder/decoder (e.g., if CSIPB or CSIPBRAL it may be used to ensure the symbols of earlier data frames are placed in the first component) and/or (b) in the decompression step.

Determining the target size and deferred target size may involve examining the state and anticipated reward, e.g., considering the size and information contained in symbols corresponding to earlier data frame(s), the bandwidth estimate of the network, how many symbols were sent over the last several time slots, parity allocated for future data frames, point of diminishing returns for how many symbols it takes to accurately compress the uncompressed frame, etc.

This is an example of spreading information content, not just symbols; the symbols that are not sent until a later time slot are chosen based on the compression (i.e., to ensure they are supplementary and do not prevent decompressing the data frame). In contrast, another approach is to spread arbitrary symbols during the streaming encoder stage; while this would enable higher-rate FEC schemes than would be possible without any spreading, it would potentially force decompression to wait until these symbols are received.

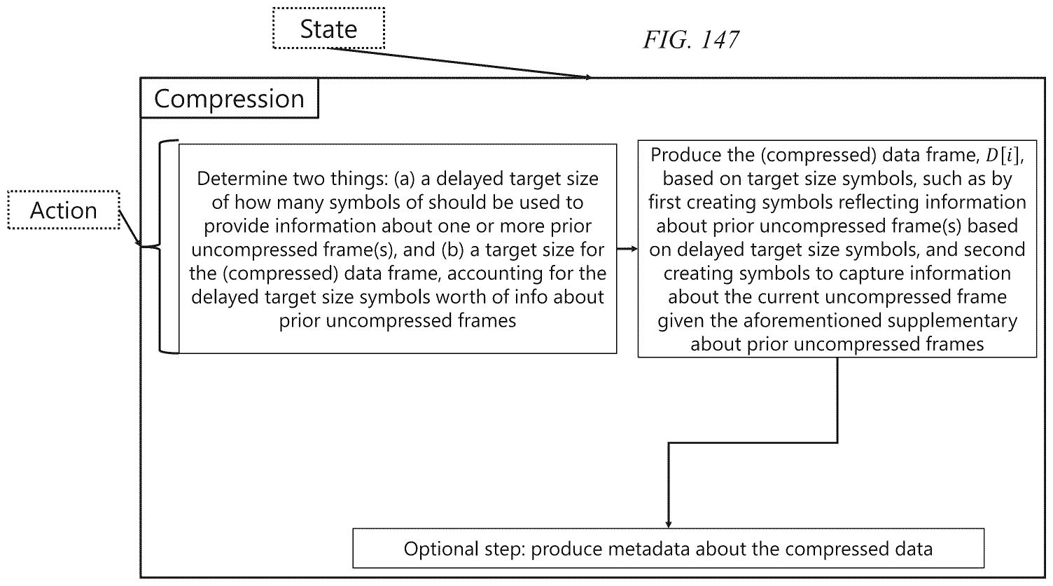

FIG. 147 illustrates a second possible compression to spread information content to smooth out when it is generated (e.g., generate less information now and generate more later). In this example, compression involves:
Identifying how many symbols to use to capture information about one or more prior uncompressed frames, and identifying how many symbols to produce in total (i.e., providing how many extra symbols to be used).
Then compression can produce the data frame that involves supplementing information about one or more earlier uncompressed frames and providing additional information about the current uncompressed frame subject to the delayed target size and target size; The purpose could be for decompressing the previous data frame(s) during the current time slot to (a) display it/them with some delay waiting for the received packets of the current time slot, and/or (b) so that the decompression of prior data frame(s) are updated and used when decompressing the new data frame.
Metadata may be produced to be used by the streaming encoder/decoder and or decompression.

This example enables spreading information content by smoothing out the sequence of sizes of (compressed) data frames; for example, if a lot of information is received about the current frame, the compression can be kept from being too large by compressing some now and filling in the gaps later. This is not just spreading symbols of data frames; for example, consider a live video call. Compression may involve separately compressing spatial regions of the uncompressed frame; one or more of these regions may either (a) not be compressed or (b) be compressed in a very lossy way using a low bitrate during the current time slot; then during a later time slot (e.g., the next time slot) additional information could be used to flesh out these spatial region(s). If there are losses and FEC involves multiple time slots to recover lost packets, the extra information can be used to display a higher-quality decompressed frame. Otherwise, this extra information can be used to improve the compression/decompression of future time slots.

Decompression may or may not happen after packets are decoded and may or may not happen across multiple time slots. For example, compression may send some information about the current uncompressed frame in the next one (or multiple) data frames. If this information is available (e.g., there was a burst, so data frame i is not decoded until time slot (i+τ) by which point there may be data from data frames i+1, . . . , i+τ available for decoding frame i).

One idea is to spread some of the information across multiple data frames. If decompression is called during time slot i, perhaps it uses some methodology (e.g., techniques like error concealment and/or infers information about parts of the uncompressed frame like pixels) to create some sort of decompressed frame to display. Then, that additional information may be available during the next time slot and used to obtain a better decompressed frame during time slot (i+1). Or the decompression module may suggest waiting until the next time slot to leverage data from that time slot in the decompressed frame (e.g., delay displaying any decompressed frame).

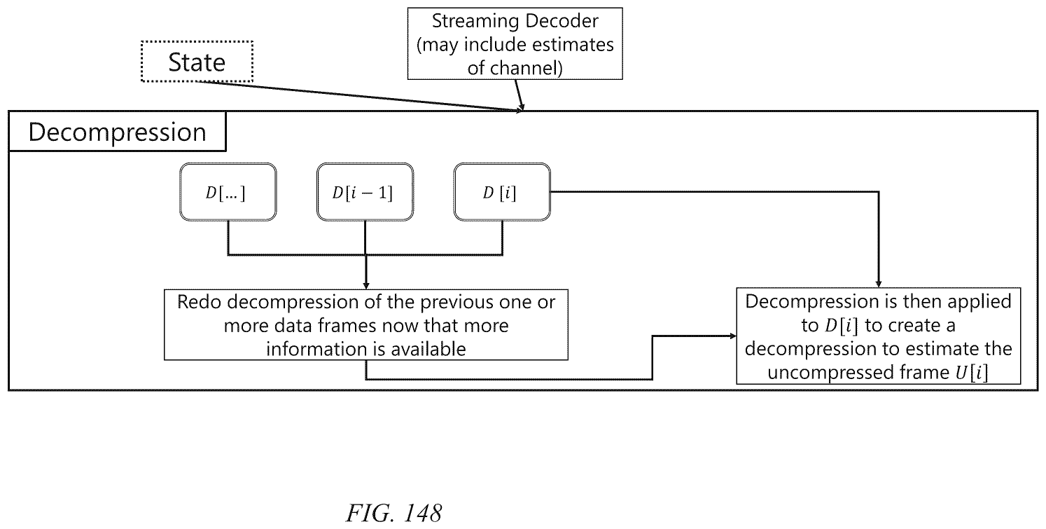

FIG. 148 illustrates decompression after spreading information content. Decompression first improves the decompression of the previous data frames and then uses them to have a better estimate when decompressing the current data frame. This is the decompression step during time slot i. Due to loss recovery, this sometimes may be applied just before one or more decompressed frames prior to i are rendered. In this example, all frames prior to i have been recovered. For many FEC schemes, often it is the intention to have this property. However, in other examples, due to packet loss and properties of the FEC scheme, only some (or none) of the symbols of one or more data frames may be available, but decompression (along with error concealment) will be used.

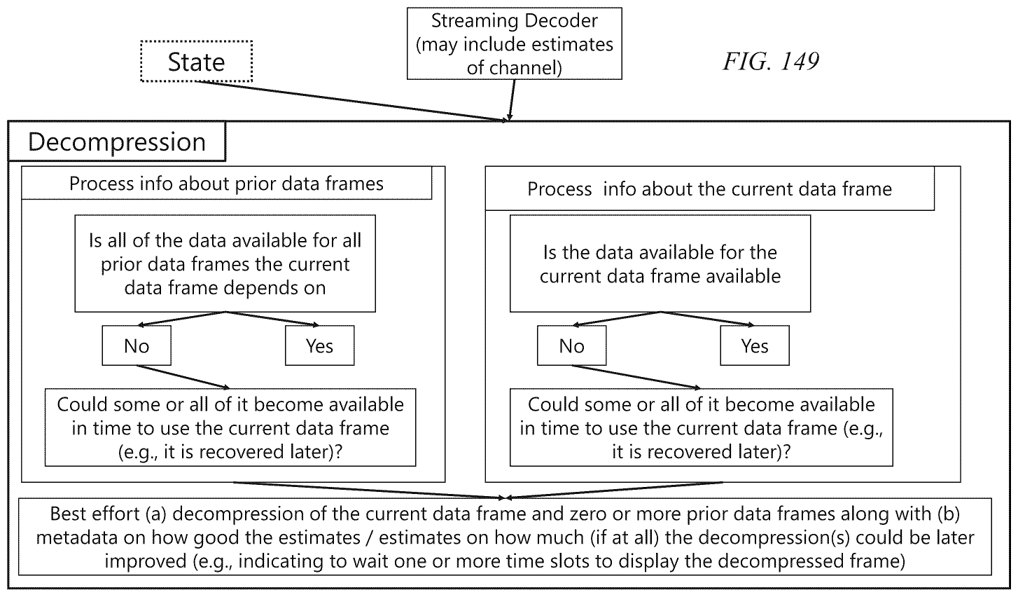

FIG. 149 illustrates one possible decompression allowing for decompressing then flagging to consider waiting for more data to render the frame (once can use the extra data to decompress to a better estimate of the uncompressed frame) detailed example of one way the process could work. Here, due to packet loss and properties of the FEC scheme, only some (or none) of the symbols of one or more data frames may be available. This is one way decompression may still be applied/combined with some sort of rendering logic (which may include error concealment).

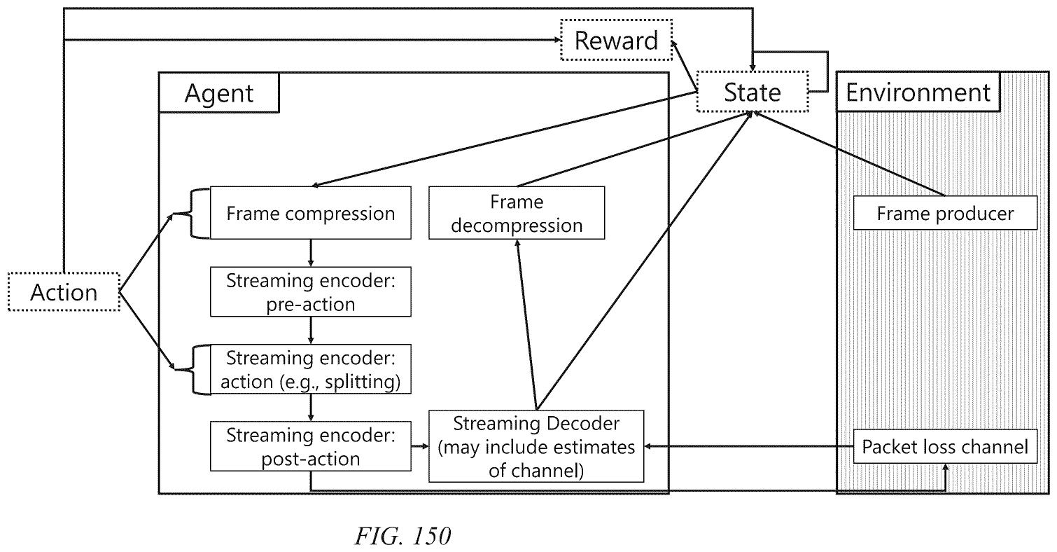

FIG. 150 illustrates treating compression and communication action (e.g., splitting, parity allocation, etc.) as a reinforcement learning problem. Previously, it was shown how to improve how compression will work in conjunction with a fixed communication scheme (e.g., CSIPB, CSIPBRAL, etc.). Now, a new methodology is introduced to codesign compression with the communication scheme. To do so, the model can be adjusted so that the action combines (a) how to compress the uncompressed frame with (b) decisions made by the streaming encoder (e.g., how to split data frames, how to allocate parity symbols, how to packetize symbols, etc.). Then a policy for both compression and streaming encoding can be obtained using techniques from reinforcement learning. The state is now the combination of (a) the information of state from compression-only, and (b) the information of state from communication-only. The action is the combination of (a) the action from compression-only with (b) the action from communication-only. The reward is a combination (e.g., a linear combination, like the summation) of the rewards of (a) the compression-related action using the compression-only reward, and (b) the communication-related action using the communication-only reward. Hence, the agent is a combination of the (a) compression-only agent, and (b) the communication-only agent. This approach can be taken instead of using alternating training of compression and communication.

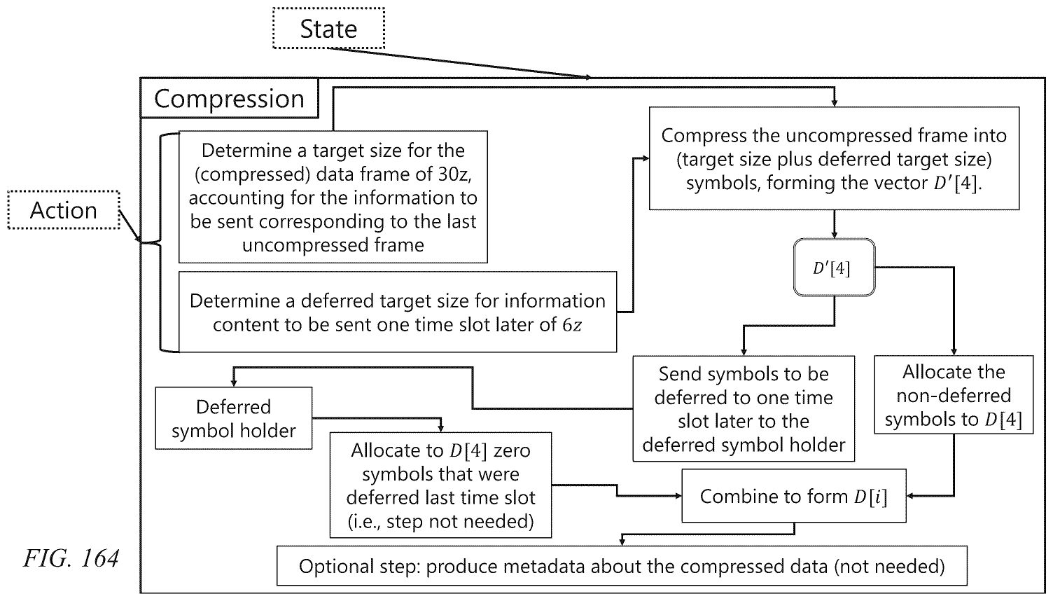

FIGS. 164-170 provide an example of FEC-aware compression, in accordance with certain embodiments. Generally speaking, for a given time slot, the system determines a target size for the compressed data frame, accounting for information to be sent corresponding to the last uncompressed frame. The system also determines a deferred target size for information to be sent one time slot later, e.g., deferring a number of symbols relating to video content that is determined to be less important to user perception of video quality (e.g., if those symbols are not available when the frame is played but are available in time to be used for any inter-frame encoding of the next frame, then the video quality will not be significantly degraded). The system compresses the uncompressed frame into (target size plus deferred target size) symbols to form a vector where the (deferred target size) symbols are to be deferred to the next frame. The compressed data to be transmitted then comprises the remaining (target size) non-deferred symbols from the vector and any deferred symbols from the prior frame. The system optionally may produce metadata about the compressed data, e.g., to be sent along with the compressed data or separately from the compressed data.

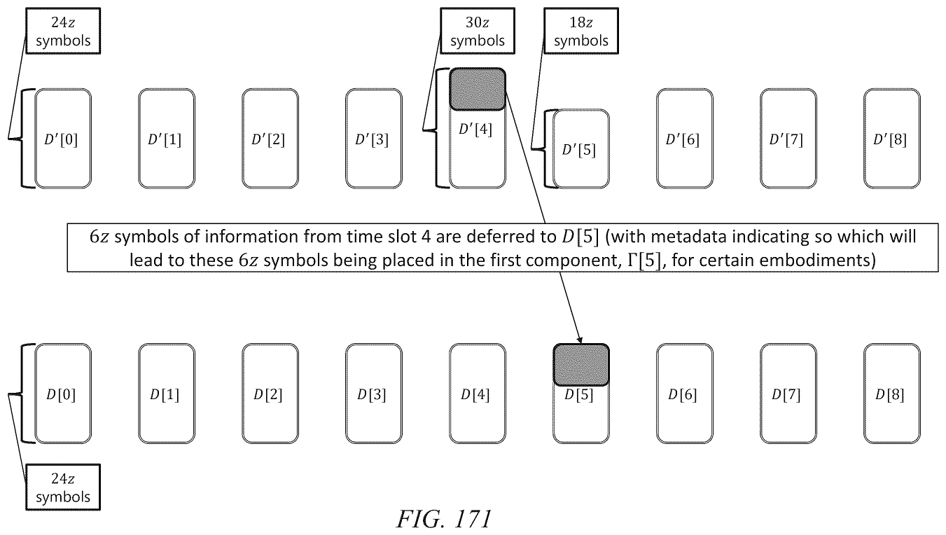

For purposes of the following example, all frames are presumed to be size 24z except for frame 4 which is size 30z and frame 5 which is size 18z (see the top row of boxes D′[0], . . . , D′[8] in FIG. 171). Information from frame 4 is spread over one time slot so it appears to FEC as though all frames are size 24z (see the bottom row of boxes D[0], . . . , D[8] in FIG. 171) but the scheme knows that the 6z symbols are from frame 4 and therefore places them in the first component of frame 5 (intending for loss recovery for partial bursts at a lower latency). This is shown in FIG. 171 in the dark box of 6z symbols moved from the top of D′[4] to the top of D[5]. A simplified real-world example that inspires this may be that for frame 4, there happens to be extra information in part of the frame that is less important. The example might relate to a video call where each frame (other than frames 4 and 5) has about 24z symbols of information, but during frame 4, there is a slight movement in the background (e.g., upper right corner) that is less important to the video call but takes up an extra 6z symbols of information and then, during frame 5, there happens to be less change in the video, so the compression can be more efficient and only use 18z symbols to convey all information.

FIG. 164 depicts compression for a frame number 4 in which the target size is determined to be 30z and the deferred target size (i.e., the number of symbols to be deferred for frame 5) is determined to be 6z, with zero symbols deferred from prior frame 3.

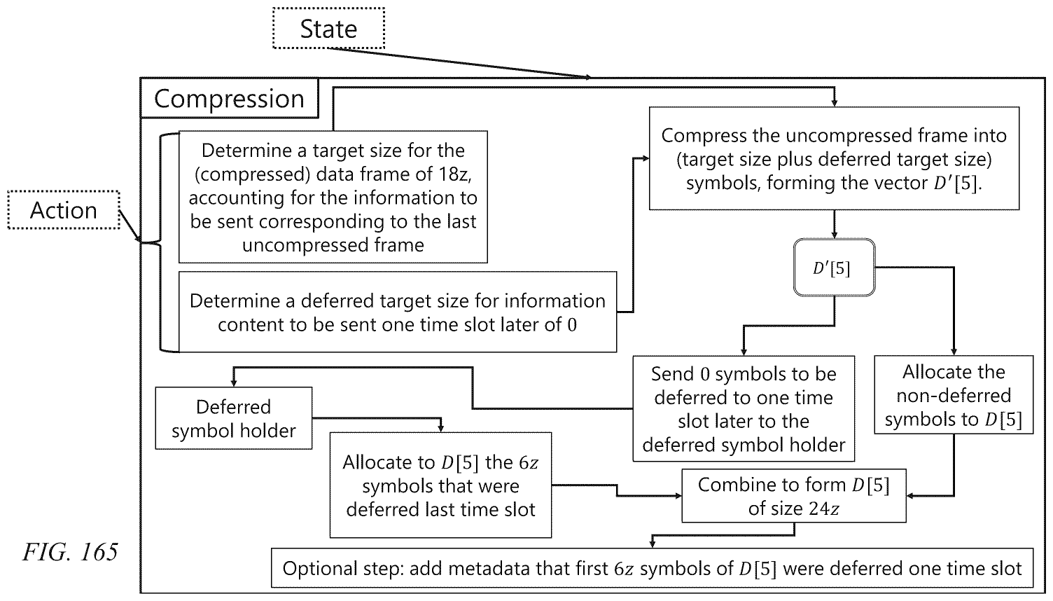

FIG. 165 depicts encoding of frame 5 following the encoding of frame 4 per FIG. 164. Here, the target size for frame 5 is determined to be 18z and the deferred target size for frame 5 is determined to be zero. After compressing frame 5, the system forms compressed data to transmit, including the non-deferred symbols (which, in this case, is all of the compressed symbols from frame 5 since the deferred target size is zero) and the 6z symbols deferred from frame 4. In certain embodiments, the coding scheme will place the 6z symbols corresponding to the uncompressed frame from time slot 4 in the first component (i.e., Γ[5]) so that it is intended to be recovered for partial bursts by time slot (5+τ−1)=(5+3−1)=7=(4+τ). In this example, there happens to be less change in the underlying video, so, given the extra info on frame 4 that was deferred, only 18z symbols are needed to produce the good quality video.

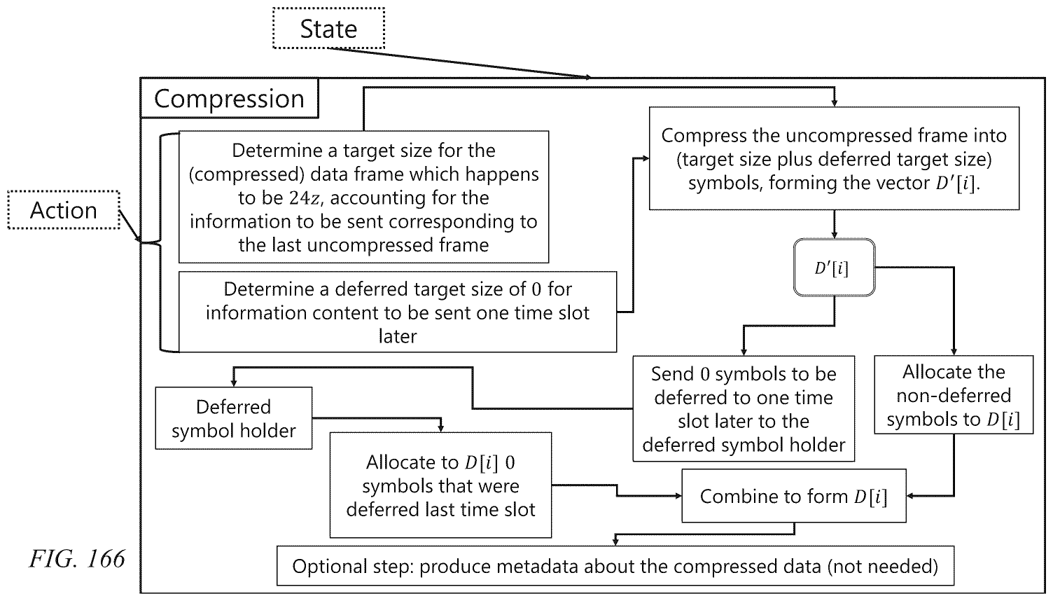

FIG. 166 depicts the generalized encoding scheme for time slots i=0, 1, 2, 3, 6, 7, 8 in which, for the sake of simplicity, the target size is determined to be 24z symbols (which, in this example, is based on how many symbols are needed to convey the information about the underlying video), and there are no deferred symbols from prior time slots. In this example, D[−1] is assumed to be the empty vector.

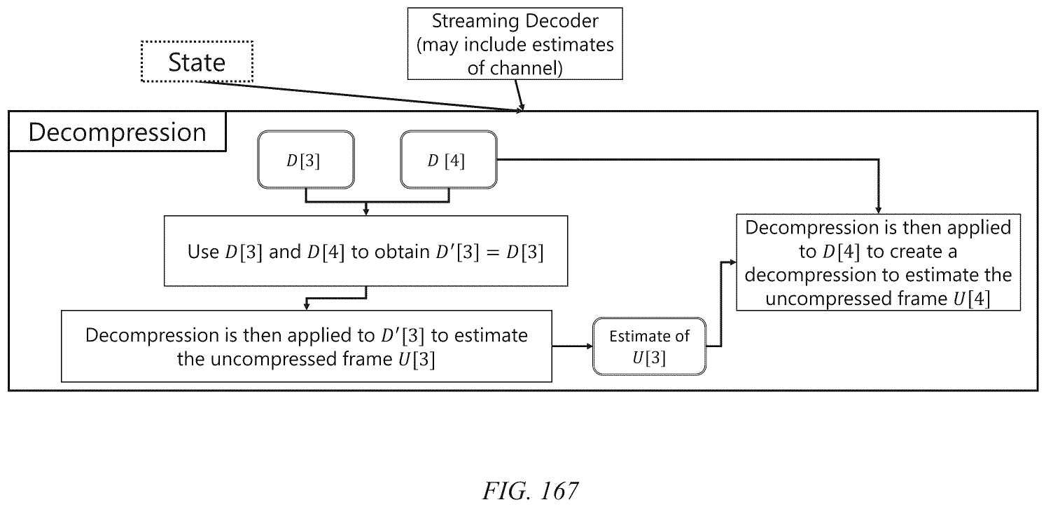

FIG. 167 depicts decompression after spreading information content for frames 3 and 4 and earlier (during time slot 7 when frame 4 has been recovered from the partial burst starting in time slot 4). Here, it is assumed that there were no losses before time slot 4 and that D[3] (which in the example equals D′[3]) was already recovered during time slot 3. Then, U[4] is estimated using only the 24z symbols that were not deferred (i.e., not using the extra 6z deferred symbols).

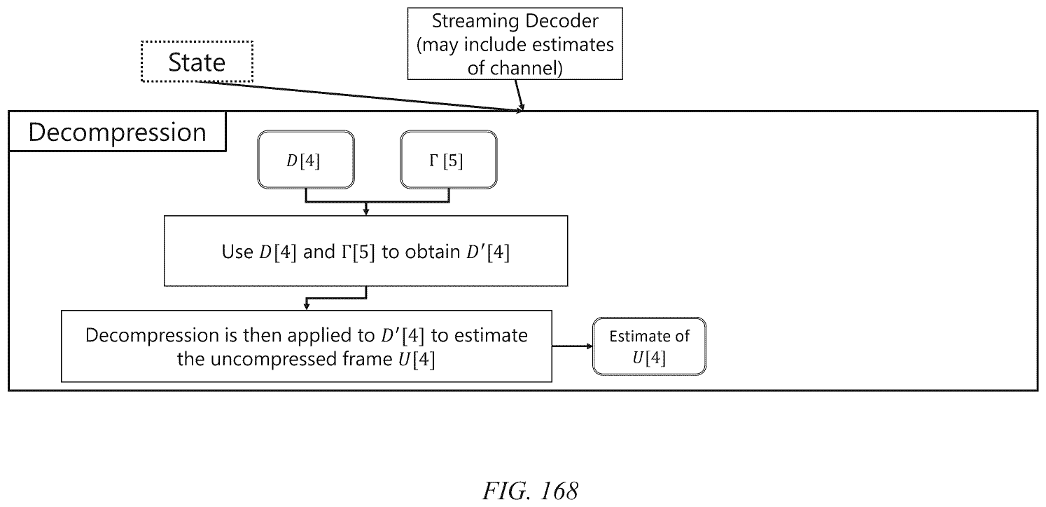

FIG. 168 depicts decompression after spreading information content for frames 4 and 5 (during time slot 7 when under certain embodiments the first component of frame 5 has been recovered from the partial burst starting in time slot 4). Here, during time slot 7, the previous frame is fully recovered now that loss recovery has occurred and all the deferred symbols from the fourth frame are available.

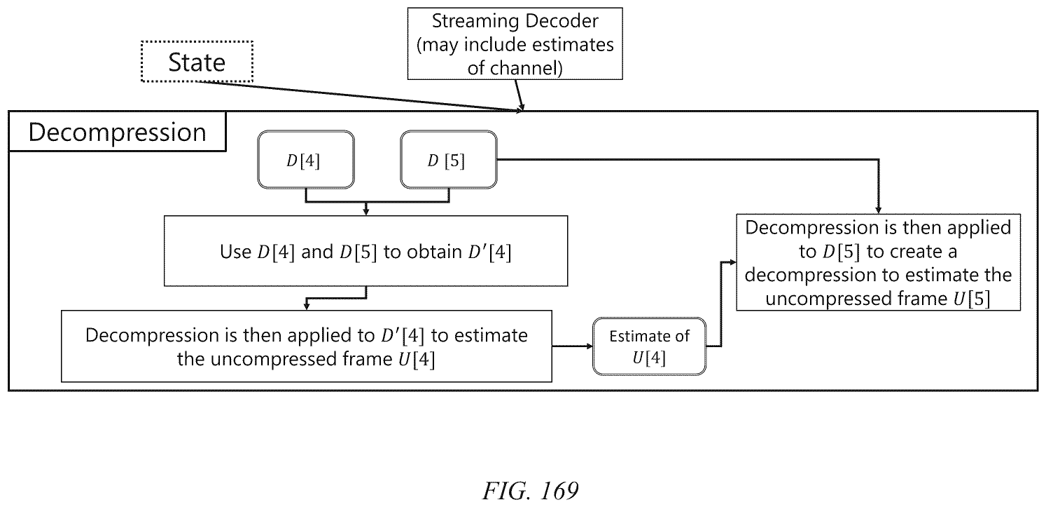

FIG. 169 depicts decompression after spreading information content for frames 4 and 5 (during time slot 5 if there are no losses before time slot 6). Here, during time slot 5, the previous frame is fully recovered.

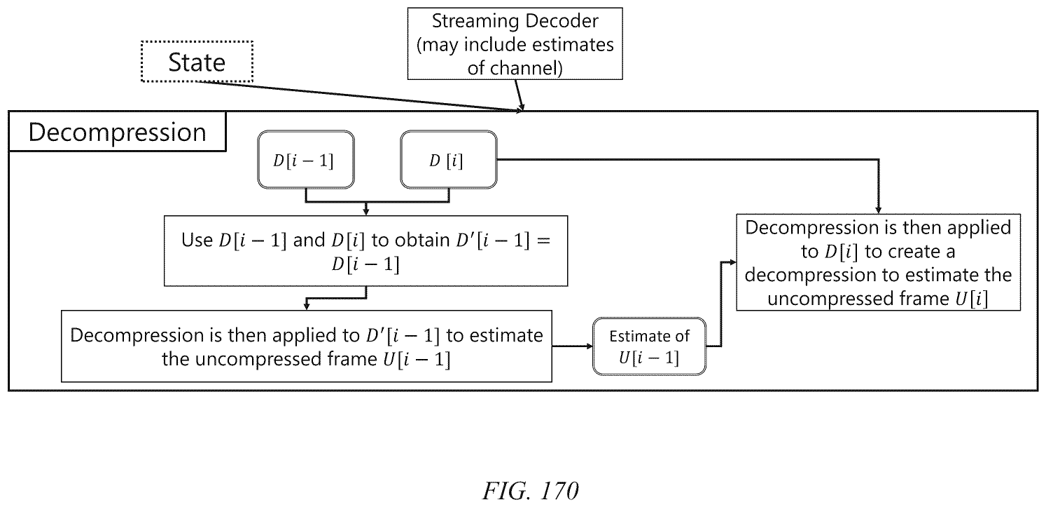

FIG. 170 depicts the generalized decoding scheme after spreading information content for frames 0,1,2,3,6,7,8. Here, there was no spreading of information content for these frames, so D[i] equals D′[i].

### Encoder-Aware Queueing and Queueing-Aware Encoding

Communicating in many scenarios (e.g., over the Internet) involves sending packets from one or more senders to one or more receivers over a network. The network comprises components (e.g., routers, switches, bridges, etc.) that forward packets. Each component has a finite memory; when it receives data faster than it can transmit data, some data (e.g., packets) must be dropped.

There has been a plethora of work on how to handle the traffic. One way is to handle scheduling (e.g., the order of transmission). A second is queue management through policies. Proposed here is a new way to handle queue management in a manner that is better suited to the needs of real-time communication. This solution can be combined with a variety of scheduling policies and/or network designs (including software-defined networking and/or traditional networks). Within queue management, active queue management may involve proactively dropping data flow packets (even when they would fit in the queue). This can help to respond to congestion early, such as by dropping bandwidth usage. Active queue management additionally or alternative may involve other queueing operations such as selectively reordering data flow packets (which can include physically moving packets within a queue and/or between a number of queues or logically changing the transmit order or timing of queued packets such as by reprioritizing or rescheduling packets).

Existing queue management policies include the following. Drop-tail may involve dropping the packet that arrives most recently whenever it does not fit. Active queue management policies like Random Early Detection (RED) may drop packets when the queue is not full, such as by randomly dropping packets with a probability that is proportional to how full the queue is. Proportional Integral controller Enhanced involves randomly dropping packets with a probability based on the derivative of the queueing latency. MM-on-off may involve periodically dropping all packets for a period of time and then dropping no packets for a period of time.

Certain embodiments manage flows based on methods for how the data of the flows have been encoded (such as FEC and/or compression) and/or characteristics of the flows (including but not limited to loss-recovery capabilities). Additional embodiments encode data (e.g., FEC and/or compression) based on queue management policy.

Certain embodiments coordinate the queue management policy with new developments in erasure codes for real-time communication (e.g., Tambur, CSIPB, CSIPBRAL, etc.) or traditional erasure codes (e.g., rateless codes) by introducing losses that are amenable to loss-recovery using such erasure codes. Under an erasure code, data might be sent along with parity that is used to recover lost data. Crucially, it has been shown that the amount of parity that needs to be sent depends on the pattern of where drops occur. For real-time communication applications (e.g., videoconferencing), communication occurs periodically such as when a new uncompressed frame is generated each time slot. For such applications, several properties of packet loss impact how much parity is needed for reliable communication. An overarching goal is to minimize the amount of parity sent, as it uses bandwidth while providing no additional information once all lost packets have been received. Recently, it has been shown that the characteristics of packet loss besides the frequency of loss, such as whether losses are clustered into partial bursts, impact how much parity is needed for reliable communication. In fact, as discussed herein, if losses occur as partial bursts, they can be recovered using far less parity than when the same number of losses occur and or the same amount of data is lost but the losses are randomly distributed over time in a non-bursty manner.

A general class of such policies is introduced in this work. One hope is to improve the QoE by reducing the frequency of non-recoverable packet loss. A second hope is to improve the goodput by reducing how much parity is needed to provide the QoE. In addition, the described mechanisms may be used for congestion control, e.g., as a flow (or all flows) send(s) more data, more packets are lost. This discourages excessive bandwidth use by the flows. A final goal may also be to have fairness across the flows.

One reason the approach makes sense is that there may be multiple components of bandwidth use for each flow and each of them may impose variability (e.g., temporary spikes of high bandwidth use). For example, suppose all flows are for videoconferencing applications. Then three components may be: (a) the target bitrate, (b) the variability in sizes of data frames arising from the video codec (e.g., during compression), and (c) the parity sent per frame (i.e., a quantity whose relative size compared to the corresponding frame may vary from frame to frame). Thus, even if all flows are using average bitrates that are below the capabilities of the system, there may be periods of time in which too much data is sent. By constructing packet losses in a way that can be recovered (which also may influence the amount of parity that is sent, including by reducing it), the system can avoid overflowing while maintaining a high QoE.

Thus, certain embodiments employ a queue management policy specifically designed to take advantage of properties of underlying FEC schemes, including being the first queue management policy to synergize well with the likes of CSIPB and/or CSIPBRAL by introducing partial bursts, which are a structure of packet losses that can be recovered using an FEC scheme that sends less bandwidth than one that must recover from arbitrary packet losses. For example, the losses may be introduced in a way that fulfills the goals of a queue management system dropping packets (e.g., like freeing space or discouraging a flow from using too much bandwidth) while minimizing the negative impact on the QoE for the flows (e.g., by having the losses be recoverable). This involves introducing a new structure for both how to drop packets and how to select when to not drop packets to synergize nicely for FEC. For example, in certain embodiments, a mechanism is introduced based on a Markov chain to lead to partial bursts by capturing their two properties: a period of higher loss (i.e., the partial burst) followed by a period of lesser (or no) loss (i.e., the partial guard space, or guard space) which the FEC scheme can adapt to so that it (a) can recover the losses in time for the recovered data to be useful while (b) not sending an unnecessarily large amount of parity symbols. The new mechanism also enables a higher goodput by allowing FEC used by the flows to occur at higher rates (i.e., a higher ratio of data to parity).

The following is a supplemental glossary used for the following queueing discussion:

| | | |
|---|---|---|
| Term | Definition | Example |

| | |
|---|---|
| Queue | the buffer that holds packets. |
| | Examples include a single router |
| | that has a buffer to hold packets, |
| | or multiple routers each with their |
| | own queue, or a single central |
| | queue to hold packets for a bunch |
| | of routers that each process one |
| | packet at a time and have no |
| | additional individual buffers. |
| Queue | determining how to handle a queue |
| management | (e.g., which packets to admit) |
| Flow | The series of communication between a |
| | sender and receiver as part of a session |
| f⁽ⁱ⁾ | the number of flows during time i |
| fᵢ | The ith flow when ordering flows |
| | from oldest (1) to newest (f⁽ⁱ⁾); |
| Session | The duration in which a flow exists |
| Active | Proactively handling a queue, such |
| queue | as by dropping packets even when |
| management | they would fit in the queue. This |
| | can help alleviate network condition |
| | by indicating that flows need to |
| | communicate less bandwidth |
| Packet | process of distributing the packets |
| allocation/ | over the one or more queues and |
| reallocation | or processing elements (e.g., routers) |
| Packet | Methodology used to determine whether |
| dropping | to drop any packets/which packets |
| procedure | to drop given the state of the system |
| n | the number of queues in the |
| | system; in some embodiments, it |
| | may be helpful to have n be time- |
| | indexed (i.e., nᵢ would be the |
| | number of queues in the system |
| | during time i), but for simplicity of |
| | presentation, n is used (and is |
| | likely to be fixed in certain |
| | embodiments). One way to reflect |
| | a varying number of frames is to |
| | let n be an upper bound on the |
| | number and during certain times |
| | restricting the state space to one |
| | where certain queues are required to |
| | be empty (i.e., effectively reducing |
| | the number of queues available for |
| | use, ni, at any given time) |
| Throughput | A term essentially meaning how much |
| | data is transmitted by the system |
| Goodput | A term essentially meaning how |
| | much information is transmitted |
| | by the system; for example, if |
| | there are no losses and packets are |
| | either (a) data or (b) parity, the |
| | goodput would be the total amount |
| | of data sent, whereas the |
| | throughput would be the goodput |
| | plus the total amount of parity sent |

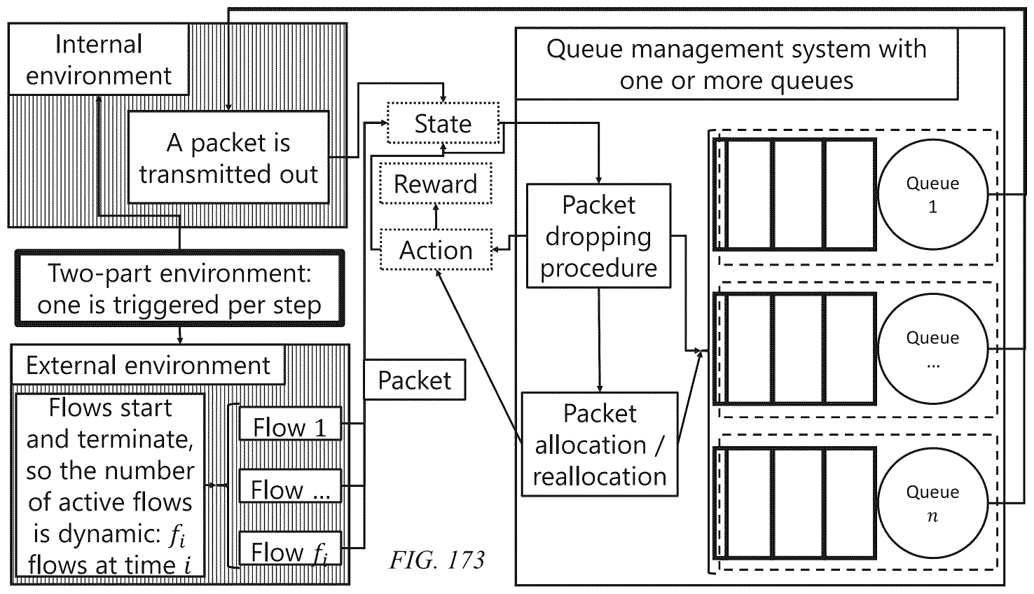

FIG. 173 is a schematic diagram for an FEC-aware packet queue management system in accordance with certain embodiments. Flows enter or leave the system dynamically. During each time, there are some number of flows. These flows send data to the queueing system, thereby updating its state. When the state is updated, the packet dropping procedure is triggered. If the state change was a new packet being received, the dropping procedure may decide whether to drop it or pass it to the packet allocation step. In addition, regardless of what the state change was, the packet dropping procedure may choose to drop any packet at any time. The packet dropping procedure is an action from a set of actions and triggers a reward. After the packet dropping procedure is triggered, the packet allocation/reallocation procedure occurs. If a new packet just arrived, it may be placed in one of the queues. Or the packets might be reallocated across the queues. Packet allocation/reallocation are actions which can cause a state change and may or may not lead to a reward. Each queue processes its packets and transmits them. Each queue may employ any queueing policy (e.g., first come first serve, last come first serve, processor sharing, priority queue, Gittins index, etc.), and in certain embodiments, different queues may use the same queueing policy or different queueing policies. Importantly, the packet dropping procedure will determine how to drop packets in a way that is amenable to recovery under FEC while also meeting other criteria like fairness across flows, discouraging congestion, etc. Every time a packet is finished processing by the queue, there is a state change. It should be noted that the policies can be learned (i.e., set via machine learning, including reinforcement learning).

There may or may not be feedback from the queue management system to the flows (e.g., to the senders of the flows) about the packet dropping procedure (which may or may not involve also mentioning the current state and what type of action is used in this state).

The packet dropping procedure could utilize knowledge about the FEC characteristics of the packet flows to make packet dropping decisions, such as, for example, the type of flow, QoS/QoE specifications for the flow (including metrics meant to estimate them, including but not limited to peak signal-to-noise ratio (PSNR), structural similarity (SSIM), or Learned Perceptual Image Patch Similarity (LPIPS)), the value of τ being used to produce the flow, the frame splitting scheme used to produce the flow (e.g., fixed vs. variable frame splitting), the parity allocation scheme used to produce the flow, guard space characteristics for the flow, failsafe characteristics for the flow, etc. In certain embodiments, metadata about FEC characteristics could be carried in-band, e.g., within the packets of the packet flow such as in packet headers. Alternatively, information about FEC characteristics could be conveyed out-of-band, e.g., using a separate metadata channel. In some embodiments, the FEC-aware packet queue management system may not be aware of the FEC characteristics but may act in a way that suitable FEC schemes could adapt to (e.g., if CSIPB were likely to be used, the FEC-aware packet queue management system may by introducing partial bursts over 50 ms time slots followed by guard spaces with no losses for at least 100 ms; such values would be likely to be considered partial bursts for the types of values of τ likely to be used for real-world applications). In some embodiments, the FEC-aware packet queue management system may be aware of high-level FEC characteristics (e.g., that a form of CSIPB is used but not the parameters or exact splitting mechanism, parity allocation mechanism, etc.) and act in a way that loss-recovery is amenable to (e.g., by introducing partial bursts over 50 ms time slots followed by guard spaces with no losses for at least 100 ms).

It should be noted that the FEC-aware packet queue management system as used here is meant to be broadly construed. For example, it may involve one or more routers (or devices functioning similarly to routers) which may each have is own queue (or a central queue may exist). The queue may hold a buffer of packets, etc.

It also should be noted that if the state has been updated after the packet dropping procedure and packet allocation/reallocation has just occurred, there may or may not be a transition from the state to the packet dropping procedure.

It also should be noted that packet allocation/reallocation can be viewed as a black box. For example, if there are a number of identical queues, one queueing scheme is to distribute the packet to the shortest queue (known as join shortest queue). Another example (if possible) is to have one central queue and then distribute the first packet (i.e., oldest) to the next available servicing device (e.g., router). Any queueing scheme should be considered as admissible. In a setting where the packet allocation policy is fixed, it can be viewed as merely impacting the state transition function given the action taken by the packet dropping procedure. The queue management system may or may not sometimes redistribute the packets over the queues; in the simplest case, the packet is allocated upon entry (i.e., reallocation never occurs). Different queues may use the same policy or different policies.

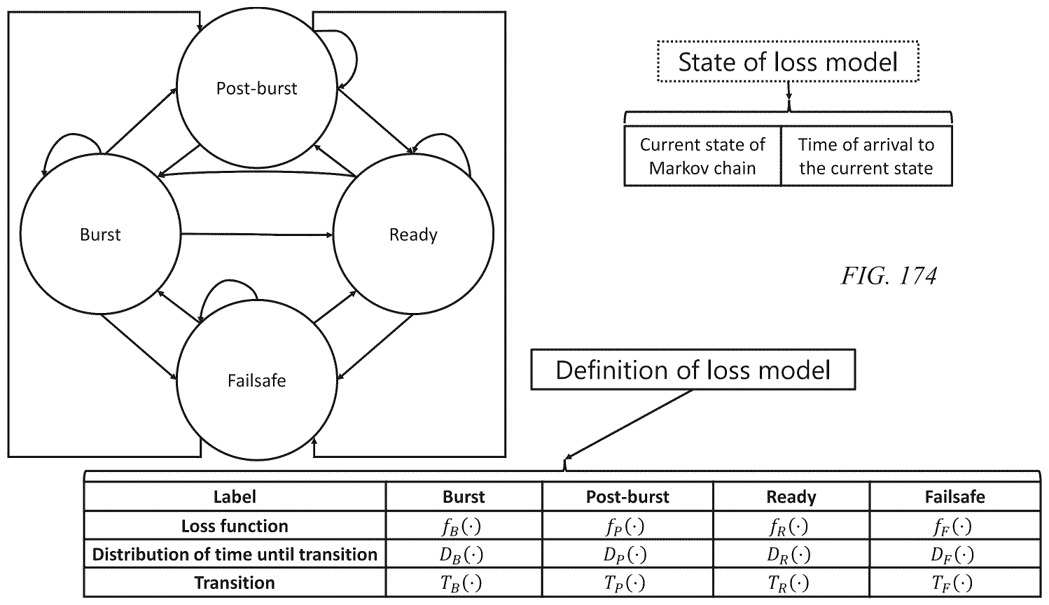

FIG. 174 provides an example of a class of loss model for FEC-aware queue management, in accordance with certain embodiments. The FEC-aware packet loss mechanism is intended to primarily introduce losses that can be recovered using the loss-recovery capabilities of the FEC code; this may include recovery by the real-time playback deadline. The FEC-aware packet loss mechanism is any methodology to introduce losses that are suited to the class of FEC schemes that are relevant to communication. The FEC-aware packet loss mechanism may also have a secondary purpose, such as a failsafe mechanism to introduce extra packet losses when needed (e.g., if there is insufficient space in the sub-system, so at least one packet must be dropped).

Now, one class of FEC-aware packet loss mechanisms is introduced. This class is intended to be well-suited to FEC for real-time communication applications including but not limited to frame splitting encoders such as CSIPB, CSIPBRAL, Tambur, etc. Here, losses are modeled with a 4-state Markov chain. The model is applied whenever a packet is eligible to be dropped. A transition is called when either (a) the elapsed time exceeds the sample, or (b) an immediate transition to the failsafe is called. Then the state of the loss model is updated accordingly. Finally, in the new state, the loss function is called to determine if the packet is to be dropped or not. This can be thought of as a 3-state Markov chain (e.g., burst, post-burst, ready) that is a complete graph plus a special₄th state that is only entered when the loss model is called with a flag indicating to transition to the failsafe state. The loss function indicates whether to drop a packet. The distribution of time until transition is sampled from every transition. The current state is maintained until either (a) the elapsed time exceeds the sample, or (b) an immediate transition to the failsafe is called. The transition function reflects the probability of transitioning to each of the states from the current state.

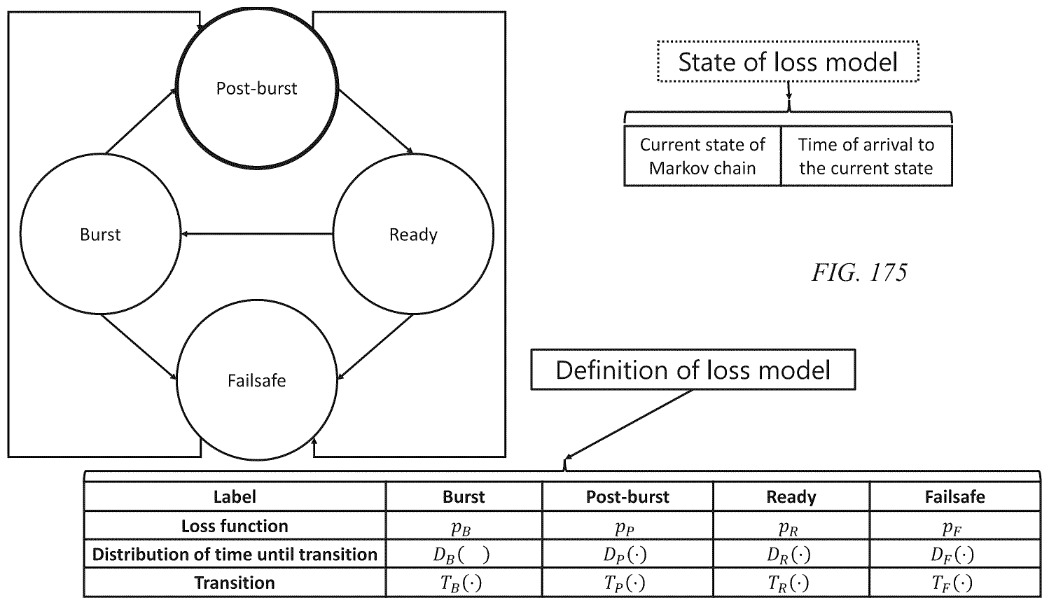

FIG. 175 provides an example of a simplified class of loss model for FEC-aware queue management, in accordance with certain embodiments. Here, the state machine starts in the post-burst state (indicated by its thicker outline). Transitions are restricted where (a) one always goes to the Post-burst state after a Failsafe, (b) leaving the Burst state goes to either the Failsafe state or the Post-burst state, (c) leaving the Post-burst state goes to either the failsafe state or the Ready state, and (d) leaving the Ready state goes to either the failsafe state or goes to the Burst state. The loss function is simply drop a packet with some probability; for example, in the Burst state, draw a sample from the Uniform distribution over [0,1] and drop the packet if and only if the sample is less than or equal to p_{B} (which itself is a value in [0,1]). The probability of loss in the failsafe may or may not be set to 1 (it is a value in [0,1]). The probability of loss in the post-burst state may or may not be set to be 0 (it is a value in [0,1]). The probability of loss in the ready state may or may not be set to be 0 (it is a value in [0,1]). Without loss of generality, the probability of loss in the burst state is at least as high as the probability of loss in the post-burst state and of the ready state (i.e., p_{B}≥p_{P} and p_{B}≥p_{R}). The distribution of time until transition from the Burst state and post-Burst state may each be a single value; for example, the burst state may be maintained for 90 ms and the post-burst state may be maintained for 120 ms. These timings may be well-suited to videoconferencing applications at 50 FPS (e.g., one uncompressed frame occurs every approximately 33.3 ms). It is the intention under this example that the burst state encompasses two consecutive time slots, then the post-burst state encompasses at least 3 consecutive time slots. This is well suited to a code that recovers a partial burst of length at most 2 time slots dropping higher than p_{B} fraction of the packets followed by a guardspace of at least 3 time slots where more than d_{P} fraction of the packets are lost. The distribution time in the ready state may also be an arbitrary value like 50 ms. It may also be 0 ms; in this case, the state may as well not exist. The distribution of time in the failsafe state may also be a fixed value like 10 ms. The transition timings may also be other distributions (e.g., exponential random variables).

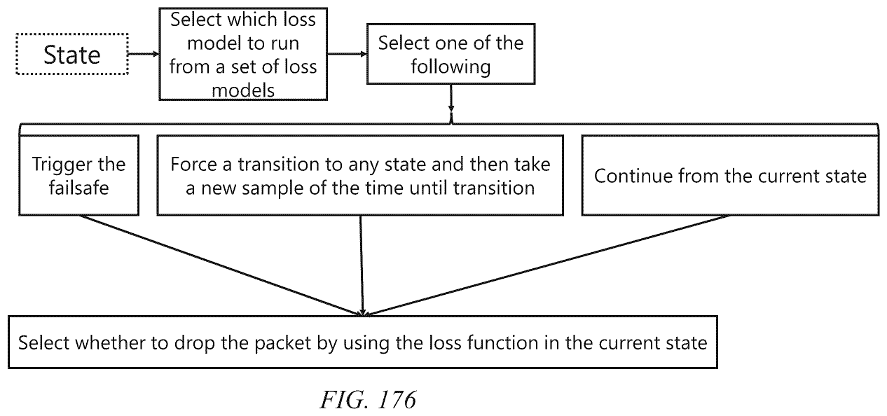

FIG. 176 illustrates a packet dropping procedure to drop certain packets on entry, in accordance with certain embodiments. Here, the packet-dropping procedure is meant to handle system-level decisions for how to run the FEC-aware packet loss mechanisms. It will select which model(s) to run as well as run the knobs of the model(s) to balance several goals like (a) handling congestion, (b) fairness (e.g., across flows or across time), (c) maximizing goodput, and (d) enabling communication with a high quality of experience. In certain embodiments, fairness may be measured by metrics like percent of packets lost, estimated loss-recovery rate, and throughput relative to other flows.

One possible packet-dropping procedure may include (a) a loss model where nothing is lost (i.e., all states have a loss function that says to not drop the packet with probability 1), and or (b) a loss model where everything is lost (i.e., all states have a loss function that says to drop the packet with probability 1), and or (c) a loss model where everything is lost in the Burst state (i.e., whenever in the Burst state a packet is guaranteed to be lost). The system selects which loss model to run from a set of loss models: one possibility is to do so independently of which flow the packet belongs to. A second possibility is to have a per-flow selection process that considers the portion of the state pertaining to information about that flow in addition to global information. The selection process may be random or deterministic. The set of loss models may be an infinite set or a finite set (most likely a small finite set). It may be a small finite set. Trigger the failsafe means transition to the Failsafe state.

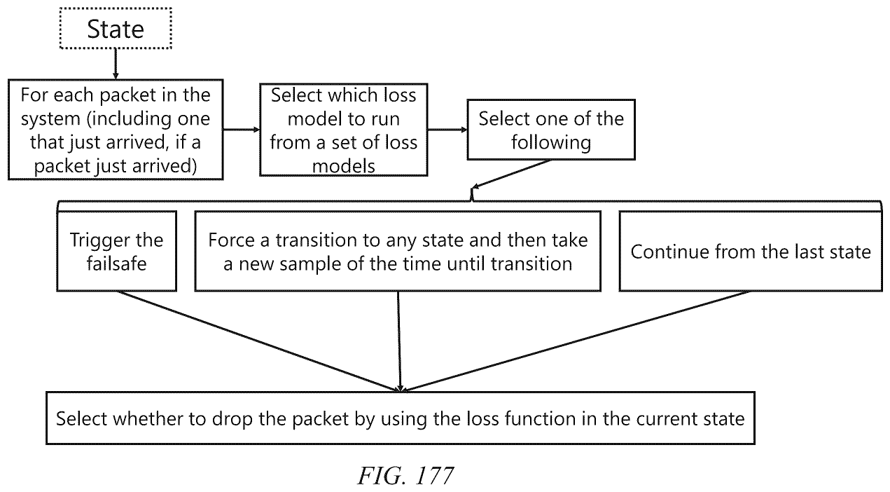

FIG. 177 illustrates a packet dropping procedure to drop certain packets from within the queue management system, in accordance with certain embodiments. Here, the system essentially applies the same procedure as dropping upon entry except now it can be applied to any packet(s) in the system. The criteria for model selection may be based on which packet is selected (e.g., based on its age); this means the policy may choose to never drop the newest packet/prioritize which model to select based on how long the packet has been waiting.

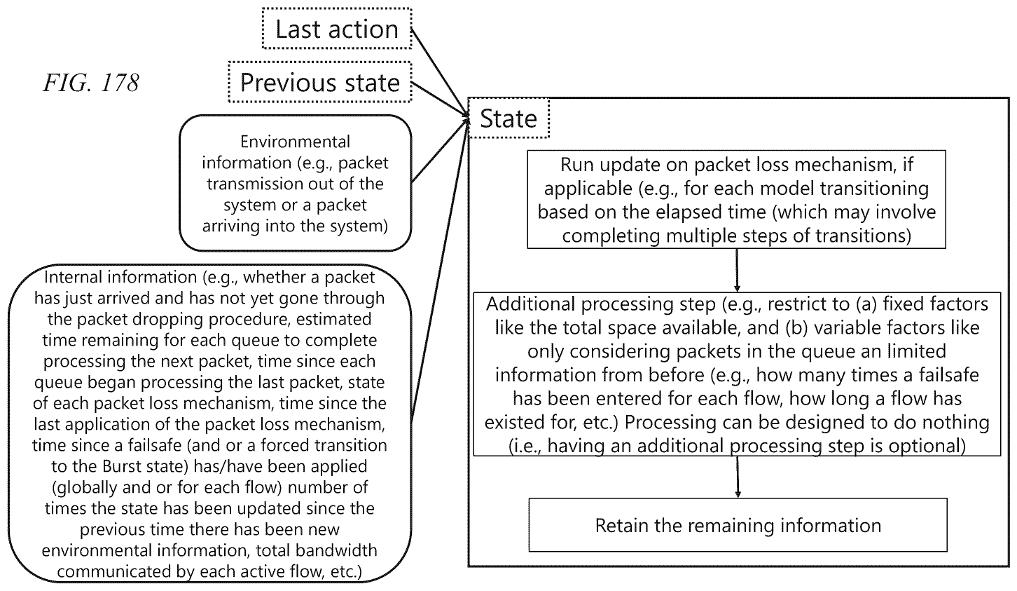

FIG. 178 illustrates the ith time updating the state. Here, the state is meant to capture the situation of the queue management system; by assumption, the state can track any piece of information pertaining to the system, although some may not be tracked in certain embodiments (as can be accomplished via the additional processing step). The following provides some additional details on how the state may accomplish this. The state is only updated after events (e.g., like a packet arrived or was transmitted, or actions were taken such as dropping packets). The state first makes updates based on the elapsed time. This may involve updating the packet loss mechanism; for example, under the proposed Markov model of FEC-aware packet loss mechanism, one or more state transitions may be needed.

The following is an example of completing multiple steps of transitions. Consider the example of 90 ms, 120 ms, and 50 ms being the only values in the distributions of time until transition for the Burst, post-burst, and Ready state, respectively. Suppose the model is currently in the Burst state, and it has been in that state for 0 ms. The Burst state timer runs for 90 ms. So, the system models transitions to the post-Burst state after 90 ms had occurred. Now, the post-Burst state timer runs for 120 ms. Then, the system transitions after 120 ms, leaving the model in the Ready state for the next 50 ms and imposes packet losses based on the Ready state. The state may also distill information (additional processing step), such as to avoid having too many possible states; this will better enable the use of reinforcement learning. After distilling the information, information is retained in the state (which can then be used by other parts of the system, all of which have access to the state).

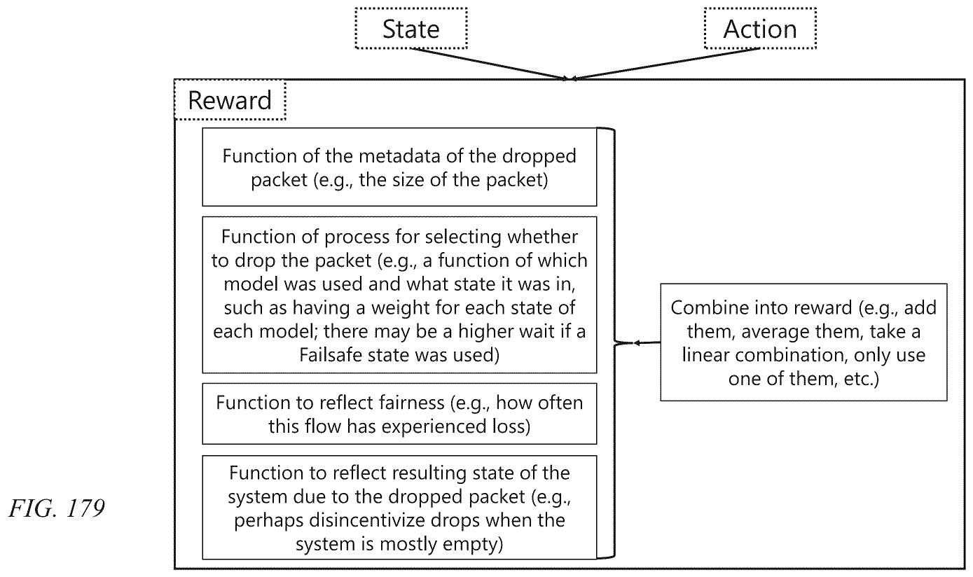

FIG. 179 illustrates an example of a possible type of reward function: reward only based on dropped packet (i.e., not for a packet allocation). Here, the reward mechanism is meant to encourage learning effective policies towards overarching goals like (a) handling congestion, (b) fairness (e.g., across flows or across time), (c) maximizing goodput, and (d) enabling communication with a high quality of experience. In certain embodiments, fairness may be measured by metrics like percent of packets lost, estimated loss-recovery rate, and throughput relative to other flows.

The following is one possible way to provide reward: rewards only occur when a packet is dropped by considering four main intrinsic sources of (negative) reward (a) a function of properties of the packet being dropped, like how much data it contained, (b) a function of whether the manner of dropping packets is intended to be recoverable (e.g., recover the lost video frame in time to play it if the application is videoconferencing); for example, if the a forced state change (including to the Failsafe) has not been triggered for a sufficiently long time (e.g., long enough in ms so that at least i time slots have passed through under CSIPB; e.g., at least 133.33 ms having passed for a 30 fps call. Another example is waiting at least the worst-case intended time to decode the final packet of the burst, which may be handled with 150 ms for some applications), (c) a function of the fairness of dropping this packet (e.g., has the flow to which the packet belongs been targeted for an unfair number of packet losses), and (d) a function of the state (e.g., system-level properties) such as indicating that the packet drop was needed to avoid overflowing a buffer versus the system being mostly empty.

Certain embodiments use a reward function that combines these four factors in a predetermined manner. For example, create a function (e.g., a metric) to measure the value/costs of an action for each of the four proposed values (e.g., function of factor (a), function of factor (b), function of factor (c), and function of factor (d)). Then create a second function to combine these four values into a reward (e.g., take a linear combination of them; one such linear combination may be adding the negative of their absolute values).

One way to do this is to have the four functions corresponding to (a-d) be (a) the size of the dropped packet normalized by the maximum transmittable unit; (b) one if a state transition has just been forced by the packet dropping procedure to enter the Burst-state or the Failsafe state before 150 ms have passed while in some combination of the Post-burst state, and otherwise zero; (c) the sum of (i) the frequency that a state transition has just been forced by the packet dropping procedure to enter the Burst-state or the Failsafe state before 150 ms have passed while in some combination of the Post-burst state and or the Ready state, and (ii) the average fraction of the bandwidth (across all flows) used by a flow minus the fraction of the total bandwidth used by the current flow in the last 150 ms; (d) the ratio between how much data is in the system (not including the packet to be dropped) to the size of the system. To combine these four quantities in a reward, one may add (i) the negative of the absolute value of the first quantity plus (ii) the negative of the absolute value of the second quantity plus (iii) the negative absolute value of the third quantity plus (iv) one minus the fourth quantity.

It should be noted that machine learning (including reinforcement learning) can be used to determine any of the queue management parameters described above.

Some additional aspects of FEC-aware queue management and queue-aware FEC and/or compression are disclosed in Appendix A of U.S. Provisional Patent Application No. 63/687,570, which is incorporated herein by reference.

### GENERALITIES

All inventions disclosed in this patent application are intended to apply to any effectively equivalent model and/or methodology. Any generalization, extension, or modification that can be reduced to the inventions disclosed would be considered as being covered. Some examples are presented below.

Variable frame rate generality (Generality 1). Consider a scenario where the frames are not created with a constant frame rate. This scenario can still be captured under the loss-recovery models described herein (e.g., CSIPB and CSIPBRAL), for example, as follows. Use a faster frame rate so the time between frames is some small value, w (which is used here as a variable and is not related to the ratio of the circumference of a circle to its diameter), where during each time slot, one of two things occurs: (a) no frame is generated, as can be represented with a pseudo-frame of size “0” symbols D[i]=“ ”; or (b) a frame, D[i], is generated. Metadata can indicate if a pseudo-frame or frame was generated. Then τ can be set based on the duration w to ensure a tolerable latency. Setting bᵢ appropriately can reflect a partial burst covering the same duration (e.g., in ms) as in the original model, but bᵢ can also be set with more granularity. Similarly, setting

$$( and {l}_{i}^{( G )} )$$

where the value during any time slot corresponding to a pseudo-frame equals the value of the prior time slot would capture the same effect as in the previous model; but lᵢ

$$( and {l}_{i}^{( G )} )$$

can also be set with more granularity. Applying loss-recovery innovations (e.g., CSIBRAL or CSIPB) to the new model (i.e., with π ms between time slots and some time slots having pseudo-frames) captures applying the invention to the scenario of a non-constant frame rate.

For example, suppose that a frame is generated every ˜33.3 ms. In between these frames (i.e., every ˜16.67 ms) a supplementary frame may or may not be generated (e.g., as an optional supplementary frame). Then one can model the system as having a frame generated every 16.67 ms where sometimes a frame of size 0 is created. In some embodiments, metadata for the supplementary frame may indicate for it to be allocated entirely to the first component with the intention that it is recovered within (τ−1) time slots; sometimes this stipulation may be combined with setting τ so that all frames are recovered during time slots corresponding to the frames generated every ˜33.3 ms, and parity symbols are only sent during such time slots. In other embodiments, the intention will be for each frame to be recovered within τ time slots (so such metadata would not be used). The example highlights the broadness of the class of models/approaches captured under the inventions.

For data compression, consider the description under “generality 1.” FEC-Aware compression can be made more powerful by applying a similar model (e.g., reducing the time between frames with the understanding that some time slots may correspond to pseudo-frames). Under such a model, compression has more granularity. For example, spreading information of a frame over multiple time slots (which would otherwise be “pseudo-frames”) can impose “pacing,” where pacing involves spreading the transmission of symbols corresponding to a frame (data and/or parity) over the duration between the frame's creation and the creation of the next frame. This can be done through the compression methodology allocating symbols of one frame over multiple time slots of small granularity where said allocation is contained within a time slots corresponding to pseudo-frames (i.e., before the next frame is created). Such an approach may or may not be combined with the FEC scheme setting τ to be small enough to leave room for the spreading of symbols of a frame over multiple time slots (i.e., the delay of (a) spreading over XX time slots, plus (b) loss recovery taking i time slots is within a desired threshold).

Another power granted to the compression method is to create frames at different frequencies depending on the underlying content. For example, if something changes in the video, such as moving the camera, it could be reflected sooner (e.g., via a supplementary frame). Another example is to send different granularities of the frame over multiple time slots (during time slots that would otherwise be called pseudo-frames, which occur before the next frame).

The compression methodology may choose to never use the “pseudo-frames” by always setting the information content to be empty during those time slots without loss of generality. As such, the additional optionality enabled by the extended model with the ability for “pseudo-frames” is not limiting.

Variability of τ generality (Generality 2). As discussed above, the parameter r could vary during a call. The loss-recovery models described herein (e.g., CSIPB and CSIPBRAL) can capture modeling i as frequently changing. For example, consider embodiments where the first component is designed to be recovered within (τ−1) time slots when losses are within the tolerance of being deemed partial bursts. Suppose τ is modeled as changing at most once per time slot; this captures larger changes for τ by changing τ by one over multiple time slots (e.g., in a short period of time). For example, under CSIPBRAL and CSIPB, it is possible to maintain the same code design and recover within the new deadline by allocating all symbols of the new frame (where r changes) to (a) the first component if τ is reduced by one, and (b) to the second component if τ is increased by one. If a partial burst starts with the frame, loss recovery would hold within the new τ. If the partial burst started in an earlier frame and encompasses the new frame, all first components of all frames in the partial burst (including the new frame) will be recovered within τ−1 (for the new τ) time slots from the new time slot. Also, the second component will still be recovered within i time slots of the new time slot (for the new τ). FEC-aware compression and/or compression-aware FEC can be optimized for such a model (where τ can change by one per time slot); for example, the optimization may be via jointly training FEC-aware compression and compression-aware FEC, or the optimization may be via alternating fixing one (of FEC-aware compression and compression-aware FEC) and training the other, such as using machine learning, such as reinforcement learning.

The reasons for changes in τ can include, for example, a change in one-way delay, frame rate, etc. For example, if the frame rate changes from fixed (e.g., 30 fps) to variable (e.g., as discussed in “Generality 1”), then the new model may be captured by changing τ. Under a variable frame rate, τ may slightly change from frame to frame (e.g., reducing or increasing by one depending on whether the time slot corresponds to one where there is always a frame or whether there is only sometimes a supplementary frame). In other settings with a variable frame rate, τ may be fixed.

### MISCELLANEOUS

In certain embodiments, metadata of various kinds may be transmitted from the sender to the receiver (e.g., metadata on how the sender is splitting frames, metadata on allocating parity symbols, a seed value for a pseudorandom number generator used for random linear combinations, metadata regarding usage of failsafe, etc.). It should be noted that such metadata could be conveyed in any appropriate manner, e.g., in message headers of messages carrying encoded data, embedded encoded or unencoded within the channel frames, in a separate stream (which may or may not also employ some form of erasure coding to recover from losses), etc. If sent in a separate stream, the separate stream could be encoded using techniques described herein to better ensure receipt of the information.

It should be noted that embodiments are not limited to any particular order of data symbols and parity symbols within channel frames.

While the above disclosure has concentrated on the methods of the present invention in the context of the overall system, it should be noted that the present invention can also take the form of a sender device, method, computer program product, and integrated circuit that performs some or all of the sender functions discussed above (e.g., splitting video frames into two components based on loss estimation parameters, generating parity data, forming channel frames, and transmitting the channel frames to the receiver in accordance with the described methodologies), and the present invention also can take the form of a receiver device, method, computer program product, and integrated circuit that performs some or all of the receiver functions discussed above (e.g., recovering video frames from received channel frames and providing loss estimation feedback to the sender in accordance with the described methodologies). More generally, Applicant reserves the right to claim any inventive aspect whether part of a sender device, a receiver device, or a larger system and in whatever form is appropriate, e.g., a system, device, method, computer program product, integrated circuit, etc.

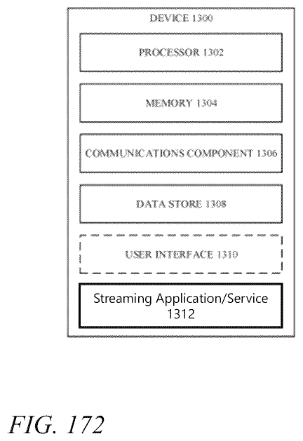

FIG. 172 is a schematic block diagram showing components of a sender device and/or receiver device 1300 in accordance with certain embodiments. In one aspect, device 1300 may include processor 1302 for carrying out processing functions associated with one or more of components and functions described herein. Processor 1302 can include a single or multiple set of processors or multi-core processors. Moreover, processor 1302 can be implemented as an integrated processing system and/or a distributed processing system.

Device 1300 may further include memory 1304, such as for storing local versions of operating systems (or components thereof) and/or applications being executed by processor 1302, such as a streaming application/service 1312, etc., related instructions, parameters, etc. Memory 1304 can include a type of memory usable by a computer, such as random access memory (RAM), read only memory (ROM), tapes, magnetic discs, optical discs, volatile memory, non-volatile memory, and any combination thereof.

Further, device 1300 may include a communications component 1306 that provides for establishing and maintaining communications with one or more other devices, parties, entities, etc. utilizing hardware, software, and services as described herein. Communications component 1306 may carry communications between components on device 1300, as well as between device 1300 and external devices, such as devices located across a communications network and/or devices serially or locally connected to device 1300. For example, communications component 1306 may include one or more buses, and may further include transmit chain components and receive chain components associated with a wireless or wired transmitter and receiver, respectively, operable for interfacing with external devices.

Additionally, device 1300 may include a data store 1308, which can be any suitable combination of hardware and/or software, that provides for mass storage of information, databases, and programs employed in connection with aspects described herein. For example, data store 1308 may be or may include a data repository for operating systems (or components thereof), applications, related parameters, etc. not currently being executed by processor 1302. In addition, data store 1308 may be a data repository for streaming application/service 1312 and/or one or more other components of the device 1300.

Device 1300 may optionally include a user interface component 1310 operable to receive inputs from a user of device 1300 and further operable to generate outputs for presentation to the user. User interface component 1310 may include one or more input devices, including but not limited to a keyboard, a number pad, a mouse, a touch-sensitive display, a navigation key, a function key, a camera, a microphone, a voice recognition component, a gesture recognition component, a depth sensor, a gaze tracking sensor, a switch/button, any other mechanism capable of receiving an input from a user, or any combination thereof. Further, user interface component 1310 may include one or more output devices, including but not limited to a display, a speaker, a wired or wireless audio interface, a haptic feedback mechanism, a printer, any other mechanism capable of presenting an output to a user, or any combination thereof. For example, user interface 1310 may allow for receiving video, audio, and other information for transmission as part of a videoconference or other application via streaming application/service 1312 and/or may render streaming content from streaming application/service 1312 for consumption by a user (e.g., on a display of the device 1300, an audio output of the device 1300, and/or the like).

Device 1300 may additionally include the streaming application/service 1312, which, for a sender device 110, may include or implement some or all of the video encoder 111, the frame splitter 112, the parity symbol generator 113, the packetizer 114, and/or the loss parameter generator 115, and for a receiver device 120, may include or implement some or all of the video decoder 121, the loss estimator 122, and/or the loss recovery processor 123.

It should be noted that embodiments include “full duplex” embodiments, e.g., where a first video stream is being sent from a first party to a second party (in which case the first party is the sender and the second party is the receiver for the first video stream) and where a second video stream is being sent from the second party to the first party (in which case the second party is the sender and the first party is the receiver for the second video stream). Without limitation, this can be particularly useful for two-way videoconferencing. Embodiments likewise can extend to multiparty communication (e.g., videoconferencing with any number of people, such as by applying the methodology for each pair of people), for example, as depicted schematically in FIG. 59 in which a connection between a sender and a receiver indicates that they are communicating.

By way of example, an element, or any portion of an element, or any combination of elements may be implemented with a “processing system” that includes one or more processors. Without limitation, some examples of processors include microprocessors, microcontrollers, digital signal processors (DSPs), graphics processing units (GPUs), tensor processing units (TPUs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software.

Such a processing system can be implemented in any of a wide variety of devices and systems, including, without limitation, such things as computing devices and systems, data communication devices and systems, video streaming systems (e.g., live video streaming), video conferencing systems, extended reality systems (e.g., virtual reality, augmented reality, mixed reality, etc.), portable computing devices (e.g., smartphones, tablet computers, etc.), wearable computing devices (e.g., smart watches, VR goggles, VR headsets, smart gloves, etc.), smart vehicles (e.g., drones, self-driving vehicles, etc.), in-vehicle entertainment systems (e.g., airplanes, trains, etc.), communication satellites, video security systems, etc.

As used herein, the term software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media. The above hardware description is provided to enable any person skilled in the art to practice the various aspects described herein.

It should be noted that headings are used above for convenience and are not to be construed as limiting the present invention in any way.

Various embodiments of the invention may be implemented at least in part in any conventional computer programming language. For example, some embodiments may be implemented in a procedural programming language (e.g., “C”), or in an object-oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

In alternative embodiments, the disclosed apparatus and methods (e.g., as in any flow charts or logic flows described above) may be implemented as a computer program product for use with a computer system. Such implementation may include a series of computer instructions fixed on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as a tangible, non-transitory semiconductor, magnetic, optical or other memory device, and may be transmitted using any communications technology, such as optical, infrared, RF/microwave, or other transmission technologies over any appropriate medium, e.g., wired (e.g., wire, coaxial cable, fiber optic cable, etc.) or wireless (e.g., through air or space).

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

Computer program logic implementing all or part of the functionality previously described herein may be executed at different times on a single processor (e.g., concurrently) or may be executed at the same or different times on multiple processors and may run under a single operating system process/thread or under different operating system processes/threads. Thus, the term “computer process” refers generally to the execution of a set of computer program instructions regardless of whether different computer processes are executed on the same or different processors and regardless of whether different computer processes run under the same operating system process/thread or different operating system processes/threads. Software systems may be implemented using various architectures such as a monolithic architecture or a microservices architecture.

Importantly, it should be noted that embodiments of the present invention may employ conventional components such as conventional computers (e.g., off-the-shelf PCs, mainframes, microprocessors), conventional programmable logic devices (e.g., off-the shelf FPGAs or PLDs), or conventional hardware components (e.g., off-the-shelf ASICs or discrete hardware components) which, when programmed or configured to perform the non-conventional methods described herein, produce non-conventional devices or systems. Thus, there is nothing conventional about the inventions described herein because even when embodiments are implemented using conventional components, the resulting devices and systems (e.g., components of the sender 110 and/or receiver 120) are necessarily non-conventional because, absent special programming or configuration, the conventional components do not inherently perform the described non-conventional functions.

The activities described and claimed herein provide technological solutions to problems that arise squarely in the realm of technology. These solutions as a whole are not well-understood, routine, or conventional and in any case provide practical applications that transform and improve computers and computer routing systems.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Various inventive concepts may be embodied as one or more methods, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements.

This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

To the extent of any inconsistency or conflict in the definition or use of terms between any of the incorporated publications, documents or things and the present application, those of the present application shall prevail.

Described embodiments are considered as illustrative only of the principles of the present invention. Further, since numerous modifications and changes will readily occur to those skilled in the art based on the teachings herein, it is not desired to limit the invention to the exact construction and operation shown and described herein.

Accordingly, all suitable modifications and equivalents may be resorted to and should be assumed to fall within the scope of the invention as may be further defined in this and any subsequent regular patent application's claims to the invention.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Various inventive concepts may be embodied as one or more methods, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Various embodiments of the present invention may be characterized by the potential claims listed in the paragraphs following this paragraph (and before the actual claims provided at the end of the application). These potential claims form a part of the written description of the application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public. Nor are these potential claims intended to limit various pursued claims.

Without limitation, potential subject matter that may be claimed (prefaced with the letter “P” so as to avoid confusion with the actual claims presented below) includes:

P1. A queue management system (including but not limited to active queue management systems), method, computer program product, or integrated circuit that selectively manages flows based on methods for how the data of the flows have been encoded (such as FEC and/or compression) and/or characteristics of the flows (including but not limited to loss-recovery capabilities).

P2. The queue management system, method, computer program product, or integrated circuit of claim P1, wherein management comprises selectively dropping packets of a given flow based on methods for how the data of the flow have been encoded (such as FEC and/or compression) and/or FEC characteristics of the flow (including but not limited to loss-recovery capabilities).

P3. The queue management system, method, computer program product, or integrated circuit of claim P2, wherein selectively dropping packets introduces partial burst losses in the packet flow.

P4. The queue management system, method, computer program product, or integrated circuit of claim P2, wherein selectively dropping packets is based on a Markov chain to introduce partial burst losses in the packet flow.

P5. The queue management system, method, computer program product, or integrated circuit of claim P2, wherein selectively dropping packets is based on a policy of fairness across multiple packet flows.

P6. The queue management system, method, computer program product, or integrated circuit of claim P2, wherein selectively dropping packets is based on introducing packet loss characteristics that are well-suited to FEC and/or compression (e.g., by introducing losses through a process likely to impose partial bursts); the method may or may not have and/or use information about FEC and/or compression parameters employed by flows, e.g., the method applies even if no information about flows' FEC and/or compression is known (which may be the typical environment in which the queue management system operates) such as by introducing losses as short periods of time with heavier (random) losses followed by short periods of time with lesser (random) losses—guardspaces—so that the flows can adapt to the “partial bursts” to obtain reliable communication with less bandwidth overhead of parity.

P7. The queue management system, method, computer program product, or integrated circuit of claim P2, wherein selectively dropping packets is based on at least one of the type of flow, QoS/QoE specifications for the flow, the value of FEC parameters being used to produce the flow (e.g., i), the frame splitting scheme used to produce the flow, which may be fixed or variable frame splitting, the parity allocation scheme used to produce the flow, guard space characteristics for the flow, or failsafe characteristics for the flow.

P8. The queue management system, method, computer program product, or integrated circuit of claim P1, wherein selectively queueing packets comprises deciding which of a plurality of queues to queue a given packet.

P9. The queue management system, method, computer program product, or integrated circuit of claim P1, wherein selectively queueing packets comprises selectively reallocating packets across a plurality of queues.

P10. The queue management system, method, computer program product, or integrated circuit of claim P1, wherein the queue management system is treated as an agent and trained, based on actions in various states and a reward function, either offline or online (e.g., using reinforcement learning).

P11. The queue management system, method, computer program product, or integrated circuit of claim P1, wherein the queue management system and FEC schemes of flows are treated as agents and trained, based on actions in various states and a reward function, either offline or online (e.g., using reinforcement learning).

P12. The queue management system, method, computer program product, or integrated circuit of claim P10, wherein the training involves joint training.

P13. The queue management system, method, computer program product, or integrated circuit of claim P10, wherein the training involves fixing a combination of some (possibly none or all) of the flows and the queue management system, training that which is not fixed, and then iterating (by changing what is fixed).

P14. A combination of (a) queue management system, method, computer program product, or integrated circuit, (b) FEC mechanism, and/or (c) compression methodology wherein the sub-systems of each component among (a), (b), and/or (c) can be tuned based on other components among (a), (b), and/or (c).

P15. The combination of claim P14, wherein parameters (e.g., of the loss-estimator, frame splitter, parity allocator of (a)) of each sub-system (of (a), (b), and/or (c)) are trained jointly through machine learning (including reinforcement learning).

P16. The combination of claim P14, wherein parameters (e.g., of the loss-estimator, frame splitter, parity allocator of (a)) of each sub-system (of (a), (b), and/or (c)) are trained by (i) fixing a combination of some (possibly none or all) of (a) the queue management system, (b) FEC mechanism, and/or (c) compression methodology then (ii) training that which is not fixed, and then (iii) iterating (by changing what is fixed).

P17. The system, method, computer program product, or integrated circuit of any one of claims P1-P13, wherein the queue management system selectively manages flows based on methods for how the data of the flows have been encoded by a frame splitting encoder comprising:
a frame splitter configured to split each of a number of data frames i into a plurality of components including at least a first component Γ[i] and a second component Υ[i];
a parity symbol generator configured to allocate parity symbols for the components to ensure that (a) if the fraction of packets lost during time slot i is at most

$${l}_{i}^{( G )}$$

and the data of all prior frames is available, then the parity symbols sent during a time slot suffice to recover the lost data during that time slot, and (b) if time slot i is part of a partial burst starting in time slot j (i.e., for each time slot z∈{j, . . . , j+bⱼ−1}, l_{z} or fewer fraction of the packets sent during the time slot are lost where i∈{j, . . . , j+bⱼ−1}) followed by a partial guard space (i.e., for each time slot z∈{j+bⱼ, . . . , j+bⱼ−1+τ}, l_{z}^{(G)} or fewer fraction of the packets sent during the time slot are lost) and all the data of frames before the start of the partial burst is available, then the data for frame i is recovered within i time slots; and
a packetizer configured to packetize the components and the parity symbols.

P18. The system, method, computer program product, or integrated circuit of claim P17, wherein parity symbols are allocated such that all lost data for the first component of the frames is to be recovered by (τ−1) time slots after the start of the partial burst and the second component of each frame of the partial burst is recovered r time slots later.

P19. The system, method, computer program product, or integrated circuit of claim P18, wherein the second component of the frames in a partial guard space after the partial burst are recovered by (τ−1) time slots after the start of the partial burst excluding future frames τ or more time slots after the start of the partial burst.

P20. The system, method, computer program product, or integrated circuit of claim P17, wherein parity symbols are allocated such that there are two or more types of parity symbols where one type of parity symbol for a frame is independent of the symbols of the second component of the same frame.

P21. The system, method, computer program product, or integrated circuit of claim P20, wherein the parity symbols allocated for a data frame i include at least a first set of parity symbols P[i] and a second set of parity symbols G[i] based on the plurality of components, wherein the second set of parity symbols is configured to ensure that (a) some parity symbols of a data frame can be used to recover the first component of the same data frame, (b) some parity symbols of a data frame can be used to recover the second component of the same data frame, and (c) some parity symbols of a data frame cannot be used to recover the second component of the data frame.

P22. The system, method, computer program product, or integrated circuit of claim P21, wherein the number of parity symbols allocated to P[i] and G[i] is based on the parameter

$${l}_{i}^{( G )} .$$

P23. The system, method, computer program product, or integrated circuit of claim P22, wherein the parameter

$${l}_{i}^{( G )}$$

is set to approximate an upper bound on the fraction of packets that may be lost during time slot i if there is no partial burst encompassing time slot i for which loss recovery is needed.

P24. The system, method, computer program product, or integrated circuit of claim P22, wherein

$${l}_{i}^{( G )}$$

is set so that the fraction of losses during time slot i is no more than

$${l}_{i}^{( G )}$$

with some probability.

P25. The system, method, computer program product, or integrated circuit of claim P21, wherein allocating the parity symbols comprises a two-stage parity allocation of (a) pre-allocating p_{i+τ} during time slot i for robustness to partial bursts then (b) increasing the size of pᵢ during time slot i for robustness to loss in the partial guard space; the size of G[i] can then be set during time slot i.

P26. The system, method, computer program product, or integrated circuit of claim P21, wherein the variable frame splitting encoder is multimodal.

P27. The system, method, computer program product, or integrated circuit of claim P21, wherein the number of parity symbols to be sent with the data of data frame i is set with the intention of (a) loss recovery during time slot i if there is no partial burst (and losses defined as partial guard space) and (b) loss recovery during time slot i of the second component of frame (i−τ) (i.e., Υ[i−τ]) which reflects if the partial burst encompasses frame (i−τ).

P28. The system, method, computer program product, or integrated circuit of claim P27, wherein:
if the partial burst includes time slot i, then some of the parity symbols are used to recover a subset of D[i] and/or some of the parity symbols are used to recover Γ[i−τ+1:i−1]; and
if the partial burst starts after time slot (i−τ) and ends before time slot i, then the parity symbols are used to recover lost symbols of Γ[i−τ+1:i−1] depending on the time slot in which the burst starts.

P29. The system, method, computer program product, or integrated circuit of claim P27, wherein the number of parity symbols pᵢ+gᵢ is set so that when

$${l}_{i}^{( G )}$$

fraction of the parity symbols are lost and a partial burst encompasses time slot (i−τ), the number of received parity symbols

$${p}_{i}^{R} + {g}_{i}^{R}$$

is approximately equal to (a) the number of missing symbols D[i] plus (b) the number of missing symbols of Υ[i−τ] less the number of received symbols of G[i−τ], where this subtraction is bounded below by 0.

P30. The system, method, computer program product, or integrated circuit of claim P29, wherein gᵢ is set so that the at least

$${g}_{i}^{R} = ( 1 - {l}_{i}^{( G )} ) {g}_{i}$$

received symbols of G[i] suffice to recover the lost symbols of Υ[i], leaving

$${p}_{i}^{R}$$

symbols of P[i] to recover the lost symbols of Γ[i] and Υ[i−τ].

P31. The system, method, computer program product, or integrated circuit of claim P29, wherein pᵢ is set approximately as follows:

$${p}_{i} ( 1 - {l}_{i}^{( G )} ) = {γ}_{i} {l}_{i}^{( G )} + max ( 0 , {l}_{i - τ} {υ}_{i - τ} - ( 1 - {l}_{i - τ} ) {g}_{i - τ} ) ,$$

leading to:

$${p}_{i} = ⌈ \frac{{γ}_{i} {l}_{i}^{( G )} + max ( 0 , {l}_{i - τ} {υ}_{i - τ} - ( 1 - {l}_{i - τ} ) {g}_{i - τ} )}{( 1 - {l}_{i}^{( G )} )} ⌉ ,$$

and the ceiling is taken to ensure pᵢ is an integer.

P32. The system, method, computer program product, or integrated circuit of claim P31, wherein pᵢ is multiplied by (1+ε) for an ε of small absolute value.

P33. The system, method, computer program product, or integrated circuit of claim P31, wherein the parity symbols are set with the intention that the number of symbols of P[i] is sufficient to recover Γ[i] during time slot i

$$( e . g . , {p}_{i} = ⌈ \frac{{l}_{i} {γ}_{i}}{1 - {l}_{i}^{( G )}} ⌉ )$$

in the event that losses do not exceed a predetermined amount.

P34. The system, method, computer program product, or integrated circuit of claim P33, wherein the predetermined amount is defined as only losses as partial guard spaces.

P35. The system, method, computer program product, or integrated circuit of claim P21, wherein the parity symbols are set with the intention that the number of symbols of G[i] is sufficient to recover Υ[i] during time slot i

$$( e . g . , {g}_{i} = ⌈ \frac{{l}_{i} {υ}_{i}}{1 - {l}_{i}^{( G )}} ⌉ )$$

in the event that losses do not exceed a predetermined amount.

P36. The system, method, computer program product, or integrated circuit of claim P35, wherein the predetermined amount is defined as only losses as partial guard spaces.

P37. The system, method, computer program product, or integrated circuit of claim P17, wherein parity symbols are allocated such that the amount of parity symbols is minimized subject to predetermined performance targets for loss recovery.

P38. The system, method, computer program product, or integrated circuit of any one of claims P17-P37, wherein the frame splitter splits the data frames into variable size components.

P39. The system, method, computer program product, or integrated circuit of any one of claims P17-P37, wherein the frame splitter splits the data frames into fixed size components.

P40. The system, method, computer program product, or integrated circuit of any one of claims P17-P37, wherein at least one of (a) splitting of the data frames into the two or more components or (b) allocating parity symbols for the two or more components or (c) packetizing the components and the parity symbols is based on feedback from a receiver.

P41. The system, method, computer program product, or integrated circuit of any one of claims P17-P37, wherein at least one of (a) splitting of the data frames into the two or more components or (b) allocating parity symbols for the two or more components or (c) packetizing the components and the parity symbols is based on predictive analytics.

P42. The system, method, computer program product, or integrated circuit of any one of claims P17-P37, wherein at least one of (a) splitting of the data frames into the two or more components or (b) allocating parity symbols for the two or more components or (c) packetizing the components and the parity symbols is based on machine learning, such as reinforcement learning.

P43. The system, method, computer program product, or integrated circuit of any one of claims P17-P37, wherein at least one of (a) splitting of the data frames into the two or more components or (b) allocating parity symbols for the two or more components or (c) packetizing the components and the parity symbols is based on reinforcement learning.

P44. The system, method, computer program product, or integrated circuit of any one of claims P17-P37, wherein the frame splitter is configured to select between splitting a given data frame into a single component or into two or more components.

P45. The system, method, computer program product, or integrated circuit of any one of claims P17-P37, wherein frame splitting is based on a heuristic.

P46. The system, method, computer program product, or integrated circuit of any one of claims P17-P37, wherein parity symbol allocation is based on a heuristic.

P47. The system, method, computer program product, or integrated circuit of any one of claims P17-P37, wherein parity symbols allocation includes at least one failsafe.

P48. The system, method, computer program product, or integrated circuit of any one of claims P17-P37, wherein in the frame splitting encoder is a compression-aware frame splitting encoder that uses compression information from a frame compressor to determine FEC parameters for transmitting compressed frames.

P49. The system, method, computer program product, or integrated circuit of claim P48, wherein the compression information comprises metadata indicating whether certain symbols are supplementary (i.e., the data frame is useful without them but even better with them).

P50. The system, method, computer program product, or integrated circuit of claim P49, wherein such supplementary symbols are placed in Υ[i] so that the non-supplementary symbols fit into I [i] to be recovered sooner.

P51. The system, method, computer program product, or integrated circuit of claim P48, wherein the FEC parameters include at least one of frame splitting parameters, parity symbol allocation parameters, and/or packetization parameters.

P52. The system, method, computer program product, or integrated circuit of claim P48, wherein the compression-aware FEC encoder is trained using machine learning (e.g., reinforcement learning), such as to set the protocol for frame splitting, parity allocation, estimating loss parameters, etc.

P53. The system, method, computer program product, or integrated circuit of claim P48, further comprising the frame compressor.

P54. The system, method, computer program product, or integrated circuit of claim P53, wherein at least one mechanism within the compression-aware FEC encoder (e.g., frame splitting, parity allocation, parameter estimation, etc.) and at least one mechanism within the frame compressor (e.g., method to set target size, primary target size, secondary target size, etc.) are trained jointly (e.g., by using machine learning, such as reinforcement learning).

P55. The system, method, computer program product, or integrated circuit of claim P54, wherein all considered mechanisms of the FEC encoder and the frame compressor are trained jointly.

P56. The system, method, computer program product, or integrated circuit of claim P54, wherein the FEC encoder and the frame compressor are trained by alternating (a) fixing some of the mechanisms, and (b) training the non-fixed mechanisms.

P57. The system, method, computer program product, or integrated circuit of any one of claims P17-P37, wherein packetizing the components and the parity symbols uses any of the packetization techniques disclosed herein (e.g., dividing each component and each type of parity symbols into equal size pieces and distributing the pieces across multiple packets).

P58. The system, method, computer program product, or integrated circuit of any one of claims P17-P37, further comprising an FEC-aware frame compressor that utilizes information from the frame splitter about FEC methodology and/or parameters (e.g., from the frame splitting encoder or parity allocator or loss estimator) to control compression of data into one or more compressed frames for the frame splitter.

P59. The system, method, computer program product, or integrated circuit of claim P58, wherein the FEC-aware frame compressor performs selective compression based on anticipated parity allocation.

P60. The system, method, computer program product, or integrated circuit of claim P58, wherein the information from the frame splitter includes at least one of frame splitting and/or parity symbol allocation information and/or indicators of frame splitting and/or parity symbol allocation information for future frames such as parameters of partial bursts and/or guardspaces.

P61. The system, method, computer program product, or integrated circuit of claim P58, wherein the frame compressor selectively spreads information for a time slot over one or more additional time slots.

P62. The system, method, computer program product, or integrated circuit of claim P61, wherein selectively spreading information comprises producing produces a lower resolution compression for an initial decompression and producing a higher resolution compression for a subsequent decompression.

P63. The system, method, computer program product, or integrated circuit of claim P61, wherein selectively spreading information comprises creating a first compression to provide a less refined version of the data for the time slot and sending extra information during one or more later time slots to refine the prior information.

P64. The system, method, computer program product, or integrated circuit of claim P58, wherein the FEC-aware frame compressor is trained using machine learning (e.g., reinforcement learning).

P65. The system, method, computer program product, or integrated circuit of claim P58, wherein both the frame splitting encoder and the FEC-aware frame compressor are trained together using machine learning (e.g., reinforcement learning).

Alternatively, wherein a subset of the mechanisms of the compression-aware FEC encoder (e.g., frame splitting, parity allocation, parameter estimation, etc.) and/or of the frame compressor (e.g., method to set target size, primary target size, secondary target size, etc.) are trained (e.g., using reinforcement learning), optionally wherein the combination may be jointly trained or may be alternating (a) fixing some of the mechanisms, and (b) training the non-fixed mechanisms.

P66. The system, method, computer program product, or integrated circuit of claim P58, wherein the FEC-aware frame compressor utilizes information about FEC methodology and/or parameters (e.g., from a frame splitting encoder or parity allocator or loss estimator) to control the target size of the compressed frame for the FEC encoder.

P67. The system, method, computer program product, or integrated circuit of claim P66, wherein the FEC-aware frame compressor is trained using machine learning (e.g., reinforcement learning where the reward is the number of symbols that are transmitted).

P68. The system, method, computer program product, or integrated circuit of claim P66, wherein both the frame splitting encoder and the FEC-aware frame compressor are trained together using machine learning (e.g., reinforcement learning).

P69. The system, method, computer program product, or integrated circuit of claim P66, wherein the frame compressor tunes the target size based on the relationship between the size of the compressed frame and the number of symbols sent (i.e., number of parity symbols for systematic FEC schemes), optionally, wherein, under certain FEC schemes (e.g., certain embodiments of CSIPB and CSIPBRAL), the amount of extra FEC redundancy (i.e., parity symbols under systematic schemes) sent may be monotonically non-decreasing with the size of the compressed frame, so the marginal cost (in bandwidth usage) of increasing the target size may differ based on the state of the system and target size.

P70. The system, method, computer program product, or integrated circuit of claim P66, wherein the frame compressor tunes the amount of data sent per frame without spreading information content, e.g., by choosing to compress to a smaller number of symbols (providing less information/a lower resolution frame) for a frame i and then for the next frame i+1 compressing to more symbols (providing more information about the next frame/higher resolution).

P71. The system, method, computer program product, or integrated circuit of claim P66, wherein the frame compressor tunes the amount of data sent per frame and also spreads information content, e.g., by choosing to compress to a smaller number of symbols (providing less information/a lower resolution frame) for a frame i and then for the next frame i+1 (a) compressing to more symbols (providing more information about the next frame/higher resolution) while also (b) sending information to help lead to a better resolution of frame i.

P72. The system, method, computer program product, or integrated circuit of claim P66, wherein the frame compressor selectively spreads information for a time slot over one or more additional time slots, e.g., by creating a first compression to provide a less refined version of the data for the time slot and sending extra information during one or more later time slots to refine the prior information.

P73. The system, method, computer program product, or integrated circuit of claim P66, wherein the FEC parameters include at least one of frame splitting parameters, parity symbol allocation parameters, and/or packetization parameters.

P74. The system, method, computer program product, or integrated circuit of claim P66, wherein the frame compressor creates one or more parts as part of compression (and may or may not include metadata about the parts) and distributes the parts over one or more compressed frames.

P75. The system, method, computer program product, or integrated circuit of claim P74, wherein the frame compressor makes two parts, allocates the first part to the current compressed frame and the second part to the subsequent compressed frame, and then uses metadata to indicate that the FEC scheme should place the second part in the first component to lead to loss recovery at a tolerable latency.

P76. The system, method, computer program product, or integrated circuit of claim P66, wherein the frame compressor adjusts the sizes of compressed frames by reducing or increasing the video quality for compressed frames to better control the amount of data needed in compressed frames such that the displayed frames may reduce the granularity of certain frames if necessary to keep the video consistent with the understanding that having a higher quality frame available than is displayed is still useful (e.g., for better inter-frame compression of future frames).

P77. The system, method, computer program product, or integrated circuit of any one of claims P1-P13, wherein the queue management system selectively manages flows based on methods for how the data of the flows have been encoded by frame splitting encoder system comprising a frame splitting encoder that receives data frames and splits each data frame i into two or more components and allocates parity symbols for data frame i including at least a first set of parity symbols P[i] and a second set of parity symbols G[i] based on the two or more components, wherein the parity symbols are configured to ensure that (a) some parity symbols of a data frame can be used to recover the first component of the same data frame, (b) some parity symbols of a data frame can be used to recover the second component of the same data frame, and (c) some parity symbols of a data frame cannot be used to recover the second component of the data frame.

P78. The system, method, computer program product, or integrated circuit of claim P77, wherein some of the parity symbols of a data frame can be used to recover either the first or second component of the same data frame (e.g., G[i]) whereas other parity symbols (e.g., P[i]) can only be used to recover the first component of the data frame (i.e., not the second component).

P79. The system, method, computer program product, or integrated circuit of claim P77, wherein some of the parity symbols of a data frame (e.g., P[i]) can be used to recover the first component (and not the second component) of the data frame and other parity symbols (e.g., G[i]) can be used to recover the second component (and not the first component).

P80. The system, method, computer program product, or integrated circuit of claim P77, wherein the number of parity symbols allocated to P[i] and G[i] is based on a parameter

$${l}_{i}^{( G )}$$

which in some embodiments may approximate an upper bound on the fraction of packets that may be lost (with some probability) during time slot i if there is no partial burst encompassing time slot i for which loss recovery is needed (e.g.,

$${l}_{i}^{( G )}$$

may be set so that the fraction of losses during time slot i is no more than

$${l}_{i}^{( G )}$$

with some probability).

P81. The system, method, computer program product, or integrated circuit of claim P77, wherein allocating the parity symbols comprises a two-stage parity allocation of (a) pre-allocating p_{i+τ} during time slot i for robustness to partial bursts then (b) increasing the size of pᵢ during time slot i for robustness to loss in the partial guard space; the size of G[i] can then be set during time slot i.

P82. The system, method, computer program product, or integrated circuit of claim P77, wherein the variable frame splitting encoder is multimodal.

P83. The system, method, computer program product, or integrated circuit of claim P77, wherein the number of parity symbols to be sent with the data of data frame i is set with the intention of (a) loss recovery during time slot i if there is no partial burst (and losses defined as partial guard space) and (b) loss recovery during time slot i of the second component of frame (i−τ) (i.e., Υ[i−τ]).

P84. The system, method, computer program product, or integrated circuit of claim P77, wherein the number of parity symbols to be sent with the data of data frame i is set with the intention of (a) loss recovery during time slot i if there is no partial burst (and losses defined as partial guard space) and (b) if there is a partial burst starting in frame j encompassing frame i, (i) loss recovery by time slot (j+τ) of the first component of frames j through (j+bⱼ−1) (i.e., Γ[j:j+bⱼ−1]), and (ii) loss recovery by time slot (i+τ) of the second component of frame i (i.e., Υ[i]).

P85. The system, method, computer program product, or integrated circuit of claim P84, wherein loss recovery of the first component of frames j through (j+bⱼ−1) (i.e., Γ[j:j+bⱼ−1]) occurs by time slot by (j+τ−1).

P86. The system, method, computer program product, or integrated circuit of claim P84, wherein the second component of the frames of the guard space will also be recovered in step (i), optionally wherein Υ[j+bⱼ:j+τ−1] (and Γ[j:j+τ−1]) is recovered by time slot (j+τ−1).

P87. The system, method, computer program product, or integrated circuit of claim P78, wherein the number of parity symbols is set so that when

$${l}_{i}^{( G )}$$

fraction of the parity symbols are lost, the number of received parity symbols of

$$P [ i ] ( i . e . , {p}_{i}^{R} )$$

is approximately equal to (a) the number of missing symbols Γ[i] plus (b) the number of missing symbols of of Υ[i−τ] less the number of received symbols of G[i−τ], where this subtraction is bounded below by 0.

P88. The system, method, computer program product, or integrated circuit of claim P87, wherein pᵢ is set approximately as follows:

$${p}_{i} ( 1 - {l}_{i}^{( G )} ) = {γ}_{i} {l}_{i}^{( G )} + max ( 0 , {l}_{i - τ} {v}_{i - τ} - ( 1 - {l}_{i - τ} ) {g}_{i - τ} ) ,$$

leading to:

$${p}_{i} = ⌈ \frac{{γ}_{i} {l}_{i}^{( G )} + max ( 0 , {l}_{i - τ} {υ}_{i - 1} - ( 1 - {l}_{i - τ} ) {g}_{i - τ} )}{( 1 - {l}_{i}^{( G )} )} ⌉ ,$$

and the ceiling is taken to ensure pᵢ is an integer.

P89. The system, method, computer program product, or integrated circuit of claim P88, wherein pᵢ is multiplied by (1+ε) for an ε of small absolute value.

P90. The system, method, computer program product, or integrated circuit of claim P77, wherein the parity symbols are set with the intention that the number of symbols of P[i] is sufficient to recover Γ[i] during time slot i

$$( e . g . , {p}_{i} = ⌈ \frac{{l}_{i} {γ}_{i}}{1 - {l}_{i}^{( G )}} ⌉ )$$

the event that there are not too many losses (e.g., there are only losses as partial guard spaces).

P91. The system, method, computer program product, or integrated circuit of claim P77, wherein the parity symbols are set with the intention that the number of symbols of G[i] is sufficient to recover Υ[i] during time slot i

$$( e . g . , {g}_{i} = ⌈ \frac{{ℓ}_{i} {υ}_{i}}{1 - {ℓ}_{i}^{( G )}} ⌉ )$$

in the event that there are not too many losses (e.g., there are only losses as partial guard spaces).

P92. The system, method, computer program product, or integrated circuit of any one of claims P77-P91, further comprising packetizing the two or more components and the parity symbols using any of the packetization techniques disclosed herein.

P93. The system, method, computer program product, or integrated circuit of claim P92, wherein striping is used.

P94. The system, method, computer program product, or integrated circuit of any one of claims P77-P92, wherein at least one of (a) splitting of the data frames into the two or more components or (b) allocating parity symbols for the two or more components or (c) packetizing the components and the parity symbols is based on machine learning, such as reinforcement learning.

P95. The system, method, computer program product, or integrated circuit of any one of claims P77-P92, further comprising an FEC-aware frame compressor that utilizes information about FEC methodology and/or parameters (e.g., from the frame splitting encoder or parity allocator or loss estimator) to control compression of data into a plurality of compressed frames for the frame splitting encoder.

P96. The system, method, computer program product, or integrated circuit of any one of claims P77-P92, further comprising a frame compressor that compresses data into a plurality of compressed frames for the frame splitting encoder, where in the frame splitting encoder uses compression information from the frame compressor to determine FEC parameters for transmitting the compressed frames.

P97. The system, method, computer program product, or integrated circuit of any one of claims P1-P13, wherein the queue management system selectively manages flows based on methods for how the data of the flows have been encoded by a variable frame splitting encoder that receives data frames and splits each data frame into two or more components, wherein the variable frame splitting encoder uses machine learning (e.g., reinforcement learning) to perform at least one of (a) splitting of the data frames into the two or more components or (b) allocating parity symbols for the two or more components or (c) packetizing the two or more components and/or the parity symbols.

P98. The system, method, computer program product, or integrated circuit of claim P97, wherein the variable frame splitting encoder is a CSIPB variable frame splitting encoder.

P99. The system, method, computer program product, or integrated circuit of claim P97, wherein the variable frame splitting encoder is a CSIPBRAL variable frame splitting encoder.

P100. The system, method, computer program product, or integrated circuit of claim P97, further including at least one of (a) a failsafe of parity symbols including linear combinations of one or more symbols of frames from more than time slots earlier, and (b) a failsafe of sending feedback from the receiver to the sender to generate a keyframe (i.e., an uncompressed frame that does not depend on prior uncompressed frames), such as in the event that a frame is not recovered in a timely manner and/or is deemed unlikely to be recovered in a timely manner.

P101. The system, method, computer program product, or integrated circuit of any one of claims P1-P13, wherein the queue management system selectively manages flows based on methods for how the data of the flows have been encoded by an encoder that generates, for each of a number of data frames i, a single component having all symbols of the data frame, in combination with any of the parity generation, packetization, and/or compression techniques disclosed herein.

P102. The system, method, computer program product, or integrated circuit of claim P101, wherein the encoder supports both (a) splitting frames into a single component and (b) splitting frames into two or more components, such that the encoder can select how to split frames, e.g., on a frame-by-frame or per-call basis.

P103. The system, method, computer program product, or integrated circuit of claim P102, wherein the encoder selects how to split frames based on feedback from a receiver.

P104. The system, method, computer program product, or integrated circuit of claim P102, wherein the encoder selects how to split frames based on predictive analytics.

P105. The system, method, computer program product, or integrated circuit of claim P102, wherein the encoder selects how to split frames based on machine learning, such as reinforcement learning.

P106. The system, method, computer program product, or integrated circuit of claim P101, wherein the encoder is configured to selectively generate two types of parity symbols for a given single component.

P107. The system, method, computer program product, or integrated circuit of any one of claims P1-P13, wherein the queue management system selectively manages flows based on methods for how the data of the flows have been encoded by an FEC-aware frame compressor that utilizes information about FEC methodology and/or parameters (e.g., from a frame splitting encoder or parity allocator or loss estimator) to control compression of data into a one or more compressed frames for the frame splitting encoder (e.g., selective compression based on anticipated parity allocation).

P108. The system, method, computer program product, or integrated circuit of claim P107, wherein the FEC parameters include at least one of frame splitting and/or parity symbol allocation information and/or indicators of frame splitting and/or parity symbol allocation information for future frames such as parameters of partial bursts and/or guardspaces.

P109. The system, method, computer program product, or integrated circuit of claim P107, wherein the frame compressor selectively spreads information for a time slot over one or more additional time slots.

P110. The system, method, computer program product, or integrated circuit of claim P109, wherein selectively spreading information comprises producing produces a lower resolution compression for an initial decompression and producing a higher resolution compression for a subsequent decompression.

P111. The system, method, computer program product, or integrated circuit of claim P109, wherein selectively spreading information comprises creating a first compression to provide a less refined version of the data for the time slot and sending extra information during one or more later time slots to refine the prior information.

P112. The system, method, computer program product, or integrated circuit of claim P107, wherein the FEC-aware frame compressor is trained using machine learning (e.g., reinforcement learning).

P113. The system, method, computer program product, or integrated circuit of claim P107, wherein both the frame splitting encoder and the FEC-aware frame compressor are trained together using machine learning (e.g., reinforcement learning), additionally or alternatively wherein a subset of the mechanisms of the compression-aware FEC encoder (e.g., frame splitting, parity allocation, parameter estimation, etc.) and/or of the frame compressor (e.g., method to set target size, primary target size, secondary target size, etc.) are trained (e.g., using reinforcement learning) such as by jointly training or alternating (a) fixing some of the mechanisms, and (b) training the non-fixed mechanisms.

P114. The system, method, computer program product, or integrated circuit of any one of claims P1-P13, wherein the queue management system selectively manages flows based on methods for how the data of the flows have been encoded by an FEC-aware frame compressor that utilizes information about FEC methodology and/or parameters (e.g., from a frame splitting encoder or parity allocator or loss estimator) to control the target size of the compressed frame for the FEC encoder.

P115. The system, method, computer program product, or integrated circuit of claim P114, wherein the FEC-aware frame compressor is trained using machine learning.

P116. The system, method, computer program product, or integrated circuit of claim P114, wherein the FEC-aware frame compressor is trained using reinforcement learning where the reward is the number of symbols that are transmitted).

P117. The system, method, computer program product, or integrated circuit of claim P114, wherein both the frame splitting encoder and the FEC-aware frame compressor are trained together using machine learning (e.g., reinforcement learning).

P118. The system, method, computer program product, or integrated circuit of claim P114, wherein the frame compressor tunes the target size based on the relationship between the size of the compressed frame and the number of symbols sent (i.e., number of parity symbols for systematic FEC schemes).

P119. The system, method, computer program product, or integrated circuit of claim P118, wherein, under certain FEC schemes (e.g., certain embodiments of CSIPB and CSIPBRAL), the amount of extra FEC redundancy (i.e., parity symbols under systematic schemes) sent may be monotonically non-decreasing with the size of the compressed frame, so the marginal cost (in bandwidth usage) of increasing the target size may differ based on the state of the system and target size.

P120. The system, method, computer program product, or integrated circuit of claim P114, wherein the FEC parameters include at least one of frame splitting parameters, parity symbol allocation parameters, and/or packetization parameters.

P121. The system, method, computer program product, or integrated circuit of claim P114, wherein the frame compressor creates one or more parts as part of compression (and may or may not include metadata about the parts) and distributes the parts over one or more compressed frames.

P122. The system, method, computer program product, or integrated circuit of claim P121, wherein the compressor makes two parts, allocates the first part to the current compressed frame and the second part to the subsequent compressed frame, and then uses metadata to indicate that the FEC scheme should place the second part in the first component to lead to loss recovery at a tolerable latency.

P123. The system, method, computer program product, or integrated circuit of claim P114, wherein the frame compressor adjusts the sizes of compressed frames by reducing or increasing the video quality for compressed frames to better control the amount of data needed in compressed frames such that the displayed frames may reduce the granularity of certain frames if necessary to keep the video consistent with the understanding that having a higher quality frame available than is displayed is still useful in some situations (e.g., for better inter-frame compression of future frames).

P124. The system, method, computer program product, or integrated circuit of any one of claims P1-P13, wherein the queue management system selectively manages flows based on methods for how the data of the flows have been encoded by a frame compressor that tunes the amount of data sent per frame without spreading information content, e.g., by choosing to compress to a smaller number of symbols (providing less information/a lower resolution frame) for a frame i and then for the next frame i+1 compressing to more symbols (providing more information about the next frame/higher resolution).

P125. The system, method, computer program product, or integrated circuit of any one of claims P1-P13, wherein the queue management system selectively manages flows based on methods for how the data of the flows have been encoded by a frame compressor that tunes the amount of data sent per frame and also spreads information content, e.g., by choosing to compress to a smaller number of symbols (providing less information/a lower resolution frame) for a frame i and then for the next frame i+1 (a) compressing to more symbols (providing more information about the next frame/higher resolution) while also (b) sending information to help lead to a better resolution of frame i.

P126. The system, method, computer program product, or integrated circuit of any one of claims P1-P13, wherein the queue management system selectively manages flows based on methods for how the data of the flows have been encoded by a frame compressor that selectively spreads information for a time slot over one or more additional time slots, e.g., by creating a first compression to provide a less refined version of the data for the time slot and sending extra information during one or more later time slots to refine the prior information.

P127. The system, method, computer program product, or integrated circuit of any one of claims P1-P13, wherein the queue management system selectively manages flows based on methods for how the data of the flows have been encoded by a compression-aware FEC encoder that receives compressed frames from a frame compressor and splits each compressed frame into one or more components to be sent over one or more time slots, wherein the compression-aware FEC encoder uses compression information from the frame compressor to determine FEC parameters for transmitting the compressed frames.

P128. The system, method, computer program product, or integrated circuit of claim P127, wherein the compression information comprises metadata indicating whether certain symbols are supplementary (i.e., the data frame is useful without them but even better with them), optionally wherein such supplementary symbols are placed in Υ[i] so that the non-supplementary symbols fit into I [i] to be recovered sooner.

P129. The system, method, computer program product, or integrated circuit of claim P127, wherein the FEC parameters include at least one of frame splitting parameters, parity symbol allocation parameters, and/or packetization parameters.

P130. The system, method, computer program product, or integrated circuit of claim P127, wherein the compression-aware FEC encoder is trained using machine learning (e.g., reinforcement learning), such as to set the protocol for frame splitting, parity allocation, estimating loss parameters, etc.

P131. The system, method, computer program product, or integrated circuit of claim P127, wherein some mechanisms within the compression-aware FEC encoder (e.g., frame splitting, parity allocation, parameter estimation, etc.) and the frame compressor (e.g., method to set target size, primary target size, secondary target size, etc.) are trained (e.g., by using machine learning, such as reinforcement learning).

P132. The system, method, computer program product, or integrated circuit of claim P131, wherein all considered mechanisms of the FEC encoder and the frame compressor are trained jointly.

P133. The system, method, computer program product, or integrated circuit of claim P131, wherein the FEC encoder and the frame compressor are trained by alternating (a) fixing some of the mechanisms, and (b) training the non-fixed mechanisms.

P134. A system, method, computer program product, or integrated circuit comprising an FEC encoder configured to make frame splitting, parity symbol allocation, and/or packetization decisions based on known and/or anticipated queue management policy.

P135. A system, method, computer program product, or integrated circuit comprising a data compressor configured to make compression decisions based on known and/or anticipated queue management policy.

Although the above discussion discloses various exemplary embodiments of the invention, it should be apparent that those skilled in the art can make various modifications that will achieve some of the advantages of the invention without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive.

What is claimed is:

1. A queue management system comprising:
at least one queue for storing and forwarding packets associated with a number of data flows; and
a queueing manager comprising at least one processor and at least one tangible, non-transitory computer-readable memory storing instructions which, when executed by the at least one processor, perform computer processes to manage queueing of packets including, for each data flow, determining forward error correction (FEC) and/or data compression encoding characteristics for the data flow associated with an encoding system for the data flow and managing queueing of data flow packets using the at least one queue based on the encoding characteristics for the data flow including at least selectively dropping and/or reordering data flow packets based on the encoding characteristics for the data flow.

2. The queue management system of claim 1, wherein the encoding characteristics include at least one of how the data of the flow has been encoded or loss-recovery capabilities of the flow.

3. The queue management system of claim 2, wherein selectively dropping and/or reordering packets introduces patterns of losses in the data flow that are consistent with loss recovery capabilities of the encoding system.

4. The queue management system of claim 3, wherein the patterns of losses include partial burst losses with optional guardspaces or partial guardspaces in the packet flow consistent with loss recovery capabilities of the encoding system.

5. The queue management system of claim 1, wherein some or all of the encoding characteristics are received by the queueing manager from the data flow encoding system and/or some or all of the encoding characteristics are derived by the queueing manager from the data flow packets.

6. The queue management system of claim 1, wherein selectively dropping and/or reordering packets is based on at least one of the type of encoding system, the type of flow, QoS/QoE specifications for the flow, FEC parameters used by the encoding system to produce the flow (e.g., τ), a frame splitting scheme used to produce the flow, a parity allocation scheme used to produce the flow, guard space characteristics for the flow, failsafe characteristics for the flow, or a data compression scheme used to produce the flow.

7. The queue management system of claim 1, wherein managing queueing of data flow packets comprises at least one of deciding which of a plurality of queues to queue a given packet or selectively reallocating packets across a plurality of queues.

8. The queue management system of claim 1, wherein the queueing manager is trained, alone or together with the encoding system, based on actions in various states and a reward function, optionally wherein the training involves fixing a combination of some (possibly none or all) of the flows and the queue management system, training that which is not fixed, and then iterating by changing what is fixed.

9. The queue management system of claim 8, wherein at least one of the queueing manager component, the FEC encoding component, or the data compression encoding component is tuned based on at least one of the other components, optionally wherein parameters of each component are trained jointly through reinforcement or other machine learning.

10. The queue management system of claim 1, wherein the encoding system includes an FEC encoding system, optionally wherein the FEC encoding system is a CSIPB or CSIPBRAL FEC encoding system.

11. A method for managing queuing of packets associated with a number of data flows using at least one queue, the method comprising, for each data flow:
determining, by a queueing manager, forward error correction (FEC) and/or data compression encoding characteristics for the data flow associated with an encoding system for the data flow; and
managing, by a queueing manager, queueing of data flow packets using the at least one queue based on the encoding characteristics for the data flow including at least selectively dropping and/or reordering data flow packets based on the encoding characteristics for the data flow.

12. The method of claim 11, wherein the encoding characteristics include at least one of how the data of the flow has been encoded or loss-recovery capabilities of the flow.

13. The method of claim 12, wherein selectively dropping and/or ordering packets introduces patterns of losses in the data flow that are consistent with loss recovery capabilities of the encoding system.

14. The method of claim 13, wherein the patterns of losses include partial burst losses with optional guardspaces or partial guardspaces in the packet flow consistent with loss recovery capabilities of the encoding system.

15. The method of claim 11, wherein some or all of the encoding characteristics are received by the queueing manager from the data flow encoding system and/or some or all of the encoding characteristics are derived by the queueing manager from the data flow packets.

16. The method of claim 11, wherein selectively dropping and/or reordering packets is based on at least one of the type of encoding system, the type of flow, QoS/QoE specifications for the flow, FEC parameters used by the encoding system to produce the flow (e.g., τ), a frame splitting scheme used to produce the flow, a parity allocation scheme used to produce the flow, guard space characteristics for the flow, failsafe characteristics for the flow, or a data compression scheme used to produce the flow.

17. The method of claim 11, wherein managing queueing of data flow packets comprises at least one of deciding which of a plurality of queues to queue a given packet or selectively reallocating packets across a plurality of queues.

18. The method of claim 11, further comprising training the queueing manager, alone or together with the encoding system, based on actions in various states and a reward function, optionally wherein the training involves fixing a combination of some (possibly none or all) of the flows and the queue management system, training that which is not fixed, and then iterating by changing what is fixed.

19. The method of claim 18, wherein at least one of the queueing manager component, the FEC encoding component, or the data compression encoding component is tuned based on at least one of the other components, optionally wherein parameters of each component are trained jointly through reinforcement or other machine learning.

20. The method of claim 11, wherein the encoding system includes an FEC encoding system, optionally wherein the FEC encoding system is a CSIPB or CSIPBRAL FEC encoding system.
